(19) United States
(12) Patent Application Publication
(10) Pub. No.: US 2024/0140868 A1
(43) Pub. Date: May 2, 2024

(54) BINDER REDUCING FORMULATION, CEMENTITIOUS COMPOSITIONS CONTAINING SAME, AND METHODS OF PREPARATION

(71) Applicant: Advanced Tech Crete, LLC, Austin, TX (US)

(72) Inventors: Jason Sharkey, Austin, TX (US); Frank Caruso, Austin, TX (US); Paul Brogan, The Woodlands, TX (US)

(21) Appl. No.: 18/384,130

(22) Filed: Oct. 26, 2023

Related U.S. Application Data
(60) Provisional application No. 63/420,867, filed on Oct. 31, 2022.

(51) Int. Cl. C04B 24/42; C04B 14/02; C04B 14/06; C04B 14/28; C04B 20/02; C04B 24/16; C04B 28/04; C04B 40/00

(52) U.S. Cl. CPC C04B 24/42; C04B 14/026; C04B 14/062; C04B 14/28; C04B 20/023; C04B 24/16; C04B 28/04; C04B 40/0046; C04B 40/0057; C04B 2103/0093

(57) ABSTRACT

Hydraulic binder reducing formulation, agent or additive for cementitious compositions, cementitious compositions containing same, and method of preparing the same. The binder reducing formulation comprises carbon nanotubes, preferably functionalized carbon nanotubes, most preferably carboxylic acid functionalized multi-wall carbon nanotubes. The binder reducing formulation may also comprise one or more of silane, glycerol, nanosilica and a surfactant. The cementitious compositions including the binder reducing formulation achieve strength values equal to or greater than strength values achieved with similar or identical cementitious compositions but devoid of the binder reducing composition.

This application claims priority of U.S. Provisional Application Ser. No. 63/420,867 filed on Oct. 31, 2022, the disclosure of which is hereby incorporated by reference.

### BACKGROUND

In general terms, concrete is a mixture of aggregates and binder. The aggregates typically include sand and gravel or crushed stone; the binder is typically water and a hydraulic cement such as Portland cement. Cement normally comprises from 10 to 15 percent by volume of a concrete mix. Hydration causes the cement and water to harden and bind the aggregates into a rock-like mass. This hardening process continues for years so that concrete strengthens over time.

Portland cement is a hydratable cement that primarily comprises one or more of hydraulic calcium silicates, aluminates and aluminoferrites, and one or more forms of calcium sulfate (e.g., gypsum), sand or clay, bauxite, and iron ore. It may also include other components such as shells, chalk, marl, shale, slag, and slate. The components typically are mixed and heated in cement processing plants to form clinker, which is then ground to a powder that can be mixed with water to form a paste or binder. Portland cement may be combined with one or more supplemental cementitious materials, such as fly ash, granulated blast furnace slag, limestone, natural pozzolans, or mixtures thereof, and provided as a blend, all of which binds aggregates together to make concrete.

The manufacture of Portland cement generates a significant amount of carbon dioxide, particularly during firing of the kiln where calcination of limestone occurs, releasing carbon dioxide. It is estimated that from 8% to 10% of global greenhouse gas emissions come from cement production and have a negative impact on global warming. Carbon dioxide is generated by both the cement production process and by energy plants that generate power to run the production process, (e.g., fossil fuel burning). Reduction of the carbon footprint of concrete thus has generated considerable interest. This can be accomplished by reducing the amount of Portland cement in concrete, but this typically is accompanied by a concomitant reduction in strength.

Carbon nanotubes (CNT's), including single-wall nanotubes, or SWCNTs, and multi-wall nanotubes or MWCNTs, have been proposed as additives to concrete to improve strength properties. However, these are difficult to disperse in aqueous solutions, thereby complicating the production process and effectively limiting their use.

It is an object of embodiments disclosed herein to provide reduced carbon footprint cementitious and concrete compositions and methods of making the same without sacrificing certain properties, such as workability and/or strength. In preferred embodiments, it is an object to provide reduced carbon footprint cementitious and concrete compositions having less cement and/or less water than conventional formulations, while surprisingly having no loss in strength, and even having increased tensile, flexural, compressive and/or mechanical strength.

It is a further object of embodiments disclosed herein to provide binder reducing formulations and preparation methods therefor that when incorporated into cementitious compositions, result in the maintenance or improvement of the mechanical strength of the compositions even if such compositions contain smaller amounts of hydraulic binder.

These and other objects, features and advantages of the embodiments disclosed herein will become apparent after a review of the following detailed description.

### SUMMARY

Problems of the prior art have been overcome by embodiments disclosed herein, which include building materials, and in particular, cementitious compositions having a reduced carbon footprint, concrete compositions having a reduced carbon footprint, methods of producing the same, and binder reducing formulations enabling the same.

In some embodiments, the cementitious compositions include a binder reducing formulation, agent or additive, wherein the binder reducing formulation, agent or additive comprises carbon nanotubes (functionalized and non-functionalized), preferably functionalized carbon nanotubes, most preferably carboxylic acid functionalized multi-wall carbon nanotubes. In certain embodiments, cementitious compositions including the binder reducing formulation achieve strength values equal to or greater than strength values achieved with similar or identical cementitious compositions but devoid of the binder reducing composition (e.g., a cementitious composition consisting essentially of Portland cement, aggregate, sand and water). In certain embodiments, these strength values are achieved despite the cementitious compositions having less binder than similar or identical cementitious compositions devoid of the binder reducing formulation. Thus, the binder reducing formulation may partially replace the hydraulic binder with no sacrifice in strength of the resulting cured concrete. In certain embodiments, the binder reducing formulation may partially replace the hydraulic binder with an increase in strength of the resulting cured concrete.

In certain embodiments, the cementitious compositions disclosed herein may be useful in construction materials, such as roadways, airport runways, bridges, commercial and residential buildings, etc.

In some embodiments, the binder reducing formulation also comprises one or more of silane, glycerol, nanosilica and a surfactant, monomer or polymer. In a preferred embodiment, the binder reducing formulation includes each of silane, glycerol, nanosilica and a surfactant. A suitable silane is (3-glycidoxypropyl)-trimethoxysilane. In some embodiments, the binder reducing formulation, the cementitious compositions and the concrete formed therewith are devoid of polycarboxylate-based superplasticizers. In some embodiments, the binder reducing formulation does not include any essential constituents other than the carbon nanotubes, silane, glycerol, nanosilica and a surfactant, and therefore consists essentially of carbon nanotubes, silane, glycerol, nanosilica and a surfactant, and particularly consists essentially of an aqueous solution of carboxy-functionalized multi-wall carbon nanotubes, silane, glycerol, nanosilica and (3-glycidoxypropyl)-trimethoxysilane. In some embodiments, the binder reducing formulation consists of an aqueous solution of carboxy-functionalized multi-wall carbon nanotubes, silane, glycerol, nanosilica and (3-glycidoxypropyl)-trimethoxysilane.

In some embodiments, disclosed are methods of producing cementitious compositions and concrete having a reduced carbon footprint, comprising combining a binder, aggregate and sand with a binder reducing formulation, wherein the binder reducing formulation may be prepared by forming a first aqueous mixture of silane and glycerol; combining a portion of said first mixture with carbon nanotubes and a first surfactant and applying ultrasonic energy, or direct or indirect sonication, to form a second mixture; combining another portion of said first mixture with nanosilica and a second surfactant and applying, ultrasonic energy, or direct or indirect sonication to form a third mixture; and combining the second and third mixtures to form a fourth mixture. In some embodiments, the first and second surfactants in the second and third mixtures are the same. In some embodiments, the surfactant is sulfonated melamine formaldehyde. The fourth mixture may be combined with a cementitious binder, such as Portland cement, and aggregate, sand and water, to form a modified cementitious composition that upon setting, exhibits excellent mechanical strength.

Accordingly, some embodiments relate to a binder reducing formulation for preparation of a cementitious composition, comprising acid functionalized carbon nanotubes, glycerol, silane, nanosilica and a surfactant. In some embodiments, the carbon nanotubes are carboxylic acid functionalized. In some embodiments, the surfactant comprises an organosilane, and may be (3-glycidoxypropyl)-trimethoxysilane.

In certain embodiments, a cementitious composition is provided comprising a binder reducing effective amount of a binder reducing formulation comprising acid functionalized carbon nanotubes, glycerol, silane, nanosilica and a surfactant, and a hydraulic binder. In some embodiments, the hydraulic binder comprises Portland cement. In some embodiments, the cementitious composition includes aggregate. In some embodiments, the mechanical strength of the cementitious composition, upon curing, is at least 5-20% greater after 28 days than the mechanical strength of an identical cementitious composition devoid of the binder reducing formulation. In some embodiments, the mechanical strength of the cementitious composition, upon curing, is at least 5%, preferably at least 10% greater after 28 days than the mechanical strength of an identical cementitious composition devoid of the binder reducing formulation. In some embodiments, the mechanical strength of the cementitious composition, upon curing, is at least 5%, at least 6%, at least 7%, at least 8%, at least 9%, at least 10%, at least 11%, at least 12%, at least 13%, at least 14%, at least 15%, at least 16%, at least 17%, at least 18%, at least 19% or at least 20%, preferably at least 10%, greater after 28 days than the mechanical strength of an identical cementitious composition devoid of the binder reducing formulation. In some embodiments, the mechanical strength of the cementitious composition, upon curing, has the same or better mechanical strength after curing for 28 days than the mechanical strength of an identical cementitious composition devoid of the binder reducing formulation, despite a reduction in hydraulic binder of 1-30% or more, e.g., despite a hydraulic binder reduction of at least 1%, at least 2%, at least 3%, at least 4%, at least 5%, at least 6%, at least 7%, at least 8%, at least 9%, at least 10%, at least 11%, at least 12%, at least 13%, at least 14%, at least 15%, at least 16%, at least 17%, at least 18%, at least 19%, at least 20%, at least 21%, at least 22%, at least 23%, at least 24%, at least 25%, at least 26%, at least 27%, at least 28%, at least 29% or at least 30%.

In certain embodiments, disclosed is a method of preparing a binder reducing formulation for incorporation into a cementitious composition to reduce the amount of hydraulic binder in the cementitious composition without a concomitant loss in mechanical strength, the method comprising preparing a first aqueous mixture of silane and glycerol; combining carbon nanotubes and a surfactant, and subjecting the resulting combination to ultrasonic energy, followed by incorporating a first portion of the first aqueous mixture to form a second mixture; combining a second portion of the first aqueous solution with nanosilica and a surfactant to form a third mixture and applying ultrasonic energy to the third mixture; and combining the second and third mixtures to form the binder reducing formulation. In some embodiments, the first aqueous mixture is stored or allowed to sit for 2-24 hours, preferably at least about 8 hours, most preferably from 8-24 hours, prior to combining it with the second and third mixtures. In some embodiments, the carbon nanotubes comprise carboxylic acid functionalized multi-wall carbon nanotubes. In some embodiments, the surfactant comprises sulfonated melamine formaldehyde. In some embodiments, the method further comprises combining a binder reducing effective amount of the binder reducing formulation with a hydraulic binder to form a cementitious composition. In some embodiments, the hydraulic binder comprises Portland cement.

In certain embodiments, disclosed is a binder reducing formulation for addition to a cementitious composition comprising a hydraulic binder, said binder reducing formulation comprising carbon nanotubes, glycerol, silane, nanosilica and a surfactant.

In certain embodiments, the carbon nanotubes are carboxylic acid functionalized.

In certain embodiments, the carbon nanotubes are multi-wall carbon nanotubes.

In certain embodiments, the surfactant comprises an organosilane. In certain embodiments, the surfactant comprises (3-glycidoxypropyl)-trimethoxysilane.

In certain embodiments, disclosed is a cementitious composition comprises a hydraulic binder and a binder reducing formulation comprising carbon nanotubes, glycerol, silane, nanosilica and a surfactant.

In certain embodiments, the hydraulic binder in the cementitious composition comprises Portland cement. In certain embodiments, the cementitious composition further comprises aggregate.

In certain embodiments, the amount of the binder reducing agent in the cementitious composition is effective to achieve a mechanical strength of the cementitious composition 28 days after curing that is at least 5% greater than the mechanical strength 28 days after curing of an identical cementitious composition devoid of said binder reducing composition. In certain embodiments, the amount of the binder reducing formulation is effective to achieve a mechanical strength of the cementitious composition 28 days after curing that is at least 10% greater than the mechanical strength 28 days after curing of an identical cementitious composition devoid of said binder reducing composition.

In certain embodiments, the cementitious composition further comprises one or more chemical admixtures selected from the group consisting of water-reducing agent, viscosity modifying agent, corrosion-inhibitor, shrinkage reducing admixture, set accelerator, set retarder, air entrainer, air detrainer, strength enhancer, pigment, colorant, thickener, and fiber for plastic shrinkage control or structural reinforcement.

In certain embodiments, the carbon nanotubes in the cementitious composition are acid-functionalized multi-wall carbon nanotubes.

In certain embodiments, disclosed is a method of preparing a binder reducing formulation for incorporation into a cementitious composition to reduce the amount of a hydraulic binder in the cementitious composition without a concomitant loss in strength, comprising:
a. preparing a first aqueous mixture of silane and glycerol;
b. combining carbon nanotubes and a surfactant, and subjecting the resulting combination to sonication, followed by incorporating a first portion of the first aqueous mixture to form a second mixture;
c. combining a second portion of the first aqueous solution with nanosilica and a surfactant to form a third mixture and applying sonication to the third mixture; and
d. combining the second and third mixtures to form the binder reducing composition.

In certain embodiments, the first aqueous mixture is stored for at least about 2 hours prior to combining it with the second and third mixtures.

In certain embodiments, the carbon nanotubes used in the method comprise carboxylic acid functionalized multi-wall carbon nanotubes.

In certain embodiments, the surfactant used in the method comprises sulfonated melamine formaldehyde.

In certain embodiments, the method further comprises combining the binder reducing formulation with cementitious composition comprising a hydraulic binder to form a modified cementitious composition.

In certain embodiments, the hydraulic binder used in the method comprises Portland cement.

In certain embodiments, the amount of the hydraulic binder used in the method of forming the modified cementitious composition is 5% less than present in an identical composition devoid of the binder reducing agent without a loss in mechanical strength 28 days after curing.

In certain embodiments, the amount of the hydraulic binder used in the method of forming the modified cementitious composition is 10% less than present in an identical composition devoid of said binder reducing agent without a loss in mechanical strength 28 days after curing.

In certain embodiments, the amount of the hydraulic binder used in the method of forming the modified cementitious composition is 15% less than present in an identical composition devoid of said binder reducing agent without a loss in mechanical strength 28 days after curing.

In certain embodiments, the amount of the hydraulic binder used in the method of forming the modified cementitious composition is 20% less than present in an identical composition devoid of said binder reducing agent without a loss in mechanical strength 28 days after curing.

In certain embodiments, the amount of the hydraulic binder used in the method of forming the modified cementitious composition is 25% less than present in an identical composition devoid of said binder reducing agent without a loss in mechanical strength 28 days after curing.

In certain embodiments, the amount of the hydraulic binder used in the method of forming the modified cementitious composition is 30% less than present in an identical composition devoid of said binder reducing agent without a loss in mechanical strength 28 days after curing.

The use of the binder reducing formulation surprisingly enables the formation of cementitious compositions using less binder that would otherwise be necessary to achieve the same strength characteristics. In some embodiments, the use of the binder reducing formulation enables the formation of cementitious compositions with improved strength characteristics when compared to similar or identical formulations having more binder and devoid of the binder reducing composition. Other characteristics, including workability, durability, density and appearance, are not compromised.

In view of the use of the binder reducing formulation and the concomitant decrease in the amount of hydraulic binder necessary to achieve the same or better strength compared to cementitious compositions devoid of the instant binder reducing formulation, a substantial reduction in carbon footprint is achieved.

### DETAILED DESCRIPTION

The singular forms “a,” “an,” and “the” include plural referents unless the context clearly dictates otherwise.

As used in the specification, various devices and parts may be described as “comprising” other components. The terms “comprise (s),” “include (s),” “having,” “has,” “can,” “contain (s),” and variants thereof, as used herein, are intended to be open-ended transitional phrases, terms, or words that do not preclude the possibility of additional components.

Ranges disclosed in the specification may and do describe all subranges therein for all purposes and that all such subranges also form part of the embodiments disclosed herein. Any range recited may be recognized as sufficiently describing and enabling the same range being broken down into at least equal halves, thirds, quarters, fifths, tenths, etc. For example, each range discussed herein can be readily broken down into a lower third, middle third and upper third, etc.

The term “cementitious” may be used herein to refer to materials that comprise Portland cement or which otherwise function as a binder to hold together fine aggregates (e.g., sand) and/or coarse aggregates (e.g., crushed gravel, stone) which may be used for constituting concrete. The cementitious compositions may be formed by mixing required amounts of certain materials, e.g., hydratable cement, water, and fine and/or coarse aggregate, as may be applicable to make the particular cement composition being formed. In certain embodiments, the cementitious material used in embodiments disclosed herein is Portland Cement as defined in ASTM C150, particularly Type I as defined in ASTM C150, which has long been in use with no limitation on the proportions of the major oxides (CaO, SiO₂, Al₂O₃, Fe₂O₃), also referred to as “ordinary Portland cement”, and Type II as defined in ASTM C150, which possesses moderate resistance to sulfate attack because of certain limitations on composition, and is sometimes called moderate-heat cement, and is intermediate between Type I and the low-heat Type IV cement. In certain embodiments, Portland cement Type I/II may be used. In certain embodiments, Portland cement Type 1L or PLC may be used. This is typically a blended cement that contains between 5-15% limestone, and meets ASTM C595, AASHTO M 240 and ASTM C1157 chemical and physical requirements.

All ASTM and AASHTO citations set forth herein are incorporated by reference, including ASTM C150, ASTM C595, ASTM C1157, ASTM C39, ASTM C192, ASTM C617, ASTM C1231, ASTM C31, ASTM C78, ASTM C1202, ASTM C666 and AASHTO M 240.

The term “aggregate” as used herein shall mean and refer to sand, crushed gravel or stone particles, for example, used for construction materials such as concrete, mortar, and asphalt, and this typically involves granular particles of average size between 0 and 50 mm. Aggregates may comprise calciferous, siliceous or siliceous limestone minerals. Such aggregates may be natural sand (e.g., derived from glacial, alluvial, or marine deposits which are typically weathered such that the particles have smooth surfaces) or may be of the “manufactured” type, which are made using mechanical crushers or grinding devices. Aggregates may be fine aggregates and/or coarse aggregates. Aggregates include crushed stone and river rock.

The term “concrete” as used herein will be understood to refer to materials including a cement binder, e.g., a hydratable cement binder (e.g., Portland cement optionally with supplemental cementitious materials such as fly ash, granulated blast furnace slag, limestone, or other pozzolanic materials), water, and aggregates (e.g., sand, crushed gravel or stones, and mixtures thereof), which form a hardened building or civil engineering structure when cured. The concrete may optionally contain one or more chemical admixtures, which can include water-reducing agents, mid-range water reducing agents, high range water-reducing agents (e.g., “superplasticizers”), viscosity modifying agents, corrosion-inhibitors, shrinkage reducing admixtures, set accelerators, set retarders, air entrainers, air detrainers, strength enhancers, pigments, colorants, fibers for plastic shrinkage control or structural reinforcement, and the like. Chemical admixtures may be added as is known in the art to enhance certain properties of the concrete, including, for example rheology (e.g., slump, fluidity), initiation of setting, rate of hardening, strength, resistance to freezing and thawing, shrinkage, etc.

As used herein, the phrase “consisting essentially of” limits the scope of a claim to the specified materials or steps and those that do not materially affect the basic and novel characteristics of the claimed subject matter. The term permits the inclusion of substances which do not materially affect the basic and novel characteristics of the composition, formulation or method under consideration. Accordingly, the expressions “consists essentially of” or “consisting essentially of” mean that the recited embodiment, feature, component, etc. must be present and that other embodiments, features, components, etc., may be present provided the presence thereof does not materially affect the performance, character or effect of the recited embodiment, feature, component, etc. The presence of impurities or a small amount of a material that has no material effect on a composition is permitted. Also, the intentional inclusion of small amounts of one or more non-recited components that otherwise have no material effect on the character or performance of a composition is still included within the definition of “consisting essentially of”.

The preferred binder used herein is Portland cement, most preferably Type 1 and/or Type II, as defined by ASTM C150.

Carbon nanotubes are an allotrope of carbon. Carbon nanotubes are commercially available and may be produced by a variety of methods, including chemical vapor deposition (CVD), arc discharge, laser vaporization, etc. Carbon nanotubes are nano-filaments or nano-fibers composed of sp² hybridized carbon atoms and have a tubular cylindrical shape. Their diameters are in the order of nanometers and lengths on the order of millimeters, leading to high aspect ratios (the ratio between the longest and shortest dimension) and high surface areas. Suitable carbon nanotubes in accordance with embodiments disclosed herein may include single-wall or multi-wall carbon nanotubes, e.g., where the tubes are formed of concentric tubes of varying diameter. Suitable carbon nanotubes or CNTs include elongated carbon material that has at least one minor dimension of about 100 nanometers or less; e.g., an average outer diameter from about 8 nm to about 80 nm, or from about 20 nm to about 30 nm, an average inner diameter from about 2 nm to about 10 nm, or from about 5 nm to about 10 nm, and an average aspect ratio from about 100 to about 4000 or from about 500 to about 1000. Preferred carbon nanotubes useful in embodiments disclosed herein are multi-wall carbon nanotubes. Most preferred carbon nanotubes useful in embodiments disclosed herein are acid functionalized multi-wall carbon nanotubes, particularly carboxylic acid-functionalized multi-wall carbon nanotubes.

Embodiments disclosed herein enable effective dispersion of the nanotubes in the cementitious binder, which has been an issue in the prior art. Dispersion of the nanotubes into the cementitious material is facilitated by the methods of embodiments disclosed herein. In certain embodiments, this dispersion is achieved by preparing a binder reducing formulation that comprises the carbon nanotubes, and combining the binder reducing formulation and the binder, rather than by adding the carbon nanotubes directly to the binder.

In some embodiments, a binder reducing formulation is prepared by preparing a first aqueous mixture of silane and glycerol. Preferably the silane is an organosilane, most preferably (3-glycidoxypropyl)-trimethoxysilane. The silane may be used to functionalize the carbon nanotubes. In some embodiments, the amount of silane in the first aqueous mixture is 1-4 times by volume the amount of glycerol, more preferably 2.5-4 times, most preferably 3.33 times. In some embodiments, there are 1.33 ml of silane and 0.4 ml of glycerol in 500 ml of aqueous solution. In some embodiments, the mixture is stirred for about one minute, such as with a magnetic stirrer, and stored for at least about 2 hours, preferably at least about 8 hours, most preferably for about 8 to about 24 hours, before being combined with additional ingredients as set forth below. Storage for more than 24 hours may be carried out, but with minimal or no additional benefit.

In certain embodiments, a portion of the first mixture is combined with carbon nanotubes and a surfactant, followed by the application of direct or indirect sonication, to form a second mixture. Preferably the carbon nanotubes are carboxylic acid functionalized multiwall carbon nanotubes (MWCNT) such as those commercially available from Sigma Aldrich. Suitable amounts of the carbon nanotubes include 0.025 g to 1 g, most preferably 0.44 g per 200 ml of water. In some embodiments, 0.50 g of MWCNT and 4.5 g of surfactant are used per 16 pounds of Portland cement. In certain embodiments, the surfactant is a melamine formaldehyde, such as naphthalene melamine formaldehyde or sulfonated melamine formaldehyde, the latter being preferred. It can function as a water reducer, promoting accelerated hardening, lowering porosity and improving workability and mechanical strength. Suitable amounts of the surfactant include 1 g to 15 g, most preferably 4.5 g per 200 ml of water. In some embodiments, the carbon nanotubes and surfactant may be subjected to sonication, either direct or indirect for several minutes prior to combining with the first aqueous solution to form the second mixture.

In some embodiments, another portion of the first aqueous solution is combined with nanosilica and a surfactant to form a third mixture. It is believed that the nanosilica functions as a filler, reducing the amount of concrete. Suitable nanosilicas include hydrophilic nanosilicas, colloidal nanosilica and amino modified nanosilica. Suitable amounts of the nanosilica include 1 g to 30 g per 200 ml of water, preferably 20 g per 200 ml of water In certain embodiments, the surfactant is a melamine formaldehyde, such as naphthalene melamine formaldehyde or sulfonated melamine formaldehyde, the latter being preferred. Suitable amounts of the surfactant include 1 g to 10 g per 200 ml of water, most preferably 4.5 g per 200 ml of water. In some embodiments, 20 g of nanosilica and 4.5 g of surfactant are used per 16 pounds of Portland cement. In certain embodiments, the third mixture is subjected to ultrasonic energy for several minutes to disperse the components, and is then combined with the second mixture to form a fourth mixture, which functions as a binder reducing formulation.

In some embodiments, lavender may be added to the binder reducing formulation, e.g. 0.001 ml per 200 ml of water.

Tables 1, 2 and 3 illustrate suitable, preferred and optimal amounts of the various components of the binder reducing formulation:

TABLE 1
Suitable Component Amounts

| COMPONENT | LOWER AMOUNT | UPPER AMOUNT |
|---|---|---|
| Water | 20 ounces | 80 ounces |
| Glycerol | 1 ml | 25 ml |
| Silane | 1 ml | 25 ml |
| Nanosilica | 0.050 g | 50 g |
| Carbon nanotubes | 0.050 g | 5 g |
| Sulfonated melamine | 0.050 g | 15 g |
| formaldehyde | | |

TABLE 2
Preferred Component Amounts

| COMPONENT | LOWER AMOUNT | UPPER AMOUNT |
|---|---|---|
| Water | 40 ounces | 70 ounces |
| Glycerol | 1.5 ml | 10 ml |
| Silane | 1.5 ml | 10 ml |
| Nanosilica | 5 g | 25 g |
| Carbon nanotubes | 0.1 g | 0.5 g |
| Sulfonated melamine | 1 g | 5 g |
| formaldehyde | | |

TABLE 3
Optimum Component Amounts

| COMPONENT | OPTIMUM AMOUNT |
|---|---|
| Water | 64 ounces |
| Glycerol | 2 ml |
| Silane | 5 ml |
| Nanosilica | 18 g |
| Carbon nanotubes | 0.44 g |
| Sulfonated melamine | 1.134 g |
| formaldehyde | |

Table 4 shows exemplary amounts of components:

| | Concentrate | | | | | |
|---|---|---|---|---|---|---|
| | (g) | mL | g/mL | g/Gal | lbs/Gal | % of Weight* |
| Carbon Nanotubes | 0.44 | 200 | 0.0022 | 8.32788 | 0.18150 | 0.00000559 |
| Nanosilica | 18 | 200 | 0.09 | 340.686 | 7.50000 | 0.00023112 |
| Sulfonated melamine | 1.134 | 200 | 0.00567 | 21.46322 | 0.47400 | 0.00001461 |
| formaldehyde | | | | | | |
| Lavender | 0.0001 | 200 | 0.0000005 | 0.001893 | 0.00004 | 0.00000000 |
| Glycerol | 0.111 | 200 | 0.000555 | 2.100897 | 0.04630 | 0.00000143 |
| Silane | 0.556 | 200 | 0.00278 | 10.52341 | 0.23200 | 0.00000715 |

*% by weight in 8 yards of Portland cement (32450.72 lbs of cement)

In certain embodiments, the resulting binder reducing formulation is incorporated into or combined with a binder, aggregate, sand and water, such as during mixing and prior to curing of the cement, to form a modified cementitious composition. Any suitable cement mixing process for forming a cementitious matrix may be used, including mixing a cement compound, an aggregate, and water according to standard ASTMC. In some embodiments, water is combined with a cementitious composition comprising the binder reducing formulation, a hydraulic binder, aggregate and sand to produce a settable hydrated concrete composition capable of setting to form a solid material. When added and used in effective amounts with a hydraulic binder such as Portland cement, the binder reducing formulation provides enhanced 28 day strength to the resultant set or cured composition. Enhanced 28 day strength may be achieved even with a 5%, 10%, 15%, 20%, 30% or even higher reduction in the amount of hydraulic binder. Enhanced strength at 5, 10, 15 and 20 days also may be achieved. In some embodiments, effective amounts of the binder reducing formulation include about 5 gallons per 4-8 yards of concrete. The binder reducing formulation may be incorporated into the cementitious composition alone, or together with other additives or admixtures. It may be added directly into a cement truck containing concrete, such as into the rotatable drum of a cement truck, such as a ready-mix truck. Rotation of the drum uniformly disperses the binder reducing formulation into the cementitious composition, resulting in a modified cementitious composition with the same or greater strength characteristics than an identical cementitious composition devoid of the binder reducing formulation, or resulting in a modified cementitious composition with the same or greater strength characteristics than a cementitious composition devoid of the binder reducing formulation and containing, for example, 5, 10, 15, 20 or 30% less hydraulic binder, but otherwise identical. Stated differently, the binder reducing formulation may partially replace the hydraulic binder of a cementitious composition without a concomitant loss in strength, and in some embodiments, with an actual increase in strength. The resulting modified cementitious compositions may be cured according to standard, well-known formation processes.

In some embodiments, the binder reducing formulation may be housed in any suitable container or packaging, including a container or packaging that may be introduced into the cementitious composition present in a cement truck without any significant deleterious effect on the composition or the truck, and that is capable of releasing the binder reducing formulation into the cementitious composition with little or no additional human intervention. For example, the container or packaging may be made of a material that may be torn, shredded, broken, cracked, punctured, dissolved, disintegrated or otherwise opened during the standard rotation of the cement mixer truck drum, to release the contents of the container or packaging into the drum interior. The container or packaging may be single use, and may be in the form of a bag (e.g., a plastic bag), drum, bottle, can, jar, barrel, bucket, etc. It may contain the binder reducing formulation in concentrated form, in a suitable dosage amount that when diluted by mixing with the contents of the cement mixer truck drum, is effective to achieve the desired strength profiles of the ultimately cured concrete.

In certain embodiments, the resulting blended cement including effective amounts of the binder reducing formulation exhibits strength profiles in conformance with Portland cement minimum standards (e.g., ASTM C39, incorporated herein by reference). In certain embodiments the resulting blended cement including effective amounts of the binder reducing formulation exhibits strength profiles exceeding Portland cement minimum standards, even with less Portland cement than required to meet the same strength profiles in the absence of the binder reducing formulation.

In some embodiments, the cementitious compositions may include other additives depending on the application, as is known by those skilled in the art. For example, thickeners such as fumed or precipitated metal oxides, clays such as bentonite or montmorillonite, associative thickeners such as those sold by Dow or BYK may be used. Suitable thickeners which could help to achieve a desired rheology include polysaccharide biopolymers such as diutan gum, welan gum, and xanthan gum, as well as cellulosic derivatives, guar gum, and starch. Other water soluble or dispersible resins could be used such as polyvinylpyrrolidones, polyvinylalcohols, or (dried) emulsion resins. Cellulosic derivatives also may be used. Other components may be used in amounts of 1-10% to provide a small amount of waterproofing, or corrosion inhibition or prevention of coating defects. Suitable components include lanolin or other waxes such as carnauba wax, fatty acids and their salts, esters or other derivatives, polyethylene and other petroleum waxes, and polydimethyl siloxane.

The cementitious compositions and concrete may optionally contain one or more additional chemical admixtures, which can include water-reducing agents, mid-range water reducing agents, high range water-reducing agents (e.g., superplasticizers), viscosity modifying agents, corrosion-inhibitors, shrinkage reducing admixtures, set accelerators, set retarders, air entrainers, air detrainers, strength enhancers, permeability enhancers, dispersants, foaming agents, pigments, colorants, fibers for plastic shrinkage control or structural reinforcement, and the like. Such chemical admixtures may be added to improve various properties of the concrete, such as its rheology (e.g., slump, fluidity), initiation of setting, rate of hardening, strength, resistance to freezing and thawing, shrinkage, and other properties. Suitable amounts of such admixtures are known or readily ascertainable by those skilled in the art.

While the embodiments described herein include a limited number of embodiments, these specific embodiments are not intended to limit the scope as otherwise described and claimed herein. Modification and variations from the described embodiments exist. More specifically, the following examples are given as a specific illustration of embodiments disclosed, and it should be understood that the embodiments disclosed are not limited to the specific details set forth in the examples.

### Examples

In Examples, the aggregate used was Limestone Rock from Martin-Marietta, 3942; 1″×¼″; the sand used was Concrete Sand from Martin-Marietta 3944; ¼″ Minus; and the binder used was Portland Cement TXI Type I/II unless otherwise specified. A Kobalt Cement Mixer (Model 0241568), Gilson Vibrating Table (HM140), Gilson Vertical Cylinder Capper, Gilson Gray Iron 900 Capping Compound, and UTEST Automatic Compression Testing Machine (Model UTC-4712-FP-N) were used. The compositions were poured into 4″×8″ cylindrical plastic molds for curing and testing.

### Preparation of Binder Reducing Agent

Step 1: Into 64 oz. (1892 ml) of distilled water was added 2 ml of glycerol, and the combination was magnetically stirred for 60 seconds. Then 5 ml of silane was added, followed by magnetic stirring for 60 seconds. The resulting mixture was allowed to stand for At least 2 hours, up to 24 but ideally 8 hours to optimally integrate the components of the mix.

Step 2: In a 400 ml beaker, to 200 ml of the mixture from Step 1 was added 0.44 g of carboxy-functionalized multi-wall carbon nanotubes (MWCNT-COOH) and 1.134 g of sulfonated melamine formaldehyde, and the combination was probe sonicated for 3 minutes at 100% amplitude and 0.7 kJ/1.

In another 400 ml beaker, to 200 ml of the mixture from Step 1 was added 18 g of surface modified (amino) SiO₂ (10-20 nm) and 1.134 g of sulfonated melamine formaldehyde, and the combination was probe sonicated for 1 minute @ 0.7 kJ/l.

In a 600 ml beaker, the liquid concentrates from Steps 2 and 3 were combined and shaken or vibrated to integrate the materials.

400 ml of the resulting mix were added to a cementitious formulation of 8 lbs of Portland cement Type I/II, 16 lbs of aggregate (less than or equal to 1.25″), 16 lbs of sand (cement commercial grade), and 64 ounces of distilled water.

The performance of the binder reducing agent was evaluated by strength tests, as follows. The individual components were weighed to obtain accurate amounts for a 1-2-2 concrete mix. The aggregate, sand, cement, binder reducing agent (when used) and water were mixed in the Kobalt Cement Mixer for 15 minutes. Suitable portions of the resulting mix were removed from the mixer and introduced into the plastic cylinder molds. The molds were then placed onto the Gilson Vibrating Table for 10 minutes, and were then allowed to cure for 24 hours, and then the molds were stripped away. The resulting concrete cylinders were weighed and capped with Gilson Capping Compound in the Gilson Vertical Cylinder Capper. Compression tests were carried out periodically at 5, 10, 15, 20 and 28 days from pour, with results as detailed in the Tables below.

In Table 1, “BASELINE” is Portland cement, sand, aggregate and water, with no binder reducing agent, tested in triplicate (“BASELINE 1” is sample 1, “Batch 1” is sample 2 and “T3” is sample 3 from a first pour; “BASELINE 2” is sample 1, “Batch 2” is sample 2 and “T3′” is sample 3 from a second pour). Each pour was from separate mixes of 8 lbs Portland Cement Type I/II, 16 pounds of aggregate, 16 pounds of sand and 1 gallon of distilled water.

TABLE 1
BASELINE

| | Pour | Weight | Test | Cure | Load | |
|---|---|---|---|---|---|---|
| Formula | Date | (lb) | Date | Days | (lbf) | PSI |
| BASELINE 1 | May, 27 2022 | 7.95 | May 31, 2022 | 5 | 43,675 | 3,478 |
| Batch 1 | | 7.95 | | | 41,627 | 3,314 |
| T3 | | 8.00 | | | 44,586 | 3,550 |
| BASELINE 1 | May, 27 2022 | 7.95 | Jun. 5, 2022 | 10 | 52,754 | 4,201 |
| Batch 1 | | 7.95 | | | 50,485 | 4,029 |
| T3 | | 8.00 | | | 51,176 | 4,078 |
| BASELINE 1 | May, 27 2022 | 7.90 | Jun. 10, 2022 | 15 | 51,988 | 4,140 |
| Batch 1 | | 7.95 | | | 50,518 | 4,023 |
| T3 | | 8.00 | | | 54,292 | 4,325 |
| BASELINE 1 | May, 27 2022 | 8.00 | Jun. 15, 2022 | 20 | 53,708 | 4,277 |
| Batch 1 | | 7.95 | | | 53,621 | 4,280 |
| T3 | | 8.00 | | | 53,030 | 4,223 |
| BASELINE 1 | May, 27 2022 | 8.00 | Jun. 23, 2022 | 28 | 55,165 | 4,393 |
| Batch 1 | | 8.10 | | | 55,874 | 4,456 |
| T3 | | 8.05 | | | 54,047 | 4,304 |
| BASELINE 2 | May, 27 2022 | 7.95 | May 31, 2022 | 5 | 43,696 | 3,479 |
| Batch 2 | | 8.00 | | | 47,232 | 3,765 |
| T3′ | | 8.05 | | | 45,052 | 3,587 |
| BASELINE 2 | May, 27 2022 | 8.00 | Jun. 5, 2022 | 10 | 51,710 | 4,123 |
| Batch 2 | | 8.00 | | | 47,505 | 3,792 |
| T3′ | | 8.00 | | | 55,164 | 4,400 |
| BASELINE 2 | May, 27 2022 | 8.00 | Jun. 10, 2022 | 15 | 55,978 | 4,464 |
| Batch 2 | | 8.05 | | | 54,495 | 4,350 |
| T3′ | | 8.00 | | | 52,842 | 4,208 |
| BASELINE 2 | May, 27 2022 | 8.00 | Jun. 15, 2022 | 20 | 52,114 | 4,150 |
| Batch 2 | | 8.05 | | | 54,600 | 4,348 |
| T3′ | | 8.05 | | | 56,310 | 4,492 |
| BASELINE 2 | May, 27 2022 | 8.05 | Jun. 23, 2022 | 28 | 56,195 | 4,475 |
| Batch 2 | | 7.95 | | | 56,320 | 4,485 |
| T3′ | | 8.00 | | | 56,534 | 4,502 |

In Table 2, “PB45” is Portland cement, sand, aggregate and water, and binder reducing agent, tested in duplicate (“PB45” is sample 1 and “T20” is sample 2 from a first pour; “PB45×2” is sample 1 and “TB20′” is sample 2 from a second pour; “PB45×2” is sample 1 and “TB20”” is sample 2 from a third pour; “PB45×2” is sample 1 and “TB20′”” is sample 2 from a fourth pour; “PB45×2” is sample 1 and “TB21” is sample 2 from a fifth pour; “PB45×2” is sample 1 and “TB23” is sample 2 from a sixth pour; “PB45×2” is sample 1 and “TB24” is sample 2 from a seventh pour; and “PB45×2” is sample 1 and “TB25” is sample 2 from an eighth pour). The first pour was 400 ml of binder reducing agent, 16 lbs Portland Cement Type I/II, 32 pounds of aggregate, 32 pounds of sand and 112 ounces of distilled water. In the first pour, the mixture from Step 1 was held for 24 hours. The second pour was 400 ml of binder reducing agent, 8 lbs Portland Cement Type I/II, 16 pounds of aggregate, 16 pounds of sand and 60 ounces of distilled water. In the second pour, the mixture from Step 1 was held for 24 hours. The third pour was 400 ml of binder reducing agent, 8 lbs Portland Cement Type I/II, 16 pounds of aggregate, 16 pounds of sand and 60 ounces of distilled water. In the third pour, the mixture from Step 1 was held for 16 hours. The fourth pour was 400 ml of binder reducing agent, 8 lbs Portland Cement Type I/II, 16 pounds of aggregate, 16 pounds of sand and 60 ounces of distilled water. In the fourth pour, the mixture from Step 1 was held for 8 hours. The fifth pour was 6400 ml of binder reducing agent, 128 lbs Portland Cement Type I/II, 256 pounds of aggregate, 256 pounds of sand and 896 ounces of distilled water. In the fifth pour, the mixture from Step 1 was held for 24 hours. The sixth pour was 9600 ml of binder reducing agent, 192 lbs Portland Cement Type I/II, 384 pounds of aggregate, 384 pounds of sand and 1344 ounces of distilled water. In the sixth pour, the mixture from Step 1 was held for 24 hours. The seventh pour was 2400 ml of binder reducing agent, 96 lbs Portland Cement Type I/II, 192 pounds of aggregate, 192 pounds of sand and 672 ounces of distilled water. In the seventh pour, the mixture from Step 1 was held for 24 hours. The eighth pour was 800 ml of binder reducing agent, 32 lbs Portland Cement Type I/II, 64 pounds of aggregate, 64 pounds of sand and 224 ounces of distilled water. In the eight pour, the mixture from Step 1 was held for 24 hours.

TABLE 2

| Formula | Pour Date | Weight (lb) | Test Date | Cure Days | Load (lbf) | PSI |
|---|---|---|---|---|---|---|
| PB45 | Jun. 24, 2022 | 8.45 | Jun. 29, 2022 | 5 | 88,970 | 7,089 |
| T20 | | 8.40 | Jun. 29, 2022 | 5 | 85,988 | 6,854 |
| | | 8.45 | Jul. 5, 2022 | 10 | 96,660 | 7,705 |
| | | 8.45 | Jul. 5, 2022 | 10 | 94,645 | 7,541 |
| | | 8.45 | Jul. 9, 2022 | 15 | 97,079 | 7,733 |
| | | 8.45 | Jul. 9, 2022 | 15 | 93,656 | 7,481 |
| | | 8.40 | Jul. 14, 2022 | 20 | 100,039 | 7,976 |
| | | 8.45 | Jul. 14, 2022 | 20 | 99,223 | 7,918 |
| | | 8.45 | Jul. 22, 2022 | 28 | 100,853 | 8,053 |
| | | 8.50 | Jul. 22, 2022 | 28 | 96,839 | 7,715 |
| PB45 x2 | Jun. 24, 2022 | 8.30 | Jun. 29, 2022 | 5 | 79,633 | 6,355 |
| T20′ | | 8.25 | Jul. 5, 2022 | 10 | 83,176 | 6,638 |
| | | 8.20 | Jul. 9, 2022 | 15 | 84,015 | 6,701 |
| | | 8.25 | Jul. 14, 2022 | 20 | 80,707 | 6,437 |
| | | 8.20 | Jul. 22, 2022 | 28 | 89,958 | 7,174 |
| PB45 x2 | Jun. 24, 2022 | 8.35 | Jun. 29, 2022 | 5 | 83,525 | 6,662 |
| T20″ | | 8.30 | Jul. 5, 2022 | 10 | 90,609 | 7,226 |
| | | 8.30 | Jul. 9, 2022 | 15 | 90,624 | 7,223 |
| | | 8.30 | Jul. 14, 2022 | 20 | 92,376 | 7,356 |
| | | 8.25 | Jul. 22, 2022 | 28 | 88,261 | 7,034 |
| PB45 x2 | Jun. 24, 2022 | 8.20 | Jun. 29, 2022 | 5 | 77,598 | 6,185 |
| T20′″ | | 8.20 | Jul. 5, 2022 | 10 | 86,126 | 6,860 |
| | | 8.25 | Jul. 9, 2022 | 15 | 71,471 | 5,704 |
| | | 8.20 | Jul. 14, 2022 | 20 | 86,216 | 6,879 |
| | | 8.20 | Jul. 22, 2022 | 28 | 82,786 | 6,605 |
| PB45 x2 | Jun. 24, 2022 | 8.45 | Jun. 29, 2022 | 5 | 79,850 | 6,364 |
| T21 | | 8.40 | | | 73,173 | 5,832 |
| | | 8.40 | | | 58,768 | 4,687 |
| | | 8.40 | | | 85,353 | 6,818 |
| | | 8.40 | | | 81,225 | 6,468 |
| | | 8.40 | | | 85,401 | 6,809 |
| | | 8.40 | | | 81,563 | 6,502 |
| | | 8.40 | | | 81,484 | 6,501 |
| | | 8.40 | | | 90,323 | 7,198 |
| | | 8.40 | | | 81,041 | 6,459 |
| | | 8.40 | | | 81,268 | 6,484 |
| | | 8.40 | | | 54,581 | 4,357 |
| | | 8.40 | | | 74,299 | 5,922 |
| | | 8.35 | | | 84,245 | 6,722 |
| | | 8.30 | | | 87,905 | 7,007 |
| | | 8.30 | | | 84,061 | 6,699 |
| PB45 x2 | Jun. 24, 2022 | 8.40 | Jul. 5, 2022 | 10 | 92,720 | 7,390 |
| T21 | | 8.40 | | | 81,867 | 6,526 |
| | | 8.40 | | | 83,130 | 6,628 |
| | | 8.40 | | | 93,200 | 7,429 |
| | | 8.35 | | | 78,012 | 6,220 |
| | | 8.35 | | | 83,815 | 6,678 |
| | | 8.35 | | | 78,774 | 6,283 |
| | | 8.35 | | | 73,216 | 5,843 |
| | | 8.35 | | | 85,153 | 6,799 |
| | | 8.35 | | | 79,902 | 6,374 |
| | | 8.30 | | | 78,858 | 6,282 |
| | | 8.30 | | | 96,086 | 7,659 |
| | | 8.30 | | | 72,327 | 5,761 |
| | | 8.30 | | | 76,331 | 6,093 |
| | | 8.30 | | | 77,200 | 6,146 |
| | | 8.30 | | | 76,547 | 6,108 |
| PB45 x2 | Jun. 24, 2022 | 8.35 | Jul. 9, 2022 | 15 | 87,266 | 6,953 |
| T21 | | 8.35 | | | 85,842 | 6,845 |
| | | 8.35 | | | 80,025 | 6,380 |
| | | 8.35 | | | 89,773 | 7,153 |
| | | 8.35 | | | 78,668 | 6,264 |
| | | 8.35 | | | 88,521 | 7,053 |
| | | 8.35 | | | 79,207 | 6,324 |
| | | 8.35 | | | 88,014 | 7,025 |
| | | 8.35 | | | 88,803 | 7,089 |
| | | 8.35 | | | 83,998 | 6,696 |
| | | 8.35 | | | 87,274 | 6,955 |
| | | 8.30 | | | 68,404 | 5,448 |
| | | 8.30 | | | 65,271 | 5,206 |
| | | 8.30 | | | 86,615 | 6,902 |
| | | 8.30 | | | 79,773 | 6,360 |
| | | 8.30 | | | 77,800 | 6,212 |
| PB45 x2 | Jun. 24, 2022 | 8.35 | Jul. 14, 2022 | 20 | 88,211 | 7,026 |
| T21 | | 8.30 | | | 77,357 | 6,175 |
| | | 8.30 | | | 78,576 | 6,262 |
| | | 8.30 | | | 88,154 | 7,023 |
| | | 8.30 | | | 91,372 | 7,283 |
| | | 8.30 | | | 88,061 | 7,017 |
| | | 8.30 | | | 81,431 | 6,491 |
| | | 8.30 | | | 81,062 | 6,462 |
| | | 8.30 | | | 80,618 | 6,424 |
| | | 8.30 | | | 74,817 | 5,970 |
| | | 8.30 | | | 89,413 | 7,127 |
| | | 8.30 | | | 93,041 | 7,414 |
| | | 8.30 | | | 80,561 | 6,422 |
| | | 8.30 | | | 88,962 | 7,085 |
| | | 8.30 | | | 91,607 | 7,312 |
| | | 8.30 | | | 96,935 | 7,731 |
| PB45 x2 | Jun. 24, 2022 | 8.35 | Jul. 22, 2022 | 28 | 68,142 | 5,435 |
| T21 | | 8.35 | | | 79,178 | 6,320 |
| | | 8.35 | | | 82,132 | 6,550 |
| | | 8.35 | | | 83,087 | 6,630 |
| | | 8.35 | | | 75,516 | 6,028 |
| | | 8.35 | | | 75,344 | 6,005 |
| | | 8.30 | | | 80,782 | 6,448 |
| | | 8.30 | | | 73,743 | 5,884 |
| | | 8.30 | | | 84,596 | 6,747 |
| | | 8.30 | | | 73,502 | 5,860 |
| | | 8.30 | | | 82,065 | 6,543 |
| | | 8.30 | | | 69,605 | 5,550 |
| | | 8.30 | | | 78,922 | 6,293 |
| | | 8.25 | | | 87,672 | 6,990 |
| | | 8.25 | | | 76,364 | 6,089 |
| | | 8.40 | | | 80,479 | 6,417 |
| PB45 x2 | Jun. 29, 2022 | 8.15 | Jul. 5, 2022 | 5 | 72,877 | 5,809 |
| T23 | | 8.20 | | | 65,935 | 5,257 |
| | | 8.20 | | | 72,523 | 5,779 |
| | | 8.20 | | | 84,071 | 6,421 |
| | | 8.20 | | | 79,055 | 6,311 |
| | | 8.20 | | | 80,570 | 6,434 |
| | | 8.20 | | | 73,323 | 5,844 |
| | | 8.20 | | | 85,179 | 6,799 |
| | | 8.20 | | | 78,005 | 6,227 |
| | | 8.20 | | | 69,103 | 5,510 |
| | | 8.25 | | | 81,620 | 6,510 |
| | | 8.25 | | | 73,505 | 5,859 |
| | | 8.25 | | | 79,839 | 6,370 |
| | | 8.25 | | | 51,693 | 4,124 |
| | | 8.25 | | | 80,821 | 6,449 |
| | | 8.25 | | | 77,044 | 6,151 |
| | | 8.25 | | | 83,776 | 6,677 |
| | | 8.25 | | | 73,950 | 5,895 |
| | | 8.25 | | | 84,978 | 6,769 |
| | | 8.25 | | | 82,450 | 6,572 |
| | | 8.30 | | | 87,383 | 6,965 |
| | | 8.30 | | | 84,335 | 6,720 |
| | | 8.30 | | | 79,006 | 6,298 |
| | | 8.30 | | | 70,023 | 5,585 |
| PB45 x2 | Jun. 29, 2022 | 8.30 | Jul. 10, 2022 | 10 | 100,816 | 8,032 |
| T23 | | 8.30 | | | 95,790 | 7,643 |
| | | 8.30 | | | 86,522 | 6,901 |
| | | 8.30 | | | 96,214 | 7,676 |
| | | 8.30 | | | 101,404 | 8,091 |
| | | 8.30 | | | 86,521 | 6,899 |
| | | 8.30 | | | 81,391 | 6,494 |
| | | 8.30 | | | 96,117 | 7,664 |
| | | 8.30 | | | 94,007 | 7,499 |
| | | 8.30 | | | 102,372 | 8,164 |
| | | 8.30 | | | 99,707 | 7,944 |
| | | 8.30 | | | 97,400 | 7,765 |
| | | 8.30 | | | 100,008 | 7,971 |
| | | 8.30 | | | 92,404 | 7,375 |
| | | 8.30 | | | 95,043 | 7,576 |
| | | 8.30 | | | 76,556 | 6,104 |
| | | 8.30 | | | 79,932 | 6,372 |
| | | 8.30 | | | 99,985 | 7,967 |
| | | 8.30 | | | 96,927 | 7,726 |
| | | 8.30 | | | 77,070 | 6,142 |
| | | 8.30 | | | 94,419 | 7,522 |
| | | 8.30 | | | 83,385 | 6,657 |
| | | 8.30 | | | 80,739 | 6,436 |
| | | 8.30 | | | 82,820 | 6,611 |
| | | 8.30 | | | 99,700 | 7,958 |
| | | 8.30 | | | 96,452 | 7,699 |
| PB45 x2 | Jun. 29, 2022 | 8.35 | Jul. 15, 2022 | 15 | 104,018 | 8,288 |
| T23 | | 8.35 | | | 102,373 | 8,151 |
| | | 8.35 | | | 97,928 | 7,807 |
| | | 8.35 | | | 102,743 | 8,187 |
| | | 8.35 | | | 99,477 | 7,934 |
| | | 8.35 | | | 100,791 | 8,028 |
| | | 8.35 | | | 95,768 | 7,643 |
| | | 8.35 | | | 104,723 | 8,351 |
| | | 8.35 | | | 101,978 | 8,125 |
| | | 8.35 | | | 98,687 | 7,869 |
| | | 8.35 | | | 101,269 | 8,084 |
| | | 8.35 | | | 100,425 | 8,006 |
| | | 8.35 | | | 98,262 | 7,830 |
| | | 8.35 | | | 100,922 | 8,046 |
| | | 8.35 | | | 96,543 | 7,694 |
| | | 8.35 | | | 99,706 | 7,947 |
| | | 8.35 | | | 86,508 | 6,900 |
| | | 8.35 | | | 83,646 | 6,668 |
| | | 8.35 | | | 85,171 | 6,795 |
| | | 8.35 | | | 102,558 | 8,180 |
| | | 8.35 | | | 84,633 | 6,745 |
| | | 8.40 | | | 101,787 | 8,119 |
| | | 8.40 | | | 91,145 | 7,267 |
| | | 8.40 | | | 81,779 | 6,520 |
| PB45 x2 | Jun. 29, 2022 | 8.30 | Jul. 20, 2022 | 20 | 98,571 | 7,864 |
| T23 | | 8.30 | | | 100,810 | 8,056 |
| | | 8.30 | | | 97,128 | 7,742 |
| | | 8.30 | | | 100,342 | 8,005 |
| | | 8.30 | | | 101,595 | 8,095 |
| | | 8.30 | | | 104,768 | 8,355 |
| | | 8.30 | | | 101,670 | 8,104 |
| | | 8.30 | | | 98,821 | 7,882 |
| | | 8.30 | | | 99,115 | 7,901 |
| | | 8.30 | | | 93,641 | 7,462 |
| | | 8.30 | | | 102,776 | 8,195 |
| | | 8.30 | | | 101,301 | 8,071 |
| | | 8.30 | | | 104,724 | 8,356 |
| | | 8.30 | | | 100,421 | 8,001 |
| | | 8.30 | | | 98,940 | 7,883 |
| | | 8.30 | | | 98,892 | 7,898 |
| | | 8.30 | | | 106,282 | 8,471 |
| | | 8.30 | | | 93,322 | 7,435 |
| | | 8.30 | | | 99,242 | 7,924 |
| | | 8.30 | | | 104,777 | 8,356 |
| | | 8.30 | | | 97,827 | 7,795 |
| | | 8.30 | | | 99,672 | 7,939 |
| | | 8.40 | | | 93,648 | 7,462 |
| | | 8.40 | | | 98,303 | 7,845 |
| PB45 x2 | Jun. 29, 2022 | 8.25 | Jul. 28, 2022 | 28 | 95,926 | 7,648 |
| T23 | | 8.25 | | | 99,305 | 7,916 |
| | | 8.25 | | | 100,220 | 7,995 |
| | | 8.25 | | | 101,126 | 8,060 |
| | | 8.25 | | | 97,393 | 7,775 |
| | | 8.25 | | | 88,686 | 7,088 |
| | | 8.25 | | | 94,393 | 7,523 |
| | | 8.25 | | | 98,654 | 7,868 |
| | | 8.25 | | | 101,599 | 8,098 |
| | | 8.25 | | | 93,252 | 7,436 |
| | | 8.25 | | | 98,073 | 7,813 |
| | | 8.25 | | | 97,905 | 7,806 |
| | | 8.25 | | | 100,518 | 8,016 |
| | | 8.25 | | | 98,660 | 7,863 |
| | | 8.25 | | | 97,963 | 7,809 |
| | | 8.25 | | | 99,502 | 7,929 |
| | | 8.25 | | | 97,100 | 7,738 |
| | | 8.25 | | | 99,661 | 7,942 |
| | | 8.25 | | | 100,530 | 8,011 |
| | | 8.25 | | | 93,712 | 7,468 |
| | | 8.25 | | | 102,370 | 8,160 |
| | | 8.20 | | | 99,434 | 7,922 |
| | | 8.20 | | | 94,506 | 7,538 |
| | | 8.30 | | | 98,910 | 7,570 |
| PB45 | Jun. 30, 2022 | 8.30 | Jul. 5, 2022 | 5 | 64,046 | 5,114 |
| T24 | | 8.30 | | | 64,707 | 5,165 |
| | | 8.35 | | | 69,625 | 5,543 |
| | | 8.35 | | | 74,345 | 5,923 |
| | | 8.35 | | | 72,517 | 5,777 |
| | | 8.35 | | | 66,923 | 5,336 |
| | | 8.35 | | | 67,722 | 5,399 |
| | | 8.40 | | | 67,854 | 5,413 |
| | | 8.40 | | | 73,324 | 5,848 |
| | | 8.40 | | | 74,649 | 5,952 |
| | | 8.40 | | | 68,565 | 5,466 |
| | | 8.40 | | | 73,372 | 5,856 |
| PB45 | Jun. 30, 2022 | 8.35 | Jul. 10, 2022 | 10 | 71,235 | 5,674 |
| T24 | | 8.35 | | | 74,514 | 5,943 |
| | | 8.35 | | | 83,643 | 6,670 |
| | | 8.35 | | | 82,917 | 6,610 |
| | | 8.35 | | | 75,181 | 5,996 |
| | | 8.35 | | | 73,362 | 5,849 |
| | | 8.35 | | | 67,800 | 5,405 |
| | | 8.35 | | | 75,294 | 6,003 |
| | | 8.35 | | | 78,648 | 6,270 |
| | | 8.35 | | | 84,403 | 6,727 |
| | | 8.35 | | | 84,410 | 6,728 |
| | | 8.35 | | | 73,263 | 5,846 |
| PB45 | Jun. 30, 2022 | 8.40 | Jul. 15, 2022 | 15 | 83,713 | 6,677 |
| T24 | | 8.40 | | | 86,525 | 6,901 |
| | | 8.40 | | | 79,644 | 6,344 |
| | | 8.40 | | | 88,320 | 7,040 |
| | | 8.40 | | | 78,288 | 6,240 |
| | | 8.40 | | | 88,693 | 7,065 |
| | | 8.40 | | | 77,733 | 6,200 |
| | | 8.40 | | | 82,207 | 6,553 |
| | | 8.40 | | | 90,499 | 7,223 |
| | | 8.40 | | | 77,786 | 6,203 |
| | | 8.40 | | | 78,737 | 6,275 |
| | | 8.40 | | | 87,257 | 6,957 |
| PB45 | Jun. 30, 2022 | 8.35 | Jul. 20, 2022 | 20 | 80,617 | 6,424 |
| T24 | | 8.35 | | | 80,626 | 6,426 |
| | | 8.35 | | | 83,656 | 6,679 |
| | | 8.35 | | | 85,099 | 6,792 |
| | | 8.35 | | | 76,798 | 6,119 |
| | | 8.35 | | | 73,556 | 5,870 |
| | | 8.35 | | | 75,048 | 5,984 |
| | | 8.35 | | | 86,053 | 6,856 |
| | | 8.35 | | | 83,619 | 6,666 |
| | | 8.35 | | | 83,717 | 6,678 |
| | | 8.35 | | | 69,595 | 5,556 |
| | | 8.35 | | | 69,432 | 5,540 |
| PB45 | Jun. 30, 2022 | 8.30 | Jul. 28, 2022 | 28 | 85,361 | 6,816 |
| T24 | | 8.30 | | | 90,421 | 7,220 |
| | | 8.30 | | | 77,095 | 6,148 |
| | | 8.30 | | | 86,672 | 6,913 |
| | | 8.40 | | | 80,935 | 6,451 |
| | | 8.40 | | | 94,446 | 7,533 |
| | | 8.40 | | | 89,774 | 7,164 |
| | | 8.40 | | | 91,525 | 7,296 |
| | | 8.45 | | | 84,403 | 6,732 |
| | | 8.45 | | | 86,196 | 6,875 |
| | | 8.45 | | | 86,616 | 6,905 |
| | | 8.45 | | | 81,814 | 6,521 |
| PB45 | Jun. 30, 2022 | 8.45 | Jul. 5, 2022 | 5 | 72,895 | 5,815 |
| T25 | | 8.45 | | | 67,544 | 5,386 |
| | | 8.45 | | | 73,040 | 5,821 |
| | | 8.45 | | | 63,518 | 5,064 |
| PB45 | Jun. 30, 2022 | 8.40 | Jul. 10, 2022 | 10 | 84,878 | 6,774 |
| T25 | | 8.40 | | | 94,120 | 7,511 |
| | | 8.40 | | | 75,628 | 6,033 |
| | | 8.40 | | | 90,534 | 7,217 |
| PB45 | Jun. 30, 2022 | 8.45 | Jul. 15, 2022 | 15 | 100,010 | 7,967 |
| T25 | | 8.45 | | | 89,597 | 7,138 |
| | | 8.45 | | | 91,440 | 7,286 |
| | | 8.45 | | | 94,169 | 7,510 |
| PB45 | Jun. 30, 2022 | 8.40 | Jul. 20, 2022 | 20 | 97,237 | 7,766 |
| T25 | | 8.40 | | | 96,006 | 7,660 |
| | | 8.40 | | | 98,212 | 7,833 |
| | | 8.45 | | | 95,797 | 7,632 |
| PB45 | Jun. 30, 2022 | 8.40 | Jul. 28, 2022 | 28 | 98,556 | 7,863 |
| T25 | | 8.40 | | | 99,502 | 7,943 |
| | | 8.45 | | | 98,182 | 7,830 |
| | | 8.45 | | | 100,702 | 8,026 |

Comparison of the results from TABLES 1 and 2 demonstrates the significant increase in mechanical strength resulting from the addition of the binder reducing agent.

In Table 3, “PB45” is Portland cement, sand, aggregate and water, and binder reducing agent, tested in duplicate, with a 5% reduction in the amount of Portland cement used compared to the BASELINE (“PB45” is sample 1 and “T27” is sample 2 from a first pour). The pour was 2400 ml of binder reducing agent, 91.2 lbs Portland Cement Type I/II, 192 pounds of aggregate, 192 pounds of sand and 672 ounces of distilled water. The mixture from Step 1 was held for 24 hours.

TABLE 3

| Formula | Pour Date | Weight (lb) | Test Date | Cure Days | Load (lbf) | PSI |
|---|---|---|---|---|---|---|
| PB45 | Jul. 7, 2022 | 8.30 | Jul. 12, 2022 | 5 | 74,380 | 5,927 |
| −5% Portland | | 8.30 | | | 72,293 | 5,768 |
| T27 | | 8.30 | | | 70,692 | 5,638 |
| | | 8.30 | | | 68,454 | 5,461 |
| | | 8.30 | | | 71,735 | 5,718 |
| | | 8.30 | | | 69,821 | 5,568 |
| | | 8.30 | | | 69,612 | 5,554 |
| | | 8.30 | | | 74,638 | 5,951 |
| | | 8.30 | | | 66,409 | 5,302 |
| | | 8.30 | | | 73,678 | 5,881 |
| | | 8.30 | | | 67,380 | 5,372 |
| | | 8.30 | | | 69,933 | 5,574 |
| PB45 | Jul. 7, 2022 | 8.30 | Jul. 17, 2022 | 10 | 83,864 | 6,693 |
| −5% Portland | | 8.30 | | | 91,944 | 7,329 |
| T27 | | 8.30 | | | 85,011 | 6,776 |
| | | 8.30 | | | 78,597 | 6,265 |
| | | 8.30 | | | 80,824 | 6,439 |
| | | 8.30 | | | 81,658 | 6,512 |
| | | 8.35 | | | 86,025 | 6,859 |
| | | 8.35 | | | 80,483 | 6,421 |
| | | 8.35 | | | 73,865 | 5,889 |
| | | 8.35 | | | 82,371 | 6,568 |
| | | 8.35 | | | 79,301 | 6,321 |
| | | 8.35 | | | 79,591 | 6,351 |
| PB45 | Jul. 7, 2022 | 8.35 | Jul. 22, 2022 | 15 | 72,918 | 5,816 |
| −5% Portland | | 8.35 | | | 64,616 | 5,160 |
| T27 | | 8.35 | | | 85,276 | 6,815 |
| | | 8.35 | | | 54,275 | 6,716 |
| | | 8.35 | | | 80,099 | 6,390 |
| | | 8.35 | | | 89,348 | 7,123 |
| | | 8.35 | | | 90,867 | 7,242 |
| | | 8.35 | | | 87,197 | 6,953 |
| | | 8.35 | | | 82,550 | 6,592 |
| | | 8.35 | | | 79,656 | 6,360 |
| | | 8.35 | | | 89,430 | 7,135 |
| | | 8.35 | | | 80,584 | 6,421 |
| PB45 | Jul. 7, 2022 | 8.35 | Jul. 27, 2022 | 20 | 79,828 | 6,364 |
| −5% Portland | | 8.35 | | | 94,747 | 7,551 |
| T27 | | 8.35 | | | 83,382 | 6,647 |
| | | 8.35 | | | 73,209 | 5,838 |
| | | 8.35 | | | 88,960 | 7,100 |
| | | 8.35 | | | 79,078 | 6,313 |
| | | 8.35 | | | 86,959 | 6,931 |
| | | 8.35 | | | 76,561 | 6,110 |
| | | 8.35 | | | 79,285 | 6,332 |
| | | 8.35 | | | 86,195 | 6,876 |
| | | 8.40 | | | 93,757 | 7,477 |
| | | 8.40 | | | 92,174 | 7,343 |
| PB45 | Jul. 7, 2022 | 8.40 | Aug. 4, 2022 | 28 | 94,979 | 7,568 |
| −5% Portland | | 8.40 | | | 86,464 | 6,898 |
| T27 | | 8.40 | | | 100,167 | 7,985 |
| | | 8.40 | | | 94,552 | 7,533 |
| | | 8.40 | | | 88,880 | 7,082 |
| | | 8.40 | | | 95,259 | 7,598 |
| | | 8.40 | | | 88,494 | 7,051 |
| | | 8.40 | | | 96,059 | 7,659 |
| | | 8.40 | | | 97,941 | 7,803 |
| | | 8.40 | | | 91,161 | 7,279 |
| | | 8.40 | | | 91,964 | 7,343 |
| | | 8.45 | | | 80,187 | 6,393 |

Comparison of the results from TABLES 1 and 3 demonstrates the significant increase in mechanical strength resulting from the addition of the binder reducing agent, despite a 5% reduction in hydraulic binder used.
In Table 4, “PB45” is Portland cement, sand, aggregate and water, and binder reducing agent, tested in duplicate, with a 10% reduction in the amount of Portland cement used compared to the BASELINE (“PB45” is sample 1 and “T28” is sample 2 from a pour). The pour was 2400 ml of binder reducing agent, 86.4 lbs Portland Cement Type I/II, 192 pounds of aggregate, 192 pounds of sand and 672 ounces of distilled water. The mixture from Step 1 was held for 24 hours.

TABLE 4

| Formula | Pour Date | Weight (lb) | Test Date | Cure Days | Load (lbf) | PSI |
|---|---|---|---|---|---|---|
| PB45 | Jul. 7, 2022 | 8.35 | Jul. 12, 2022 | 5 | 76,969 | 6,144 |
| −10% Portland | | 8.35 | | | 76,366 | 6,087 |
| T28 | | 8.35 | | | 79,136 | 6,313 |
| | | 8.35 | | | 78,952 | 6,296 |
| | | 8.35 | | | 76,750 | 6,121 |
| | | 8.35 | | | 78,656 | 6,276 |
| | | 8.35 | | | 72,931 | 5,817 |
| | | 8.35 | | | 77,327 | 6,164 |
| | | 8.35 | | | 77,219 | 6,158 |
| | | 8.35 | | | 75,872 | 6,048 |
| | | 8.35 | | | 75,113 | 5,991 |
| | | 8.35 | | | 75,906 | 6,049 |
| PB45 | Jul. 7, 2022 | 8.35 | Jul. 17, 2022 | 10 | 80,077 | 6,396 |
| −10% Portland | | 8.35 | | | 81,934 | 6,539 |
| T28 | | 8.35 | | | 79,881 | 6,377 |
| | | 8.35 | | | 79,255 | 6,316 |
| | | 8.35 | | | 88,437 | 7,050 |
| | | 8.35 | | | 86,750 | 6,915 |
| | | 8.35 | | | 85,145 | 6,791 |
| | | 8.35 | | | 80,648 | 6,428 |
| | | 8.35 | | | 79,535 | 6,337 |
| | | 8.35 | | | 81,494 | 6,500 |
| | | 8.35 | | | 87,116 | 6,944 |
| | | 8.35 | | | 86,207 | 6,873 |
| PB45 | Jul. 7, 2022 | 8.35 | Jul. 22, 2022 | 15 | 81,908 | 6,533 |
| −10% Portland | | 8.35 | | | 75,901 | 6,050 |
| T28 | | 8.35 | | | 88,110 | 7,024 |
| | | 8.35 | | | 87,473 | 6,977 |
| | | 8.35 | | | 89,126 | 7,117 |
| | | 8.35 | | | 79,465 | 6,337 |
| | | 8.35 | | | 89,213 | 7,122 |
| | | 8.35 | | | 78,117 | 6,228 |
| | | 8.35 | | | 81,803 | 6,520 |
| | | 8.35 | | | 85,399 | 6,812 |
| | | 8.35 | | | 84,724 | 6,757 |
| | | 8.35 | | | 89,362 | 7,123 |
| PB45 | Jul. 7, 2022 | 8.40 | Jul. 27, 2022 | 20 | 93,939 | 7,491 |
| −10% Portland | | 8.40 | | | 79,019 | 6,295 |
| T28 | | 8.40 | | | 90,683 | 7,237 |
| | | 8.40 | | | 88,345 | 7,042 |
| | | 8.40 | | | 77,616 | 6,198 |
| | | 8.40 | | | 84,115 | 6,709 |
| | | 8.40 | | | 89,414 | 7,133 |
| | | 8.40 | | | 76,877 | 6,132 |
| | | 8.40 | | | 94,213 | 7,515 |
| | | 8.40 | | | 91,962 | 7,331 |
| | | 8.40 | | | 91,589 | 7,306 |
| | | 8.40 | | | 90,844 | 7,238 |
| PB45 | Jul. 7, 2022 | 8.30 | Aug. 4, 2022 | 28 | 72,844 | 5,806 |
| −10% Portland | | 8.30 | | | 76,857 | 6,132 |
| T28 | | 8.30 | | | 69,043 | 5,507 |
| | | 8.30 | | | 75,145 | 5,990 |
| | | 8.30 | | | 87,539 | 6,984 |
| | | 8.35 | | | 79,949 | 6,373 |
| | | 8.35 | | | 84,026 | 6,713 |
| | | 8.35 | | | 68,337 | 5,442 |
| | | 8.35 | | | 80,642 | 6,432 |
| | | 8.40 | | | 81,567 | 6,504 |
| | | 8.40 | | | 78,757 | 6,280 |
| | | 8.40 | | | 74,150 | 5,913 |

Comparison of the results from TABLES 1 and 4 demonstrates the significant increase in mechanical strength resulting from the addition of the binder reducing agent, despite a 10% reduction in hydraulic binder used.

In Table 5, “PB45” is Portland cement, sand, aggregate and water, and binder reducing agent, tested in duplicate, with a 15% reduction in the amount of Portland cement used compared to the BASELINE (“PB45” is sample 1 and “T29” is sample 2 from a pour). The pour was 1600 ml of binder reducing agent, 54.4 lbs Portland Cement Type I/II, 128 pounds of aggregate, 128 pounds of sand and 448 ounces of distilled water. The mixture from Step 1 was held for 24 hours.

TABLE 5

| Formula | Pour Date | Weight (lb) | Test Date | Cure Days | Load (lbf) | PSI |
|---|---|---|---|---|---|---|
| PB45 | Jul. 12, 2022 | 8.30 | Jul. 17, 2022 | 5 | 63,352 | 5,050 |
| −15% Portland | | 8.30 | | | 61,836 | 4,932 |
| T29 | | 8.30 | | | 64,894 | 5,169 |
| | | 8.30 | | | 66,454 | 5,303 |
| | | 8.30 | | | 65,588 | 5,225 |
| | | 8.30 | | | 68,141 | 5,428 |
| | | 8.30 | | | 67,947 | 5,381 |
| | | 8.30 | | | 68,378 | 5,457 |
| PB45 | Jul. 7, 2022 | 8.30 | Jul. 22, 2022 | 10 | 75,614 | 6,028 |
| −15% Portland | | 8.30 | | | 74,176 | 5,915 |
| T29 | | 8.30 | | | 78,896 | 6,309 |
| | | 8.30 | | | 75,376 | 6,018 |
| | | 8.30 | | | 73,057 | 5,827 |
| | | 8.30 | | | 77,820 | 6,207 |
| | | 8.30 | | | 72,054 | 5,746 |
| | | 8.30 | | | 71,175 | 5,679 |
| PB45 | Jul. 7, 2022 | 8.30 | Jul. 27, 2022 | 15 | 82,254 | 6,560 |
| −15% Portland | | 8.30 | | | 75,138 | 5,993 |
| T29 | | 8.30 | | | 78,973 | 6,301 |
| | | 8.30 | | | 78,175 | 6,233 |
| | | 8.30 | | | 83,517 | 6,664 |
| | | 8.30 | | | 80,598 | 6,432 |
| | | 8.30 | | | 73,492 | 5,860 |
| | | 8.30 | | | 77,927 | 6,216 |
| PB45 | Jul. 7, 2022 | 8.30 | Aug. 1, 2022 | 20 | 77,057 | 6,150 |
| −15% Portland | | 8.30 | | | 83,260 | 6,642 |
| T29 | | 8.30 | | | 74,924 | 5,976 |
| | | 8.30 | | | 77,093 | 6,145 |
| | | 8.30 | | | 75,327 | 6,008 |
| | | 8.30 | | | 77,808 | 6,211 |
| | | 8.30 | | | 83,120 | 6,624 |
| | | 8.30 | | | 83,328 | 6,644 |
| PB45 | Jul. 7, 2022 | 8.30 | Aug. 9, 2022 | 28 | 76,400 | 6,090 |
| −15% Portland | | 8.35 | | | 77,234 | 6,163 |
| T29 | | 8.35 | | | 82,520 | 6,585 |
| | | 8.35 | | | 81,844 | 6,527 |
| | | 8.35 | | | 84,716 | 6,753 |
| | | 8.35 | | | 78,615 | 6,268 |
| | | 8.35 | | | 83,560 | 6,661 |
| | | 8.20 | | | 71,661 | 5,712 |

Comparison of the results from TABLES 1 and 5 demonstrates the significant increase in mechanical strength resulting from the addition of the binder reducing agent, despite a 15% reduction in hydraulic binder used.

In Table 6, “PB45” is Portland cement, sand, aggregate and water, and binder reducing agent, tested in duplicate, with a 20% reduction in the amount of Portland cement used compared to the BASELINE (“PB45” is sample 1 and “T30” is sample 2 from a pour). The pour was 1600 ml of binder reducing agent, 51.2 lbs Portland Cement Type I/II, 128 pounds of aggregate, 128 pounds of sand and 448 ounces of distilled water. The mixture from Step 1 was held for 24 hours.

TABLE 6

| Formula | Pour Date | Weight (lb) | Test Date | Cure Days | Load (lbf) | PSI |
|---|---|---|---|---|---|---|
| PB45 | Jul. 12, 2022 | 8.30 | Jul. 17, 2022 | 5 | 61,785 | 4,928 |
| −20% Portland | | 8.30 | | | 64,640 | 5,160 |
| T30 | | 8.30 | | | 67,626 | 5,393 |
| | | 8.30 | | | 62,825 | 5,013 |
| | | 8.30 | | | 69,165 | 5,507 |
| | | 8.30 | | | 71,817 | 5,727 |
| | | 8.30 | | | 71,452 | 5,700 |
| | | 8.30 | | | 70,261 | 5,600 |
| PB45 | Jul. 7, 2022 | 8.25 | Jul. 22, 2022 | 10 | 75,503 | 6,018 |
| −20% Portland | | 8.25 | | | 67,614 | 5,391 |
| T30 | | 8.25 | | | 67,415 | 5,381 |
| | | 8.25 | | | 73,656 | 5,881 |
| | | 8.25 | | | 68,149 | 5,436 |
| | | 8.25 | | | 74,799 | 5,966 |
| | | 8.25 | | | 76,167 | 6,070 |
| | | 8.25 | | | 73,062 | 5,825 |
| PB45 | Jul. 7, 2022 | 8.25 | Jul. 27, 2022 | 15 | 78,371 | 6,249 |
| −20% Portland | | 8.25 | | | 69,797 | 5,567 |
| T30 | | 8.25 | | | 71,845 | 5,730 |
| | | 8.25 | | | 71,507 | 5,700 |
| | | 8.25 | | | 73,453 | 5,862 |
| | | 8.25 | | | 68,589 | 5,473 |
| | | 8.35 | | | 80,876 | 6,448 |
| | | 8.35 | | | 75,100 | 5,984 |
| PB45 | Jul. 7, 2022 | 8.30 | Aug. 1, 2022 | 20 | 76,008 | 6,064 |
| −20% Portland | | 8.30 | | | 85,074 | 6,783 |
| T30 | | 8.30 | | | 77,037 | 6,141 |
| | | 8.30 | | | 74,249 | 5,920 |
| | | 8.30 | | | 82,438 | 6,571 |
| | | 8.30 | | | 76,679 | 6,118 |
| | | 8.30 | | | 74,780 | 5,962 |
| | | 8.30 | | | 82,275 | 6,563 |
| PB45 | Jul. 7, 2022 | 8.20 | Aug. 9, 2022 | 28 | 79,507 | 6,338 |
| −20% Portland | | 8.20 | | | 83,483 | 6,653 |
| T30 | | 8.20 | | | 79,464 | 6,333 |
| | | 8.20 | | | 78,350 | 6,250 |
| | | 8.20 | | | 79,018 | 6,306 |
| | | 8.20 | | | 78,861 | 6,295 |
| | | 8.20 | | | 80,672 | 6,430 |
| | | 8.20 | | | 83,214 | 6,634 |

Comparison of the results from TABLES 1 and 6 demonstrates the significant increase in mechanical strength resulting from the addition of the binder reducing agent, despite a 20% reduction in hydraulic binder used.

In Table 7, “PB45” is Portland cement, sand, aggregate and water, and binder reducing agent, tested in duplicate, with river rock used as the aggregate (no larger than 0.5″). Less water was used due to the river rock being wet. The pour was 800 ml of binder reducing agent, 32 lbs Portland Cement Type I/II, 64 pounds of coarse aggregate (river rock), 64 pounds of sand (fine aggregate) and 198 ounces of distilled water. The mixture from Step 1 was held for 24 hours. The curing tank was a tank providing a controlled environment for curing (73° F. for 3 days).

TABLE 7

| Formula | Pour Date | Weight (lb) | Test Date | Cure Days | Load (lbf) | PSI |
|---|---|---|---|---|---|---|
| PB45 | Jul. 28, 2022 | 8.20 | Aug. 2, 2022 | 5 | 51,770 | 4,128 |
| T39 | | 8.20 | | 5 | 54,784 | 4,365 |
| | | 8.20 | | 5 | 54,206 | 4,323 |
| | | 8.20 | | 5 | 55,751 | 4,449 |
| | | 8.20 | | 5 | 53,338 | 4,253 |
| PB45 | Jul. 28, 2022 | 8.40 | Aug. 2, 2022 | 5 | 66,521 | 5,302 |
| T39 | | 8.40 | | 5 | 71,213 | 5,676 |
| River Rock | | 8.40 | | 5 | 66,031 | 5,268 |
| Curing | | 8.40 | | 5 | 68,035 | 5,422 |
| Tank Used | | | | | | |
| | | 8.40 | | 5 | 67,550 | 5,386 |
| PB45 | Jul. 28, 2022 | 8.25 | Aug. 7, 2022 | 10 | 63,414 | 5,056 |
| T39 | | 8.25 | | 10 | 64,097 | 5,110 |
| | | 8.25 | | 10 | 65,617 | 5,226 |
| | | 8.25 | | 10 | 61,095 | 4,874 |
| | | 8.25 | | 10 | 64,718 | 5,163 |
| PB45 | Jul. 28, 2022 | 8.45 | Aug. 7, 2022 | 10 | 82,132 | 6,549 |
| T39 | | 8.45 | | 10 | 78,038 | 6,219 |
| | | 8.45 | | 10 | 79,190 | 6,314 |
| Curing | | 8.45 | | 10 | 71,462 | 5,701 |
| Tank Used | | | | | | |
| | | 8.45 | | 10 | 77,650 | 6,188 |

Comparison of the results from TABLES 1 and 7 demonstrates the significant increase in mechanical strength resulting from the addition of the binder reducing agent.

In Table 8, “PB45×½” is Portland cement, sand, aggregate and water, and binder reducing agent, tested in duplicate (“PB45×4” is sample 1 and “T40” is sample 2 from a pour). The pour was 400 ml of binder reducing agent, 32 lbs Portland Cement Type I/II, 64 pounds of coarse aggregate no larger than 1.5″, 64 pounds of sand and 224 ounces of distilled water. The mixture from Step 1 was held for 24 hours.

TABLE 8

| Formula | Pour Date | Weight (lb) | Test Date | Cure Days | Load (lbf) | PSI |
|---|---|---|---|---|---|---|
| PB45 ½ | Aug. 3, 2022 | 8.45 | Aug. 8, 2022 | 5 | 58,781 | 4,691 |
| T40 | | 8.45 | | | 57,113 | 4,557 |
| | | 8.45 | | | 57,082 | 4,556 |
| | | 8.45 | | | 57,533 | 4,592 |
| PB45 ½ | Aug. 3, 2022 | 8.45 | Aug. 13, 2022 | 10 | 69,563 | 5,550 |
| T40 | | 8.45 | | | 61,827 | 4,927 |
| | | 8.45 | | | 65,679 | 5,237 |
| | | 8.45 | | | 68,072 | 5,430 |
| PB45 ½ | Aug. 3, 2022 | 8.45 | Aug. 18, 2022 | 15 | 61,227 | 4,885 |
| T40 | | 8.45 | | | 59,090 | 4,714 |
| | | 8.45 | | | 63,714 | 5,086 |
| | | 8.45 | | | 67,235 | 5,365 |
| PB45 ½ | Aug. 3, 2022 | 8.40 | Aug. 23, 2022 | 20 | 65,299 | 5,206 |
| T40 | | 8.40 | | | 63,058 | 5,030 |
| | | 8.40 | | | 64,980 | 5,185 |
| | | 8.40 | | | 68,785 | 5,482 |
| PB45 ½ | Aug. 3, 2022 | 8.40 | Aug. 31, 2022 | 28 | 57,440 | 4,578 |
| T40 | | 8.40 | | | 64,391 | 5,132 |
| | | 8.45 | | | 64,680 | 5,155 |
| | | 8.45 | | | 74,003 | 5,898 |

Comparison of the results from TABLES 1 and 8 demonstrates the significant increase in mechanical strength resulting from the addition of the binder reducing agent.

In Table 9, “PB45” is Portland cement, sand, aggregate and water, and binder reducing agent, tested in duplicate, with a 30% reduction in the amount of Portland cement used compared to the BASELINE (“PB45” is sample 1 and “T41” is sample 2 from a pour). The pour was 800 ml of binder reducing agent, 19.2 lbs Portland Cement Type I/II, 64 pounds of coarse aggregate no larger than 1.5″, 64 pounds of sand (fine aggregate) and 134.4 ounces of distilled water. The mixture from Step 1 was held for 24 hours.

TABLE 9

| Formula | Pour Date | Weight (lb) | Test Date | Cure Days | Load (lbf) | PSI |
|---|---|---|---|---|---|---|
| PB45 | Aug. 3, 2022 | 8.50 | Aug. 8, 2022 | 5 | 39,935 | 3,188 |
| T41 | | 8.50 | | | 46,923 | 3,747 |
| −30% P/W | | 8.50 | | | 40,110 | 3,202 |
| | | 8.50 | | | 46,939 | 3,739 |
| PB45 | Aug. 3, 2022 | 8.45 | Aug. 13, 2022 | 10 | 49,832 | 3,973 |
| T41 | | 8.45 | | | 57,930 | 4,617 |
| −30% P/W | | 8.45 | | | 55,585 | 4,435 |
| | | 8.45 | | | 54,027 | 4,309 |
| PB45 | Aug. 3, 2022 | 8.40 | Aug. 18, 2022 | 15 | 59,566 | 4,750 |
| T41 | | 8.40 | | | 50,150 | 4,003 |
| −30% P/W | | 8.40 | | | 58,736 | 4,685 |
| | | 8.45 | | | 47,370 | 3,784 |
| PB45 | Aug. 3, 2022 | 8.30 | Aug. 23, 2022 | 20 | 53,247 | 4,250 |
| T41 | | 8.30 | | | 57,197 | 4,566 |
| −30% P/W | | 8.35 | | | 52,969 | 4,225 |
| | | 8.45 | | | 51,649 | 4,118 |
| PB45 | Aug. 3, 2022 | 8.50 | Aug. 31, 2022 | 28 | 51,204 | 4,081 |
| T41 | | 8.55 | | | 63,199 | 5,037 |
| −30% P/W | | 8.55 | | | 60,070 | 4,790 |
| | | 8.55 | | | 60,191 | 4,805 |

Comparison of the results from TABLES 1 and 9 demonstrates excellent mechanical strength resulting from the addition of the binder reducing agent, despite the reduction of binder used.

In Table 10, “PB45” is Portland cement, sand, aggregate and water, and binder reducing agent, tested in duplicate, with a 40% reduction in the amount of Portland cement used compared to the BASELINE (“PB45” is sample 1 and “T42” is sample 2 from a pour). The pour was 800 ml of binder reducing agent, 19.2 lbs Portland Cement Type I/II, 64 pounds of coarse aggregate no larger than 1.5″, 64 pounds of sand (fine aggregate) and 134.4 ounces of distilled water. The mixture from Step 1 was held for 24 hours.

TABLE 10

| Formula | Pour Date | Weight (lb) | Test Date | Cure Days | Load (lbf) | PSI |
|---|---|---|---|---|---|---|
| PB45 | Aug. 3, 2022 | 8.30 | Aug. 8, 2022 | 5 | 43,654 | 3,484 |
| T42 | | 8.30 | | | 43,203 | 3,446 |
| −40% P/W | | 8.35 | | | 41,969 | 3,350 |
| | | 8.35 | | | 45,954 | 3,668 |
| PB45 | Aug. 3, 2022 | 8.50 | Aug. 13, 2022 | 10 | 51,306 | 4,094 |
| T42 | | 8.50 | | | 49,536 | 3,954 |
| −40% P/W | | 8.50 | | | 54,577 | 4,351 |
| | | 8.50 | | | 48,056 | 3,835 |
| PB45 | Aug. 3, 2022 | 8.35 | Aug. 18, 2022 | 15 | 46,461 | 3,708 |
| T42 | | 8.35 | | | 50,918 | 4,060 |
| −40% P/W | | 8.45 | | | 44,882 | 3,583 |
| | | 8.45 | | | 51,695 | 4,128 |
| PB45 | Aug. 3, 2022 | 8.50 | Aug. 23, 2022 | 20 | 42,199 | 3,368 |
| T42 | | 8.50 | | | 54,538 | 4,348 |
| −40% P/W | | 8.50 | | | 50,210 | 4,005 |
| | | 8.55 | | | 48,957 | 3,908 |
| PB45 | Aug. 3, 2022 | 8.55 | Aug. 31, 2022 | 28 | 57,905 | 4,615 |
| T42 | | 8.60 | | | 54,315 | 4,331 |
| −40% P/W | | 8.60 | | | 53,927 | 4,305 |
| | | 8.60 | | | 55,443 | 4,426 |

Comparison of the results from TABLES 1 and 10 demonstrates excellent mechanical strength resulting from the addition of the binder reducing agent, despite the reduction of binder used.

In Table 11, “PB45+V” is Portland cement plus lavender, sand, aggregate and water, and binder reducing agent, tested in duplicate (“PB45+V” is sample 1 and “T45” is sample 2 from a pour). The pour was 400 ml of binder reducing agent, 16 lbs Portland Cement Type I/II, 1 drop of lavender (approximately 0.01 ml), 32 pounds of coarse aggregate no larger than 1.5″, 32 pounds of sand (fine aggregate) and 112 ounces of distilled water. The mixture from Step 1 was held for 24 hours.

TABLE 11

| Formula | Pour Date | Weight (lb) | Test Date | Cure Days | Load (lbf) | PSI |
|---|---|---|---|---|---|---|
| PB45 + V | Aug. 4, 2022 | 8.35 | Aug. 9, 2022 | 5 | 64,800 | 5,167 |
| T45 | | 8.50 | | | 67,320 | 5,370 |
| | | 8.50 | | | 67,570 | 5,389 |
| | | 8.50 | | | 64,132 | 5,114 |
| | | 8.55 | | | 65,961 | 5,260 |
| PB45 + V | Aug. 4, 2022 | 8.35 | Aug. 14, 2022 | 10 | 75,808 | 6,043 |
| T45 | | 8.40 | | | 74,353 | 5,935 |
| | | 8.50 | | | 75,058 | 5,984 |
| | | 8.50 | | | 75,259 | 6,002 |
| | | 8.50 | | | 78,179 | 6,228 |

Comparison of the results from TABLES 1 and 11 demonstrates the significant increase in mechanical strength resulting from the addition of the binder reducing agent.

In Table 12, “PB45 PS” is Portland cement, sand, aggregate and water, and binder reducing agent, tested in duplicate, with probe sonication steps carried out for 2 minutes (“PB45 PS” is sample 1 and “T46” is sample 2 from a pour). The pour was 400 ml of binder reducing agent, 16 lbs Portland Cement Type I/II, 32 pounds of coarse aggregate no larger than 1.5″, 32 pounds of sand (fine aggregate) and 112 ounces of distilled water. The mixture from Step 1 was held for 24 hours.

TABLE 12

| Formula | Pour Date | Weight (lb) | Test Date | Cure Days | Load (lbf) | PSI |
|---|---|---|---|---|---|---|
| PB45 PS | Aug. 4, 2022 | 8.50 | Aug. 9, 2022 | 5 | 65,618 | 5,236 |
| T46 | | 8.50 | | | 60,592 | 4,834 |
| | | 8.50 | | | 62,431 | 4,977 |
| | | 8.55 | | | 61,736 | 4,924 |
| | | 8.55 | | | 64,463 | 5,140 |
| PB45 PS | Aug. 4, 2022 | 8.50 | Aug. 14, 2022 | 10 | 71,332 | 5,691 |
| T46 | | 8.50 | | | 75,275 | 6,005 |
| | | 8.55 | | | 74,806 | 5,963 |
| | | 8.55 | | | 79,033 | 6,298 |
| | | 8.60 | | | 75,696 | 6,038 |

Comparison of the results from TABLES 1 and 12 demonstrates the significant increase in mechanical strength resulting from the addition of the binder reducing agent.

In Table 13, “PB45” is Portland cement, sand, aggregate and water, and binder reducing agent, tested in duplicate, with a 5% reduction in the amount of Portland cement and a 5% reduction in the amount of water used compared to the BASELINE (“PB45” is sample 1 and “T47” is sample 2 from a pour). The pour was 800 ml of binder reducing agent, 30.4 lbs Portland Cement Type I/II, 64 pounds of coarse aggregate no larger than 1.5″, 64 pounds of sand (fine aggregate) and 212.8 ounces of distilled water. The mixture from Step 1 was held for 24 hours.

TABLE 13

| Formula | Pour Date | Weight (lb) | Test Date | Cure Days | Load (lbf) | PSI |
|---|---|---|---|---|---|---|
| PB45 | Aug. 9, 2022 | 8.30 | Aug. 14, 2022 | 5 | 60,110 | 4,795 |
| T47 | | 8.30 | | | 66,454 | 5,300 |
| −5% P/W | | 8.30 | | | 66,516 | 5,306 |
| | | 8.30 | | | 65,534 | 5,227 |
| PB45 | Aug. 9, 2022 | 8.30 | Aug. 19, 2022 | 10 | 70,726 | 5,644 |
| T47 | | 8.30 | | | 70,709 | 5,636 |
| −5% P/W | | 8.35 | | | 68,718 | 5,486 |
| | | 8.35 | | | 70,866 | 5,648 |
| PB45 | Aug. 9, 2022 | 8.40 | Aug. 24, 2022 | 15 | 73,757 | 5,884 |
| T47 | | 8.40 | | | 73,879 | 5,887 |
| −5% P/W | | 8.40 | | | 75,077 | 5,983 |
| | | 8.40 | | | 75,136 | 5,994 |
| PB45 | Aug. 9, 2022 | 8.35 | Aug. 29, 2022 | 20 | 71,503 | 5,703 |
| T47 | | 8.35 | | | 71,686 | 5,716 |
| −5% P/W | | 8.35 | | | 67,628 | 5,399 |
| | | 8.35 | | | 72,707 | 5,803 |
| PB45 | Aug. 9, 2022 | 8.35 | Sep. 6, 2022 | 28 | 78,459 | 6,256 |
| T47 | | 8.35 | | | 71,981 | 5,736 |
| −5% P/W | | 8.35 | | | 73,968 | 5,904 |
| | | 8.35 | | | 74,363 | 5,930 |

Comparison of the results from TABLES 1 and 13 demonstrates excellent mechanical strength resulting from the addition of the binder reducing agent, despite the reduction of binder and water used.

In Table 14, “PB45” is Portland cement, sand, aggregate and water, and binder reducing agent, tested in duplicate, with a 10% reduction in the amount of Portland cement and a 10% reduction in the amount of water used compared to the BASELINE (“PB45” is sample 1 and “T48” is sample 2 from a pour). The pour was 800 ml of binder reducing agent, 28.8 lbs Portland Cement Type I/II, 64 pounds of coarse aggregate no larger than 1.5″, 64 pounds of sand (fine aggregate) and 201.6 ounces of distilled water. The mixture from Step 1 was held for 24 hours.

TABLE 14

| Formula | Pour Date | Weight (lb) | Test Date | Cure Days | Load (lbf) | PSI |
|---|---|---|---|---|---|---|
| PB45 | Aug. 9, 2022 | 8.30 | Aug. 14, 2022 | 5 | 54,659 | 4,362 |
| T48 | | 8.30 | | | 51,564 | 4,115 |
| −10% P/W | | 8.30 | | | 54,288 | 4,334 |
| | | 8.30 | | | 53,261 | 4,250 |
| PB45 | Aug. 9, 2022 | 8.30 | Aug. 19, 2022 | 10 | 64,336 | 5,134 |
| T48 | | 8.30 | | | 57,842 | 4,619 |
| −10% P/W | | 8.30 | | | 58,756 | 4,685 |
| | | 8.35 | | | 60,741 | 4,848 |
| PB45 | Aug. 9, 2022 | 8.40 | Aug. 24, 2022 | 15 | 62,937 | 5,018 |
| T48 | | 8.45 | | | 64,212 | 5,126 |
| −10% P/W | | 8.45 | | | 63,390 | 5,055 |
| | | 8.45 | | | 63,337 | 5,053 |
| PB45 | Aug. 9, 2022 | 8.35 | Aug. 29, 2022 | 20 | 63,312 | 5,047 |
| T48 | | 8.35 | | | 62,997 | 5,027 |
| −10% P/W | | 8.35 | | | 69,540 | 5,545 |
| | | 8.35 | | | 61,749 | 4,925 |
| PB45 | Aug. 9, 2022 | 8.35 | Sep. 6, 2022 | 28 | 65,825 | 5,251 |
| T48 | | 8.35 | | | 66,871 | 5,332 |
| −10% P/W | | 8.35 | | | 63,783 | 5,099 |
| | | 8.35 | | | 70,185 | 5,602 |

Comparison of the results from TABLES 1 and 14 demonstrates excellent mechanical strength resulting from the addition of the binder reducing agent, despite the reduction of binder and water used.

In Table 15, “PB45×½” is Portland cement, sand, aggregate and water, and binder reducing agent, tested in duplicate, with a 5% reduction in the amount of Portland cement and a 5% reduction in the amount of water used compared to the BASELINE (“PB45” is sample 1 and “T49” is sample 2 from a pour). The pour was 800 ml of binder reducing agent, 30.4 lbs Portland Cement Type I/II, 64 pounds of coarse aggregate no larger than 1.5″, 64 pounds of sand (fine aggregate) and 212.8 ounces of distilled water. The mixture from Step 1 was held for 24 hours.

TABLE 15

| Formula | Pour Date | Weight (lb) | Test Date | Cure Days | Load (lbf) | PSI |
|---|---|---|---|---|---|---|
| PB45 ½ | Aug. 9, 2022 | 8.30 | Aug. 14, 2022 | 5 | 54,695 | 4,365 |
| T49 | | 8.30 | | | 50,657 | 4,040 |
| −5% P/W | | 8.30 | | | 56,211 | 4,484 |
| | | 8.30 | | | 53,106 | 4,236 |
| PB45 ½ | Aug. 9, 2022 | 8.30 | Aug. 19, 2022 | 10 | 58,292 | 4,648 |
| T49 | | 8.35 | | | 56,243 | 4,487 |
| −5% P/W | | 8.35 | | | 60,449 | 4,823 |
| | | 8.40 | | | 57,024 | 4,549 |
| PB45 ½ | Aug. 9, 2022 | 8.45 | Aug. 24, 2022 | 15 | 64,308 | 5,130 |
| T49 | | 8.45 | | | 64,841 | 5,176 |
| −5% P/W | | 8.50 | | | 62,297 | 4,964 |
| | | 8.50 | | | 65,946 | 5,260 |
| PB45 ½ | Aug. 9, 2022 | 8.35 | Aug. 29, 2022 | 20 | 60,001 | 4,784 |
| T49 | | 8.35 | | | 56,718 | 4,524 |
| −5% P/W | | 8.35 | | | 61,850 | 4,933 |
| | | 8.35 | | | 61,250 | 4,886 |
| PB45 ½ | Aug. 9, 2022 | 8.35 | Sep. 6, 2022 | 28 | 63,498 | 5,064 |
| T49 | | 8.35 | | | 64,208 | 5,125 |
| −5% P/W | | 8.35 | | | 59,873 | 4,774 |
| | | 8.35 | | | 62,437 | 4,984 |

Comparison of the results from TABLES 1 and 15 demonstrates excellent mechanical strength resulting from the addition of the binder reducing agent, despite the reduction of binder and water used.

In Table 16, “PB45×½” is Portland cement, sand, aggregate and water, and binder reducing agent, tested in duplicate, with a 10% reduction in the amount of Portland cement and a 10% reduction in the amount of water used compared to the BASELINE (“PB45” is sample 1 and “T50” is sample 2 from a pour). The pour was 800 ml of binder reducing agent, 28.8 lbs Portland Cement Type I/II, 64 pounds of coarse aggregate no larger than 1.5″, 64 pounds of sand (fine aggregate) and 201.6 ounces of distilled water. The mixture from Step 1 was held for 24 hours.

TABLE 16

| Formula | Pour Date | Weight (lb) | Test Date | Cure Days | Load (lbf) | PSI |
|---|---|---|---|---|---|---|
| PB45 ½ | Aug. 9, 2022 | 8.30 | Aug. 14, 2022 | 5 | 52,605 | 4,199 |
| T50 | | 8.30 | | | 51,550 | 4,113 |
| −10% P/W | | 8.30 | | | 54,313 | 4,334 |
| | | 8.30 | | | 54,456 | 4,343 |
| PB45 ½ | Aug. 9, 2022 | 8.30 | Aug. 19, 2022 | 10 | 61,522 | 4,909 |
| T50 | | 8.30 | | | 58,229 | 4,644 |
| −10% P/W | | 8.30 | | | 60,935 | 4,857 |
| | | 8.40 | | | 60,082 | 4,790 |
| PB45 ½ | Aug. 9, 2022 | 8.35 | Aug. 24, 2022 | 15 | 62,102 | 4,598 |
| T50 | | 8.35 | | | 62,438 | 4,982 |
| −10% P/W | | 8.35 | | | 64,540 | 5,147 |
| | | 8.35 | | | 63,102 | 5,037 |
| PB45 ½ | Aug. 9, 2022 | 8.35 | Aug. 29, 2022 | 20 | 68,733 | 5,473 |
| T50 | | 8.35 | | | 66,468 | 5,305 |
| −10% P/W | | 8.35 | | | 63,303 | 5,052 |
| | | 8.35 | | | 63,401 | 5,062 |
| PB45 ½ | Aug. 9, 2022 | 8.35 | Sep. 6, 2022 | 28 | 71,412 | 5,693 |
| T50 | | 8.35 | | | 68,181 | 5,438 |
| −10% P/W | | 8.35 | | | 67,168 | 5,355 |
| | | 8.35 | | | 66,675 | 5,317 |

Comparison of the results from TABLES 1 and 16 demonstrates excellent mechanical strength resulting from the addition of the binder reducing agent, despite the reduction of binder and water used.

In Table 17, “PB45” is Portland cement, sand, aggregate and water, and binder reducing agent, tested in duplicate, with conditioned tap water (glycerol (3 ml per gallon of water) and silane (10 ml per gallon of water) added) used instead of distilled water and with probe sonication steps carried out for 1 minute (“PB45” is sample 1 and “T51” is sample 2 from a pour). The pour was 400 ml of binder reducing agent, 16 lbs Portland Cement Type I/II, 32 pounds of coarse aggregate no larger than 1.5″, 32 pounds of sand (fine aggregate) and 112 ounces of conditioned tap water. The mixture from Step 1 was held for 24 hours.

TABLE 17

| Formula | Pour Date | Weight (lb) | Test Date | Cure Days | Load (lbf) | PSI |
|---|---|---|---|---|---|---|
| PB45 | Aug. 10, 2022 | 8.50 | Aug. 15, 2022 | 5 | 63,004 | 5,024 |
| T51 | | 8.50 | | | 63,555 | 5,071 |
| | | 8.50 | | | 62,644 | 4,998 |
| | | 8.50 | | | 65,758 | 5,243 |
| | | 8.50 | | | 64,668 | 5,155 |
| PB45 | Aug. 10, 2022 | 8.45 | Aug. 20, 2022 | 10 | 69,695 | 5,559 |
| T51 | | 8.45 | | | 69,681 | 5,557 |
| | | 8.45 | | | 71,729 | 5,719 |
| | | 8.55 | | | 73,376 | 5,849 |
| | | 8.55 | | | 67,503 | 5,380 |

Comparison of the results from TABLES 1 and 17 demonstrates excellent mechanical strength resulting from the addition of the binder reducing agent, despite the use of conditioned tap water.

In Table 18, “PB45” is Portland cement, sand, aggregate and water, and binder reducing agent, tested in duplicate, with conditioned distilled water (glycerol (3 ml per gallon of water) and silane (10 ml per gallon of water) added) used instead of distilled water and with probe sonication steps carried out for 1 minute (“PB45” is sample 1 and “T52” is sample 2 from a pour). The pour was 400 ml of binder reducing agent, 16 lbs Portland Cement Type I/II, 32 pounds of coarse aggregate no larger than 1.5″, 32 pounds of sand (fine aggregate) and 112 ounces of conditioned distilled water. The mixture from Step 1 was held for 24 hours.

TABLE 18

| Formula | Pour Date | Weight (lb) | Test Date | Cure Days | Load (lbf) | PSI |
|---|---|---|---|---|---|---|
| PB45 | Aug. 10, 2022 | 8.50 | Aug. 15, 2022 | 5 | 66,164 | 5,276 |
| T52 | | 8.50 | | | 61,993 | 4,946 |
| | | 8.50 | | | 62,420 | 4,979 |
| | | 8.50 | | | 64,678 | 5,159 |
| | | 8.50 | | | 63,007 | 5,021 |
| PB45 | Aug. 10, 2022 | 8.45 | Aug. 20, 2022 | 10 | 70,921 | 5,651 |
| T52 | | 8.45 | | | 67,033 | 5,347 |
| | | 8.50 | | | 72,476 | 5,778 |
| | | 8.50 | | | 74,682 | 5,958 |
| | | 8.55 | | | 70,215 | 5,600 |

Comparison of the results from TABLES 1 and 18 demonstrates excellent mechanical strength resulting from the addition of the binder reducing agent, despite the use of conditioned distilled water.

In Table 19, “PB45” is Portland cement, sand, aggregate and water, and binder reducing agent, tested in duplicate (“PB45” is sample 1 and “T54” is sample 2 from a pour). The pour was 800 ml of binder reducing agent, 32 lbs Portland Cement Type I/II, 96 pounds of coarse aggregate no larger than 1.5″, 96 pounds of sand (fine aggregate) and 224 ounces of distilled water. The mixture from Step 1 was held for 24 hours.

TABLE 19

| Formula | Pour Date | Weight (lb) | Test Date | Cure Days | Load (lbf) | PSI |
|---|---|---|---|---|---|---|
| PB45 | Aug. 17, 2022 | 8.25 | Aug. 22, 2022 | 5 | 30,427 | 2,425 |
| T54 | | 8.25 | | | 33,927 | 2,704 |
| 1-3-3 | | 8.25 | | | 33,149 | 2,642 |
| | | 8.25 | | | 34,580 | 2,756 |
| PB45 | Aug. 17, 2022 | 8.20 | Aug. 27, 2022 | 10 | 44,351 | 3,540 |
| T54 | | 8.20 | | | 27,297 | 2,174 |
| 1-3-3 | | 8.20 | | | 40,316 | 3,215 |
| | | 8.20 | | | 32,938 | 2,624 |
| PB45 | Aug. 17, 2022 | 8.15 | Sep. 1, 2022 | 15 | 38,907 | 3,106 |
| T54 | | 8.20 | | | 40,799 | 3,257 |
| 1-3-3 | | 8.20 | | | 39,146 | 3,125 |
| | | 8.20 | | | 40,198 | 3,209 |
| PB45 | Aug. 17, 2022 | 8.25 | Sep. 6, 2022 | 20 | 42,027 | 3,355 |
| T54 | | 8.25 | | | 42,916 | 3,426 |
| 1-3-3 | | 8.25 | | | 42,465 | 3,390 |
| | | 8.25 | | | 43,893 | 3,504 |
| PB45 | Aug. 17, 2022 | 8.15 | Sep. 14, 2022 | 28 | 46,900 | 3,744 |
| T54 | | 8.20 | | | 47,626 | 3,802 |
| 1-3-3 | | 8.25 | | | 47,038 | 3,755 |
| | | 8.30 | | | 46,098 | 3,680 |

Comparison of the results from TABLES 1 and 19 demonstrates the significant increase in mechanical strength resulting from the addition of the binder reducing agent.

In Table 20, “PB45” is Portland cement, sand, aggregate and water, and binder reducing agent, tested in duplicate (“PB45” is sample 1 and “T55” is sample 2 from a pour). The pour was 3200 ml of binder reducing agent, 128 lbs Portland Cement Type I/II, 256 pounds of coarse aggregate no larger than 1.5″, 256 pounds of sand (fine aggregate) and 896 ounces of distilled water. The mixture from Step 1 was held for 24 hours. These pours were in 3′×3′ slabs, not cylinders.

TABLE 20

| Formula | Pour Date | Weight (lb) | Test Date | Cure Days | Load (lbf) | PSI |
|---|---|---|---|---|---|---|
| PB45 | Aug. 17, 2022 | 5.30 | Aug. 22, 2022 | 5 | 78,117 | 6,224 |
| T55 | | 5.30 | | | 81,548 | 6,506 |
| 3′ × 3′ Slab | | 5.30 | | | 75,897 | 6,061 |
| | | 8.05 | | | 55,562 | 4,432 |
| | | 8.10 | | | 55,502 | 4,430 |
| PB45 | Aug. 17, 2022 | 5.25 | Aug. 27, 2022 | 10 | 67,756 | 5,407 |
| T55 | | 5.30 | | | 84,157 | 6,710 |
| 3′ × 3′ Slab | | 5.40 | | | 77,114 | 6,150 |
| | | 8.15 | | | 63,746 | 5,088 |
| | | 8.15 | | | 64,131 | 5,118 |
| PB45 | Aug. 17, 2022 | 5.50 | Sep. 01, 2022 | 15 | 80,766 | 6,439 |
| T55 | | 5.50 | | | 79,809 | 6,358 |
| 3′ × 3′ Slab | | 5.60 | | | 81,860 | 6,528 |
| PB45 | Aug. 17, 2022 | 5.50 | Sep. 06, 2022 | 20 | 85,068 | 6,790 |
| T55 | | 5.50 | | | 80,333 | 6,412 |
| 3′ × 3′ Slab | | 5.50 | | | 81,986 | 6,544 |
| PB45 | Aug. 17, 2022 | 5.40 | Sep. 14, 2022 | 28 | 87,364 | 6,957 |
| T55 | | 5.45 | | | 92,285 | 7,356 |
| 3′ × 3′ Slab | | 5.45 | | | 90,349 | 7,198 |

Comparison of the results from TABLES 1 and 20 demonstrates the significant increase in mechanical strength resulting from the addition of the binder reducing agent.

In Table 21, “PB45-10P” is Portland cement, sand, aggregate and water, and binder reducing agent, tested in duplicate, with a 10% reduction in Portland cement compared to the BASELINE (“PB45-10P” is sample 1 and “T56” is sample 2 from a pour). The pour was 3200 ml of binder reducing agent, 115.2 lbs Portland Cement Type I/II, 256 pounds of coarse aggregate no larger than 1.5″, 256 pounds of sand (fine aggregate) and 896 ounces of distilled water. The mixture from Step 1 was held for 24 hours. These pours were in 3′×3′ slabs, not cylinders.

TABLE 21

| Formula | Pour Date | Weight (lb) | Test Date | Cure Days | Load (lbf) | PSI |
|---|---|---|---|---|---|---|
| PB45 −10 P | Aug. 17, 2022 | 5.30 | Aug. 22, 2022 | 5 | 69,301 | 5,253 |
| T56 | | 5.30 | | | 77,619 | 6,187 |
| 3′ × 3′ Slab | | 5.30 | | | 76,622 | 6,106 |
| PB45 −10 P | Aug. 17, 2022 | 5.35 | Aug. 27, 2022 | 10 | 78,516 | 6,270 |
| T56 | | 5.35 | | | 72,489 | 5,785 |
| 3′ × 3′ Slab | | 5.50 | | | 75,934 | 6,053 |
| PB45 −10 P | Aug. 17, 2022 | 5.45 | Sep. 01, 2022 | 15 | 79,154 | 6,304 |
| T56 | | 5.60 | | | 75,227 | 5,997 |
| 3′ × 3′ Slab | | 5.55 | | | 79,978 | 6,381 |
| PB45 −10 P | Aug. 17, 2022 | 5.50 | Sep. 06, 2022 | 20 | 82,462 | 6,482 |
| T56 | | 5.55 | | | 81,448 | 6,501 |
| 3′ × 3′ Slab | | 5.55 | | | 80,032 | 6,388 |
| PB45 −10 P | Aug. 17, 2022 | 5.45 | Sep. 14, 2022 | 28 | 79,083 | 6,307 |
| T56 | | 5.45 | | | 73,953 | 5,898 |
| 3′ × 3′ Slab | | 5.45 | | | 84,988 | 6,770 |

Comparison of the results from TABLES 1 and 21 demonstrates the significant increase in mechanical strength resulting from the addition of the binder reducing agent.

In Table 22, “PB45” is Portland cement, sand, aggregate and water, and binder reducing agent, tested in duplicate (“PB45” is sample 1 and “T58” is sample 2 from a pour). The pour was 800 ml of binder reducing agent, 32 lbs Portland Cement Type I/II, 64 pounds of coarse aggregate no larger than 1.5″, 64 pounds of sand (fine aggregate) and 224 ounces of distilled water. The mixture from Step 1 was held for 24 hours.

TABLE 22

| Formula | Pour Date | Weight (lb) | Test Date | Cure Days | Load (lbf) | PSI |
|---|---|---|---|---|---|---|
| PB45 | Aug. 22, 2022 | 8.25 | Aug. 27, 2022 | 5 | 64,882 | 5,178 |
| T58 | | 8.25 | | | 63,249 | 5,044 |
| | | 8.25 | | | 62,752 | 5,011 |
| | | 8.30 | | | 64,999 | 5,185 |
| | | 8.30 | Sep. 01, 2022 | 10 | 72,976 | 5,816 |
| | | 8.30 | | | 74,425 | 5,940 |
| | | 8.30 | | | 73,451 | 5,859 |
| | | 8.30 | | | 73,182 | 5,832 |
| | | 8.35 | Sep. 06, 2022 | 15 | 76,935 | 6,138 |
| | | 8.35 | | | 72,691 | 5,800 |
| | | 8.35 | | | 75,811 | 6,046 |
| | | 8.35 | | | 74,805 | 5,970 |
| | | 8.35 | Sep. 11, 2022 | 20 | 79,061 | 6,303 |
| | | 8.35 | | | 83,000 | 6,615 |
| | | 8.35 | | | 80,335 | 6,408 |
| | | 8.35 | | | 79,140 | 6,315 |
| | | 8.40 | Sep. 18, 2022 | 28 | 79,241 | 6,327 |
| | | 8.40 | | | 81,492 | 6,495 |
| | | 8.40 | | | 80,191 | 6,395 |
| | | 8.45 | | | 83,359 | 6,644 |

Comparison of the results from TABLES 1 and 22 demonstrates the significant increase in mechanical strength resulting from the addition of the binder reducing agent.

In Table 23, “PB45” is Portland cement, sand, aggregate and water, and binder reducing agent, tested in duplicate (“PB45” is sample 1 and “T59” is sample 2 from a pour). The pour was 400 ml of binder reducing agent, 16 lbs Portland Cement Type I/II, 32 pounds of coarse aggregate no larger than 1.5″, 32 pounds of sand (fine aggregate) and 112 ounces of distilled water. The mixture from Step 1 was held for 24 hours.

TABLE 23

| Formula | Pour Date | Weight (lb) | Test Date | Cure Days | Load (lbf) | PSI |
|---|---|---|---|---|---|---|
| PB45 | Aug. 22, 2022 | 8.30 | Aug. 27, 2022 | 5 | 70,223 | 5,597 |
| T59 | | 8.30 | | | 71,106 | 5,667 |
| | | 8.35 | Sep. 01, 2022 | 10 | 81,077 | 6,460 |
| | | 8.35 | | | 80,963 | 6,452 |
| | | 8.35 | Sep. 06, 2022 | 15 | 82,531 | 6,578 |
| | | 8.35 | | | 83,547 | 6,661 |
| | | 8.40 | Sep. 11, 2022 | 20 | 87,868 | 7,003 |
| | | 8.40 | | | 85,160 | 6,790 |
| | | 8.40 | Sep. 18, 2022 | 28 | 87,007 | 6,933 |
| | | 8.45 | | | 88,428 | 7,049 |

Comparison of the results from TABLES 1 and 23 demonstrates the significant increase in mechanical strength resulting from the addition of the binder reducing agent.

In Table 24, “PB45” is Portland cement, sand, aggregate and water, and binder reducing agent, tested in duplicate (“PB45” is sample 1 and “T60” is sample 2 from a pour). Bath sonication was used instead of probe sonication. The pour was 800 ml of binder reducing agent, 32 lbs Portland Cement Type I/II, 64 pounds of coarse aggregate no larger than 1.5″, 64 pounds of sand (fine aggregate) and 224 ounces of distilled water. The mixture from Step 1 was held for 24 hours.

TABLE 24

| Formula | Pour Date | Weight (lb) | Test Date | Cure Days | Load (lbf) | PSI |
|---|---|---|---|---|---|---|
| PB45 | Aug. 22, 2022 | 8.20 | Aug. 27, 2022 | 5 | 49,992 | 3,988 |
| T60 | | 8.20 | | | 50,430 | 4,022 |
| | | 8.20 | | | 55,865 | 4,458 |
| | | 8.20 | | | 53,225 | 4,241 |
| | | 8.20 | Sep. 01, 2022 | 10 | 63,821 | 5,090 |
| | | 8.25 | | | 52,050 | 4,150 |
| | | 8.25 | | | 49,131 | 3,913 |
| | | 8.25 | | | 62,800 | 5,011 |
| | | 8.25 | Sep. 06, 2022 | 15 | 58,352 | 4,657 |
| | | 8.25 | | | 59,687 | 4,760 |
| | | 8.25 | | | 58,934 | 4,704 |
| | | 8.25 | | | 58,746 | 4,689 |
| | | 8.30 | Sep. 11, 2022 | 20 | 61,657 | 4,917 |
| | | 8.30 | | | 65,791 | 5,244 |
| | | 8.30 | | | 57,133 | 4,553 |
| | | 8.30 | | | 63,750 | 5,084 |
| | | 8.20 | Sep. 18, 2022 | 28 | 58,700 | 4,681 |
| | | 8.30 | | | 59,026 | 4,707 |
| | | 8.30 | | | 55,079 | 4,389 |
| | | 8.30 | | | 43,050 | 3,427 |

Comparison of the results from TABLES 1 and 24 demonstrates the significant increase in mechanical strength resulting from the addition of the binder reducing agent.

In Table 25, “PB45” is Portland cement, sand, aggregate and water, and binder reducing agent, tested in duplicate (“PB45” is sample 1 and “T61” is sample 2 from a pour). Bath sonication was used instead of probe sonication. The pour was 400 ml of binder reducing agent, 16 lbs Portland Cement Type I/II, 32 pounds of coarse aggregate no larger than 1.5″, 32 pounds of sand (fine aggregate) and 112 ounces of distilled water. The mixture from Step 1 was held for 24 hours.

TABLE 25

| Formula | Pour Date | Weight (lb) | Test Date | Cure Days | Load (lbf) | PSI |
|---|---|---|---|---|---|---|
| PB45 | Aug. 22, 2022 | 8.30 | Aug. 27, 2022 | 5 | 73,914 | 5,896 |
| T61 | | 8.30 | | | 74,424 | 5,933 |
| | | 8.35 | Sep. 01, 2022 | 10 | 85,280 | 6,805 |
| | | 8.35 | | | 84,350 | 6,731 |
| | | 8.35 | Sep. 06, 2022 | 15 | 87,028 | 6,937 |
| | | 8.35 | | | 88,332 | 7,048 |
| | | 8.35 | Sep. 11, 2022 | 20 | 88,771 | 7,080 |
| | | 8.35 | | | 89,214 | 7,118 |
| | | 8.35 | Sep. 18, 2022 | 28 | 91,254 | 7,277 |
| | | 8.40 | | | 90,936 | 7,247 |

Comparison of the results from TABLES 1 and 25 demonstrates the significant increase in mechanical strength resulting from the addition of the binder reducing agent.

In Table 26, “PB45” is Portland cement, sand, aggregate and water, and binder reducing agent). The binder reducing agent was added to 4.5 yards of concrete in a mixer truck. The pour was 5 gallons of binder reducing agent, 700 pounds Portland Cement Type I/II, 1450 pounds of coarse aggregate no larger than 1.5″, 1544 pounds of sand (fine aggregate) and 317 pounds of distilled water. The mixture from Step 1 was held for 24 hours. Core samples were taken from a slab; cylinder samples from a mixer truck.

TABLE 26

| Formula | Pour Date | Weight (lb) | Test Date | Cure Days | | PSI |
|---|---|---|---|---|---|---|
| PB45 | Sep. 09, 2022 | — | Sep. 14, 2022 | 5 | Core | 3,660 |
| Alabama Pour | | — | | | Cylinder | 3,260 |
| | | — | Sep. 19, 2022 | 10 | Core | 3,975 |
| | | — | | | Cylinder | 4,090 |
| | | — | Sep. 24, 2022 | 15 | Core | 4,465 |
| | | — | | | Cylinder | 4,400 |
| | | — | Sep. 29, 2022 | 20 | Core | — |
| | | — | | | Cylinder | 4,380 |
| | | — | Oct. 07, 2022 | 28 | Core | — |
| | | — | | | Cylinder | 4,920 |

Excellent mechanical strength was demonstrated.

In Table 27, “PB45” is Portland cement, sand, aggregate and water, and binder reducing agent). The binder reducing agent was added to 4.5 yards of concrete in a mixer truck, using 10% less binder than in the previous experiment of Table 26. The pour was 5 gallons of binder reducing agent, 630 pounds Portland Cement Type I/II, 1450 pounds of coarse aggregate no larger than 1.5″, 1544 pounds of sand (fine aggregate) and 317 pounds of distilled water. The mixture from Step 1 was held for 24 hours. Core samples were taken from a slab; cylinder samples from a mixer truck.

TABLE 27

| Formula | Pour Date | Weight (lb) | Test Date | Cure Days | | PSI |
|---|---|---|---|---|---|---|
| PB45 −10% P | Sep. 09, 2022 | — | Sep. 14, 2022 | 5 | Core | 3,630 |
| Alabama Pour | | — | | | Cylinder | 3,640 |
| | | — | Sep. 19, 2022 | 10 | Core | 3,950 |
| | | — | | | Cylinder | 3,920 |
| | | — | Sep. 24, 2022 | 15 | Core | — |
| | | — | | | Cylinder | 4,450 |
| | | — | Sep. 29, 2022 | 20 | Core | — |
| | | — | | | Cylinder | 4,580 |

Excellent mechanical strength was demonstrated despite the reduction in the amount of binder used.

In Table 28, “PB45” is Portland cement, sand, aggregate and water, and binder reducing agent). The binder reducing agent was added to 4.5 yards of concrete in a mixer truck. The pour was 5 gallons of binder reducing agent, 700 pounds Portland Cement Type I/II, 1450 pounds of coarse aggregate no larger than 1.5″, 1544 pounds of sand (fine aggregate) and 317 pounds of distilled water. The mixture from Step 1 was held for 24 hours. Core samples were taken from a slab; cylinder samples from a mixer truck.

TABLE 28

| Formula | Pour Date | Weight (lb) | Test Date | Cure Days | | PSI |
|---|---|---|---|---|---|---|
| PB45 | Oct. 05, 2022 | — | Oct. 10, 2022 | 5 | Core | 5,160 |
| Ohio Pour | | — | | | Cylinder | 5,530 |
| | | — | Oct. 14, 2022 | 10 | Core | 5,610 |
| | | — | | | Cylinder | 5,810 |
| | | — | Oct. 19, 2022 | 15 | Core | 6,150 |
| | | — | | | Cylinder | 5,980 |
| | | — | Oct. 25, 2022 | 20 | Core | 6,290 |
| | | — | | | Cylinder | 6,790 |

Excellent mechanical strength was demonstrated.

In Table 29, “PB45” is Portland cement, sand, aggregate and water, and binder reducing agent). The binder reducing agent was added to 4.5 yards of concrete in a mixer truck, using 10% less binder than in the previous experiment of Table 28. The pour was 5 gallons of binder reducing agent, 630 pounds Portland Cement Type I/II, 1450 pounds of coarse aggregate no larger than 1.5″, 1544 pounds of sand (fine aggregate) and 317 pounds of distilled water. The mixture from Step 1 was held for 24 hours. Core samples were taken from a slab; cylinder samples from a mixer truck.

TABLE 29

| Formula | Pour Date | Weight (lb) | Test Date | Cure Days. | | PSI |
|---|---|---|---|---|---|---|
| PB45 −10% P | Oct. 05, 2022 | — | Oct. 10, 2022 | 5 | Core | 4,920 |
| Ohio Pour | | — | | | Cylinder | 5,030 |
| | | — | Oct. 14, 2022 | 10 | Core | 5,080 |
| | | — | | | Cylinder | 5,410 |
| | | — | Oct. 19, 2022 | 15 | Core | 5,360 |
| | | — | | | Cylinder | 5,840 |
| | | — | Oct. 25, 2022 | 20 | Core | 5,770 |
| | | — | | | Cylinder | 5,300 |

Excellent mechanical strength was demonstrated despite the reduction in the amount of binder used.

In Table 30, “PB45” is Portland cement, sand, aggregate and water, and binder reducing agent, tested in duplicate, triplicate, etc., as the case may be (“PB45” is sample 1 and “T63” is sample 2 from a pour, etc.). Per 10 4″×8″ Cylinders: 16 lbs. of Portland I/II cement, 32 pounds of medium to large aggregate (rock), 32 lbs. of fine aggregate (sand), 8.34 lbs. of water and 0.88 lbs. of binder reducing formulation. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens.

TABLE 30

| Formula | Pour Date | Weight (lb) | Test Date | Cure Days | Load (lbf) | PSI |
|---|---|---|---|---|---|---|
| PB45 | Oct. 12, 2022 | 8.30 | Oct. 17, 2022 | 5 | 66,338 | 5,290 |
| T63 | Oct. 12, 2022 | 8.35 | Oct. 17, 2022 | 5 | 66,349 | 5,291 |
| 10 Cylinders | Oct. 12, 2022 | 8.35 | Oct. 17, 2022 | 5 | 64,607 | 5,152 |
| Portland I/II | Oct. 12, 2022 | 8.35 | Oct. 17, 2022 | 5 | 67,795 | 5,409 |
| 1:2:2 Mix | Oct. 12, 2022 | 8.35 | Oct. 17, 2022 | 5 | 65,020 | 5,187 |
| | Oct. 12, 2022 | 8.30 | Oct. 22, 2022 | 10 | 73,612 | 5,868 |
| | Oct. 12, 2022 | 8.35 | Oct. 22, 2022 | 10 | 74,399 | 5,933 |
| | Oct. 12, 2022 | 8.35 | Oct. 22, 2022 | 10 | 75,401 | 6,014 |
| | Oct. 12, 2022 | 8.35 | Oct. 22, 2022 | 10 | 74,852 | 5,966 |
| | Oct. 12, 2022 | 8.40 | Oct. 22, 2022 | 10 | 72,144 | 5,753 |
| PB45 | Oct. 17, 2022 | 8.30 | Oct. 22, 2022 | 5 | 61,638 | 5,916 |
| T64 | Oct. 17, 2022 | 8.30 | Oct. 22, 2022 | 5 | 58,239 | 4,646 |
| 10 Cylinders | Oct. 17, 2022 | 8.30 | Oct. 22, 2022 | 5 | 56,319 | 4,494 |
| Portland I/II | Oct. 17, 2022 | 8.30 | Oct. 22, 2022 | 5 | 56,961 | 4,544 |
| 1:2:2 Mix | Oct. 17, 2022 | 8.30 | Oct. 22, 2022 | 5 | 58,723 | 4,682 |
| | Oct. 17, 2022 | 8.30 | Oct. 27, 2022 | 10 | 78,299 | 6,249 |
| | Oct. 17, 2022 | 8.30 | Oct. 27, 2022 | 10 | 77,497 | 6,191 |
| | Oct. 17, 2022 | 8.35 | Oct. 27, 2022 | 10 | 79,605 | 6,345 |
| | Oct. 17, 2022 | 8.35 | Oct. 27, 2022 | 10 | 71,167 | 5,677 |
| | Oct. 17, 2022 | 8.35 | Oct. 27, 2022 | 10 | 74,840 | 5,969 |
| PB45 | Oct. 17, 2022 | 8.35 | Oct. 22, 2022 | 5 | 60,196 | 4,801 |
| T65 | Oct. 17, 2022 | 8.35 | Oct. 22, 2022 | 5 | 56,318 | 4,491 |
| 5 Cylinders | Oct. 17, 2022 | 8.35 | Oct. 22, 2022 | 5 | 53,368 | 4,258 |
| Portland I/II | Oct. 17, 2022 | 8.30 | Oct. 27, 2022 | 10 | 78,665 | 6,275 |
| 1:2:2 Mix | Oct. 17, 2022 | 8.30 | Oct. 27, 2022 | 10 | 80,263 | 6,399 |
| PB45 | Nov. 02, 2022 | 8.30 | Nov. 07, 2022 | 5 | 66,593 | 5,311 |
| T70 | Nov. 02, 2022 | 8.30 | Nov. 07, 2022 | 5 | 69,058 | 5,505 |
| 50 Cylinders | Nov. 02, 2022 | 8.30 | Nov. 07, 2022 | 5 | 68,607 | 5,468 |
| Portland I/II | Nov. 02, 2022 | 8.30 | Nov. 07, 2022 | 5 | 69,320 | 5,537 |
| 1:2:2 Mix | Nov. 02, 2022 | 8.30 | Nov. 07, 2022 | 5 | 74,695 | 5,955 |
| | Nov. 02, 2022 | 8.30 | Nov. 07, 2022 | 5 | 69,902 | 5,581 |
| | Nov. 02, 2022 | 8.30 | Nov. 07, 2022 | 5 | 70,916 | 5,657 |
| | Nov. 02, 2022 | 8.30 | Nov. 07, 2022 | 5 | 65,070 | 5,187 |
| | Nov. 02, 2022 | 8.35 | Nov. 07, 2022 | 5 | 69,563 | 5,552 |
| | Nov. 02, 2022 | 8.35 | Nov. 07, 2022 | 5 | 67,084 | 5,356 |
| | Nov. 02, 2022 | 8.30 | Nov. 12, 2022 | 10 | 85,973 | 6,855 |
| | Nov. 02, 2022 | 8.35 | Nov. 12, 2022 | 10 | 80,650 | 6,431 |
| | Nov. 02, 2022 | 8.35 | Nov. 12, 2022 | 10 | 83,644 | 6,676 |
| | Nov. 02, 2022 | 8.35 | Nov. 12, 2022 | 10 | 80,346 | 6,402 |
| | Nov. 02, 2022 | 8.35 | Nov. 12, 2022 | 10 | 82,311 | 6,567 |
| | Nov. 02, 2022 | 8.35 | Nov. 12, 2022 | 10 | 82,118 | 6,549 |
| | Nov. 02, 2022 | 8.35 | Nov. 12, 2022 | 10 | 89,994 | 7,177 |
| | Nov. 02, 2022 | 8.35 | Nov. 12, 2022 | 10 | 80,598 | 6,431 |
| | Nov. 02, 2022 | 8.35 | Nov. 12, 2022 | 10 | 80,543 | 6,424 |
| | Nov. 02, 2022 | 8.35 | Nov. 12, 2022 | 10 | 78,052 | 6,222 |
| | Nov. 02, 2022 | 8.35 | Nov. 17, 2022 | 15 | 82,645 | 6,588 |
| | Nov. 02, 2022 | 8.35 | Nov. 17, 2022 | 15 | 86,184 | 6,868 |
| | Nov. 02, 2022 | 8.35 | Nov. 17, 2022 | 15 | 78,998 | 6,295 |
| | Nov. 02, 2022 | 8.35 | Nov. 17, 2022 | 15 | 83,628 | 6,665 |
| | Nov. 02, 2022 | 8.40 | Nov. 17, 2022 | 15 | 87,257 | 6,950 |
| | Nov. 02, 2022 | 8.40 | Nov. 17, 2022 | 15 | 80,213 | 6,395 |
| | Nov. 02, 2022 | 8.40 | Nov. 17, 2022 | 15 | 82,398 | 6,566 |
| | Nov. 02, 2022 | 8.40 | Nov. 17, 2022 | 15 | 84,194 | 6,789 |
| | Nov. 02, 2022 | 8.35 | Nov. 17, 2022 | 15 | 82,741 | 6,595 |
| | Nov. 02, 2022 | 8.35 | Nov. 17, 2022 | 15 | 83,032 | 6,621 |
| | Nov. 02, 2022 | 8.40 | Nov. 22, 2022 | 20 | 88,521 | 7,061 |
| | Nov. 02, 2022 | 8.40 | Nov. 22, 2022 | 20 | 86,996 | 6,941 |
| | Nov. 02, 2022 | 8.40 | Nov. 22, 2022 | 20 | 89,152 | 7,111 |
| | Nov. 02, 2022 | 8.40 | Nov. 22, 2022 | 20 | 83,339 | 6,648 |
| | Nov. 02, 2022 | 8.40 | Nov. 22, 2022 | 20 | 83,043 | 6,624 |
| | Nov. 02, 2022 | 8.40 | Nov. 22, 2022 | 20 | 87,281 | 6,956 |
| | Nov. 02, 2022 | 8.40 | Nov. 22, 2022 | 20 | 88,293 | 7,041 |
| | Nov. 02, 2022 | 8.40 | Nov. 22, 2022 | 20 | 91,634 | 7,300 |
| | Nov. 02, 2022 | 8.35 | Nov. 22, 2022 | 20 | 88,554 | 7,064 |
| | Nov. 02, 2022 | 8.35 | Nov. 22, 2022 | 20 | 84,260 | 6,718 |
| | Nov. 02, 2022 | 8.30 | Nov. 30, 2022 | 28 | 81,882 | 6,529 |
| | Nov. 02, 2022 | 8.30 | Nov. 30, 2022 | 28 | 84,477 | 6,743 |
| | Nov. 02, 2022 | 8.35 | Nov. 30, 2022 | 28 | 82,674 | 6,597 |
| | Nov. 02, 2022 | 8.35 | Nov. 30, 2022 | 28 | 84,602 | 6,744 |
| | Nov. 02, 2022 | 8.45 | Nov. 30, 2022 | 28 | 94,717 | 7,549 |
| | Nov. 02, 2022 | 8.45 | Nov. 30, 2022 | 28 | 85,580 | 6,822 |
| | Nov. 02, 2022 | 8.45 | Nov. 30, 2022 | 28 | 86,795 | 6,918 |
| | Nov. 02, 2022 | 8.45 | Nov. 30, 2022 | 28 | 87,195 | 6,951 |
| | Nov. 02, 2022 | 8.35 | Nov. 30, 2022 | 28 | 85,109 | 6,786 |
| | Nov. 02, 2022 | 8.35 | Nov. 30, 2022 | 28 | 86,674 | 6,909 |
| PB45 | Nov. 02, 2022 | 8.30 | Nov. 07, 2022 | 5 | 68,873 | 5,492 |
| T71 | Nov. 02, 2022 | 8.30 | Nov. 07, 2022 | 5 | 71,651 | 5,716 |
| 50 Cylinders | Nov. 02, 2022 | 8.30 | Nov. 07, 2022 | 5 | 65,451 | 5,219 |
| Portland I/II | Nov. 02, 2022 | 8.30 | Nov. 07, 2022 | 5 | 60,372 | 4,816 |
| 1:2:2 Mix | Nov. 02, 2022 | 8.30 | Nov. 07, 2022 | 5 | 67,029 | 5,344 |
| | Nov. 02, 2022 | 8.30 | Nov. 07, 2022 | 5 | 68,062 | 5,430 |
| | Nov. 02, 2022 | 8.30 | Nov. 07, 2022 | 5 | 63,813 | 5,089 |
| | Nov. 02, 2022 | 8.30 | Nov. 07, 2022 | 5 | 63,413 | 5,055 |
| | Nov. 02, 2022 | 8.35 | Nov. 07, 2022 | 5 | 54,921 | 4,380 |
| | Nov. 02, 2022 | 8.35 | Nov. 07, 2022 | 5 | 53,021 | 4,232 |
| | Nov. 02, 2022 | 8.30 | Nov. 12, 2022 | 10 | 73,992 | 5,900 |
| | Nov. 02, 2022 | 8.30 | Nov. 12, 2022 | 10 | 71,247 | 5,686 |
| | Nov. 02, 2022 | 8.35 | Nov. 12, 2022 | 10 | 73,342 | 5,847 |
| | Nov. 02, 2022 | 8.35 | Nov. 12, 2022 | 10 | 75,763 | 6,041 |
| | Nov. 02, 2022 | 8.35 | Nov. 12, 2022 | 10 | 79,368 | 6,328 |
| | Nov. 02, 2022 | 8.35 | Nov. 12, 2022 | 10 | 77,964 | 6,222 |
| | Nov. 02, 2022 | 8.35 | Nov. 12, 2022 | 10 | 77,479 | 6,179 |
| | Nov. 02, 2022 | 8.35 | Nov. 12, 2022 | 10 | 70,450 | 5,617 |
| | Nov. 02, 2022 | 8.30 | Nov. 12, 2022 | 10 | 64,472 | 5,142 |
| | Nov. 02, 2022 | 8.35 | Nov. 12, 2022 | 10 | 62,404 | 4,979 |
| | Nov. 02, 2022 | 8.35 | Nov. 17, 2022 | 15 | 74,399 | 5,931 |
| | Nov. 02, 2022 | 8.35 | Nov. 17, 2022 | 15 | 81,011 | 6,462 |
| | Nov. 02, 2022 | 8.35 | Nov. 17, 2022 | 15 | 71,679 | 5,713 |
| | Nov. 02, 2022 | 8.35 | Nov. 17, 2022 | 15 | 77,874 | 6,212 |
| | Nov. 02, 2022 | 8.35 | Nov. 17, 2022 | 15 | 81,460 | 6,493 |
| | Nov. 02, 2022 | 8.35 | Nov. 17, 2022 | 15 | 74,800 | 5,963 |
| | Nov. 02, 2022 | 8.35 | Nov. 17, 2022 | 15 | 72,815 | 5,806 |
| | Nov. 02, 2022 | 8.35 | Nov. 17, 2022 | 15 | 78,680 | 6,267 |
| | Nov. 02, 2022 | 8.30 | Nov. 17, 2022 | 15 | 67,817 | 5,406 |
| | Nov. 02, 2022 | 8.35 | Nov. 17, 2022 | 15 | 67,355 | 5,372 |
| | Nov. 02, 2022 | 8.40 | Nov. 22, 2022 | 20 | 79,822 | 6,367 |
| | Nov. 02, 2022 | 8.40 | Nov. 22, 2022 | 20 | 86,754 | 6,914 |
| | Nov. 02, 2022 | 8.40 | Nov. 22, 2022 | 20 | 79,057 | 6,300 |
| | Nov. 02, 2022 | 8.40 | Nov. 22, 2022 | 20 | 74,589 | 5,945 |
| | Nov. 02, 2022 | 8.40 | Nov. 22, 2022 | 20 | 83,699 | 6,678 |
| | Nov. 02, 2022 | 8.40 | Nov. 22, 2022 | 20 | 76,030 | 6,059 |
| | Nov. 02, 2022 | 8.40 | Nov. 22, 2022 | 20 | 83,396 | 6,645 |
| | Nov. 02, 2022 | 8.40 | Nov. 22, 2022 | 20 | 76,447 | 6,094 |
| | Nov. 02, 2022 | 8.30 | Nov. 22, 2022 | 20 | 67,045 | 5,344 |
| | Nov. 02, 2022 | 8.35 | Nov. 22, 2022 | 20 | 61,679 | 4,918 |
| | Nov. 02, 2022 | 8.35 | Nov. 30, 2022 | 28 | 84,774 | 6,756 |
| | Nov. 02, 2022 | 8.35 | Nov. 30, 2022 | 28 | 77,376 | 6,172 |
| | Nov. 02, 2022 | 8.35 | Nov. 30, 2022 | 28 | 73,978 | 5,899 |
| | Nov. 02, 2022 | 8.35 | Nov. 30, 2022 | 28 | 75,981 | 6,057 |
| | Nov. 02, 2022 | 8.40 | Nov. 30, 2022 | 28 | 83,671 | 6,674 |
| | Nov. 02, 2022 | 8.40 | Nov. 30, 2022 | 28 | 78,681 | 6,270 |
| | Nov. 02, 2022 | 8.40 | Nov. 30, 2022 | 28 | 81,153 | 6,480 |
| | Nov. 02, 2022 | 8.40 | Nov. 30, 2022 | 28 | 74,251 | 5,918 |
| | Nov. 02, 2022 | 8.30 | Nov. 30, 2022 | 28 | 81,429 | 6,502 |
| | Nov. 02, 2022 | 8.35 | Nov. 30, 2022 | 28 | 81,692 | 6,523 |
| PB45 | Nov. 09, 2022 | 8.35 | Nov. 14, 2022 | 5 | 63,825 | 5,091 |
| T72 | Nov. 09, 2022 | 8.40 | Nov. 14, 2022 | 5 | 60,276 | 4,806 |
| 40 Cylinders | Nov. 09, 2022 | 8.40 | Nov. 14, 2022 | 5 | 63,295 | 5,048 |
| Portland I/II | Nov. 09, 2022 | 8.40 | Nov. 14, 2022 | 5 | 62,319 | 4,972 |
| 1:2:2 Mix | Nov. 09, 2022 | 8.40 | Nov. 14, 2022 | 5 | 60,053 | 4,792 |
| | Nov. 09, 2022 | 8.40 | Nov. 14, 2022 | 5 | 62,490 | 4,985 |
| | Nov. 09, 2022 | 8.40 | Nov. 14, 2022 | 5 | 74,959 | 5,981 |
| | Nov. 09, 2022 | 8.45 | Nov. 14, 2022 | 5 | 72,980 | 5,825 |
| | Nov. 09, 2022 | 8.35 | Nov. 19, 2022 | 10 | 70,887 | 5,651 |
| | Nov. 09, 2022 | 8.35 | Nov. 19, 2022 | 10 | 69,168 | 5,514 |
| | Nov. 09, 2022 | 8.35 | Nov. 19, 2022 | 10 | 68,084 | 5,425 |
| | Nov. 09, 2022 | 8.35 | Nov. 19, 2022 | 10 | 69,164 | 5,515 |
| | Nov. 09, 2022 | 8.35 | Nov. 19, 2022 | 10 | 74,419 | 5,933 |
| | Nov. 09, 2022 | 8.35 | Nov. 19, 2022 | 10 | 73,481 | 5,859 |
| | Nov. 09, 2022 | 8.45 | Nov. 19, 2022 | 10 | 84,036 | 6,697 |
| | Nov. 09, 2022 | 8.45 | Nov. 19, 2022 | 10 | 82,253 | 6,559 |
| | Nov. 09, 2022 | 8.40 | Nov. 23, 2022 | 15 | 76,317 | 6,084 |
| | Nov. 09, 2022 | 8.40 | Nov. 23, 2022 | 15 | 75,991 | 6,059 |
| | Nov. 09, 2022 | 8.40 | Nov. 23, 2022 | 15 | 71,935 | 5,737 |
| | Nov. 09, 2022 | 8.40 | Nov. 23, 2022 | 15 | 77,863 | 6,205 |
| | Nov. 09, 2022 | 8.40 | Nov. 23, 2022 | 15 | 72,440 | 5,774 |
| | Nov. 09, 2022 | 8.40 | Nov. 23, 2022 | 15 | 73,015 | 5,822 |
| | Nov. 09, 2022 | 8.40 | Nov. 23, 2022 | 15 | 83,221 | 6,635 |
| | Nov. 09, 2022 | 8.45 | Nov. 23, 2022 | 15 | 85,194 | 6,792 |
| | Nov. 09, 2022 | 8.35 | Nov. 24, 2022 | 20 | 78,299 | 6,241 |
| | Nov. 09, 2022 | 8.35 | Nov. 24, 2022 | 20 | 76,901 | 6,129 |
| | Nov. 09, 2022 | 8.35 | Nov. 24, 2022 | 20 | 77,271 | 6,148 |
| | Nov. 09, 2022 | 8.35 | Nov. 24, 2022 | 20 | 76,262 | 6,081 |
| | Nov. 09, 2022 | 8.35 | Nov. 24, 2022 | 20 | 75,413 | 6,018 |
| | Nov. 09, 2022 | 8.35 | Nov. 24, 2022 | 20 | 75,382 | 6,015 |
| | Nov. 09, 2022 | 8.45 | Nov. 24, 2022 | 20 | 83,019 | 6,617 |
| | Nov. 09, 2022 | 8.45 | Nov. 24, 2022 | 20 | 78,764 | 6,278 |
| | Nov. 09, 2022 | 8.35 | Nov. 29, 2022 | 28 | 80,970 | 6,450 |
| | Nov. 09, 2022 | 8.35 | Nov. 29, 2022 | 28 | 77,706 | 6,196 |
| | Nov. 09, 2022 | 8.35 | Nov. 29, 2022 | 28 | 77,141 | 6,154 |
| | Nov. 09, 2022 | 8.35 | Nov. 29, 2022 | 28 | 80,051 | 6,392 |
| | Nov. 09, 2022 | 8.35 | Nov. 29, 2022 | 28 | 82,969 | 6,625 |
| | Nov. 09, 2022 | 8.35 | Nov. 29, 2022 | 28 | 81,817 | 6,533 |
| | Nov. 09, 2022 | 8.45 | Nov. 29, 2022 | 28 | 85,439 | 6,811 |
| | Nov. 09, 2022 | 8.50 | Nov. 29, 2022 | 28 | 82,924 | 6,607 |
| PB45 | Nov. 09, 2022 | 8.30 | Nov. 14, 2022 | 5 | 63,329 | 5,053 |
| T73 | Nov. 09, 2022 | 8.40 | Nov. 14, 2022 | 5 | 70,040 | 5,580 |
| 40 Cylinders | Nov. 09, 2022 | 8.40 | Nov. 14, 2022 | 5 | 68,042 | 5,426 |
| Portland I/II | Nov. 09, 2022 | 8.40 | Nov. 14, 2022 | 5 | 69,752 | 5,564 |
| 1:2:2 Mix | Nov. 09, 2022 | 8.40 | Nov. 14, 2022 | 5 | 67,946 | 5,419 |
| | Nov. 09, 2022 | 8.40 | Nov. 14, 2022 | 5 | 70,477 | 5,620 |
| | Nov. 09, 2022 | 8.40 | Nov. 14, 2022 | 5 | 68,432 | 5,462 |
| | Nov. 09, 2022 | 8.50 | Nov. 14, 2022 | 5 | 79,996 | 6,379 |
| | Nov. 09, 2022 | 8.30 | Nov. 19, 2022 | 10 | 67,581 | 5,387 |
| | Nov. 09, 2022 | 8.30 | Nov. 19, 2022 | 10 | 65,976 | 5,264 |
| | Nov. 09, 2022 | 8.30 | Nov. 19, 2022 | 10 | 70,921 | 5,653 |
| | Nov. 09, 2022 | 8.30 | Nov. 19, 2022 | 10 | 69,837 | 5,569 |
| | Nov. 09, 2022 | 8.30 | Nov. 19, 2022 | 10 | 67,517 | 5,382 |
| | Nov. 09, 2022 | 8.30 | Nov. 19, 2022 | 10 | 68,908 | 5,493 |
| | Nov. 09, 2022 | 8.40 | Nov. 19, 2022 | 10 | 92,668 | 7,385 |
| | Nov. 09, 2022 | 8.50 | Nov. 19, 2022 | 10 | 79,009 | 6,298 |
| | Nov. 09, 2022 | 8.30 | Nov. 23, 2022 | 15 | 70,427 | 5,614 |
| | Nov. 09, 2022 | 8.40 | Nov. 23, 2022 | 15 | 78,991 | 6,296 |
| | Nov. 09, 2022 | 8.40 | Nov. 23, 2022 | 15 | 80,427 | 6,418 |
| | Nov. 09, 2022 | 8.40 | Nov. 23, 2022 | 15 | 82,694 | 6,600 |
| | Nov. 09, 2022 | 8.40 | Nov. 23, 2022 | 15 | 79,916 | 6,374 |
| | Nov. 09, 2022 | 8.40 | Nov. 23, 2022 | 15 | 78,785 | 6,280 |
| | Nov. 09, 2022 | 8.45 | Nov. 23, 2022 | 15 | 73,062 | 5,825 |
| | Nov. 09, 2022 | 8.50 | Nov. 23, 2022 | 15 | 84,869 | 6,766 |
| | Nov. 09, 2022 | 8.30 | Nov. 24, 2022 | 20 | 73,243 | 5,840 |
| | Nov. 09, 2022 | 8.30 | Nov. 24, 2022 | 20 | 71,828 | 5,724 |
| | Nov. 09, 2022 | 8.30 | Nov. 24, 2022 | 20 | 74,163 | 5,912 |
| | Nov. 09, 2022 | 8.30 | Nov. 24, 2022 | 20 | 73,222 | 5,843 |
| | Nov. 09, 2022 | 8.30 | Nov. 24, 2022 | 20 | 72,760 | 5,803 |
| | Nov. 09, 2022 | 8.30 | Nov. 24, 2022 | 20 | 71,991 | 5,740 |
| | Nov. 09, 2022 | 8.45 | Nov. 24, 2022 | 20 | 73,771 | 5,885 |
| | Nov. 09, 2022 | 8.45 | Nov. 24, 2022 | 20 | 71,057 | 5,666 |
| | Nov. 09, 2022 | 8.30 | Nov. 29, 2022 | 28 | 85,237 | 6,818 |
| | Nov. 09, 2022 | 8.40 | Nov. 29, 2022 | 28 | 85,098 | 6,780 |
| | Nov. 09, 2022 | 8.40 | Nov. 29, 2022 | 28 | 79,917 | 6,338 |
| | Nov. 09, 2022 | 8.40 | Nov. 29, 2022 | 28 | 82,104 | 6,545 |
| | Nov. 09, 2022 | 8.45 | Nov. 29, 2022 | 28 | 83,798 | 6,687 |
| | Nov. 09, 2022 | 8.45 | Nov. 29, 2022 | 28 | 78,655 | 6,271 |
| | Nov. 09, 2022 | 8.50 | Nov. 29, 2022 | 28 | 74,663 | 5,954 |
| | Nov. 09, 2022 | 8.50 | Nov. 29, 2022 | 28 | 83,468 | 6,656 |
| PB45 | Nov. 10, 2022 | 8.30 | Nov. 15, 2022 | 5 | 44,954 | 3,584 |
| T75 | Nov. 10, 2022 | 8.30 | Nov. 15, 2022 | 5 | 48,586 | 3,876 |
| 20 Cylinders | Nov. 10, 2022 | 8.35 | Nov. 15, 2022 | 5 | 53,105 | 4,237 |
| Portland I/II | Nov. 10, 2022 | 8.35 | Nov. 15, 2022 | 5 | 49,982 | 3,985 |
| 1:2:2 Mix | Nov. 10, 2022 | 8.35 | Nov. 20, 2022 | 10 | 56,952 | 4,540 |
| | Nov. 10, 2022 | 8.40 | Nov. 20, 2022 | 10 | 58,907 | 4,700 |
| | Nov. 10, 2022 | 8.40 | Nov. 20, 2022 | 10 | 55,420 | 4,421 |
| | Nov. 10, 2022 | 8.40 | Nov. 20, 2022 | 10 | 67,898 | 5,413 |
| | Nov. 10, 2022 | 8.30 | Nov. 25, 2022 | 15 | 58,209 | 4,641 |
| | Nov. 10, 2022 | 8.35 | Nov. 25, 2022 | 15 | 66,311 | 5,279 |
| | Nov. 10, 2022 | 8.35 | Nov. 25, 2022 | 15 | 47,118 | 3,756 |
| | Nov. 10, 2022 | 8.35 | Nov. 25, 2022 | 15 | 60,552 | 4,826 |
| | Nov. 10, 2022 | 8.30 | Nov. 30, 2022 | 20 | 52,767 | 4,208 |
| | Nov. 10, 2022 | 8.30 | Nov. 30, 2022 | 20 | 49,822 | 3,976 |
| | Nov. 10, 2022 | 8.30 | Nov. 30, 2022 | 20 | 47,551 | 3,792 |
| | Nov. 10, 2022 | 8.35 | Nov. 30, 2022 | 20 | 60,874 | 4,854 |
| | Nov. 10, 2022 | 8.30 | Dec. 08, 2022 | 28 | 65,147 | 5,198 |
| | Nov. 10, 2022 | 8.35 | Dec. 08, 2022 | 28 | 69,165 | 5,516 |
| | Nov. 10, 2022 | 8.40 | Dec. 08, 2022 | 28 | 68,596 | 5,475 |
| | Nov. 10, 2022 | 8.40 | Dec. 08, 2022 | 28 | 71,155 | 5,678 |

Comparison of the results from TABLES 1 and 9 demonstrates the significant increase in mechanical strength resulting from the addition of the binder reducing agent.

In Table 31, Per 10 4″×8″ Cylinders: 12 lbs. of Portland I/II cement, 41 pounds of medium to large aggregate (rock), 27 lbs. of fine aggregate (sand), and 8.34 lbs. of water. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens. This table serves as the baseline measure for all 1:3:2 mixtures utilizing Portland I/II cement as the binder.

TABLE 31

| Formula | Pour Date | Weight (lb) | Test Date | Cure Days | LBF | PSI |
|---|---|---|---|---|---|---|
| Baseline | Nov. 30, 2022 | 8.45 | Dec. 05, 2022 | 5 | 47,154 | 3,766 |
| T85 | Nov. 30, 2022 | 8.45 | Dec. 05, 2022 | 5 | 45,481 | 3,631 |
| 20 Cylinders | Nov. 30, 2022 | 8.45 | Dec. 05, 2022 | 5 | 43,831 | 3,497 |
| Portland I/II | Nov. 30, 2022 | 8.45 | Dec. 05, 2022 | 5 | 43,048 | 3,435 |
| 1:3:2 Mix | Nov. 30, 2022 | 8.40 | Dec. 10, 2022 | 10 | 53,990 | 4,306 |
| | Nov. 30, 2022 | 8.45 | Dec. 10, 2022 | 10 | 52,166 | 4,155 |
| | Nov. 30, 2022 | 8.45 | Dec. 10, 2022 | 10 | 53,880 | 4,300 |
| | Nov. 30, 2022 | 8.45 | Dec. 10, 2022 | 10 | 53,730 | 4,288 |
| | Nov. 30, 2022 | 8.45 | Dec. 15, 2022 | 15 | 59,519 | 4,749 |
| | Nov. 30, 2022 | 8.45 | Dec. 15, 2022 | 15 | 61,689 | 4,923 |
| | Nov. 30, 2022 | 8.50 | Dec. 15, 2022 | 15 | 60,162 | 4,798 |
| | Nov. 30, 2022 | 8.50 | Dec. 15, 2022 | 15 | 57,545 | 4,589 |
| | Nov. 30, 2022 | 8.45 | Dec. 20, 2022 | 20 | 58,330 | 4,653 |
| | Nov. 30, 2022 | 8.50 | Dec. 20, 2022 | 20 | 59,620 | 4,754 |
| | Nov. 30, 2022 | 8.40 | Dec. 20, 2022 | 20 | 62,306 | 4,967 |
| | Nov. 30, 2022 | 8.45 | Dec. 20, 2022 | 20 | 58,938 | 4,703 |
| | Nov. 30, 2022 | 8.40 | Dec. 28, 2022 | 28 | 62,957 | 5,024 |
| | Nov. 30, 2022 | 8.45 | Dec. 28, 2022 | 28 | 62,768 | 5,006 |
| | Nov. 30, 2022 | 8.45 | Dec. 28, 2022 | 28 | 64,340 | 5,129 |
| | Nov. 30, 2022 | 8.50 | Dec. 28, 2022 | 28 | 62,011 | 4,948 |

In Table 32, “PB45” is Portland cement, sand, aggregate and water, and binder reducing agent, tested in duplicate, triplicate, etc., as the case may be (“PB45” is sample 1 and “T88” is sample 2 from a pour). Per 10 4″×8″ Cylinders: 12 lbs. of Portland I/II cement, 41 pounds of medium to large aggregate (rock), 27 lbs. of fine aggregate (sand), 8.34 lbs. of water and 0.88 lbs. of binder reducing formulation. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens.

TABLE 32

| Formula | Pour Date | Weight (lb) | Test Date | Cure Days | LBF | PSI |
|---|---|---|---|---|---|---|
| PB45 | Dec. 06, 2022 | 8.45 | Dec. 11, 2022 | 5 | 59,707 | 4,766 |
| T88 | Dec. 06, 2022 | 8.45 | Dec. 11, 2022 | 5 | 59,594 | 4,758 |
| 20 Cylinders | Dec. 06, 2022 | 8.45 | Dec. 11, 2022 | 5 | 65,713 | 5,238 |
| Portland I/II | Dec. 06, 2022 | 8.45 | Dec. 11, 2022 | 5 | 67,271 | 5,363 |
| 1:3:2 Mix | Dec. 06, 2022 | 8.45 | Dec. 16, 2022 | 10 | 64,216 | 5,121 |
| | Dec. 06, 2022 | 8.45 | Dec. 16, 2022 | 10 | 66,508 | 5,301 |
| | Dec. 06, 2022 | 8.45 | Dec. 16, 2022 | 10 | 73,022 | 5,821 |
| | Dec. 06, 2022 | 8.45 | Dec. 16, 2022 | 10 | 71,431 | 5,697 |
| | Dec. 06, 2022 | 8.45 | Dec. 21, 2022 | 15 | 67,430 | 5,374 |
| | Dec. 06, 2022 | 8.45 | Dec. 21, 2022 | 15 | 70,754 | 5,640 |
| | Dec. 06, 2022 | 8.45 | Dec. 21, 2022 | 15 | 78,180 | 6,229 |
| | Dec. 06, 2022 | 8.45 | Dec. 21, 2022 | 15 | 79,499 | 6,339 |
| | Dec. 06, 2022 | 8.45 | Dec. 26, 2022 | 20 | 74,838 | 5,972 |
| | Dec. 06, 2022 | 8.45 | Dec. 26, 2022 | 20 | 71,703 | 5,719 |
| | Dec. 06, 2022 | 8.45 | Dec. 26, 2022 | 20 | 81,566 | 6,513 |
| | Dec. 06, 2022 | 8.45 | Dec. 26, 2022 | 20 | 84,406 | 6,733 |
| | Dec. 06, 2022 | 8.45 | Jan. 02, 2023 | 28 | 86,676 | 6,921 |
| | Dec. 06, 2022 | 8.45 | Jan. 02, 2023 | 28 | 85,011 | 6,788 |
| | Dec. 06, 2022 | 8.45 | Jan. 02, 2023 | 28 | 86,279 | 6,879 |
| | Dec. 06, 2022 | 8.45 | Jan. 02, 2023 | 28 | 83,771 | 6,689 |

Comparison of the results from TABLES 32 and 31 demonstrates the significant increase in mechanical strength resulting from the addition of the binder reducing agent.

In Table 33, “PB45” is Portland cement, sand, aggregate and water, and binder reducing agent, tested in duplicate, triplicate, etc., as the case may be (“PB45” is sample 1 and “T76” is sample 2 from a pour). Per 10 4″×8″ Cylinders: 10.8 lbs. of Portland I/II cement, 41 pounds of medium to large aggregate (rock), 27 lbs. of fine aggregate (sand), 8.34 lbs. of water and 0.88 lbs. of binder reducing formulation. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens.

TABLE 33

| | | Weight | | | | |
|---|---|---|---|---|---|---|
| Formula | Pour Date | (lb) | Test Date | Cure Days | LBF | PSI |
| PB45 | Nov. 10, 2022 | 8.45 | Nov. 15, 2022 | 5 | 56,158 | 4,480 |
| T76 | Nov. 10, 2022 | 8.45 | Nov. 15, 2022 | 5 | 56,613 | 4,509 |
| 20 Cylinders | Nov. 10, 2022 | 8.45 | Nov. 15, 2022 | 5 | 55,317 | 4,409 |
| −10% Portland I/II | Nov. 10, 2022 | 8.50 | Nov. 15, 2022 | 5 | 55,681 | 4,443 |
| 1:3:2 Mix | Nov. 10, 2022 | 8.45 | Nov. 20, 2022 | 10 | 66,956 | 5,337 |
| | Nov. 10, 2022 | 8.45 | Nov. 20, 2022 | 10 | 65,339 | 5,216 |
| | Nov. 10, 2022 | 8.50 | Nov. 20, 2022 | 10 | 69,131 | 5,507 |
| | Nov. 10, 2022 | 8.50 | Nov. 20, 2022 | 10 | 67,772 | 5,402 |
| | Nov. 10, 2022 | 8.40 | Nov. 25, 2022 | 15 | 72,237 | 5,757 |
| | Nov. 10, 2022 | 8.45 | Nov. 25, 2022 | 15 | 69,981 | 5,582 |
| | Nov. 10, 2022 | 8.45 | Nov. 25, 2022 | 15 | 64,555 | 5,153 |
| | Nov. 10, 2022 | 8.50 | Nov. 25, 2022 | 15 | 74,434 | 5,936 |
| | Nov. 10, 2022 | 8.40 | Nov. 30, 2022 | 20 | 73,014 | 5,820 |
| | Nov. 10, 2022 | 8.45 | Nov. 30, 2022 | 20 | 71,121 | 5,670 |
| | Nov. 10, 2022 | 8.45 | Nov. 30, 2022 | 20 | 73,472 | 5,860 |
| | Nov. 10, 2022 | 8.50 | Nov. 30, 2022 | 20 | 75,276 | 5,998 |
| | Nov. 10, 2022 | 8.45 | Dec. 8, 2022 | 28 | 77,554 | 6,182 |
| | Nov. 10, 2022 | 8.50 | Dec. 8, 2022 | 28 | 78,240 | 6,236 |
| | Nov. 10, 2022 | 8.50 | Dec. 8, 2022 | 28 | 78,018 | 6,217 |
| | Nov. 10, 2022 | 8.50 | Dec. 8, 2022 | 28 | 78,927 | 6,288 |

Comparative to Table 31 for improved results despite removing 100 of the binder.

In Table 34, “PB45” is Portland cement, sand, aggregate and water, and binder reducing agent, tested in duplicate, triplicate, etc., as the case may be (“PB45” is sample 1 and “T77” is sample 2 from a pour, etc.). Per 10 4″×8″ Cylinders: 9.6 lbs. of Portland I/II cement, 41 pounds of medium to large aggregate (rock), 27 lbs. of fine aggregate (sand), 8.34 lbs. of water and 0.88 lbs. of binder reducing formulation. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens.

TABLE 34

| | | Weight | | | | |
|---|---|---|---|---|---|---|
| Formula | Pour Date | (lb) | Test Date | Cure Days | LBF | PSI |
| PB45 | Nov. 10, 2022 | 8.40 | Nov. 15, 2022 | 5 | 50,951 | 4,065 |
| T77 | Nov. 10, 2022 | 8.40 | Nov. 15, 2022 | 5 | 51,331 | 4,095 |
| 20 Cylinders | Nov. 10, 2022 | 8.40 | Nov. 15, 2022 | 5 | 50,218 | 4,004 |
| −20% Portland | Nov. 10, 2022 | 8.45 | Nov. 15, 2022 | 5 | 50,991 | 4,068 |
| I/II | | | | | | |
| 1:3:2 Mix | Nov. 10, 2022 | 8.40 | Nov. 20, 2022 | 10 | 63,868 | 5,096 |
| | Nov. 10, 2022 | 8.40 | Nov. 20, 2022 | 10 | 53,793 | 4,288 |
| | Nov. 10, 2022 | 8.45 | Nov. 20, 2022 | 10 | 56,198 | 4,481 |
| | Nov. 10, 2022 | 8.45 | Nov. 20, 2022 | 10 | 57,548 | 4,592 |
| | Nov. 10, 2022 | 8.45 | Nov. 25, 2022 | 15 | 53,499 | 4,267 |
| | Nov. 10, 2022 | 8.45 | Nov. 25, 2022 | 15 | 49,170 | 3,923 |
| | Nov. 10, 2022 | 8.45 | Nov. 25, 2022 | 15 | 68,380 | 5,450 |
| | Nov. 10, 2022 | 8.45 | Nov. 25, 2022 | 15 | 64,072 | 5,109 |
| | Nov. 10, 2022 | 8.40 | Nov. 30, 2022 | 20 | 57,771 | 4,607 |
| | Nov. 10, 2022 | 8.45 | Nov. 30, 2022 | 20 | 59,246 | 4,724 |
| | Nov. 10, 2022 | 8.45 | Nov. 30, 2022 | 20 | 60,856 | 4,852 |
| | Nov. 10, 2022 | 8.45 | Nov. 30, 2022 | 20 | 56,494 | 4,505 |
| | Nov. 10, 2022 | 8.40 | Dec. 8, 2022 | 28 | 64,651 | 5,160 |
| | Nov. 10, 2022 | 8.40 | Dec. 8, 2022 | 28 | 68,898 | 5,500 |
| | Nov. 10, 2022 | 8.45 | Dec. 8, 2022 | 28 | 70,940 | 5,652 |
| | Nov. 10, 2022 | 8.45 | Dec. 8, 2022 | 28 | 70,593 | 5,624 |
| PB45 | Nov. 10, 2022 | 8.40 | Nov. 15, 2022 | 5 | 43,083 | 3,436 |
| T78 | Nov. 10, 2022 | 8.40 | Nov. 15, 2022 | 5 | 42,321 | 3,376 |
| 20 Cylinders | Nov. 10, 2022 | 8.45 | Nov. 15, 2022 | 5 | 44,756 | 3,572 |
| −20% Portland | Nov. 10, 2022 | 8.50 | Nov. 15, 2022 | 5 | 47,641 | 3,799 |
| I/II | | | | | | |
| 1:3:2 Mix | Nov. 10, 2022 | 8.35 | Nov. 20, 2022 | 10 | 55,301 | 4,410 |
| | Nov. 10, 2022 | 8.40 | Nov. 20, 2022 | 10 | 54,533 | 4,350 |
| | Nov. 10, 2022 | 8.45 | Nov. 20, 2022 | 10 | 54,192 | 4,324 |
| | Nov. 10, 2022 | 8.50 | Nov. 20, 2022 | 10 | 56,786 | 4,528 |
| | Nov. 10, 2022 | 8.40 | Nov. 25, 2022 | 15 | 59,447 | 4,744 |
| | Nov. 10, 2022 | 8.40 | Nov. 25, 2022 | 15 | 61,048 | 4,872 |
| | Nov. 10, 2022 | 8.40 | Nov. 25, 2022 | 15 | 61,334 | 4,896 |
| | Nov. 10, 2022 | 8.50 | Nov. 25, 2022 | 15 | 62,794 | 5,006 |
| | Nov. 10, 2022 | 8.35 | Nov. 30, 2022 | 20 | 60,582 | 4,834 |
| | Nov. 10, 2022 | 8.40 | Nov. 30, 2022 | 20 | 60,020 | 4,789 |
| | Nov. 10, 2022 | 8.40 | Nov. 30, 2022 | 20 | 58,078 | 4,636 |
| | Nov. 10, 2022 | 8.45 | Nov. 30, 2022 | 20 | 61,342 | 4,893 |
| | Nov. 10, 2022 | 8.35 | Dec. 8, 2022 | 28 | 63,584 | 5,071 |
| | Nov. 10, 2022 | 8.40 | Dec. 8, 2022 | 28 | 62,172 | 4,958 |
| | Nov. 10, 2022 | 8.50 | Dec. 8, 2022 | 28 | 66,594 | 5,311 |
| | Nov. 10, 2022 | 8.50 | Dec. 8, 2022 | 28 | 66,551 | 5,302 |
| PB45 | Nov. 30, 2022 | 8.35 | Dec. 5, 2022 | 5 | 43,001 | 3,433 |
| T81 | Nov. 30, 2022 | 8.40 | Dec. 5, 2022 | 5 | 42,351 | 3,376 |
| 20 Cylinders | Nov. 30, 2022 | 8.50 | Dec. 5, 2022 | 5 | 40,878 | 3,261 |
| −20% Portland | Nov. 30, 2022 | 8.55 | Dec. 5, 2022 | 5 | 41,247 | 3,292 |
| I/II | | | | | | |
| 1:3:2 Mix | Nov. 30, 2022 | 8.35 | Dec. 10, 2022 | 10 | 53,609 | 4,276 |
| | Nov. 30, 2022 | 8.45 | Dec. 10, 2022 | 10 | 53,048 | 4,235 |
| | Nov. 30, 2022 | 8.45 | Dec. 10, 2022 | 10 | 54,943 | 4,387 |
| | Nov. 30, 2022 | 8.55 | Dec. 10, 2022 | 10 | 52,930 | 4,222 |
| | Nov. 30, 2022 | 8.35 | Dec. 15, 2022 | 15 | 61,005 | 4,864 |
| | Nov. 30, 2022 | 8.40 | Dec. 15, 2022 | 15 | 55,822 | 4,454 |
| | Nov. 30, 2022 | 8.40 | Dec. 15, 2022 | 15 | 60,712 | 4,847 |
| | Nov. 30, 2022 | 8.55 | Dec. 15, 2022 | 15 | 56,364 | 4,498 |
| | Nov. 30, 2022 | 8.40 | Dec. 20, 2022 | 20 | 62,203 | 4,964 |
| | Nov. 30, 2022 | 8.45 | Dec. 20, 2022 | 20 | 59,003 | 4,707 |
| | Nov. 30, 2022 | 8.50 | Dec. 20, 2022 | 20 | 60,039 | 4,785 |
| | Nov. 30, 2022 | 8.50 | Dec. 20, 2022 | 20 | 62,599 | 4,993 |
| | Nov. 30, 2022 | 8.40 | Dec. 28, 2022 | 28 | 62,713 | 5,004 |
| | Nov. 30, 2022 | 8.40 | Dec. 28, 2022 | 28 | 63,795 | 5,087 |
| | Nov. 30, 2022 | 8.50 | Dec. 28, 2022 | 28 | 72,883 | 5,811 |
| | Nov. 30, 2022 | 8.50 | Dec. 28, 2022 | 28 | 73,182 | 5,832 |
| PB45 | Nov. 30, 2022 | 8.40 | Dec. 5, 2022 | 5 | 43,727 | 3,489 |
| T82 | Nov. 30, 2022 | 8.45 | Dec. 5, 2022 | 5 | 40,630 | 3,241 |
| 20 Cylinders | Nov. 30, 2022 | 8.50 | Dec. 5, 2022 | 5 | 38,327 | 3,058 |
| −20% Portland | Nov. 30, 2022 | 8.55 | Dec. 5, 2022 | 5 | 40,079 | 3,207 |
| I/II | | | | | | |
| 1:3:2 Mix | Nov. 30, 2022 | 8.45 | Dec. 10, 2022 | 10 | 49,895 | 3,975 |
| | Nov. 30, 2022 | 8.45 | Dec. 10, 2022 | 10 | 55,224 | 4,405 |
| | Nov. 30, 2022 | 8.50 | Dec. 10, 2022 | 10 | 54,265 | 4,329 |
| | Nov. 30, 2022 | 8.55 | Dec. 10, 2022 | 10 | 51,409 | 4,102 |
| | Nov. 30, 2022 | 8.45 | Dec. 15, 2022 | 15 | 54,427 | 4,343 |
| | Nov. 30, 2022 | 8.45 | Dec. 15, 2022 | 15 | 55,244 | 4,412 |
| | Nov. 30, 2022 | 8.50 | Dec. 15, 2022 | 15 | 55,526 | 4,426 |
| | Nov. 30, 2022 | 8.50 | Dec. 15, 2022 | 15 | 54,556 | 4,353 |
| | Nov. 30, 2022 | 8.35 | Dec. 20, 2022 | 20 | 54,909 | 4,377 |
| | Nov. 30, 2022 | 8.40 | Dec. 20, 2022 | 20 | 60,265 | 4,806 |
| | Nov. 30, 2022 | 8.50 | Dec. 20, 2022 | 20 | 64,572 | 5,147 |
| | Nov. 30, 2022 | 8.50 | Dec. 20, 2022 | 20 | 55,147 | 4,400 |
| | Nov. 30, 2022 | 8.40 | Dec. 28, 2022 | 28 | 63,275 | 5,046 |
| | Nov. 30, 2022 | 8.40 | Dec. 28, 2022 | 28 | 69,581 | 5,556 |
| | Nov. 30, 2022 | 8.50 | Dec. 28, 2022 | 28 | 63,982 | 5,104 |
| | Nov. 30, 2022 | 8.50 | Dec. 28, 2022 | 28 | 68,806 | 5,485 |
| PB45 | Dec. 13, 2022 | 8.50 | Dec. 18, 2022 | 5 | 39,424 | 3,145 |
| T89 | Dec. 13, 2022 | 8.50 | Dec. 18, 2022 | 5 | 39,861 | 3,180 |
| 20 Cylinders | Dec. 13, 2022 | 8.50 | Dec. 18, 2022 | 5 | 42,476 | 3,380 |
| −20% Portland | Dec. 13, 2022 | 8.50 | Dec. 18, 2022 | 5 | 43,942 | 3,506 |
| I/II | | | | | | |
| 1:3:2 Mix | Dec. 13, 2022 | 8.50 | Dec. 23, 2022 | 10 | 43,617 | 3,482 |
| | Dec. 13, 2022 | 8.50 | Dec. 23, 2022 | 10 | 42,706 | 3,407 |
| | Dec. 13, 2022 | 8.50 | Dec. 23, 2022 | 10 | 48,182 | 3,847 |
| | Dec. 13, 2022 | 8.50 | Dec. 23, 2022 | 10 | 47,320 | 3,769 |
| | Dec. 13, 2022 | 8.50 | Dec. 28, 2022 | 15 | 48,747 | 3,881 |
| | Dec. 13, 2022 | 8.50 | Dec. 28, 2022 | 15 | 49,221 | 3,928 |
| | Dec. 13, 2022 | 8.50 | Dec. 28, 2022 | 15 | 55,496 | 4,428 |
| | Dec. 13, 2022 | 8.50 | Dec. 28, 2022 | 15 | 54,777 | 4,369 |
| | Dec. 13, 2022 | 8.50 | Jan. 2, 2023 | 20 | 48,947 | 3,905 |
| | Dec. 13, 2022 | 8.50 | Jan. 2, 2023 | 20 | 47,305 | 3,769 |
| | Dec. 13, 2022 | 8.50 | Jan. 2, 2023 | 20 | 55,006 | 4,386 |
| | Dec. 13, 2022 | 8.50 | Jan. 2, 2023 | 20 | 48,550 | 3,873 |
| | Dec. 13, 2022 | 8.50 | Jan. 10, 2023 | 28 | 56,439 | 4,500 |
| | Dec. 13, 2022 | 8.50 | Jan. 10, 2023 | 28 | 57,296 | 4,573 |
| | Dec. 13, 2022 | 8.55 | Jan. 10, 2023 | 28 | 57,747 | 4,607 |
| | Dec. 13, 2022 | 8.55 | Jan. 10, 2023 | 28 | 57,639 | 4,592 |
| PB45 | Mar. 17, 2023 | 8.05 | Mar. 22, 2023 | 5 | 33,851 | 2,700 |
| T120 | Mar. 17, 2023 | 8.15 | Mar. 22, 2023 | 5 | 36,346 | 2,899 |
| 100 Cylinders | Mar. 17, 2023 | 8.20 | Mar. 22, 2023 | 5 | 40,296 | 3,216 |
| −20% Portland | Mar. 17, 2023 | 8.20 | Mar. 22, 2023 | 5 | 35,064 | 2,796 |
| I/II | | | | | | |
| 1:3:2 Mix | Mar. 17, 2023 | 8.20 | Mar. 22, 2023 | 5 | 37,115 | 2,960 |
| | Mar. 17, 2023 | 8.20 | Mar. 22, 2023 | 5 | 35,692 | 2,848 |
| | Mar. 17, 2023 | 8.25 | Mar. 22, 2023 | 5 | 34,050 | 2,712 |
| | Mar. 17, 2023 | 8.25 | Mar. 22, 2023 | 5 | 34,433 | 2,746 |
| | Mar. 17, 2023 | 8.25 | Mar. 22, 2023 | 5 | 35,138 | 2,802 |
| | Mar. 17, 2023 | 8.30 | Mar. 22, 2023 | 5 | 31,557 | 2,517 |
| | Mar. 17, 2023 | 8.30 | Mar. 22, 2023 | 5 | 35,176 | 2,806 |
| | Mar. 17, 2023 | 8.30 | Mar. 22, 2023 | 5 | 36,827 | 2,938 |
| | Mar. 17, 2023 | 8.30 | Mar. 22, 2023 | 5 | 33,985 | 2,711 |
| | Mar. 17, 2023 | 8.30 | Mar. 22, 2023 | 5 | 33,800 | 2,695 |
| | Mar. 17, 2023 | 8.30 | Mar. 22, 2023 | 5 | 35,606 | 2,840 |
| | Mar. 17, 2023 | 8.30 | Mar. 22, 2023 | 5 | 35,468 | 2,829 |
| | Mar. 17, 2023 | 8.30 | Mar. 22, 2023 | 5 | 37,394 | 2,990 |
| | Mar. 17, 2023 | 8.30 | Mar. 22, 2023 | 5 | 35,080 | 2,799 |
| | Mar. 17, 2023 | 8.30 | Mar. 22, 2023 | 5 | 34,356 | 2,741 |
| | Mar. 17, 2023 | 8.30 | Mar. 22, 2023 | 5 | 35,517 | 2,832 |
| | Mar. 17, 2023 | 8.15 | Mar. 27, 2023 | 10 | 42,304 | 3,374 |
| | Mar. 17, 2023 | 8.20 | Mar. 27, 2023 | 10 | 40,975 | 3,268 |
| | Mar. 17, 2023 | 8.20 | Mar. 27, 2023 | 10 | 42,502 | 3,388 |
| | Mar. 17, 2023 | 8.20 | Mar. 27, 2023 | 10 | 44,427 | 3,545 |
| | Mar. 17, 2023 | 8.20 | Mar. 27, 2023 | 10 | 38,305 | 3,055 |
| | Mar. 17, 2023 | 8.25 | Mar. 27, 2023 | 10 | 39,216 | 3,130 |
| | Mar. 17, 2023 | 8.25 | Mar. 27, 2023 | 10 | 42,342 | 3,377 |
| | Mar. 17, 2023 | 8.25 | Mar. 27, 2023 | 10 | 39,969 | 3,190 |
| | Mar. 17, 2023 | 8.25 | Mar. 27, 2023 | 10 | 42,367 | 3,379 |
| | Mar. 17, 2023 | 8.30 | Mar. 27, 2023 | 10 | 45,849 | 3,660 |
| | Mar. 17, 2023 | 8.30 | Mar. 27, 2023 | 10 | 40,712 | 3,247 |
| | Mar. 17, 2023 | 8.30 | Mar. 27, 2023 | 10 | 38,060 | 3,036 |
| | Mar. 17, 2023 | 8.30 | Mar. 27, 2023 | 10 | 42,874 | 3,421 |
| | Mar. 17, 2023 | 8.30 | Mar. 27, 2023 | 10 | 42,703 | 3,408 |
| | Mar. 17, 2023 | 8.30 | Mar. 27, 2023 | 10 | 38,530 | 3,073 |
| | Mar. 17, 2023 | 8.30 | Mar. 27, 2023 | 10 | 39,797 | 3,174 |
| | Mar. 17, 2023 | 8.30 | Mar. 27, 2023 | 10 | 42,463 | 3,387 |
| | Mar. 17, 2023 | 8.30 | Mar. 27, 2023 | 10 | 42,693 | 3,405 |
| | Mar. 17, 2023 | 8.35 | Mar. 27, 2023 | 10 | 42,405 | 3,382 |
| | Mar. 17, 2023 | 8.40 | Mar. 27, 2023 | 10 | 37,628 | 3,001 |
| | Mar. 17, 2023 | 8.35 | Apr. 1, 2023 | 15 | 45,592 | 3,635 |
| | Mar. 17, 2023 | 8.25 | Apr. 1, 2023 | 15 | 42,889 | 3,423 |
| | Mar. 17, 2023 | 8.25 | Apr. 1, 2023 | 15 | 45,827 | 3,656 |
| | Mar. 17, 2023 | 8.25 | Apr. 1, 2023 | 15 | 44,797 | 3,574 |
| | Mar. 17, 2023 | 8.30 | Apr. 1, 2023 | 15 | 51,024 | 4,068 |
| | Mar. 17, 2023 | 8.25 | Apr. 1, 2023 | 15 | 42,100 | 3,359 |
| | Mar. 17, 2023 | 8.30 | Apr. 1, 2023 | 15 | 42,875 | 3,422 |
| | Mar. 17, 2023 | 8.35 | Apr. 1, 2023 | 15 | 45,382 | 3,621 |
| | Mar. 17, 2023 | 8.30 | Apr. 1, 2023 | 15 | 42,653 | 3,403 |
| | Mar. 17, 2023 | 8.30 | Apr. 1, 2023 | 15 | 47,051 | 3,751 |
| | Mar. 17, 2023 | 8.35 | Apr. 1, 2023 | 15 | 42,879 | 3,422 |
| | Mar. 17, 2023 | 8.35 | Apr. 1, 2023 | 15 | 41,555 | 3,317 |
| | Mar. 17, 2023 | 8.35 | Apr. 1, 2023 | 15 | 44,289 | 3,532 |
| | Mar. 17, 2023 | 8.30 | Apr. 1, 2023 | 15 | 47,651 | 3,798 |
| | Mar. 17, 2023 | 8.25 | Apr. 1, 2023 | 15 | 48,117 | 3,839 |
| | Mar. 17, 2023 | 8.10 | Apr. 1, 2023 | 15 | 46,651 | 3,722 |
| | Mar. 17, 2023 | 8.40 | Apr. 1, 2023 | 15 | 40,323 | 3,217 |
| | Mar. 17, 2023 | 8.30 | Apr. 1, 2023 | 15 | 46,731 | 3,727 |
| | Mar. 17, 2023 | 8.20 | Apr. 1, 2023 | 15 | 43,130 | 3,440 |
| | Mar. 17, 2023 | 8.30 | Apr. 1, 2023 | 15 | 43,933 | 3,505 |
| | Mar. 17, 2023 | 8.10 | Apr. 6, 2023 | 20 | 50,677 | 4,037 |
| | Mar. 17, 2023 | 8.15 | Apr. 6, 2023 | 20 | 43,281 | 3,451 |
| | Mar. 17, 2023 | 8.15 | Apr. 6, 2023 | 20 | 47,028 | 3,748 |
| | Mar. 17, 2023 | 8.15 | Apr. 6, 2023 | 20 | 47,385 | 3,781 |
| | Mar. 17, 2023 | 8.15 | Apr. 6, 2023 | 20 | 43,626 | 3,481 |
| | Mar. 17, 2023 | 8.20 | Apr. 6, 2023 | 20 | 42,854 | 3,420 |
| | Mar. 17, 2023 | 8.20 | Apr. 6, 2023 | 20 | 45,639 | 3,636 |
| | Mar. 17, 2023 | 8.20 | Apr. 6, 2023 | 20 | 45,022 | 3,593 |
| | Mar. 17, 2023 | 8.25 | Apr. 6, 2023 | 20 | 54,724 | 4,368 |
| | Mar. 17, 2023 | 8.25 | Apr. 6, 2023 | 20 | 46,419 | 3,702 |
| | Mar. 17, 2023 | 8.25 | Apr. 6, 2023 | 20 | 46,653 | 3,722 |
| | Mar. 17, 2023 | 8.25 | Apr. 6, 2023 | 20 | 54,067 | 4,312 |
| | Mar. 17, 2023 | 8.25 | Apr. 6, 2023 | 20 | 52,346 | 4,173 |
| | Mar. 17, 2023 | 8.25 | Apr. 6, 2023 | 20 | 45,110 | 3,600 |
| | Mar. 17, 2023 | 8.25 | Apr. 6, 2023 | 20 | 54,662 | 4,361 |
| | Mar. 17, 2023 | 8.30 | Apr. 6, 2023 | 20 | 45,310 | 3,616 |
| | Mar. 17, 2023 | 8.30 | Apr. 6, 2023 | 20 | 47,439 | 3,786 |
| | Mar. 17, 2023 | 8.30 | Apr. 6, 2023 | 20 | 47,606 | 3,796 |
| | Mar. 17, 2023 | 8.30 | Apr. 6, 2023 | 20 | 43,596 | 3,476 |
| | Mar. 17, 2023 | 8.35 | Apr. 6, 2023 | 20 | 45,931 | 3,661 |
| | Mar. 17, 2023 | 8.00 | Apr. 14, 2023 | 28 | 48,733 | 3,881 |
| | Mar. 17, 2023 | 8.15 | Apr. 14, 2023 | 28 | 53,492 | 4,260 |
| | Mar. 17, 2023 | 8.25 | Apr. 14, 2023 | 28 | 53,613 | 4,267 |
| | Mar. 17, 2023 | 8.25 | Apr. 14, 2023 | 28 | 55,790 | 4,443 |
| | Mar. 17, 2023 | 8.25 | Apr. 14, 2023 | 28 | 58,375 | 4,645 |
| | Mar. 17, 2023 | 8.25 | Apr. 14, 2023 | 28 | 61,201 | 4,871 |
| | Mar. 17, 2023 | 8.30 | Apr. 14, 2023 | 28 | 60,172 | 4,792 |
| | Mar. 17, 2023 | 8.30 | Apr. 14, 2023 | 28 | 55,099 | 4,388 |
| | Mar. 17, 2023 | 8.35 | Apr. 14, 2023 | 28 | 56,456 | 4,496 |
| | Mar. 17, 2023 | 8.40 | Apr. 14, 2023 | 28 | 52,839 | 4,208 |
| | Mar. 17, 2023 | 8.10 | Apr. 14, 2023 | 28 | 50,152 | 3,994 |
| | Mar. 17, 2023 | 8.20 | Apr. 14, 2023 | 28 | 56,067 | 4,472 |
| | Mar. 17, 2023 | 8.20 | Apr. 14, 2023 | 28 | 57,400 | 4,577 |
| | Mar. 17, 2023 | 8.25 | Apr. 14, 2023 | 28 | 50,416 | 4,023 |
| | Mar. 17, 2023 | 8.25 | Apr. 14, 2023 | 28 | 50,108 | 3,999 |
| | Mar. 17, 2023 | 8.25 | Apr. 14, 2023 | 28 | 48,645 | 3,874 |
| | Mar. 17, 2023 | 8.25 | Apr. 14, 2023 | 28 | 49,210 | 3,919 |
| | Mar. 17, 2023 | 8.30 | Apr. 14, 2023 | 28 | 48,909 | 3,895 |
| | Mar. 17, 2023 | 8.35 | Apr. 14, 2023 | 28 | 48,695 | 3,878 |
| | Mar. 17, 2023 | 8.35 | Apr. 14, 2023 | 28 | 49,122 | 3,912 |
| PB45 | Apr. 6, 2023 | 8.45 | Apr. 11, 2023 | 5 | 41,692 | 3,327 |
| T128 | Apr. 6, 2023 | 8.45 | Apr. 11, 2023 | 5 | 41,898 | 3,344 |
| 80 Cylinders | Apr. 6, 2023 | 8.55 | Apr. 11, 2023 | 5 | 42,583 | 3,394 |
| −20% Portland | Apr. 6, 2023 | 8.55 | Apr. 11, 2023 | 5 | 41,291 | 3,295 |
| I/II | | | | | | |
| 1:3:2 Mix | Apr. 6, 2023 | 8.40 | Apr. 11, 2023 | 5 | 42,612 | 3,403 |
| | Apr. 6, 2023 | 8.40 | Apr. 11, 2023 | 5 | 42,020 | 3,352 |
| | Apr. 6, 2023 | 8.45 | Apr. 11, 2023 | 5 | 43,304 | 3,456 |
| | Apr. 6, 2023 | 8.45 | Apr. 11, 2023 | 5 | 41,488 | 3,310 |
| | Apr. 6, 2023 | 8.40 | Apr. 11, 2023 | 5 | 42,137 | 3,364 |
| | Apr. 6, 2023 | 8.50 | Apr. 11, 2023 | 5 | 45,314 | 3,616 |
| | Apr. 6, 2023 | 8.50 | Apr. 11, 2023 | 5 | 43,745 | 3,482 |
| | Apr. 6, 2023 | 8.50 | Apr. 11, 2023 | 5 | 43,015 | 3,432 |
| | Apr. 6, 2023 | 8.35 | Apr. 11, 2023 | 5 | 35,154 | 2,798 |
| | Apr. 6, 2023 | 8.45 | Apr. 11, 2023 | 5 | 39,174 | 3,118 |
| | Apr. 6, 2023 | 8.45 | Apr. 11, 2023 | 5 | 38,019 | 3,026 |
| | Apr. 6, 2023 | 8.45 | Apr. 11, 2023 | 5 | 39,099 | 3,112 |
| | Apr. 6, 2023 | 8.55 | Apr. 16, 2023 | 10 | 47,876 | 3,811 |
| | Apr. 6, 2023 | 8.55 | Apr. 16, 2023 | 10 | 52,525 | 4,183 |
| | Apr. 6, 2023 | 8.55 | Apr. 16, 2023 | 10 | 53,209 | 4,237 |
| | Apr. 6, 2023 | 8.60 | Apr. 16, 2023 | 10 | 54,414 | 4,332 |
| | Apr. 6, 2023 | 8.45 | Apr. 16, 2023 | 10 | 42,380 | 3,373 |
| | Apr. 6, 2023 | 8.40 | Apr. 16, 2023 | 10 | 48,284 | 3,856 |
| | Apr. 6, 2023 | 8.40 | Apr. 16, 2023 | 10 | 50,535 | 4,042 |
| | Apr. 6, 2023 | 8.45 | Apr. 16, 2023 | 10 | 51,085 | 4,075 |
| | Apr. 6, 2023 | 8.45 | Apr. 16, 2023 | 10 | 53,655 | 4,275 |
| | Apr. 6, 2023 | 8.45 | Apr. 16, 2023 | 10 | 52,168 | 4,154 |
| | Apr. 6, 2023 | 8.45 | Apr. 16, 2023 | 10 | 53,262 | 4,245 |
| | Apr. 6, 2023 | 8.50 | Apr. 16, 2023 | 10 | 52,926 | 4,213 |
| | Apr. 6, 2023 | 8.45 | Apr. 16, 2023 | 10 | 44,527 | 3,546 |
| | Apr. 6, 2023 | 8.45 | Apr. 16, 2023 | 10 | 48,192 | 3,837 |
| | Apr. 6, 2023 | 8.45 | Apr. 16, 2023 | 10 | 47,155 | 3,753 |
| | Apr. 6, 2023 | 8.45 | Apr. 16, 2023 | 10 | 45,539 | 3,625 |
| | Apr. 6, 2023 | 8.50 | Apr. 21, 2023 | 15 | 53,801 | 4,283 |
| | Apr. 6, 2023 | 8.50 | Apr. 21, 2023 | 15 | 51,559 | 4,108 |
| | Apr. 6, 2023 | 8.50 | Apr. 21, 2023 | 15 | 52,155 | 4,151 |
| | Apr. 6, 2023 | 8.55 | Apr. 21, 2023 | 15 | 51,961 | 4,136 |
| | Apr. 6, 2023 | 8.40 | Apr. 21, 2023 | 15 | 54,206 | 4,318 |
| | Apr. 6, 2023 | 8.40 | Apr. 21, 2023 | 15 | 46,991 | 3,750 |
| | Apr. 6, 2023 | 8.40 | Apr. 21, 2023 | 15 | 48,703 | 3,878 |
| | Apr. 6, 2023 | 8.45 | Apr. 21, 2023 | 15 | 52,083 | 4,147 |
| | Apr. 6, 2023 | 8.45 | Apr. 21, 2023 | 15 | 55,743 | 4,440 |
| | Apr. 6, 2023 | 8.45 | Apr. 21, 2023 | 15 | 55,426 | 4,426 |
| | Apr. 6, 2023 | 8.50 | Apr. 21, 2023 | 15 | 54,912 | 4,381 |
| | Apr. 6, 2023 | 8.50 | Apr. 21, 2023 | 15 | 55,325 | 4,402 |
| | Apr. 6, 2023 | 8.40 | Apr. 21, 2023 | 15 | 49,823 | 3,975 |
| | Apr. 6, 2023 | 8.45 | Apr. 21, 2023 | 15 | 47,730 | 3,808 |
| | Apr. 6, 2023 | 8.50 | Apr. 21, 2023 | 15 | 51,845 | 4,126 |
| | Apr. 6, 2023 | 8.50 | Apr. 21, 2023 | 15 | 50,884 | 4,049 |
| | Apr. 6, 2023 | 8.45 | Apr. 26, 2023 | 20 | 57,719 | 4,521 |
| | Apr. 6, 2023 | 8.55 | Apr. 26, 2023 | 20 | 56,728 | 4,598 |
| | Apr. 6, 2023 | 8.55 | Apr. 26, 2023 | 20 | 54,576 | 4,358 |
| | Apr. 6, 2023 | 8.55 | Apr. 26, 2023 | 20 | 56,569 | 4,509 |
| | Apr. 6, 2023 | 8.40 | Apr. 26, 2023 | 20 | 55,555 | 4,422 |
| | Apr. 6, 2023 | 8.40 | Apr. 26, 2023 | 20 | 56,707 | 4,515 |
| | Apr. 6, 2023 | 8.40 | Apr. 26, 2023 | 20 | 56,756 | 4,518 |
| | Apr. 6, 2023 | 8.45 | Apr. 26, 2023 | 20 | 58,213 | 4,635 |
| | Apr. 6, 2023 | 8.40 | Apr. 26, 2023 | 20 | 59,603 | 4,745 |
| | Apr. 6, 2023 | 8.45 | Apr. 26, 2023 | 20 | 58,663 | 4,669 |
| | Apr. 6, 2023 | 8.45 | Apr. 26, 2023 | 20 | 57,109 | 4,546 |
| | Apr. 6, 2023 | 8.50 | Apr. 26, 2023 | 20 | 58,004 | 4,624 |
| | Apr. 6, 2023 | 8.45 | Apr. 26, 2023 | 20 | 57,840 | 4,608 |
| | Apr. 6, 2023 | 8.45 | Apr. 26, 2023 | 20 | 55,581 | 4,428 |
| | Apr. 6, 2023 | 8.50 | Apr. 26, 2023 | 20 | 53,949 | 4,298 |
| | Apr. 6, 2023 | 8.50 | Apr. 26, 2023 | 20 | 53,949 | 4,300 |
| | Apr. 6, 2023 | 8.35 | May 4, 2023 | 28 | 67,270 | 5,352 |
| | Apr. 6, 2023 | 8.40 | May 4, 2023 | 28 | 62,393 | 4,965 |
| | Apr. 6, 2023 | 8.40 | May 4, 2023 | 28 | 62,712 | 4,990 |
| | Apr. 6, 2023 | 8.45 | May 4, 2023 | 28 | 65,100 | 5,180 |
| | Apr. 6, 2023 | 8.40 | May 4, 2023 | 28 | 62,807 | 4,998 |
| | Apr. 6, 2023 | 8.40 | May 4, 2023 | 28 | 59,720 | 4,752 |
| | Apr. 6, 2023 | 8.45 | May 4, 2023 | 28 | 63,000 | 5,008 |
| | Apr. 6, 2023 | 8.50 | May 4, 2023 | 28 | 61,857 | 4,922 |
| | Apr. 6, 2023 | 8.35 | May 4, 2023 | 28 | 64,328 | 5,119 |
| | Apr. 6, 2023 | 8.35 | May 4, 2023 | 28 | 65,293 | 5,194 |
| | Apr. 6, 2023 | 8.40 | May 4, 2023 | 28 | 60,564 | 4,819 |
| | Apr. 6, 2023 | 8.45 | May 4, 2023 | 28 | 63,843 | 5,080 |
| | Apr. 6, 2023 | 8.40 | May 4, 2023 | 28 | 59,979 | 4,772 |
| | Apr. 6, 2023 | 8.40 | May 4, 2023 | 28 | 60,715 | 4,848 |
| | Apr. 6, 2023 | 8.40 | May 4, 2023 | 28 | 62,243 | 4,970 |
| | Apr. 6, 2023 | 8.40 | May 4, 2023 | 28 | 60,189 | 4,806 |
| PB45 | Apr. 14, 2023 | 8.45 | Apr. 19, 2023 | 5 | 32,525 | 2,593 |
| T130 | Apr. 14, 2023 | 8.50 | Apr. 19, 2023 | 5 | 30,488 | 2,427 |
| 60 Cylinders | Apr. 14, 2023 | 8.50 | Apr. 19, 2023 | 5 | 29,891 | 2,379 |
| −20% Portland | Apr. 14, 2023 | 8.50 | Apr. 19, 2023 | 5 | 32,580 | 2,590 |
| I/II | | | | | | |
| 1:3:2 Mix | Apr. 14, 2023 | 8.45 | Apr. 19, 2023 | 5 | 30,730 | 2,450 |
| | Apr. 14, 2023 | 8.45 | Apr. 19, 2023 | 5 | 33,680 | 2,680 |
| | Apr. 14, 2023 | 8.45 | Apr. 19, 2023 | 5 | 33,495 | 2,667 |
| | Apr. 14, 2023 | 8.45 | Apr. 19, 2023 | 5 | 33,809 | 2,692 |
| | Apr. 14, 2023 | 8.45 | Apr. 19, 2023 | 5 | 33,922 | 2,701 |
| | Apr. 14, 2023 | 8.50 | Apr. 19, 2023 | 5 | 29,460 | 2,340 |
| | Apr. 14, 2023 | 8.50 | Apr. 19, 2023 | 5 | 33,060 | 2,630 |
| | Apr. 14, 2023 | 8.50 | Apr. 19, 2023 | 5 | 30,460 | 2,420 |
| | Apr. 14, 2023 | 8.40 | Apr. 24, 2023 | 10 | 36,358 | 2,894 |
| | Apr. 14, 2023 | 8.40 | Apr. 24, 2023 | 10 | 36,287 | 2,889 |
| | Apr. 14, 2023 | 8.50 | Apr. 24, 2023 | 10 | 37,633 | 2,997 |
| | Apr. 14, 2023 | 8.45 | Apr. 24, 2023 | 10 | 34,050 | 2,710 |
| | Apr. 14, 2023 | 8.40 | Apr. 24, 2023 | 10 | 37,700 | 3,000 |
| | Apr. 14, 2023 | 8.40 | Apr. 24, 2023 | 10 | 40,950 | 3,260 |
| | Apr. 14, 2023 | 8.40 | Apr. 24, 2023 | 10 | 42,450 | 3,379 |
| | Apr. 14, 2023 | 8.40 | Apr. 24, 2023 | 10 | 40,597 | 3,232 |
| | Apr. 14, 2023 | 8.45 | Apr. 24, 2023 | 10 | 40,306 | 3,210 |
| | Apr. 14, 2023 | 8.45 | Apr. 24, 2023 | 10 | 44,730 | 3,560 |
| | Apr. 14, 2023 | 8.45 | Apr. 24, 2023 | 10 | 41,900 | 3,330 |
| | Apr. 14, 2023 | 8.45 | Apr. 24, 2023 | 10 | 39,310 | 3,130 |
| | Apr. 14, 2023 | 8.40 | Apr. 29, 2023 | 15 | 36,267 | 2,884 |
| | Apr. 14, 2023 | 8.40 | Apr. 29, 2023 | 15 | 38,924 | 3,097 |
| | Apr. 14, 2023 | 8.50 | Apr. 29, 2023 | 15 | 40,451 | 3,218 |
| | Apr. 14, 2023 | 8.40 | Apr. 29, 2023 | 15 | 40,070 | 3,190 |
| | Apr. 14, 2023 | 8.45 | Apr. 29, 2023 | 15 | 39,170 | 3,120 |
| | Apr. 14, 2023 | 8.45 | Apr. 29, 2023 | 15 | 38,850 | 3,090 |
| | Apr. 14, 2023 | 8.45 | Apr. 29, 2023 | 15 | 44,344 | 3,521 |
| | Apr. 14, 2023 | 8.50 | Apr. 29, 2023 | 15 | 45,509 | 3,620 |
| | Apr. 14, 2023 | 8.50 | Apr. 29, 2023 | 15 | 45,249 | 3,599 |
| | Apr. 14, 2023 | 8.45 | Apr. 29, 2023 | 15 | 46,160 | 3,670 |
| | Apr. 14, 2023 | 8.45 | Apr. 29, 2023 | 15 | 44,630 | 3,550 |
| | Apr. 14, 2023 | 8.45 | Apr. 29, 2023 | 15 | 45,320 | 3,610 |
| | Apr. 14, 2023 | 8.50 | May 4, 2023 | 20 | 46,084 | 3,667 |
| | Apr. 14, 2023 | 8.50 | May 4, 2023 | 20 | 42,214 | 3,359 |
| | Apr. 14, 2023 | 8.50 | May 4, 2023 | 20 | 41,096 | 3,270 |
| | Apr. 14, 2023 | 8.40 | May 4, 2023 | 20 | 44,040 | 3,500 |
| | Apr. 14, 2023 | 8.40 | May 4, 2023 | 20 | 40,580 | 3,230 |
| | Apr. 14, 2023 | 8.40 | May 4, 2023 | 20 | 44,660 | 3,550 |
| | Apr. 14, 2023 | 8.45 | May 4, 2023 | 20 | 50,107 | 3,987 |
| | Apr. 14, 2023 | 8.50 | May 4, 2023 | 20 | 50,298 | 4,002 |
| | Apr. 14, 2023 | 8.50 | May 4, 2023 | 20 | 48,774 | 3,881 |
| | Apr. 14, 2023 | 8.45 | May 4, 2023 | 20 | 49,830 | 3,960 |
| | Apr. 14, 2023 | 8.45 | May 4, 2023 | 20 | 46,990 | 3,740 |
| | Apr. 14, 2023 | 8.40 | May 4, 2023 | 20 | 47,310 | 3,760 |
| | Apr. 14, 2023 | 8.35 | May 12, 2023 | 28 | 51,410 | 4,105 |
| | Apr. 14, 2023 | 8.40 | May 12, 2023 | 28 | 51,961 | 4,149 |
| | Apr. 14, 2023 | 8.40 | May 12, 2023 | 28 | 51,484 | 4,092 |
| | Apr. 14, 2023 | 8.40 | May 12, 2023 | 28 | 49,744 | 3,972 |
| | Apr. 14, 2023 | 8.40 | May 12, 2023 | 28 | 47,750 | 3,800 |
| | Apr. 14, 2023 | 8.40 | May 12, 2023 | 28 | 48,617 | 3,882 |
| | Apr. 14, 2023 | 8.45 | May 12, 2023 | 28 | 49,672 | 3,953 |
| | Apr. 14, 2023 | 8.45 | May 12, 2023 | 28 | 52,359 | 4,164 |
| | Apr. 14, 2023 | 8.45 | May 12, 2023 | 28 | 50,581 | 4,023 |
| | Apr. 14, 2023 | 8.45 | May 12, 2023 | 28 | 48,170 | 3,830 |
| | Apr. 14, 2023 | 8.45 | May 12, 2023 | 28 | 49,740 | 3,960 |
| | Apr. 14, 2023 | 8.45 | May 12, 2023 | 28 | 49,980 | 3,980 |
| PB45 | Apr. 27, 2023 | 8.45 | May 2, 2023 | 5 | 36,959 | 2,941 |
| T131 | Apr. 27, 2023 | 8.45 | May 2, 2023 | 5 | 39,818 | 3,167 |
| 80 Cylinders | Apr. 27, 2023 | 8.45 | May 2, 2023 | 5 | 38,817 | 3,088 |
| −20% Portland | Apr. 27, 2023 | 8.50 | May 2, 2023 | 5 | 38,852 | 3,091 |
| I/II | | | | | | |
| 1:3:2 Mix | Apr. 27, 2023 | 8.50 | May 2, 2023 | 5 | 40,013 | 3,184 |
| | Apr. 27, 2023 | 8.50 | May 2, 2023 | 5 | 37,914 | 3,017 |
| | Apr. 27, 2023 | 8.50 | May 2, 2023 | 5 | 38,288 | 3,046 |
| | Apr. 27, 2023 | 8.55 | May 2, 2023 | 5 | 40,012 | 3,183 |
| | Apr. 27, 2023 | 8.45 | May 2, 2023 | 5 | 44,330 | 3,528 |
| | Apr. 27, 2023 | 8.45 | May 2, 2023 | 5 | 40,104 | 3,191 |
| | Apr. 27, 2023 | 8.45 | May 2, 2023 | 5 | 40,865 | 3,252 |
| | Apr. 27, 2023 | 8.45 | May 2, 2023 | 5 | 39,577 | 3,149 |
| | Apr. 27, 2023 | 8.46 | May 2, 2023 | 5 | 42,504 | 3,382 |
| | Apr. 27, 2023 | 8.45 | May 2, 2023 | 5 | 40,287 | 3,206 |
| | Apr. 27, 2023 | 8.45 | May 2, 2023 | 5 | 40,432 | 3,215 |
| | Apr. 27, 2023 | 8.50 | May 2, 2023 | 5 | 44,941 | 3,576 |
| | Apr. 27, 2023 | 8.45 | May 7, 2023 | 10 | 48,616 | 3,869 |
| | Apr. 27, 2023 | 8.45 | May 7, 2023 | 10 | 48,561 | 3,864 |
| | Apr. 27, 2023 | 8.45 | May 7, 2023 | 10 | 48,675 | 3,871 |
| | Apr. 27, 2023 | 8.50 | May 7, 2023 | 10 | 49,541 | 3,942 |
| | Apr. 27, 2023 | 8.50 | May 7, 2023 | 10 | 53,357 | 4,244 |
| | Apr. 27, 2023 | 8.50 | May 7, 2023 | 10 | 47,629 | 3,787 |
| | Apr. 27, 2023 | 8.50 | May 7, 2023 | 10 | 51,438 | 4,093 |
| | Apr. 27, 2023 | 8.50 | May 7, 2023 | 10 | 54,070 | 4,303 |
| | Apr. 27, 2023 | 8.40 | May 7, 2023 | 10 | 50,748 | 4,038 |
| | Apr. 27, 2023 | 8.40 | May 7, 2023 | 10 | 54,084 | 4,065 |
| | Apr. 27, 2023 | 8.40 | May 7, 2023 | 10 | 49,559 | 3,943 |
| | Apr. 27, 2023 | 8.40 | May 7, 2023 | 10 | 49,624 | 3,949 |
| | Apr. 27, 2023 | 8.40 | May 7, 2023 | 10 | 50,508 | 4,018 |
| | Apr. 27, 2023 | 8.45 | May 7, 2023 | 10 | 50,195 | 3,994 |
| | Apr. 27, 2023 | 8.45 | May 7, 2023 | 10 | 47,859 | 3,808 |
| | Apr. 27, 2023 | 8.45 | May 7, 2023 | 10 | 52,185 | 4,148 |
| | Apr. 27, 2023 | 8.40 | May 12, 2023 | 15 | 55,483 | 4,412 |
| | Apr. 27, 2023 | 8.50 | May 12, 2023 | 15 | 57,334 | 4,562 |
| | Apr. 27, 2023 | 8.50 | May 12, 2023 | 15 | 54,700 | 4,350 |
| | Apr. 27, 2023 | 8.50 | May 12, 2023 | 15 | 56,050 | 4,458 |
| | Apr. 27, 2023 | 8.50 | May 12, 2023 | 15 | 56,138 | 4,442 |
| | Apr. 27, 2023 | 8.50 | May 12, 2023 | 15 | 55,501 | 4,417 |
| | Apr. 27, 2023 | 8.50 | May 12, 2023 | 15 | 56,393 | 4,485 |
| | Apr. 27, 2023 | 8.60 | May 12, 2023 | 15 | 57,972 | 4,613 |
| | Apr. 27, 2023 | 8.35 | May 12, 2023 | 15 | 55,547 | 4,418 |
| | Apr. 27, 2023 | 8.40 | May 12, 2023 | 15 | 57,068 | 4,539 |
| | Apr. 27, 2023 | 8.45 | May 12, 2023 | 15 | 53,379 | 4,246 |
| | Apr. 27, 2023 | 8.45 | May 12, 2023 | 15 | 54,755 | 4,356 |
| | Apr. 27, 2023 | 8.45 | May 12, 2023 | 15 | 57,759 | 4,595 |
| | Apr. 27, 2023 | 8.45 | May 12, 2023 | 15 | 55,819 | 4,440 |
| | Apr. 27, 2023 | 8.50 | May 12, 2023 | 15 | 57,426 | 4,570 |
| | Apr. 27, 2023 | 8.50 | May 12, 2023 | 15 | 57,248 | 4,554 |
| | Apr. 27, 2023 | 8.45 | May 17, 2023 | 20 | 56,035 | 4,456 |
| | Apr. 27, 2023 | 8.50 | May 17, 2023 | 20 | 55,687 | 4,429 |
| | Apr. 27, 2023 | 8.50 | May 17, 2023 | 20 | 55,306 | 4,398 |
| | Apr. 27, 2023 | 8.50 | May 17, 2023 | 20 | 55,394 | 4,405 |
| | Apr. 27, 2023 | 8.50 | May 17, 2023 | 20 | 58,095 | 4,621 |
| | Apr. 27, 2023 | 8.50 | May 17, 2023 | 20 | 58,877 | 4,682 |
| | Apr. 27, 2023 | 8.50 | May 17, 2023 | 20 | 57,908 | 4,608 |
| | Apr. 27, 2023 | 8.55 | May 17, 2023 | 20 | 58,915 | 4,685 |
| | Apr. 27, 2023 | 8.45 | May 17, 2023 | 20 | 56,254 | 4,477 |
| | Apr. 27, 2023 | 8.45 | May 17, 2023 | 20 | 58,085 | 4,619 |
| | Apr. 27, 2023 | 8.45 | May 17, 2023 | 20 | 55,158 | 4,390 |
| | Apr. 27, 2023 | 8.45 | May 17, 2023 | 20 | 57,972 | 4,610 |
| | Apr. 27, 2023 | 8.45 | May 17, 2023 | 20 | 55,623 | 4,423 |
| | Apr. 27, 2023 | 8.50 | May 17, 2023 | 20 | 56,601 | 4,501 |
| | Apr. 27, 2023 | 8.50 | May 17, 2023 | 20 | 56,513 | 4,494 |
| | Apr. 27, 2023 | 8.50 | May 17, 2023 | 20 | 56,236 | 4,472 |
| | Apr. 27, 2023 | 8.45 | May 25, 2023 | 28 | 60,389 | 4,822 |
| | Apr. 27, 2023 | 8.45 | May 25, 2023 | 28 | 68,170 | 5,424 |
| | Apr. 27, 2023 | 8.45 | May 25, 2023 | 28 | 64,078 | 5,099 |
| | Apr. 27, 2023 | 8.45 | May 25, 2023 | 28 | 59,881 | 4,764 |
| | Apr. 27, 2023 | 8.50 | May 25, 2023 | 28 | 64,948 | 5,186 |
| | Apr. 27, 2023 | 8.50 | May 25, 2023 | 28 | 60,877 | 4,861 |
| | Apr. 27, 2023 | 8.55 | May 25, 2023 | 28 | 57,408 | 4,584 |
| | Apr. 27, 2023 | 8.40 | May 25, 2023 | 28 | 59,537 | 4,754 |
| | Apr. 27, 2023 | 8.40 | May 25, 2023 | 28 | 57,546 | 4,579 |
| | Apr. 27, 2023 | 8.40 | May 25, 2023 | 28 | 58,003 | 4,609 |
| | Apr. 27, 2023 | 8.45 | May 25, 2023 | 28 | 60,126 | 4,801 |
| | Apr. 27, 2023 | 8.45 | May 25, 2023 | 28 | 58,723 | 4,672 |
| | Apr. 27, 2023 | 8.45 | May 25, 2023 | 28 | 64,134 | 5,121 |
| | Apr. 27, 2023 | 8.50 | May 25, 2023 | 28 | 62,731 | 5,009 |

Comparative to Table 31 for improved results despite removing 20% of the binder.

In Table 35, “PB45” is Portland cement, sand, aggregate and water, and binder reducing agent, tested in duplicate, triplicate, etc., as the case may be (“PB45” is sample 1 and “T77” is sample 2 from a pour, etc.). Per 10 4″×8″ Cylinders: 8.4 lbs. of Portland I/II cement, 41 pounds of medium to large aggregate (rock), 27 lbs. of fine aggregate (sand), 8.34 lbs. of water and 0.88 lbs. of binder reducing formulation. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens.

TABLE 35

| | | Weight | | | | |
|---|---|---|---|---|---|---|
| Formula | Pour Date | (lb) | Test Date | Cure Days | LBF | PSI |
| PB45 | Nov. 17, 2022 | 8.45 | Nov. 22, 2022 | 5 | 43,744 | 3,485 |
| T79 | Nov. 17, 2022 | 8.50 | Nov. 22, 2022 | 5 | 42,577 | 3,392 |
| 20 Cylinders | Nov. 17, 2022 | 8.50 | Nov. 22, 2022 | 5 | 42,983 | 3,424 |
| −30% Portland | Nov. 17, 2022 | 8.50 | Nov. 22, 2022 | 5 | 47,454 | 3,788 |
| I/II | | | | | | |
| 1:3:2 Mix | Nov. 17, 2022 | 8.45 | Nov. 27, 2022 | 10 | 49,581 | 3,954 |
| | Nov. 17, 2022 | 8.50 | Nov. 27, 2022 | 10 | 50,754 | 4,048 |
| | Nov. 17, 2022 | 8.40 | Nov. 27, 2022 | 10 | 55,130 | 4,393 |
| | Nov. 17, 2022 | 8.50 | Nov. 27, 2022 | 10 | 57,330 | 4,572 |
| | Nov. 17, 2022 | 8.50 | Dec. 2, 2022 | 15 | 52,687 | 4,202 |
| | Nov. 17, 2022 | 8.50 | Dec. 2, 2022 | 15 | 52,389 | 4,179 |
| | Nov. 17, 2022 | 8.50 | Dec. 2, 2022 | 15 | 62,657 | 4,995 |
| | Nov. 17, 2022 | 8.50 | Dec. 2, 2022 | 15 | 66,451 | 5,300 |
| | Nov. 17, 2022 | 8.50 | Dec. 7, 2022 | 20 | 53,170 | 4,243 |
| | Nov. 17, 2022 | 8.50 | Dec. 7, 2022 | 20 | 48,461 | 3,881 |
| | Nov. 17, 2022 | 8.50 | Dec. 7, 2022 | 20 | 55,508 | 4,427 |
| | Nov. 17, 2022 | 8.50 | Dec. 7, 2022 | 20 | 58,003 | 4,626 |
| | Nov. 17, 2022 | 8.45 | Dec. 15, 2022 | 28 | 64,173 | 5,123 |
| | Nov. 17, 2022 | 8.45 | Dec. 15, 2022 | 28 | 69,598 | 5,551 |
| | Nov. 17, 2022 | 8.45 | Dec. 15, 2022 | 28 | 70,047 | 5,588 |
| | Nov. 17, 2022 | 8.45 | Dec. 15, 2022 | 28 | 69,400 | 5,529 |
| PB45 | Nov. 30, 2022 | 8.40 | Dec. 5, 2022 | 5 | 35,926 | 2,866 |
| T83 | Nov. 30, 2022 | 8.45 | Dec. 5, 2022 | 5 | 33,846 | 2,699 |
| 20 Cylinders | Nov. 30, 2022 | 8.40 | Dec. 5, 2022 | 5 | 34,680 | 2,766 |
| −30% Portland | Nov. 30, 2022 | 8.50 | Dec. 5, 2022 | 5 | 36,321 | 2,891 |
| I/II | | | | | | |
| 1:3:2 Mix | Nov. 30, 2022 | 8.40 | Dec. 10, 2022 | 10 | 46,614 | 3,713 |
| | Nov. 30, 2022 | 8.45 | Dec. 10, 2022 | 10 | 46,434 | 3,699 |
| | Nov. 30, 2022 | 8.45 | Dec. 10, 2022 | 10 | 45,271 | 3,611 |
| | Nov. 30, 2022 | 8.45 | Dec. 10, 2022 | 10 | 41,279 | 3,294 |
| | Nov. 30, 2022 | 8.40 | Dec. 15, 2022 | 15 | 49,514 | 3,949 |
| | Nov. 30, 2022 | 8.40 | Dec. 15, 2022 | 15 | 48,309 | 3,853 |
| | Nov. 30, 2022 | 8.50 | Dec. 15, 2022 | 15 | 49,034 | 3,910 |
| | Nov. 30, 2022 | 8.50 | Dec. 15, 2022 | 15 | 50,804 | 4,049 |
| | Nov. 30, 2022 | 8.35 | Dec. 20, 2022 | 20 | 53,817 | 4,291 |
| | Nov. 30, 2022 | 8.50 | Dec. 20, 2022 | 20 | 51,538 | 4,111 |
| | Nov. 30, 2022 | 8.55 | Dec. 20, 2022 | 20 | 53,703 | 4,285 |
| | Nov. 30, 2022 | 8.55 | Dec. 20, 2022 | 20 | 55,751 | 4,450 |
| | Nov. 30, 2022 | 8.40 | Dec. 28, 2022 | 28 | 55,695 | 4,447 |
| | Nov. 30, 2022 | 8.45 | Dec. 28, 2022 | 28 | 58,711 | 4,688 |
| | Nov. 30, 2022 | 8.55 | Dec. 28, 2022 | 28 | 64,798 | 5,170 |
| | Nov. 30, 2022 | 8.55 | Dec. 28, 2022 | 28 | 60,162 | 4,800 |
| PB45 | Nov. 30, 2022 | 8.40 | Dec. 5, 2022 | 5 | 30,577 | 2,436 |
| T84 | Nov. 30, 2022 | 8.50 | Dec. 5, 2022 | 5 | 30,911 | 2,461 |
| 20 Cylinders | Nov. 30, 2022 | 8.45 | Dec. 5, 2022 | 5 | 32,633 | 2,603 |
| −30% Portland | Nov. 30, 2022 | 8.45 | Dec. 5, 2022 | 5 | 35,740 | 2,850 |
| I/II | | | | | | |
| 1:3:2 Mix | Nov. 30, 2022 | 8.35 | Dec. 10, 2022 | 10 | 43,627 | 3,481 |
| | Nov. 30, 2022 | 8.35 | Dec. 10, 2022 | 10 | 44,562 | 3,551 |
| | Nov. 30, 2022 | 8.40 | Dec. 10, 2022 | 10 | 43,701 | 3,485 |
| | Nov. 30, 2022 | 8.45 | Dec. 10, 2022 | 10 | 41,741 | 3,324 |
| | Nov. 30, 2022 | 8.35 | Dec. 15, 2022 | 15 | 42,305 | 3,374 |
| | Nov. 30, 2022 | 8.45 | Dec. 15, 2022 | 15 | 47,160 | 3,759 |
| | Nov. 30, 2022 | 8.50 | Dec. 15, 2022 | 15 | 48,257 | 3,849 |
| | Nov. 30, 2022 | 8.50 | Dec. 15, 2022 | 15 | 44,841 | 3,575 |
| | Nov. 30, 2022 | 8.30 | Dec. 20, 2022 | 20 | 53,866 | 4,295 |
| | Nov. 30, 2022 | 8.45 | Dec. 20, 2022 | 20 | 50,413 | 4,022 |
| | Nov. 30, 2022 | 8.45 | Dec. 20, 2022 | 20 | 49,093 | 3,914 |
| | Nov. 30, 2022 | 8.45 | Dec. 20, 2022 | 20 | 49,720 | 3,966 |
| | Nov. 30, 2022 | 8.40 | Dec. 28, 2022 | 28 | 53,889 | 4,303 |
| | Nov. 30, 2022 | 8.40 | Dec. 28, 2022 | 28 | 56,131 | 4,482 |
| | Nov. 30, 2022 | 8.40 | Dec. 28, 2022 | 28 | 57,591 | 4,594 |
| | Nov. 30, 2022 | 8.45 | Dec. 28, 2022 | 28 | 58,215 | 4,642 |
| PB45 | Dec. 1, 2022 | 8.35 | Dec. 6, 2022 | 5 | 26,060 | 2,075 |
| T86 | Dec. 1, 2022 | 8.40 | Dec. 6, 2022 | 5 | 26,222 | 2,088 |
| 20 Cylinders | Dec. 1, 2022 | 8.40 | Dec. 6, 2022 | 5 | 27,302 | 2,176 |
| −30% Portland | Dec. 1, 2022 | 8.50 | Dec. 6, 2022 | 5 | 29,204 | 2,328 |
| I/II | | | | | | |
| 1:3:2 Mix | Dec. 1, 2022 | 8.30 | Dec. 11, 2022 | 10 | 33,581 | 2,680 |
| | Dec. 1, 2022 | 8.40 | Dec. 11, 2022 | 10 | 33,832 | 2,700 |
| | Dec. 1, 2022 | 8.40 | Dec. 11, 2022 | 10 | 36,588 | 2,920 |
| | Dec. 1, 2022 | 8.50 | Dec. 11, 2022 | 10 | 35,586 | 2,840 |
| | Dec. 1, 2022 | 8.40 | Dec. 16, 2022 | 15 | 41,268 | 3,291 |
| | Dec. 1, 2022 | 8.40 | Dec. 16, 2022 | 15 | 37,669 | 3,004 |
| | Dec. 1, 2022 | 8.50 | Dec. 16, 2022 | 15 | 39,966 | 3,189 |
| | Dec. 1, 2022 | 8.50 | Dec. 16, 2022 | 15 | 35,425 | 2,825 |
| | Dec. 1, 2022 | 8.35 | Dec. 21, 2022 | 20 | 39,799 | 3,173 |
| | Dec. 1, 2022 | 8.40 | Dec. 21, 2022 | 20 | 43,180 | 3,446 |
| | Dec. 1, 2022 | 8.40 | Dec. 21, 2022 | 20 | 43,957 | 3,508 |
| | Dec. 1, 2022 | 8.45 | Dec. 21, 2022 | 20 | 45,534 | 3,633 |
| | Dec. 1, 2022 | 8.35 | Dec. 29, 2022 | 28 | 47,302 | 3,777 |
| | Dec. 1, 2022 | 8.35 | Dec. 29, 2022 | 28 | 50,120 | 4,002 |
| | Dec. 1, 2022 | 8.40 | Dec. 29, 2022 | 28 | 52,495 | 4,187 |
| | Dec. 1, 2022 | 8.40 | Dec. 29, 2022 | 28 | 52,564 | 4,196 |

Comparative to Table 31 for improved results despite removing 30% of the binder.

In Table 36, “PB45” is Portland cement, sand, aggregate and water, and binder reducing agent, tested in duplicate, triplicate, etc., as the case may be (“PB45” is sample 1 and “T80” is sample 2 from a pour). Per 10 4″×8″ Cylinders: 7.2 lbs. of Portland I/II cement, 41 pounds of medium to large aggregate (rock), 27 lbs. of fine aggregate (sand), 8.34 lbs. of water and 0.88 lbs. of binder reducing formulation. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens.

TABLE 36

| | | Weight | | | | |
|---|---|---|---|---|---|---|
| Formula | Pour Date | (lb) | Test Date | Cure Days | LBF | PSI |
| PB45 | Nov. 17, 2022 | 8.40 | Nov. 22, 2022 | 5 | 29,493 | 2,355 |
| T80 | Nov. 17, 2022 | 8.45 | Nov. 22, 2022 | 5 | 28,379 | 2,266 |
| 20 Cylinders | Nov. 17, 2022 | 8.40 | Nov. 22, 2022 | 5 | 31,898 | 2,547 |
| −40% Portland I/II | Nov. 17, 2022 | 8.15 | Nov. 22, 2022 | 5 | 30,082 | 2,402 |
| 1:3:2 Mix | Nov. 17, 2022 | 8.35 | Nov. 27, 2022 | 10 | 33,664 | 2,688 |
| | Nov. 17, 2022 | 8.40 | Nov. 27, 2022 | 10 | 33,125 | 2,645 |
| | Nov. 17, 2022 | 8.40 | Nov. 27, 2022 | 10 | 36,714 | 2,801 |
| | Nov. 17, 2022 | 8.45 | Nov. 27, 2022 | 10 | 35,012 | 2,788 |
| | Nov. 17, 2022 | 8.40 | Dec. 2, 2022 | 15 | 35,770 | 2,849 |
| | Nov. 17, 2022 | 8.45 | Dec. 2, 2022 | 15 | 36,653 | 2,921 |
| | Nov. 17, 2022 | 8.40 | Dec. 2, 2022 | 15 | 39,794 | 3,175 |
| | Nov. 17, 2022 | 8.40 | Dec. 2, 2022 | 15 | 41,699 | 3,326 |
| | Nov. 17, 2022 | 8.35 | Dec. 7, 2022 | 20 | 36,043 | 2,872 |
| | Nov. 17, 2022 | 8.40 | Dec. 7, 2022 | 20 | 36,136 | 2,880 |
| | Nov. 17, 2022 | 8.30 | Dec. 7, 2022 | 20 | 42,140 | 3,361 |
| | Nov. 17, 2022 | 8.35 | Dec. 7, 2022 | 20 | 35,740 | 2,850 |
| | Nov. 17, 2022 | 8.40 | Dec. 15, 2022 | 28 | 42,858 | 3,420 |
| | Nov. 17, 2022 | 8.40 | Dec. 15, 2022 | 28 | 44,187 | 3,525 |
| | Nov. 17, 2022 | 8.45 | Dec. 15, 2022 | 28 | 46,153 | 3,677 |
| | Nov. 17, 2022 | 8.45 | Dec. 15, 2022 | 28 | 43,782 | 3,488 |

Comparative to Table 31 results were less than comparable to baseline with removal of 40% of the binder.

In Table 37, “PB45” is Portland cement, sand, aggregate and water, and binder reducing agent, tested in duplicate, triplicate, etc., as the case may be (“PB45” is sample 1 and “T122” is sample 2 from a pour). Per 10 4″×8″ Cylinders: 9 lbs. of Portland I/II cement, 41 pounds of medium to large aggregate (rock), 27 lbs. of fine aggregate (sand), 8.34 lbs. of water and 0.88 lbs. of binder reducing formulation. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens.

TABLE 37

| | | Weight | | | | |
|---|---|---|---|---|---|---|
| Formula | Pour Date | (lb) | Test Date | Cure Days | LBF | PSI |
| PB45 | Mar. 20, 2023 | 8.05 | Mar. 25, 2023 | 5 | 16,309 | 1,298 |
| T122 | Mar. 20, 2023 | 8.05 | Mar. 25, 2023 | 5 | 24,917 | 1,984 |
| 100 Cylinders | Mar. 20, 2023 | 8.05 | Mar. 25, 2023 | 5 | 25,695 | 2,046 |
| −25% Portland I/II | Mar. 20, 2023 | 8.10 | Mar. 25, 2023 | 5 | 21,277 | 1,705 |
| 1:3:2 Mix | Mar. 20, 2023 | 8.15 | Mar. 25, 2023 | 5 | 31,426 | 2,503 |
| | Mar. 20, 2023 | 8.15 | Mar. 25, 2023 | 5 | 17,748 | 1,413 |
| | Mar. 20, 2023 | 8.15 | Mar. 25, 2023 | 5 | 29,628 | 2,360 |
| | Mar. 20, 2023 | 8.15 | Mar. 25, 2023 | 5 | 28,731 | 2,288 |
| | Mar. 20, 2023 | 8.15 | Mar. 25, 2023 | 5 | 22,032 | 1,754 |
| | Mar. 20, 2023 | 8.15 | Mar. 25, 2023 | 5 | 16,836 | 1,340 |
| | Mar. 20, 2023 | 8.15 | Mar. 25, 2023 | 5 | 20,100 | 1,600 |
| | Mar. 20, 2023 | 8.20 | Mar. 25, 2023 | 5 | 23,723 | 1,892 |
| | Mar. 20, 2023 | 8.20 | Mar. 25, 2023 | 5 | 24,497 | 1,950 |
| | Mar. 20, 2023 | 8.20 | Mar. 25, 2023 | 5 | 27,605 | 2,198 |
| | Mar. 20, 2023 | 8.20 | Mar. 25, 2023 | 5 | 19,729 | 1,571 |
| | Mar. 20, 2023 | 8.20 | Mar. 25, 2023 | 5 | 27,224 | 2,167 |
| | Mar. 20, 2023 | 8.20 | Mar. 25, 2023 | 5 | 28,061 | 2,238 |
| | Mar. 20, 2023 | 8.20 | Mar. 25, 2023 | 5 | 31,336 | 2,497 |
| | Mar. 20, 2023 | 8.20 | Mar. 25, 2023 | 5 | 32,692 | 2,608 |
| | Mar. 20, 2023 | 8.25 | Mar. 25, 2023 | 5 | 28,896 | 2,300 |
| | Mar. 20, 2023 | 8.20 | Mar. 30, 2023 | 10 | 29,505 | 2,354 |
| | Mar. 20, 2023 | 8.20 | Mar. 30, 2023 | 10 | 31,976 | 2,551 |
| | Mar. 20, 2023 | 8.25 | Mar. 30, 2023 | 10 | 27,612 | 2,203 |
| | Mar. 20, 2023 | 8.30 | Mar. 30, 2023 | 10 | 29,367 | 2,343 |
| | Mar. 20, 2023 | 8.15 | Mar. 30, 2023 | 10 | 25,720 | 2,052 |
| | Mar. 20, 2023 | 8.15 | Mar. 30, 2023 | 10 | 33,014 | 2,634 |
| | Mar. 20, 2023 | 8.20 | Mar. 30, 2023 | 10 | 32,601 | 2,601 |
| | Mar. 20, 2023 | 8.10 | Mar. 30, 2023 | 10 | 30,154 | 2,400 |
| | Mar. 20, 2023 | 8.15 | Mar. 30, 2023 | 10 | 37,197 | 2,963 |
| | Mar. 20, 2023 | 8.15 | Mar. 30, 2023 | 10 | 34,432 | 2,741 |
| | Mar. 20, 2023 | 8.20 | Mar. 30, 2023 | 10 | 35,358 | 2,821 |
| | Mar. 20, 2023 | 8.25 | Mar. 30, 2023 | 10 | 26,960 | 2,151 |
| | Mar. 20, 2023 | 8.20 | Mar. 30, 2023 | 10 | 28,978 | 2,312 |
| | Mar. 20, 2023 | 8.25 | Mar. 30, 2023 | 10 | 36,398 | 2,904 |
| | Mar. 20, 2023 | 8.20 | Mar. 30, 2023 | 10 | 35,734 | 2,851 |
| | Mar. 20, 2023 | 8.10 | Mar. 30, 2023 | 10 | 32,801 | 2,617 |
| | Mar. 20, 2023 | 8.20 | Mar. 30, 2023 | 10 | 32,212 | 2,570 |
| | Mar. 20, 2023 | 8.50 | Mar. 30, 2023 | 10 | 34,405 | 2,745 |
| | Mar. 20, 2023 | 8.15 | Mar. 30, 2023 | 10 | 29,843 | 2,381 |
| | Mar. 20, 2023 | 8.15 | Mar. 30, 2023 | 10 | 30,457 | 2,430 |
| | Mar. 20, 2023 | 8.10 | Apr. 4, 2023 | 15 | 38,329 | 3,056 |
| | Mar. 20, 2023 | 8.10 | Apr. 4, 2023 | 15 | 35,060 | 2,798 |
| | Mar. 20, 2023 | 8.10 | Apr. 4, 2023 | 15 | 30,678 | 2,445 |
| | Mar. 20, 2023 | 8.10 | Apr. 4, 2023 | 15 | 31,451 | 2,510 |
| | Mar. 20, 2023 | 8.10 | Apr. 4, 2023 | 15 | 32,141 | 2,565 |
| | Mar. 20, 2023 | 8.15 | Apr. 4, 2023 | 15 | 30,800 | 2,458 |
| | Mar. 20, 2023 | 8.15 | Apr. 4, 2023 | 15 | 36,313 | 2,898 |
| | Mar. 20, 2023 | 8.15 | Apr. 4, 2023 | 15 | 32,554 | 2,598 |
| | Mar. 20, 2023 | 8.15 | Apr. 4, 2023 | 15 | 32,466 | 2,591 |
| | Mar. 20, 2023 | 8.20 | Apr. 4, 2023 | 15 | 35,411 | 2,826 |
| | Mar. 20, 2023 | 8.20 | Apr. 4, 2023 | 15 | 35,649 | 2,845 |
| | Mar. 20, 2023 | 8.20 | Apr. 4, 2023 | 15 | 33,043 | 2,637 |
| | Mar. 20, 2023 | 8.20 | Apr. 4, 2023 | 15 | 36,213 | 2,890 |
| | Mar. 20, 2023 | 8.20 | Apr. 4, 2023 | 15 | 32,980 | 2,632 |
| | Mar. 20, 2023 | 8.20 | Apr. 4, 2023 | 15 | 32,953 | 2,627 |
| | Mar. 20, 2023 | 8.20 | Apr. 4, 2023 | 15 | 35,074 | 2,792 |
| | Mar. 20, 2023 | 8.25 | Apr. 4, 2023 | 15 | 36,100 | 2,881 |
| | Mar. 20, 2023 | 8.25 | Apr. 4, 2023 | 15 | 31,639 | 2,525 |
| | Mar. 20, 2023 | 8.25 | Apr. 4, 2023 | 15 | 35,975 | 2,871 |
| | Mar. 20, 2023 | 8.25 | Apr. 4, 2023 | 15 | 32,276 | 2,569 |
| | Mar. 20, 2023 | 8.10 | Apr. 9, 2023 | 20 | 33,847 | 2,694 |
| | Mar. 20, 2023 | 8.10 | Apr. 9, 2023 | 20 | 32,516 | 2,588 |
| | Mar. 20, 2023 | 8.15 | Apr. 9, 2023 | 20 | 30,355 | 2,416 |
| | Mar. 20, 2023 | 8.15 | Apr. 9, 2023 | 20 | 29,285 | 2,331 |
| | Mar. 20, 2023 | 8.15 | Apr. 9, 2023 | 20 | 29,951 | 2,384 |
| | Mar. 20, 2023 | 8.15 | Apr. 9, 2023 | 20 | 35,265 | 2,807 |
| | Mar. 20, 2023 | 8.15 | Apr. 9, 2023 | 20 | 31,397 | 2,499 |
| | Mar. 20, 2023 | 8.15 | Apr. 9, 2023 | 20 | 30,744 | 2,447 |
| | Mar. 20, 2023 | 8.20 | Apr. 9, 2023 | 20 | 30,731 | 2,446 |
| | Mar. 20, 2023 | 8.20 | Apr. 9, 2023 | 20 | 35,631 | 2,836 |
| | Mar. 20, 2023 | 8.20 | Apr. 9, 2023 | 20 | 36,938 | 2,940 |
| | Mar. 20, 2023 | 8.20 | Apr. 9, 2023 | 20 | 39,401 | 3,136 |
| | Mar. 20, 2023 | 8.25 | Apr. 9, 2023 | 20 | 33,694 | 2,681 |
| | Mar. 20, 2023 | 8.25 | Apr. 9, 2023 | 20 | 36,925 | 2,939 |
| | Mar. 20, 2023 | 8.25 | Apr. 9, 2023 | 20 | 33,357 | 2,655 |
| | Mar. 20, 2023 | 8.25 | Apr. 9, 2023 | 20 | 29,850 | 2,376 |
| | Mar. 20, 2023 | 8.30 | Apr. 9, 2023 | 20 | 35,455 | 2,822 |
| | Mar. 20, 2023 | 8.25 | Apr. 9, 2023 | 20 | 43,939 | 3,497 |
| | Mar. 20, 2023 | 8.25 | Apr. 9, 2023 | 20 | 46,250 | 3,682 |
| | Mar. 20, 2023 | 8.36 | Apr. 9, 2023 | 20 | 43,751 | 3,490 |
| | Mar. 20, 2023 | 8.10 | Apr. 17, 2023 | 28 | 43,022 | 3,429 |
| | Mar. 20, 2023 | 8.10 | Apr. 17, 2023 | 28 | 43,341 | 3,451 |
| | Mar. 20, 2023 | 8.10 | Apr. 17, 2023 | 28 | 41,283 | 3,286 |
| | Mar. 20, 2023 | 8.10 | Apr. 17, 2023 | 28 | 42,974 | 3,424 |
| | Mar. 20, 2023 | 8.10 | Apr. 17, 2023 | 28 | 48,423 | 3,855 |
| | Mar. 20, 2023 | 8.15 | Apr. 17, 2023 | 28 | 41,219 | 3,282 |
| | Mar. 20, 2023 | 8.15 | Apr. 17, 2023 | 28 | 45,966 | 3,660 |
| | Mar. 20, 2023 | 8.15 | Apr. 17, 2023 | 28 | 47,055 | 3,746 |
| | Mar. 20, 2023 | 8.15 | Apr. 17, 2023 | 28 | 41,595 | 3,312 |
| | Mar. 20, 2023 | 8.15 | Apr. 17, 2023 | 28 | 47,963 | 3,819 |
| | Mar. 20, 2023 | 8.20 | Apr. 17, 2023 | 28 | 41,181 | 3,279 |
| | Mar. 20, 2023 | 8.20 | Apr. 17, 2023 | 28 | 41,431 | 3,299 |
| | Mar. 20, 2023 | 8.20 | Apr. 17, 2023 | 28 | 42,233 | 3,363 |
| | Mar. 20, 2023 | 8.25 | Apr. 17, 2023 | 28 | 43,153 | 3,436 |
| | Mar. 20, 2023 | 8.25 | Apr. 17, 2023 | 28 | 37,759 | 3,005 |
| | Mar. 20, 2023 | 8.25 | Apr. 17, 2023 | 28 | 41,363 | 3,297 |
| | Mar. 20, 2023 | 8.30 | Apr. 17, 2023 | 28 | 41,181 | 3,279 |
| | Mar. 20, 2023 | 8.30 | Apr. 17, 2023 | 28 | 41,826 | 3,354 |
| | Mar. 20, 2023 | 8.30 | Apr. 17, 2023 | 28 | 39,264 | 3,126 |
| | Mar. 20, 2023 | 8.30 | Apr. 17, 2023 | 28 | 42,635 | 3,395 |

Comparative to Table 31 for comparable results despite removing 250 of the binder.

In Table 38, “PB45” is Portland cement, sand, aggregate and water, and binder reducing agent, tested in duplicate, triplicate, etc., as the case may be (“PB45” is sample 1 and “T90” is sample 2 from a pour, etc.). Per 10 4″×8″ Cylinders: 12 lbs. of Portland IL (PLC) cement, 41 pounds of medium to large aggregate (rock), 27 lbs. of fine aggregate (sand), and 8.34 lbs. of water. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens. This Table will serve as the baseline measure for all 1:3:2 mixtures utilizing Portland IL (PLC) cement as the binder.

TABLE 38

| | | Weight | | | | |
|---|---|---|---|---|---|---|
| Formula | Pour Date | (lb) | Test Date | Cure Days | LBF | PSI |
| Baseline | Dec. 17, 2022 | 8.25 | Dec. 22, 2022 | 5 | 33,678 | 2,684 |
| T90 | Dec. 17, 2022 | 8.25 | Dec. 22, 2022 | 5 | 36,284 | 2,896 |
| 20 Cylinders | Dec. 17, 2022 | 8.25 | Dec. 22, 2022 | 5 | 35,841 | 2,860 |
| Portland 1L | Dec. 17, 2022 | 8.25 | Dec. 22, 2022 | 5 | 36,810 | 2,934 |
| 1:3:2 Mix | Dec. 17, 2022 | 8.25 | Dec. 27, 2022 | 10 | 39,968 | 3,189 |
| | Dec. 17, 2022 | 8.25 | Dec. 27, 2022 | 10 | 44,473 | 3,551 |
| | Dec. 17, 2022 | 8.25 | Dec. 27, 2022 | 10 | 46,629 | 3,721 |
| | Dec. 17, 2022 | 8.25 | Dec. 27, 2022 | 10 | 43,797 | 3,494 |
| | Dec. 17, 2022 | 8.25 | Jan. 2, 2023 | 15 | 46,963 | 3,744 |
| | Dec. 17, 2022 | 8.25 | Jan. 2, 2023 | 15 | 50,073 | 3,993 |
| | Dec. 17, 2022 | 8.25 | Jan. 2, 2023 | 15 | 50,760 | 4,049 |
| | Dec. 17, 2022 | 8.25 | Jan. 2, 2023 | 15 | 46,274 | 3,694 |
| | Dec. 17, 2022 | 8.25 | Jan. 6, 2023 | 20 | 47,451 | 3,787 |
| | Dec. 17, 2022 | 8.25 | Jan. 6, 2023 | 20 | 50,711 | 4,042 |
| | Dec. 17, 2022 | 8.25 | Jan. 6, 2023 | 20 | 48,549 | 3,871 |
| | Dec. 17, 2022 | 8.25 | Jan. 6, 2023 | 20 | 46,316 | 3,695 |
| | Dec. 17, 2022 | 8.25 | Jan. 13, 2023 | 28 | 49,869 | 3,972 |
| | Dec. 17, 2022 | 8.25 | Jan. 13, 2023 | 28 | 50,558 | 4,033 |
| | Dec. 17, 2022 | 8.25 | Jan. 13, 2023 | 28 | 49,047 | 3,914 |
| | Dec. 17, 2022 | 8.25 | Jan. 13, 2023 | 28 | 50,567 | 4,036 |
| Baseline | Feb. 13, 2023 | 8.20 | Feb. 18, 2023 | 5 | 33,621 | 2,682 |
| T112 | Feb. 13, 2023 | 8.20 | Feb. 18, 2023 | 5 | 34,010 | 2,713 |
| 20 Cylinders | Feb. 13, 2023 | 8.20 | Feb. 18, 2023 | 5 | 32,804 | 2,614 |
| Portland 1L | Feb. 13, 2023 | 8.20 | Feb. 18, 2023 | 5 | 36,108 | 2,880 |
| 1:3:2 Mix | Feb. 13, 2023 | 8.15 | Feb. 23, 2023 | 10 | 42,570 | 3,399 |
| | Feb. 13, 2023 | 8.20 | Feb. 23, 2023 | 10 | 44,515 | 3,552 |
| | Feb. 13, 2023 | 8.20 | Feb. 23, 2023 | 10 | 44,814 | 3,579 |
| | Feb. 13, 2023 | 8.20 | Feb. 23, 2023 | 10 | 42,397 | 3,381 |
| | Feb. 13, 2023 | 8.10 | Feb. 28, 2023 | 15 | 52,068 | 4,151 |
| | Feb. 13, 2023 | 8.15 | Feb. 28, 2023 | 15 | 48,189 | 3,846 |
| | Feb. 13, 2023 | 8.20 | Feb. 28, 2023 | 15 | 45,592 | 3,638 |
| | Feb. 13, 2023 | 8.20 | Feb. 28, 2023 | 15 | 46,597 | 3,718 |
| | Feb. 13, 2023 | 8.10 | Mar. 5, 2023 | 20 | 47,762 | 3,809 |
| | Feb. 13, 2023 | 8.10 | Mar. 5, 2023 | 20 | 52,835 | 4,214 |
| | Feb. 13, 2023 | 8.20 | Mar. 5, 2023 | 20 | 51,038 | 4,072 |
| | Feb. 13, 2023 | 8.20 | Mar. 5, 2023 | 20 | 49,381 | 3,941 |
| | Feb. 13, 2023 | 8.15 | Mar. 13, 2023 | 28 | 53,927 | 4,306 |
| | Feb. 13, 2023 | 8.15 | Mar. 13, 2023 | 28 | 53,676 | 4,286 |
| | Feb. 13, 2023 | 8.20 | Mar. 13, 2023 | 28 | 54,966 | 4,389 |
| | Feb. 13, 2023 | 8.20 | Mar. 13, 2023 | 28 | 54,217 | 4,324 |

In Table 39, “PB45” is Portland cement, sand, aggregate and water, and binder reducing agent, tested in duplicate, triplicate, etc., as the case may be (“PB45” is sample 1 and “T91” is sample 2 from a pour, etc.). Per 10 4″×8″ Cylinders: 12 lbs. of Portland IL (PLC) cement, 41 pounds of medium to large aggregate (rock), 27 lbs. of fine aggregate (sand), and 8.34 lbs. of water and 0.88 lbs. of binder reducing formulation. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens.

TABLE 39

| Formula | Pour Date | Weight (lb) | Test Date | Cure Days | LBF | PSI |
|---|---|---|---|---|---|---|
| PB45 | Dec. 17, 2022 | 8.30 | Dec. 22, 2022 | 5 | 57,044 | 4,550 |
| T91 | Dec. 17, 2022 | 8.30 | Dec. 22, 2022 | 5 | 57,406 | 4,578 |
| 20 Cylinders | Dec. 17, 2022 | 8.35 | Dec. 22, 2022 | 5 | 59,188 | 4,721 |
| Portland 1L | Dec. 17, 2022 | 8.40 | Dec. 22, 2022 | 5 | 60,517 | 4,829 |
| 1:3:2 Mix | Dec. 17, 2022 | 8.30 | Dec. 27, 2022 | 10 | 66,229 | 5,285 |
| | Dec. 17, 2022 | 8.30 | Dec. 27, 2022 | 10 | 57,285 | 4,568 |
| | Dec. 17, 2022 | 8.35 | Dec. 27, 2022 | 10 | 62,498 | 4,978 |
| | Dec. 17, 2022 | 8.40 | Dec. 27, 2022 | 10 | 65,802 | 5,247 |
| | Dec. 17, 2022 | 8.35 | Jan. 2, 2023 | 15 | 67,047 | 5,354 |
| | Dec. 17, 2022 | 8.35 | Jan. 2, 2023 | 15 | 66,317 | 5,285 |
| | Dec. 17, 2022 | 8.40 | Jan. 2, 2023 | 15 | 62,811 | 5,013 |
| | Dec. 17, 2022 | 8.40 | Jan. 2, 2023 | 15 | 63,277 | 5,050 |
| | Dec. 17, 2022 | 8.35 | Jan. 6, 2023 | 20 | 67,430 | 5,370 |
| | Dec. 17, 2022 | 8.35 | Jan. 6, 2023 | 20 | 67,320 | 5,369 |
| | Dec. 17, 2022 | 8.35 | Jan. 6, 2023 | 20 | 61,683 | 4,918 |
| | Dec. 17, 2022 | 8.40 | Jan. 6, 2023 | 20 | 68,185 | 5,440 |
| | Dec. 17, 2022 | 8.35 | Jan. 13, 2023 | 28 | 69,625 | 5,550 |
| | Dec. 17, 2022 | 8.35 | Jan. 13, 2023 | 28 | 70,013 | 5,559 |
| | Dec. 17, 2022 | 8.40 | Jan. 13, 2023 | 28 | 67,665 | 5,403 |
| | Dec. 17, 2022 | 8.40 | Jan. 13, 2023 | 28 | 70,583 | 5,636 |
| PB45 | Dec. 17, 2022 | 8.40 | Dec. 22, 2022 | 5 | 62,547 | 4,988 |
| T92 | Dec. 17, 2022 | 8.40 | Dec. 22, 2022 | 5 | 66,822 | 5,331 |
| 20 Cylinders | Dec. 17, 2022 | 8.40 | Dec. 22, 2022 | 5 | 66,855 | 5,336 |
| Portland 1L | Dec. 17, 2022 | 8.45 | Dec. 22, 2022 | 5 | 67,802 | 5,402 |
| 1:3:2 Mix | Dec. 17, 2022 | 8.40 | Dec. 27, 2022 | 10 | 74,359 | 5,927 |
| | Dec. 17, 2022 | 8.40 | Dec. 27, 2022 | 10 | 76,911 | 6,134 |
| | Dec. 17, 2022 | 8.35 | Dec. 27, 2022 | 10 | 69,666 | 5,558 |
| | Dec. 17, 2022 | 8.45 | Dec. 27, 2022 | 10 | 74,800 | 5,961 |
| | Dec. 17, 2022 | 8.30 | Jan. 2, 2023 | 15 | 76,119 | 6,068 |
| | Dec. 17, 2022 | 8.30 | Jan. 2, 2023 | 15 | 78,430 | 6,254 |
| | Dec. 17, 2022 | 8.35 | Jan. 2, 2023 | 15 | 68,299 | 5,445 |
| | Dec. 17, 2022 | 8.45 | Jan. 2, 2023 | 15 | 70,562 | 5,630 |
| | Dec. 17, 2022 | 8.30 | Jan. 6, 2023 | 20 | 78,049 | 6,226 |
| | Dec. 17, 2022 | 8.30 | Jan. 6, 2023 | 20 | 76,044 | 6,063 |
| | Dec. 17, 2022 | 8.40 | Jan. 6, 2023 | 20 | 76,560 | 6,105 |
| | Dec. 17, 2022 | 8.45 | Jan. 6, 2023 | 20 | 76,277 | 6,081 |
| | Dec. 17, 2022 | 8.30 | Jan. 13, 2023 | 28 | 77,887 | 6,213 |
| | Dec. 17, 2022 | 8.30 | Jan. 13, 2023 | 28 | 81,297 | 6,485 |
| | Dec. 17, 2022 | 8.45 | Jan. 13, 2023 | 28 | 80,269 | 6,403 |
| | Dec. 17, 2022 | 8.50 | Jan. 13, 2023 | 28 | 79,579 | 6,348 |
| PB45 | Jan. 13, 2023 | 8.35 | Jan. 18, 2023 | 5 | 49,168 | 3,924 |
| T97 | Jan. 13, 2023 | 8.50 | Jan. 18, 2023 | 5 | 48,295 | 3,854 |
| 20 Cylinders | Jan. 13, 2023 | 8.45 | Jan. 18, 2023 | 5 | 51,600 | 4,120 |
| Portland 1L | Jan. 13, 2023 | 8.45 | Jan. 18, 2023 | 5 | 53,781 | 4,290 |
| 1:3:2 Mix | Jan. 13, 2023 | 8.25 | Jan. 23, 2023 | 10 | 59,471 | 4,742 |
| | Jan. 13, 2023 | 8.30 | Jan. 23, 2023 | 10 | 57,569 | 4,594 |
| | Jan. 13, 2023 | 8.50 | Jan. 23, 2023 | 10 | 59,526 | 4,814 |
| | Jan. 13, 2023 | 8.50 | Jan. 23, 2023 | 10 | 63,812 | 5,092 |
| | Jan. 13, 2023 | 8.30 | Jan. 28, 2023 | 15 | 54,136 | 4,319 |
| | Jan. 13, 2023 | 8.40 | Jan. 28, 2023 | 15 | 58,833 | 4,694 |
| | Jan. 13, 2023 | 8.40 | Jan. 28, 2023 | 15 | 56,245 | 4,488 |
| | Jan. 13, 2023 | 8.45 | Jan. 28, 2023 | 15 | 62,094 | 4,946 |
| | Jan. 13, 2023 | 8.30 | Feb. 2, 2023 | 20 | 57,002 | 4,549 |
| | Jan. 13, 2023 | 8.30 | Feb. 2, 2023 | 20 | 64,461 | 5,136 |
| | Jan. 13, 2023 | 8.40 | Feb. 2, 2023 | 20 | 70,273 | 5,601 |
| | Jan. 13, 2023 | 8.45 | Feb. 2, 2023 | 20 | 69,561 | 5,548 |
| | Jan. 13, 2023 | 8.20 | Feb. 10, 2023 | 28 | 71,372 | 5,699 |
| | Jan. 13, 2023 | 8.35 | Feb. 10, 2023 | 28 | 71,811 | 5,734 |
| | Jan. 13, 2023 | 8.30 | Feb. 10, 2023 | 28 | 72,728 | 5,805 |
| | Jan. 13, 2023 | 8.45 | Feb. 10, 2023 | 28 | 73,926 | 5,894 |

Comparative to Table 38 for improved results.

In Table 40, “PB45” is Portland cement, sand, aggregate and water, and binder reducing agent, tested in duplicate, triplicate, etc., as the case may be (“PB45” is sample 1 and “T93” is sample 2 from a pour, etc.). Per 10 4″×8″ Cylinders: 10.8 lbs. of Portland IL (PLC) cement, 41 pounds of medium to large aggregate (rock), 27 lbs. of fine aggregate (sand), and 8.34 lbs. of water and 0.88 lbs. of binder reducing formulation. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens.

TABLE 40

| Formula | Pour Date | Weight (lb) | Test Date | Cure Days | LBF | PSI |
|---|---|---|---|---|---|---|
| PB45 | Dec. 17, 2022 | 8.30 | Dec. 22, 2022 | 5 | 52,469 | 4,185 |
| T93 | Dec. 17, 2022 | 8.30 | Dec. 22, 2022 | 5 | 52,156 | 4,163 |
| 20 Cylinders | Dec. 17, 2022 | 8.40 | Dec. 22, 2022 | 5 | 52,323 | 4,175 |
| −10% Portland 1L | Dec. 17, 2022 | 8.40 | Dec. 22, 2022 | 5 | 52,071 | 4,155 |
| 1:3:2 Mix | Dec. 17, 2022 | 8.30 | Dec. 27, 2022 | 10 | 59,286 | 4,727 |
| | Dec. 17, 2022 | 8.30 | Dec. 27, 2022 | 10 | 58,024 | 4,626 |
| | Dec. 17, 2022 | 8.40 | Dec. 27, 2022 | 10 | 63,668 | 5,074 |
| | Dec. 17, 2022 | 8.45 | Dec. 27, 2022 | 10 | 63,487 | 5,061 |
| | Dec. 17, 2022 | 8.30 | Jan. 2, 2023 | 15 | 61,770 | 4,927 |
| | Dec. 17, 2022 | 8.30 | Jan. 2, 2023 | 15 | 59,266 | 4,724 |
| | Dec. 17, 2022 | 8.40 | Jan. 2, 2023 | 15 | 57,832 | 4,610 |
| | Dec. 17, 2022 | 8.40 | Jan. 2, 2023 | 15 | 62,370 | 4,977 |
| | Dec. 17, 2022 | 8.25 | Jan. 6, 2023 | 20 | 65,190 | 5,199 |
| | Dec. 17, 2022 | 8.25 | Jan. 6, 2023 | 20 | 66,418 | 5,295 |
| | Dec. 17, 2022 | 8.40 | Jan. 6, 2023 | 20 | 65,925 | 5,255 |
| | Dec. 17, 2022 | 8.45 | Jan. 6, 2023 | 20 | 64,355 | 5,131 |
| | Dec. 17, 2022 | 8.35 | Jan. 13, 2023 | 28 | 66,755 | 5,325 |
| | Dec. 17, 2022 | 8.35 | Jan. 13, 2023 | 28 | 67,896 | 5,416 |
| | Dec. 17, 2022 | 8.40 | Jan. 13, 2023 | 28 | 66,542 | 5,308 |
| | Dec. 17, 2022 | 8.45 | Jan. 13, 2023 | 28 | 66,203 | 5,281 |
| PB45 | Jan. 13, 2023 | 8.25 | Jan. 18, 2023 | 5 | 47,883 | 3,819 |
| T98 | Jan. 13, 2023 | 8.30 | Jan. 18, 2023 | 5 | 48,475 | 3,866 |
| 20 Cylinders | Jan. 13, 2023 | 8.40 | Jan. 18, 2023 | 5 | 49,474 | 3,946 |
| −10% Portland 1L | Jan. 13, 2023 | 8.45 | Jan. 18, 2023 | 5 | 45,756 | 3,652 |
| 1:3:2 Mix | Jan. 13, 2023 | 8.20 | Jan. 23, 2023 | 10 | 54,864 | 4,373 |
| | Jan. 13, 2023 | 8.25 | Jan. 23, 2023 | 10 | 43,375 | 3,460 |
| | Jan. 13, 2023 | 8.35 | Jan. 23, 2023 | 10 | 49,298 | 3,933 |
| | Jan. 13, 2023 | 8.35 | Jan. 23, 2023 | 10 | 57,724 | 4,606 |
| | Jan. 13, 2023 | 8.30 | Jan. 28, 2023 | 15 | 47,188 | 3,768 |
| | Jan. 13, 2023 | 8.35 | Jan. 28, 2023 | 15 | 58,137 | 4,639 |
| | Jan. 13, 2023 | 8.40 | Jan. 28, 2023 | 15 | 56,924 | 4,538 |
| | Jan. 13, 2023 | 8.40 | Jan. 28, 2023 | 15 | 51,747 | 4,135 |
| | Jan. 13, 2023 | 8.20 | Feb. 2, 2023 | 20 | 53,788 | 4,293 |
| | Jan. 13, 2023 | 8.25 | Feb. 2, 2023 | 20 | 63,645 | 5,075 |
| | Jan. 13, 2023 | 8.45 | Feb. 2, 2023 | 20 | 58,073 | 4,631 |
| | Jan. 13, 2023 | 8.45 | Feb. 2, 2023 | 20 | 60,144 | 4,794 |
| | Jan. 13, 2023 | 8.20 | Feb. 10, 2023 | 28 | 64,033 | 5,113 |
| | Jan. 13, 2023 | 8.00 | Feb. 10, 2023 | 28 | 61,504 | 4,911 |
| | Jan. 13, 2023 | 8.30 | Feb. 10, 2023 | 28 | 63,329 | 5,054 |
| | Jan. 13, 2023 | 8.45 | Feb. 10, 2023 | 28 | 66,196 | 5,281 |
| PB45 | Jan. 26, 2023 | 5.75 | Jan. 31, 2023 | 5 | 42,820 | 3,417 |
| T104 | Jan. 26, 2023 | 6.05 | Jan. 31, 2023 | 5 | 43,069 | 3,438 |
| 20 Cylinders | Jan. 26, 2023 | 6.05 | Jan. 31, 2023 | 5 | 43,309 | 3,460 |
| −10% Portland 1L | Jan. 26, 2023 | 6.05 | Jan. 31, 2023 | 5 | 43,767 | 3,494 |
| 1:3:2 Mix | Jan. 26, 2023 | 5.80 | Feb. 6, 2023 | 10 | 55,758 | 4,452 |
| | Jan. 26, 2023 | 5.85 | Feb. 6, 2023 | 10 | 53,353 | 4,260 |
| | Jan. 26, 2023 | 5.85 | Feb. 6, 2023 | 10 | 53,895 | 4,302 |
| | Jan. 26, 2023 | 5.85 | Feb. 6, 2023 | 10 | 54,729 | 4,366 |
| | Jan. 26, 2023 | 5.90 | Feb. 10, 2023 | 15 | 58,997 | 4,705 |
| | Jan. 26, 2023 | 5.95 | Feb. 10, 2023 | 15 | 57,665 | 4,597 |
| | Jan. 26, 2023 | 5.95 | Feb. 10, 2023 | 15 | 57,301 | 4,576 |
| | Jan. 26, 2023 | 5.95 | Feb. 10, 2023 | 15 | 57,304 | 4,568 |
| | Jan. 26, 2023 | 5.70 | Feb. 15, 2023 | 20 | 62,740 | 5,000 |
| | Jan. 26, 2023 | 5.75 | Feb. 15, 2023 | 20 | 61,518 | 4,909 |
| | Jan. 26, 2023 | 5.75 | Feb. 15, 2023 | 20 | 60,927 | 4,862 |
| | Jan. 26, 2023 | 5.75 | Feb. 15, 2023 | 20 | 62,324 | 4,970 |
| | Jan. 26, 2023 | 5.70 | Feb. 23, 2023 | 28 | 67,024 | 5,350 |
| | Jan. 26, 2023 | 5.70 | Feb. 23, 2023 | 28 | 64,940 | 5,183 |
| | Jan. 26, 2023 | 5.70 | Feb. 23, 2023 | 28 | 67,765 | 5,403 |
| | Jan. 26, 2023 | 5.75 | Feb. 23, 2023 | 28 | 65,957 | 5,266 |
| PB45 | Feb. 7, 2023 | 8.25 | Feb. 12, 2023 | 5 | 39,551 | 3,155 |
| T107 | Feb. 7, 2023 | 8.30 | Feb. 12, 2023 | 5 | 39,828 | 3,179 |
| 20 Cylinders | Feb. 7, 2023 | 8.35 | Feb. 12, 2023 | 5 | 45,647 | 3,644 |
| −10% Portland 1L | Feb. 7, 2023 | 8.40 | Feb. 12, 2023 | 5 | 46,291 | 3,693 |
| 1:3:2 Mix | Feb. 7, 2023 | 8.25 | Feb. 17, 2023 | 10 | 46,670 | 3,720 |
| | Feb. 7, 2023 | 8.30 | Feb. 17, 2023 | 10 | 43,951 | 3,507 |
| | Feb. 7, 2023 | 8.35 | Feb. 17, 2023 | 10 | 50,752 | 4,047 |
| | Feb. 7, 2023 | 8.40 | Feb. 17, 2023 | 10 | 48,393 | 3,861 |
| | Feb. 7, 2023 | 8.25 | Feb. 23, 2023 | 15 | 47,181 | 3,764 |
| | Feb. 7, 2023 | 8.30 | Feb. 23, 2023 | 15 | 47,459 | 3,787 |
| | Feb. 7, 2023 | 8.35 | Feb. 23, 2023 | 15 | 56,676 | 4,520 |
| | Feb. 7, 2023 | 8.45 | Feb. 23, 2023 | 15 | 53,678 | 4,281 |
| | Feb. 7, 2023 | 8.30 | Feb. 28, 2023 | 20 | 48,728 | 3,886 |
| | Feb. 7, 2023 | 8.35 | Feb. 28, 2023 | 20 | 48,176 | 3,842 |
| | Feb. 7, 2023 | 8.40 | Feb. 28, 2023 | 20 | 57,505 | 4,586 |
| | Feb. 7, 2023 | 8.45 | Feb. 28, 2023 | 20 | 55,495 | 4,430 |
| | Feb. 7, 2023 | 8.00 | Mar. 8, 2023 | 28 | 58,711 | 4,688 |
| | Feb. 7, 2023 | 8.15 | Mar. 8, 2023 | 28 | 59,137 | 4,722 |
| | Feb. 7, 2023 | 8.30 | Mar. 8, 2023 | 28 | 59,937 | 4,779 |
| | Feb. 7, 2023 | 8.40 | Mar. 8, 2023 | 28 | 65,155 | 5,196 |

Comparative to Table 38 for improved results despite removing 100 of the binder.

In Table 41, “PB45” is Portland cement, sand, aggregate and water, and binder reducing agent, tested in duplicate, triplicate, etc., as the case may be (“PB45” is sample 1 and “T94” is sample 2 from a pour, etc.). Per 10 4″×8″ Cylinders: 9.6 lbs. of Portland IL (PLC) cement, 41 pounds of medium to large aggregate (rock), 27 lbs. of fine aggregate (sand), and 8.34 lbs. of water and 0.88 lbs. of binder reducing formulation. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens.

TABLE 41

| Formula | Pour Date | Weight (lb) | Test Date | Cure Days | LBF | PSI |
|---|---|---|---|---|---|---|
| PB45 | Dec. 17, 2022 | 8.25 | Dec. 22, 2022 | 5 | 47,082 | 3,756 |
| T94 | Dec. 17, 2022 | 8.25 | Dec. 22, 2022 | 5 | 45,316 | 3,614 |
| 19 Cylinders | Dec. 17, 2022 | 8.45 | Dec. 22, 2022 | 5 | 47,080 | 3,755 |
| −20% Portland 1L | Dec. 17, 2022 | 8.45 | Dec. 22, 2022 | 5 | 46,683 | 3,727 |
| 1:3:2 Mix | Dec. 17, 2022 | 8.25 | Dec. 27, 2022 | 10 | 52,349 | 4,175 |
| | Dec. 17, 2022 | 8.25 | Dec. 27, 2022 | 10 | 57,416 | 4,579 |
| | Dec. 17, 2022 | 8.45 | Dec. 27, 2022 | 10 | 60,551 | 4,833 |
| | Dec. 17, 2022 | 8.45 | Dec. 27, 2022 | 10 | 57,156 | 4,562 |
| | Dec. 17, 2022 | 8.40 | Jan. 2, 2023 | 15 | 58,650 | 4,674 |
| | Dec. 17, 2022 | 8.40 | Jan. 2, 2023 | 15 | 59,122 | 4,717 |
| | Dec. 17, 2022 | 8.50 | Jan. 2, 2023 | 15 | 56,940 | 4,543 |
| | Dec. 17, 2022 | 8.50 | Jan. 2, 2023 | 15 | 57,820 | 4,613 |
| | Dec. 17, 2022 | 8.40 | Jan. 6, 2023 | 20 | 61,870 | 4,936 |
| | Dec. 17, 2022 | 8.40 | Jan. 6, 2023 | 20 | 63,645 | 5,076 |
| | Dec. 17, 2022 | 8.40 | Jan. 6, 2023 | 20 | 51,957 | 4,144 |
| | Dec. 17, 2022 | 8.45 | Jan. 6, 2023 | 20 | 54,157 | 4,319 |
| | Dec. 17, 2022 | 8.30 | Jan. 13, 2023 | 28 | 65,411 | 5,223 |
| | Dec. 17, 2022 | 8.30 | Jan. 13, 2023 | 28 | 64,549 | 5,149 |
| | Dec. 17, 2022 | 8.45 | Jan. 13, 2023 | 28 | 63,922 | 5,099 |
| PB45 | Jan. 13, 2023 | 8.35 | Jan. 18, 2023 | 5 | 42,926 | 3,424 |
| T99 | Jan. 13, 2023 | 8.40 | Jan. 18, 2023 | 5 | 43,721 | 3,489 |
| 20 Cylinders | Jan. 13, 2023 | 8.55 | Jan. 18, 2023 | 5 | 44,891 | 3,583 |
| −20% Portland 1L | Jan. 13, 2023 | 8.55 | Jan. 18, 2023 | 5 | 47,157 | 3,762 |
| 1:3:2 Mix | Jan. 13, 2023 | 8.30 | Jan. 23, 2023 | 10 | 53,455 | 4,261 |
| | Jan. 13, 2023 | 8.40 | Jan. 23, 2023 | 10 | 54,072 | 4,313 |
| | Jan. 13, 2023 | 8.55 | Jan. 23, 2023 | 10 | 56,195 | 4,476 |
| | Jan. 13, 2023 | 8.50 | Jan. 23, 2023 | 10 | 53,613 | 4,280 |
| | Jan. 13, 2023 | 8.35 | Jan. 28, 2023 | 15 | 55,956 | 4,463 |
| | Jan. 13, 2023 | 8.40 | Jan. 28, 2023 | 15 | 57,130 | 4,555 |
| | Jan. 13, 2023 | 8.50 | Jan. 28, 2023 | 15 | 49,651 | 3,953 |
| | Jan. 13, 2023 | 8.50 | Jan. 28, 2023 | 15 | 53,817 | 4,292 |
| | Jan. 13, 2023 | 8.35 | Feb. 2, 2023 | 20 | 56,309 | 4,496 |
| | Jan. 13, 2023 | 8.40 | Feb. 2, 2023 | 20 | 57,310 | 4,571 |
| | Jan. 13, 2023 | 8.50 | Feb. 2, 2023 | 20 | 57,499 | 4,588 |
| | Jan. 13, 2023 | 8.45 | Feb. 2, 2023 | 20 | 57,804 | 4,609 |
| | Jan. 13, 2023 | 8.30 | Feb. 10, 2023 | 28 | 58,938 | 4,702 |
| | Jan. 13, 2023 | 8.40 | Feb. 10, 2023 | 28 | 60,470 | 4,824 |
| | Jan. 13, 2023 | 8.55 | Feb. 10, 2023 | 28 | 64,718 | 5,158 |
| PB45 | Jan. 26, 2023 | 6.05 | Jan. 31, 2023 | 5 | 50,289 | 4,017 |
| T105 | Jan. 26, 2023 | 6.05 | Jan. 31, 2023 | 5 | 49,089 | 3,918 |
| 20 Cylinders | Jan. 26, 2023 | 6.10 | Jan. 31, 2023 | 5 | 50,278 | 4,013 |
| −20% Portland 1L | Jan. 26, 2023 | 6.10 | Jan. 31, 2023 | 5 | 51,033 | 4,076 |
| 1:3:2 Mix | Jan. 26, 2023 | 5.80 | Feb. 6, 2023 | 10 | 57,642 | 4,600 |
| | Jan. 26, 2023 | 5.85 | Feb. 6, 2023 | 10 | 61,347 | 4,890 |
| | Jan. 26, 2023 | 5.85 | Feb. 6, 2023 | 10 | 58,808 | 4,697 |
| | Jan. 26, 2023 | 5.85 | Feb. 6, 2023 | 10 | 60,437 | 4,826 |
| | Jan. 26, 2023 | 5.95 | Feb. 10, 2023 | 15 | 61,391 | 4,894 |
| | Jan. 26, 2023 | 5.95 | Feb. 10, 2023 | 15 | 61,422 | 4,898 |
| | Jan. 26, 2023 | 5.95 | Feb. 10, 2023 | 15 | 60,115 | 4,795 |
| | Jan. 26, 2023 | 5.95 | Feb. 10, 2023 | 15 | 60,467 | 4,825 |
| | Jan. 26, 2023 | 5.75 | Feb. 15, 2023 | 20 | 66,257 | 5,289 |
| | Jan. 26, 2023 | 5.75 | Feb. 15, 2023 | 20 | 65,011 | 5,187 |
| | Jan. 26, 2023 | 5.75 | Feb. 15, 2023 | 20 | 66,560 | 5,309 |
| | Jan. 26, 2023 | 5.75 | Feb. 15, 2023 | 20 | 67,006 | 5,349 |
| | Jan. 26, 2023 | 5.75 | Feb. 23, 2023 | 28 | 74,615 | 5,953 |
| | Jan. 26, 2023 | 5.75 | Feb. 23, 2023 | 28 | 73,345 | 5,846 |
| | Jan. 26, 2023 | 5.75 | Feb. 23, 2023 | 28 | 72,795 | 5,806 |
| | Jan. 26, 2023 | 5.75 | Feb. 23, 2023 | 28 | 74,959 | 5,971 |
| PB45 | Feb. 7, 2023 | 8.25 | Feb. 12, 2023 | 5 | 29,278 | 2,334 |
| T108 | Feb. 7, 2023 | 8.30 | Feb. 12, 2023 | 5 | 29,155 | 2,321 |
| 20 Cylinders | Feb. 7, 2023 | 8.30 | Feb. 12, 2023 | 5 | 36,192 | 2,887 |
| −20% Portland 1L | Feb. 7, 2023 | 8.40 | Feb. 12, 2023 | 5 | 38,786 | 3,096 |
| 1:3:2 Mix | Feb. 7, 2023 | 8.25 | Feb. 17, 2023 | 10 | 34,511 | 2,752 |
| | Feb. 7, 2023 | 8.30 | Feb. 17, 2023 | 10 | 36,228 | 2,889 |
| | Feb. 7, 2023 | 8.35 | Feb. 17, 2023 | 10 | 36,806 | 2,938 |
| | Feb. 7, 2023 | 8.35 | Feb. 17, 2023 | 10 | 39,700 | 3,168 |
| | Feb. 7, 2023 | 8.20 | Feb. 23, 2023 | 15 | 36,326 | 2,897 |
| | Feb. 7, 2023 | 8.25 | Feb. 23, 2023 | 15 | 37,050 | 2,954 |
| | Feb. 7, 2023 | 8.25 | Feb. 23, 2023 | 15 | 47,637 | 3,800 |
| | Feb. 7, 2023 | 8.35 | Feb. 23, 2023 | 15 | 44,614 | 3,559 |
| | Feb. 7, 2023 | 8.20 | Feb. 28, 2023 | 20 | 38,003 | 3,031 |
| | Feb. 7, 2023 | 8.20 | Feb. 28, 2023 | 20 | 35,790 | 2,855 |
| | Feb. 7, 2023 | 8.35 | Feb. 28, 2023 | 20 | 37,834 | 3,015 |
| | Feb. 7, 2023 | 8.35 | Feb. 28, 2023 | 20 | 36,727 | 2,928 |
| | Feb. 7, 2023 | 8.00 | Mar. 8, 2023 | 28 | 46,709 | 3,726 |
| | Feb. 7, 2023 | 8.00 | Mar. 8, 2023 | 28 | 46,728 | 3,727 |
| | Feb. 7, 2023 | 8.35 | Mar. 8, 2023 | 28 | 50,851 | 4,056 |
| | Feb. 7, 2023 | 8.45 | Mar. 8, 2023 | 28 | 51,926 | 4,138 |
| PB45 | Feb. 22, 2023 | 8.25 | Feb. 27, 2023 | 5 | 29,099 | 2,319 |
| T115 | Feb. 22, 2023 | 8.30 | Feb. 27, 2023 | 5 | 29,473 | 2,349 |
| 20 Cylinders | Feb. 22, 2023 | 8.35 | Feb. 27, 2023 | 5 | 29,280 | 2,333 |
| −20% Portland 1L | Feb. 22, 2023 | 8.40 | Feb. 27, 2023 | 5 | 29,972 | 2,389 |
| 1:3:2 Mix | Feb. 22, 2023 | 8.30 | Mar. 4, 2023 | 10 | 35,117 | 2,801 |
| | Feb. 22, 2023 | 8.30 | Mar. 4, 2023 | 10 | 36,605 | 2,919 |
| | Feb. 22, 2023 | 8.30 | Mar. 4, 2023 | 10 | 33,900 | 2,705 |
| | Feb. 22, 2023 | 8.35 | Mar. 4, 2023 | 10 | 35,996 | 2,871 |
| | Feb. 22, 2023 | 8.15 | Mar. 9, 2023 | 15 | 36,873 | 2,940 |
| | Feb. 22, 2023 | 8.20 | Mar. 9, 2023 | 15 | 39,774 | 3,175 |
| | Feb. 22, 2023 | 8.25 | Mar. 9, 2023 | 15 | 40,635 | 3,244 |
| | Feb. 22, 2023 | 8.15 | Mar. 9, 2023 | 15 | 38,239 | 3,051 |
| | Feb. 22, 2023 | 8.30 | Mar. 14, 2023 | 20 | 39,840 | 3,179 |
| | Feb. 22, 2023 | 8.30 | Mar. 14, 2023 | 20 | 41,095 | 3,280 |
| | Feb. 22, 2023 | 8.30 | Mar. 14, 2023 | 20 | 39,388 | 3,143 |
| | Feb. 22, 2023 | 8.35 | Mar. 14, 2023 | 20 | 40,850 | 3,257 |
| | Feb. 22, 2023 | 8.10 | Mar. 22, 2023 | 28 | 41,303 | 3,298 |
| | Feb. 22, 2023 | 8.15 | Mar. 22, 2023 | 28 | 41,917 | 3,347 |
| | Feb. 22, 2023 | 8.25 | Mar. 22, 2023 | 28 | 42,568 | 3,399 |
| | Feb. 22, 2023 | 8.30 | Mar. 22, 2023 | 28 | 41,540 | 3,312 |
| PB45 | Mar. 6, 2023 | 8.20 | Mar. 11, 2023 | 5 | 35,382 | 2,821 |
| T117 | Mar. 6, 2023 | 8.30 | Mar. 11, 2023 | 5 | 34,851 | 2,781 |
| 20 Cylinders | Mar. 6, 2023 | 8.20 | Mar. 11, 2023 | 5 | 36,190 | 2,884 |
| −20% Portland 1L | Mar. 6, 2023 | 8.25 | Mar. 11, 2023 | 5 | 33,567 | 2,675 |
| 1:3:2 Mix | Mar. 6, 2023 | 8.15 | Mar. 16, 2023 | 10 | 42,875 | 3,418 |
| | Mar. 6, 2023 | 8.30 | Mar. 16, 2023 | 10 | 45,253 | 3,610 |
| | Mar. 6, 2023 | 8.25 | Mar. 16, 2023 | 10 | 42,075 | 3,360 |
| | Mar. 6, 2023 | 8.25 | Mar. 16, 2023 | 10 | 44,925 | 3,582 |
| | Mar. 6, 2023 | 8.25 | Mar. 21, 2023 | 15 | 46,881 | 3,741 |
| | Mar. 6, 2023 | 8.30 | Mar. 21, 2023 | 15 | 48,153 | 3,841 |
| | Mar. 6, 2023 | 8.30 | Mar. 21, 2023 | 15 | 49,881 | 3,980 |
| | Mar. 6, 2023 | 8.45 | Mar. 21, 2023 | 15 | 55,022 | 4,392 |
| | Mar. 6, 2023 | 8.20 | Mar. 26, 2023 | 20 | 47,718 | 3,807 |
| | Mar. 6, 2023 | 8.30 | Mar. 26, 2023 | 20 | 49,964 | 3,986 |
| | Mar. 6, 2023 | 8.20 | Mar. 26, 2023 | 20 | 48,741 | 3,888 |
| | Mar. 6, 2023 | 8.30 | Mar. 26, 2023 | 20 | 52,659 | 4,200 |
| | Mar. 6, 2023 | 8.25 | Apr. 3, 2023 | 28 | 49,496 | 3,949 |
| | Mar. 6, 2023 | 8.25 | Apr. 3, 2023 | 28 | 49,503 | 3,946 |
| | Mar. 6, 2023 | 8.30 | Apr. 3, 2023 | 28 | 51,267 | 4,090 |
| | Mar. 6, 2023 | 8.30 | Apr. 3, 2023 | 28 | 51,422 | 4,106 |
| PB45 | Mar. 9, 2023 | 8.20 | Mar. 14, 2023 | 5 | 37,785 | 3,009 |
| T118 | Mar. 9, 2023 | 8.20 | Mar. 14, 2023 | 5 | 36,146 | 2,883 |
| 40 Cylinders | Mar. 9, 2023 | 8.30 | Mar. 14, 2023 | 5 | 28,123 | 2,240 |
| −20% Portland 1L | Mar. 9, 2023 | 8.30 | Mar. 14, 2023 | 5 | 26,504 | 2,111 |
| 1:3:2 Mix | Mar. 9, 2023 | 8.25 | Mar. 14, 2023 | 5 | 28,977 | 2,308 |
| | Mar. 9, 2023 | 8.30 | Mar. 14, 2023 | 5 | 33,188 | 2,646 |
| | Mar. 9, 2023 | 8.35 | Mar. 14, 2023 | 5 | 32,078 | 2,558 |
| | Mar. 9, 2023 | 8.45 | Mar. 14, 2023 | 5 | 32,261 | 2,570 |
| | Mar. 9, 2023 | 8.15 | Mar. 19, 2023 | 10 | 46,977 | 3,748 |
| | Mar. 9, 2023 | 8.20 | Mar. 19, 2023 | 10 | 45,320 | 3,617 |
| | Mar. 9, 2023 | 8.30 | Mar. 19, 2023 | 10 | 36,092 | 2,878 |
| | Mar. 9, 2023 | 8.30 | Mar. 19, 2023 | 10 | 43,734 | 3,491 |
| | Mar. 9, 2023 | 8.30 | Mar. 19, 2023 | 10 | 40,362 | 3,220 |
| | Mar. 9, 2023 | 8.35 | Mar. 19, 2023 | 10 | 40,815 | 3,253 |
| | Mar. 9, 2023 | 8.40 | Mar. 19, 2023 | 10 | 40,035 | 3,194 |
| | Mar. 9, 2023 | 8.40 | Mar. 19, 2023 | 10 | 41,102 | 3,280 |
| | Mar. 9, 2023 | 8.15 | Mar. 24, 2023 | 15 | 46,477 | 3,710 |
| | Mar. 9, 2023 | 8.15 | Mar. 24, 2023 | 15 | 46,087 | 3,677 |
| | Mar. 9, 2023 | 8.20 | Mar. 24, 2023 | 15 | 46,141 | 3,680 |
| | Mar. 9, 2023 | 8.25 | Mar. 24, 2023 | 15 | 45,452 | 3,625 |
| | Mar. 9, 2023 | 8.25 | Mar. 24, 2023 | 15 | 53,636 | 4,280 |
| | Mar. 9, 2023 | 8.30 | Mar. 24, 2023 | 15 | 52,249 | 4,167 |
| | Mar. 9, 2023 | 8.30 | Mar. 24, 2023 | 15 | 51,983 | 4,145 |
| | Mar. 9, 2023 | 8.30 | Mar. 24, 2023 | 15 | 58,849 | 4,697 |
| | Mar. 9, 2023 | 8.25 | Mar. 29, 2023 | 20 | 49,237 | 3,927 |
| | Mar. 9, 2023 | 8.25 | Mar. 29, 2023 | 20 | 50,499 | 4,027 |
| | Mar. 9, 2023 | 8.25 | Mar. 29, 2023 | 20 | 49,199 | 3,924 |
| | Mar. 9, 2023 | 8.30 | Mar. 29, 2023 | 20 | 49,914 | 3,981 |
| | Mar. 9, 2023 | 8.15 | Mar. 29, 2023 | 20 | 52,595 | 4,115 |
| | Mar. 9, 2023 | 8.15 | Mar. 29, 2023 | 20 | 48,585 | 3,875 |
| | Mar. 9, 2023 | 8.20 | Mar. 29, 2023 | 20 | 52,995 | 4,228 |
| | Mar. 9, 2023 | 8.30 | Mar. 29, 2023 | 20 | 47,757 | 3,809 |
| | Mar. 9, 2023 | 8.20 | Apr. 6, 2023 | 28 | 48,217 | 3,848 |
| | Mar. 9, 2023 | 8.30 | Apr. 6, 2023 | 28 | 49,019 | 3,912 |
| | Mar. 9, 2023 | 8.30 | Apr. 6, 2023 | 28 | 48,713 | 3,886 |
| | Mar. 9, 2023 | 8.30 | Apr. 6, 2023 | 28 | 54,916 | 4,385 |
| | Mar. 9, 2023 | 8.35 | Apr. 6, 2023 | 28 | 53,839 | 4,299 |
| | Mar. 9, 2023 | 8.40 | Apr. 6, 2023 | 28 | 48,743 | 3,890 |
| | Mar. 9, 2023 | 8.40 | Apr. 6, 2023 | 28 | 49,370 | 3,940 |
| | Mar. 9, 2023 | 8.40 | Apr. 6, 2023 | 28 | 53,967 | 4,306 |
| PB45 | Mar. 17, 2023 | 8.10 | Mar. 22, 2023 | 5 | 37,690 | 3,007 |
| T119 | Mar. 17, 2023 | 8.15 | Mar. 22, 2023 | 5 | 42,702 | 3,406 |
| 100 Cylinders | Mar. 17, 2023 | 8.15 | Mar. 22, 2023 | 5 | 48,926 | 3,903 |
| −20% Portland 1L | Mar. 17, 2023 | 8.20 | Mar. 22, 2023 | 5 | 49,347 | 3,935 |
| 1:3:2 Mix | Mar. 17, 2023 | 8.20 | Mar. 22, 2023 | 5 | 38,049 | 3,035 |
| | Mar. 17, 2023 | 8.25 | Mar. 22, 2023 | 5 | 37,777 | 3,013 |
| | Mar. 17, 2023 | 8.25 | Mar. 22, 2023 | 5 | 46,744 | 3,729 |
| | Mar. 17, 2023 | 8.25 | Mar. 22, 2023 | 5 | 39,398 | 3,141 |
| | Mar. 17, 2023 | 8.25 | Mar. 22, 2023 | 5 | 40,242 | 3,210 |
| | Mar. 17, 2023 | 8.25 | Mar. 22, 2023 | 5 | 39,899 | 3,183 |
| | Mar. 17, 2023 | 8.25 | Mar. 22, 2023 | 5 | 38,247 | 3,053 |
| | Mar. 17, 2023 | 8.25 | Mar. 22, 2023 | 5 | 38,940 | 3,108 |
| | Mar. 17, 2023 | 8.25 | Mar. 22, 2023 | 5 | 48,702 | 3,887 |
| | Mar. 17, 2023 | 8.25 | Mar. 22, 2023 | 5 | 47,981 | 3,827 |
| | Mar. 17, 2023 | 8.30 | Mar. 22, 2023 | 5 | 38,573 | 3,073 |
| | Mar. 17, 2023 | 8.30 | Mar. 22, 2023 | 5 | 43,630 | 3,480 |
| | Mar. 17, 2023 | 8.30 | Mar. 22, 2023 | 5 | 47,275 | 3,765 |
| | Mar. 17, 2023 | 8.30 | Mar. 22, 2023 | 5 | 38,744 | 3,089 |
| | Mar. 17, 2023 | 8.30 | Mar. 22, 2023 | 5 | 47,834 | 3,815 |
| | Mar. 17, 2023 | 8.35 | Mar. 23, 2023 | 5 | 43,906 | 3,502 |
| | Mar. 17, 2023 | 8.10 | Mar. 27, 2023 | 10 | 46,594 | 3,719 |
| | Mar. 17, 2023 | 8.15 | Mar. 27, 2023 | 10 | 50,496 | 4,028 |
| | Mar. 17, 2023 | 8.20 | Mar. 27, 2023 | 10 | 56,656 | 4,518 |
| | Mar. 17, 2023 | 8.20 | Mar. 27, 2023 | 10 | 43,134 | 3,440 |
| | Mar. 17, 2023 | 8.20 | Mar. 27, 2023 | 10 | 42,848 | 3,418 |
| | Mar. 17, 2023 | 8.20 | Mar. 27, 2023 | 10 | 42,317 | 3,377 |
| | Mar. 17, 2023 | 8.25 | Mar. 27, 2023 | 10 | 43,092 | 3,431 |
| | Mar. 17, 2023 | 8.25 | Mar. 27, 2023 | 10 | 43,408 | 3,462 |
| | Mar. 17, 2023 | 8.25 | Mar. 27, 2023 | 10 | 42,154 | 3,362 |
| | Mar. 17, 2023 | 8.25 | Mar. 27, 2023 | 10 | 44,135 | 3,521 |
| | Mar. 17, 2023 | 8.25 | Mar. 27, 2023 | 10 | 44,661 | 3,580 |
| | Mar. 17, 2023 | 8.25 | Mar. 27, 2023 | 10 | 41,699 | 3,328 |
| | Mar. 17, 2023 | 8.30 | Mar. 27, 2023 | 10 | 50,649 | 4,040 |
| | Mar. 17, 2023 | 8.30 | Mar. 27, 2023 | 10 | 46,444 | 3,705 |
| | Mar. 17, 2023 | 8.30 | Mar. 27, 2023 | 10 | 54,293 | 4,329 |
| | Mar. 17, 2023 | 8.30 | Mar. 27, 2023 | 10 | 45,849 | 3,659 |
| | Mar. 17, 2023 | 8.30 | Mar. 27, 2023 | 10 | 42,746 | 3,412 |
| | Mar. 17, 2023 | 8.30 | Mar. 27, 2023 | 10 | 43,395 | 3,461 |
| | Mar. 17, 2023 | 8.35 | Mar. 27, 2023 | 10 | 50,157 | 3,997 |
| | Mar. 17, 2023 | 8.40 | Mar. 27, 2023 | 10 | 43,925 | 3,504 |
| | Mar. 17, 2023 | 8.10 | Apr. 1, 2023 | 15 | 43,394 | 3,463 |
| | Mar. 17, 2023 | 8.20 | Apr. 1, 2023 | 15 | 47,499 | 3,790 |
| | Mar. 17, 2023 | 8.25 | Apr. 1, 2023 | 15 | 48,518 | 3,870 |
| | Mar. 17, 2023 | 8.15 | Apr. 1, 2023 | 15 | 55,782 | 4,447 |
| | Mar. 17, 2023 | 8.30 | Apr. 1, 2023 | 15 | 46,737 | 3,730 |
| | Mar. 17, 2023 | 8.25 | Apr. 1, 2023 | 15 | 45,253 | 3,609 |
| | Mar. 17, 2023 | 8.25 | Apr. 1, 2023 | 15 | 44,243 | 3,527 |
| | Mar. 17, 2023 | 8.25 | Apr. 1, 2023 | 15 | 43,959 | 3,505 |
| | Mar. 17, 2023 | 8.30 | Apr. 1, 2023 | 15 | 44,865 | 3,579 |
| | Mar. 17, 2023 | 8.25 | Apr. 1, 2023 | 15 | 50,804 | 4,051 |
| | Mar. 17, 2023 | 8.25 | Apr. 1, 2023 | 15 | 48,722 | 3,886 |
| | Mar. 17, 2023 | 8.25 | Apr. 1, 2023 | 15 | 44,112 | 3,521 |
| | Mar. 17, 2023 | 8.25 | Apr. 1, 2023 | 15 | 43,840 | 3,497 |
| | Mar. 17, 2023 | 8.20 | Apr. 1, 2023 | 15 | 57,109 | 4,555 |
| | Mar. 17, 2023 | 8.35 | Apr. 1, 2023 | 15 | 45,111 | 3,599 |
| | Mar. 17, 2023 | 8.20 | Apr. 1, 2023 | 15 | 48,904 | 3,903 |
| | Mar. 17, 2023 | 8.25 | Apr. 1, 2023 | 15 | 53,798 | 4,292 |
| | Mar. 17, 2023 | 8.20 | Apr. 1, 2023 | 15 | 46,208 | 3,687 |
| | Mar. 17, 2023 | 8.25 | Apr. 1, 2023 | 15 | 49,020 | 3,911 |
| | Mar. 17, 2023 | 8.25 | Apr. 1, 2023 | 15 | 47,065 | 3,755 |
| | Mar. 17, 2023 | 8.00 | Apr. 6, 2023 | 20 | 51,638 | 4,121 |
| | Mar. 17, 2023 | 8.10 | Apr. 6, 2023 | 20 | 48,556 | 3,875 |
| | Mar. 17, 2023 | 8.15 | Apr. 6, 2023 | 20 | 48,117 | 3,840 |
| | Mar. 17, 2023 | 8.15 | Apr. 6, 2023 | 20 | 55,887 | 4,457 |
| | Mar. 17, 2023 | 8.15 | Apr. 6, 2023 | 20 | 49,470 | 3,948 |
| | Mar. 17, 2023 | 8.20 | Apr. 6, 2023 | 20 | 52,260 | 4,168 |
| | Mar. 17, 2023 | 8.20 | Apr. 6, 2023 | 20 | 48,317 | 3,856 |
| | Mar. 17, 2023 | 8.20 | Apr. 6, 2023 | 20 | 47,967 | 3,828 |
| | Mar. 17, 2023 | 8.20 | Apr. 6, 2023 | 20 | 47,255 | 3,763 |
| | Mar. 17, 2023 | 8.25 | Apr. 6, 2023 | 20 | 48,073 | 3,836 |
| | Mar. 17, 2023 | 8.25 | Apr. 6, 2023 | 20 | 53,499 | 4,265 |
| | Mar. 17, 2023 | 8.25 | Apr. 6, 2023 | 20 | 48,255 | 3,851 |
| | Mar. 17, 2023 | 8.25 | Apr. 6, 2023 | 20 | 47,465 | 3,788 |
| | Mar. 17, 2023 | 8.25 | Apr. 6, 2023 | 20 | 59,702 | 4,763 |
| | Mar. 17, 2023 | 8.30 | Apr. 6, 2023 | 20 | 60,133 | 4,791 |
| | Mar. 17, 2023 | 8.30 | Apr. 6, 2023 | 20 | 51,656 | 4,120 |
| | Mar. 17, 2023 | 8.30 | Apr. 6, 2023 | 20 | 47,616 | 3,800 |
| | Mar. 17, 2023 | 8.30 | Apr. 6, 2023 | 20 | 52,207 | 4,165 |
| | Mar. 17, 2023 | 8.30 | Apr. 6, 2023 | 20 | 47,541 | 3,794 |
| | Mar. 17, 2023 | 8.35 | Apr. 6, 2023 | 20 | 56,274 | 4,488 |
| | Mar. 17, 2023 | 8.15 | Apr. 14, 2023 | 28 | 55,765 | 4,441 |
| | Mar. 17, 2023 | 8.20 | Apr. 14, 2023 | 28 | 62,154 | 4,947 |
| | Mar. 17, 2023 | 8.20 | Apr. 14, 2023 | 28 | 57,636 | 4,590 |
| | Mar. 17, 2023 | 8.20 | Apr. 14, 2023 | 28 | 54,803 | 4,365 |
| | Mar. 17, 2023 | 8.20 | Apr. 14, 2023 | 28 | 56,996 | 4,537 |
| | Mar. 17, 2023 | 8.25 | Apr. 14, 2023 | 28 | 54,562 | 4,343 |
| | Mar. 17, 2023 | 8.30 | Apr. 14, 2023 | 28 | 62,809 | 5,002 |
| | Mar. 17, 2023 | 8.30 | Apr. 14, 2023 | 28 | 56,631 | 4,510 |
| | Mar. 17, 2023 | 8.30 | Apr. 14, 2023 | 28 | 59,460 | 4,731 |
| | Mar. 17, 2023 | 8.30 | Apr. 14, 2023 | 28 | 57,723 | 4,597 |
| | Mar. 17, 2023 | 8.20 | Apr. 14, 2023 | 28 | 49,662 | 3,955 |
| | Mar. 17, 2023 | 8.25 | Apr. 14, 2023 | 28 | 52,985 | 4,226 |
| | Mar. 17, 2023 | 8.25 | Apr. 14, 2023 | 28 | 48,235 | 3,847 |
| | Mar. 17, 2023 | 8.25 | Apr. 14, 2023 | 28 | 51,782 | 4,132 |
| | Mar. 17, 2023 | 8.25 | Apr. 14, 2023 | 28 | 50,775 | 4,051 |
| | Mar. 17, 2023 | 8.30 | Apr. 14, 2023 | 28 | 52,695 | 4,204 |
| | Mar. 17, 2023 | 8.30 | Apr. 14, 2023 | 28 | 50,052 | 3,986 |
| | Mar. 17, 2023 | 8.30 | Apr. 14, 2023 | 28 | 50,190 | 3,997 |
| | Mar. 17, 2023 | 8.35 | Apr. 14, 2023 | 28 | 49,235 | 3,921 |
| | Mar. 17, 2023 | 8.40 | Apr. 14, 2023 | 28 | 51,805 | 4,133 |
| PB45 | Mar. 21, 2023 | 8.15 | Mar. 27, 2023 | 5 | 36,887 | 2,943 |
| T123 | Mar. 21, 2023 | 8.20 | Mar. 27, 2023 | 5 | 37,878 | 3,022 |
| 10 Cylinders | Mar. 21, 2023 | 8.15 | Apr. 1, 2023 | 10 | 38,191 | 3,047 |
| −20% Portland 1L | Mar. 21, 2023 | 8.20 | Apr. 1, 2023 | 10 | 39,382 | 3,142 |
| 1:3:2 Mix | Mar. 21, 2023 | 8.15 | Apr. 6, 2023 | 15 | 43,627 | 3,480 |
| | Mar. 21, 2023 | 8.20 | Apr. 6, 2023 | 15 | 43,007 | 3,427 |
| | Mar. 21, 2023 | 8.20 | Apr. 11, 2023 | 20 | 38,710 | 3,081 |
| | Mar. 21, 2023 | 8.20 | Apr. 11, 2023 | 20 | 45,496 | 3,632 |
| | Mar. 21, 2023 | 8.15 | Apr. 19, 2023 | 28 | 48,201 | 3,838 |
| | Mar. 21, 2023 | 8.20 | Apr. 19, 2023 | 28 | 49,080 | 3,908 |
| PB45 | Mar. 21, 2023 | 8.15 | Mar. 27, 2023 | 5 | 33,084 | 2,636 |
| T124 | Mar. 21, 2023 | 8.20 | Mar. 27, 2023 | 5 | 30,529 | 2,430 |
| 10 Cylinders | Mar. 21, 2023 | 8.25 | Apr. 1, 2023 | 10 | 31,385 | 2,504 |
| −20% Portland I/II | Mar. 21, 2023 | 8.30 | Apr. 1, 2023 | 10 | 34,657 | 2,765 |
| 1:3:2 Mix | Mar. 21, 2023 | 8.20 | Apr. 6, 2023 | 15 | 35,123 | 2,803 |
| | Mar. 21, 2023 | 8.30 | Apr. 6, 2023 | 15 | 34,622 | 2,763 |
| | Mar. 21, 2023 | 8.20 | Apr. 11, 2023 | 20 | 38,722 | 3,082 |
| | Mar. 21, 2023 | 8.25 | Apr. 11, 2023 | 20 | 40,441 | 3,219 |
| | Mar. 21, 2023 | 8.20 | Apr. 19, 2023 | 28 | 44,128 | 3,532 |
| | Mar. 21, 2023 | 8.25 | Apr. 19, 2023 | 28 | 47,910 | 3,816 |
| PB45 | Apr. 6, 2023 | 8.40 | Apr. 11, 2023 | 5 | 44,205 | 3,526 |
| T127 | Apr. 6, 2023 | 8.40 | Apr. 11, 2023 | 5 | 43,379 | 3,462 |
| 80 Cylinders | Apr. 6, 2023 | 8.45 | Apr. 11, 2023 | 5 | 45,843 | 3,658 |
| −20% Portland 1L | Apr. 6, 2023 | 8.45 | Apr. 11, 2023 | 5 | 47,096 | 3,758 |
| 1:3:2 Mix | Apr. 6, 2023 | 8.25 | Apr. 11, 2023 | 5 | 41,160 | 3,287 |
| | Apr. 6, 2023 | 8.25 | Apr. 11, 2023 | 5 | 40,330 | 3,210 |
| | Apr. 6, 2023 | 8.30 | Apr. 11, 2023 | 5 | 38,823 | 3,090 |
| | Apr. 6, 2023 | 8.35 | Apr. 11, 2023 | 5 | 42,330 | 3,374 |
| | Apr. 6, 2023 | 8.25 | Apr. 11, 2023 | 5 | 38,898 | 3,096 |
| | Apr. 6, 2023 | 8.30 | Apr. 11, 2023 | 5 | 42,529 | 3,385 |
| | Apr. 6, 2023 | 8.35 | Apr. 11, 2023 | 5 | 41,610 | 3,320 |
| | Apr. 6, 2023 | 8.40 | Apr. 11, 2023 | 5 | 40,412 | 3,224 |
| | Apr. 6, 2023 | 8.25 | Apr. 11, 2023 | 5 | 38,019 | 3,026 |
| | Apr. 6, 2023 | 8.35 | Apr. 11, 2023 | 5 | 42,023 | 3,352 |
| | Apr. 6, 2023 | 8.40 | Apr. 11, 2023 | 5 | 40,442 | 3,228 |
| | Apr. 6, 2023 | 8.40 | Apr. 11, 2023 | 5 | 40,539 | 3,235 |
| | Apr. 6, 2023 | 8.45 | Apr. 11, 2023 | 5 | 45,770 | 3,642 |
| | Apr. 6, 2023 | 8.35 | Apr. 16, 2023 | 10 | 53,341 | 4,248 |
| | Apr. 6, 2023 | 8.35 | Apr. 16, 2023 | 10 | 57,278 | 4,561 |
| | Apr. 6, 2023 | 8.45 | Apr. 16, 2023 | 10 | 57,800 | 4,600 |
| | Apr. 6, 2023 | 8.25 | Apr. 16, 2023 | 10 | 48,253 | 3,841 |
| | Apr. 6, 2023 | 8.30 | Apr. 16, 2023 | 10 | 48,792 | 3,885 |
| | Apr. 6, 2023 | 8.30 | Apr. 16, 2023 | 10 | 50,209 | 3,997 |
| | Apr. 6, 2023 | 8.35 | Apr. 16, 2023 | 10 | 51,007 | 4,066 |
| | Apr. 6, 2023 | 8.30 | Apr. 16, 2023 | 10 | 48,030 | 3,825 |
| | Apr. 6, 2023 | 8.30 | Apr. 16, 2023 | 10 | 48,773 | 3,887 |
| | Apr. 6, 2023 | 8.35 | Apr. 16, 2023 | 10 | 48,881 | 3,891 |
| | Apr. 6, 2023 | 8.35 | Apr. 16, 2023 | 10 | 47,613 | 3,792 |
| | Apr. 6, 2023 | 8.40 | Apr. 16, 2023 | 10 | 45,733 | 3,647 |
| | Apr. 6, 2023 | 8.40 | Apr. 16, 2023 | 10 | 52,693 | 4,194 |
| | Apr. 6, 2023 | 8.40 | Apr. 16, 2023 | 10 | 50,891 | 4,053 |
| | Apr. 6, 2023 | 8.45 | Apr. 16, 2023 | 10 | 50,175 | 3,993 |
| | Apr. 6, 2023 | 8.40 | Apr. 21, 2023 | 15 | 53,985 | 4,299 |
| | Apr. 6, 2023 | 8.40 | Apr. 21, 2023 | 15 | 56,528 | 4,502 |
| | Apr. 6, 2023 | 8.40 | Apr. 21, 2023 | 15 | 55,738 | 4,437 |
| | Apr. 6, 2023 | 8.45 | Apr. 21, 2023 | 15 | 56,321 | 4,494 |
| | Apr. 6, 2023 | 8.30 | Apr. 21, 2023 | 15 | 53,122 | 4,239 |
| | Apr. 6, 2023 | 8.30 | Apr. 21, 2023 | 15 | 51,490 | 4,108 |
| | Apr. 6, 2023 | 8.35 | Apr. 21, 2023 | 15 | 53,742 | 4,279 |
| | Apr. 6, 2023 | 8.40 | Apr. 21, 2023 | 15 | 50,077 | 3,986 |
| | Apr. 6, 2023 | 8.25 | Apr. 21, 2023 | 15 | 49,227 | 3,919 |
| | Apr. 6, 2023 | 8.25 | Apr. 21, 2023 | 15 | 47,855 | 3,818 |
| | Apr. 6, 2023 | 8.30 | Apr. 21, 2023 | 15 | 50,432 | 4,016 |
| | Apr. 6, 2023 | 8.30 | Apr. 21, 2023 | 15 | 49,009 | 3,911 |
| | Apr. 6, 2023 | 8.35 | Apr. 21, 2023 | 15 | 51,742 | 4,123 |
| | Apr. 6, 2023 | 8.35 | Apr. 21, 2023 | 15 | 52,582 | 4,186 |
| | Apr. 6, 2023 | 8.35 | Apr. 21, 2023 | 15 | 53,968 | 4,296 |
| | Apr. 6, 2023 | 8.40 | Apr. 21, 2023 | 15 | 50,297 | 4,008 |
| | Apr. 6, 2023 | 8.35 | Apr. 26, 2023 | 20 | 60,451 | 4,896 |
| | Apr. 6, 2023 | 8.40 | Apr. 26, 2023 | 20 | 58,154 | 4,633 |
| | Apr. 6, 2023 | 8.45 | Apr. 26, 2023 | 20 | 59,509 | 4,740 |
| | Apr. 6, 2023 | 8.45 | Apr. 26, 2023 | 20 | 60,695 | 4,833 |
| | Apr. 6, 2023 | 8.30 | Apr. 26, 2023 | 20 | 55,443 | 4,417 |
| | Apr. 6, 2023 | 8.30 | Apr. 26, 2023 | 20 | 57,970 | 4,613 |
| | Apr. 6, 2023 | 8.30 | Apr. 26, 2023 | 20 | 55,556 | 4,424 |
| | Apr. 6, 2023 | 8.35 | Apr. 26, 2023 | 20 | 56,213 | 4,475 |
| | Apr. 6, 2023 | 8.20 | Apr. 26, 2023 | 20 | 54,037 | 4,305 |
| | Apr. 6, 2023 | 8.30 | Apr. 26, 2023 | 20 | 53,911 | 4,295 |
| | Apr. 6, 2023 | 8.35 | Apr. 26, 2023 | 20 | 54,318 | 4,326 |
| | Apr. 6, 2023 | 8.40 | Apr. 26, 2023 | 20 | 53,635 | 4,273 |
| | Apr. 6, 2023 | 8.35 | Apr. 26, 2023 | 20 | 56,183 | 4,476 |
| | Apr. 6, 2023 | 8.40 | Apr. 26, 2023 | 20 | 54,504 | 4,346 |
| | Apr. 6, 2023 | 8.40 | Apr. 26, 2023 | 20 | 54,840 | 4,369 |
| | Apr. 6, 2023 | 8.40 | Apr. 26, 2023 | 20 | 55,542 | 4,426 |
| | Apr. 6, 2023 | 8.40 | May 4, 2023 | 28 | 66,105 | 5,260 |
| | Apr. 6, 2023 | 8.40 | May 4, 2023 | 28 | 69,631 | 5,539 |
| | Apr. 6, 2023 | 8.50 | May 4, 2023 | 28 | 71,063 | 5,655 |
| | Apr. 6, 2023 | 8.50 | May 4, 2023 | 28 | 70,391 | 5,601 |
| | Apr. 6, 2023 | 8.30 | May 4, 2023 | 28 | 56,769 | 4,517 |
| | Apr. 6, 2023 | 8.35 | May 4, 2023 | 28 | 58,501 | 4,654 |
| | Apr. 6, 2023 | 8.40 | May 4, 2023 | 28 | 60,110 | 4,782 |
| | Apr. 6, 2023 | 8.40 | May 4, 2023 | 28 | 59,344 | 4,722 |
| | Apr. 6, 2023 | 8.30 | May 4, 2023 | 28 | 60,201 | 4,807 |
| | Apr. 6, 2023 | 8.30 | May 4, 2023 | 28 | 58,673 | 4,685 |
| | Apr. 6, 2023 | 8.35 | May 4, 2023 | 28 | 59,475 | 4,749 |
| | Apr. 6, 2023 | 8.35 | May 4, 2023 | 28 | 56,868 | 4,525 |
| | Apr. 6, 2023 | 8.30 | May 4, 2023 | 28 | 61,381 | 4,884 |
| | Apr. 6, 2023 | 8.35 | May 4, 2023 | 28 | 58,773 | 4,677 |
| | Apr. 6, 2023 | 8.40 | May 4, 2023 | 28 | 61,724 | 4,911 |
| | Apr. 6, 2023 | 8.45 | May 4, 2023 | 28 | 60,802 | 4,838 |
| PB45 | Apr. 14, 2023 | 8.35 | Apr. 19, 2023 | 5 | 33,890 | 2,701 |
| T129 | Apr. 14, 2023 | 8.40 | Apr. 19, 2023 | 5 | 32,096 | 2,555 |
| 60 Cylinders | Apr. 14, 2023 | 8.40 | Apr. 19, 2023 | 5 | 32,712 | 2,604 |
| −20% Portland 1L | Apr. 14, 2023 | 8.40 | Apr. 19, 2023 | 5 | 31,480 | 2,510 |
| 1:3:2 Mix | Apr. 14, 2023 | 8.45 | Apr. 19, 2023 | 5 | 32,660 | 2,600 |
| | Apr. 14, 2023 | 8.30 | Apr. 19, 2023 | 5 | 31,910 | 2,540 |
| | Apr. 14, 2023 | 8.30 | Apr. 19, 2023 | 5 | 39,107 | 3,112 |
| | Apr. 14, 2023 | 8.35 | Apr. 19, 2023 | 5 | 40,239 | 3,204 |
| | Apr. 14, 2023 | 8.40 | Apr. 19, 2023 | 5 | 36,985 | 2,943 |
| | Apr. 14, 2023 | 8.40 | Apr. 19, 2023 | 5 | 40,790 | 3,250 |
| | Apr. 14, 2023 | 8.35 | Apr. 19, 2023 | 5 | 36,350 | 2,890 |
| | Apr. 14, 2023 | 8.40 | Apr. 19, 2023 | 5 | 40,390 | 3,210 |
| | Apr. 14, 2023 | 8.35 | Apr. 24, 2023 | 10 | 36,363 | 2,896 |
| | Apr. 14, 2023 | 8.40 | Apr. 24, 2023 | 10 | 36,351 | 2,894 |
| | Apr. 14, 2023 | 8.40 | Apr. 24, 2023 | 10 | 35,511 | 2,828 |
| | Apr. 14, 2023 | 8.30 | Apr. 24, 2023 | 10 | 36,100 | 2,870 |
| | Apr. 14, 2023 | 8.30 | Apr. 24, 2023 | 10 | 38,340 | 3,050 |
| | Apr. 14, 2023 | 8.30 | Apr. 24, 2023 | 10 | 39,460 | 3,140 |
| | Apr. 14, 2023 | 8.30 | Apr. 24, 2023 | 10 | 38,066 | 3,031 |
| | Apr. 14, 2023 | 8.30 | Apr. 24, 2023 | 10 | 41,242 | 3,284 |
| | Apr. 14, 2023 | 8.35 | Apr. 24, 2023 | 10 | 43,420 | 3,458 |
| | Apr. 14, 2023 | 8.40 | Apr. 24, 2023 | 10 | 42,570 | 3,390 |
| | Apr. 14, 2023 | 8.40 | Apr. 24, 2023 | 10 | 42,670 | 3,390 |
| | Apr. 14, 2023 | 8.40 | Apr. 24, 2023 | 10 | 42,210 | 3,360 |
| | Apr. 14, 2023 | 8.35 | Apr. 29, 2023 | 15 | 44,093 | 3,507 |
| | Apr. 14, 2023 | 8.40 | Apr. 29, 2023 | 15 | 43,971 | 3,499 |
| | Apr. 14, 2023 | 8.40 | Apr. 29, 2023 | 15 | 44,143 | 3,511 |
| | Apr. 14, 2023 | 8.35 | Apr. 29, 2023 | 15 | 42,550 | 3,390 |
| | Apr. 14, 2023 | 8.35 | Apr. 29, 2023 | 15 | 40,570 | 3,230 |
| | Apr. 14, 2023 | 8.35 | Apr. 29, 2023 | 15 | 41,910 | 3,340 |
| | Apr. 14, 2023 | 8.35 | Apr. 29, 2023 | 15 | 43,576 | 3,468 |
| | Apr. 14, 2023 | 8.40 | Apr. 29, 2023 | 15 | 43,809 | 3,485 |
| | Apr. 14, 2023 | 8.40 | Apr. 29, 2023 | 15 | 43,716 | 3,477 |
| | Apr. 14, 2023 | 8.35 | Apr. 29, 2023 | 15 | 43,640 | 3,470 |
| | Apr. 14, 2023 | 8.35 | Apr. 29, 2023 | 15 | 44,720 | 3,560 |
| | Apr. 14, 2023 | 8.55 | Apr. 29, 2023 | 15 | 44,350 | 3,530 |
| | Apr. 14, 2023 | 8.25 | May 4, 2023 | 20 | 47,455 | 3,776 |
| | Apr. 14, 2023 | 8.35 | May 4, 2023 | 20 | 47,812 | 3,805 |
| | Apr. 14, 2023 | 8.40 | May 4, 2023 | 20 | 48,870 | 3,888 |
| | Apr. 14, 2023 | 8.40 | May 4, 2023 | 20 | 46,400 | 3,690 |
| | Apr. 14, 2023 | 8.40 | May 4, 2023 | 20 | 47,630 | 3,790 |
| | Apr. 14, 2023 | 8.40 | May 4, 2023 | 20 | 48,620 | 3,870 |
| | Apr. 14, 2023 | 8.35 | May 4, 2023 | 20 | 50,119 | 3,988 |
| | Apr. 14, 2023 | 8.35 | May 4, 2023 | 20 | 45,995 | 3,659 |
| | Apr. 14, 2023 | 8.40 | May 4, 2023 | 20 | 49,038 | 3,902 |
| | Apr. 14, 2023 | 8.30 | May 4, 2023 | 20 | 52,280 | 4,160 |
| | Apr. 14, 2023 | 8.35 | May 4, 2023 | 20 | 48,460 | 3,860 |
| | Apr. 14, 2023 | 8.35 | May 4, 2023 | 20 | 47,010 | 3,740 |
| | Apr. 14, 2023 | 8.30 | May 12, 2023 | 28 | 51,486 | 4,095 |
| | Apr. 14, 2023 | 8.35 | May 12, 2023 | 28 | 48,824 | 3,885 |
| | Apr. 14, 2023 | 8.35 | May 12, 2023 | 28 | 48,775 | 3,877 |
| | Apr. 14, 2023 | 8.35 | May 12, 2023 | 28 | 49,481 | 3,951 |
| | Apr. 14, 2023 | 8.35 | May 12, 2023 | 28 | 48,880 | 3,890 |
| | Apr. 14, 2023 | 8.35 | May 12, 2023 | 28 | 49,980 | 3,980 |
| | Apr. 14, 2023 | 8.30 | May 12, 2023 | 28 | 49,264 | 3,911 |
| | Apr. 14, 2023 | 8.30 | May 12, 2023 | 28 | 50,609 | 4,026 |
| | Apr. 14, 2023 | 8.30 | May 12, 2023 | 28 | 52,240 | 4,155 |
| | Apr. 14, 2023 | 8.30 | May 12, 2023 | 28 | 50,990 | 4,060 |
| | Apr. 14, 2023 | 8.35 | May 12, 2023 | 28 | 50,100 | 3,990 |
| | Apr. 14, 2023 | 8.40 | May 12, 2023 | 28 | 52,660 | 4,190 |
| PB45 | Apr. 27, 2023 | 8.40 | May 2, 2023 | 5 | 46,852 | 3,727 |
| T132 | Apr. 27, 2023 | 8.45 | May 2, 2023 | 5 | 41,442 | 3,294 |
| 80 Cylinders | Apr. 27, 2023 | 8.45 | May 2, 2023 | 5 | 40,108 | 3,188 |
| −20% Portland 1L | Apr. 27, 2023 | 8.45 | May 2, 2023 | 5 | 50,126 | 3,986 |
| 1:3:2 Mix | Apr. 27, 2023 | 8.45 | May 2, 2023 | 5 | 44,941 | 3,573 |
| | Apr. 27, 2023 | 8.50 | May 2, 2023 | 5 | 51,521 | 4,099 |
| | Apr. 27, 2023 | 8.50 | May 2, 2023 | 5 | 47,655 | 3,767 |
| | Apr. 27, 2023 | 8.50 | May 2, 2023 | 5 | 47,415 | 3,772 |
| | Apr. 27, 2023 | 8.35 | May 2, 2023 | 5 | 47,639 | 3,790 |
| | Apr. 27, 2023 | 8.35 | May 2, 2023 | 5 | 46,451 | 3,695 |
| | Apr. 27, 2023 | 8.40 | May 2, 2023 | 5 | 49,052 | 3,901 |
| | Apr. 27, 2023 | 8.40 | May 2, 2023 | 5 | 46,090 | 3,666 |
| | Apr. 27, 2023 | 8.40 | May 2, 2023 | 5 | 48,655 | 3,872 |
| | Apr. 27, 2023 | 8.45 | May 2, 2023 | 5 | 51,383 | 4,089 |
| | Apr. 27, 2023 | 8.45 | May 2, 2023 | 5 | 52,271 | 4,160 |
| | Apr. 27, 2023 | 8.45 | May 2, 2023 | 5 | 47,833 | 3,802 |
| | Apr. 27, 2023 | 8.40 | May 7, 2023 | 10 | 53,436 | 4,252 |
| | Apr. 27, 2023 | 8.40 | May 7, 2023 | 10 | 55,504 | 4,413 |
| | Apr. 27, 2023 | 8.45 | May 7, 2023 | 10 | 56,361 | 4,485 |
| | Apr. 27, 2023 | 8.50 | May 7, 2023 | 10 | 56,990 | 4,535 |
| | Apr. 27, 2023 | 8.50 | May 7, 2023 | 10 | 52,520 | 4,180 |
| | Apr. 27, 2023 | 8.50 | May 7, 2023 | 10 | 52,160 | 4,151 |
| | Apr. 27, 2023 | 8.50 | May 7, 2023 | 10 | 54,378 | 4,323 |
| | Apr. 27, 2023 | 8.50 | May 7, 2023 | 10 | 55,332 | 4,402 |
| | Apr. 27, 2023 | 8.30 | May 7, 2023 | 10 | 54,399 | 4,325 |
| | Apr. 27, 2023 | 8.30 | May 7, 2023 | 10 | 53,197 | 4,233 |
| | Apr. 27, 2023 | 8.35 | May 7, 2023 | 10 | 49,604 | 3,945 |
| | Apr. 27, 2023 | 8.35 | May 7, 2023 | 10 | 53,655 | 4,267 |
| | Apr. 27, 2023 | 8.40 | May 7, 2023 | 10 | 52,208 | 4,151 |
| | Apr. 27, 2023 | 8.45 | May 7, 2023 | 10 | 55,612 | 4,425 |
| | Apr. 27, 2023 | 8.45 | May 7, 2023 | 10 | 54,986 | 4,376 |
| | Apr. 27, 2023 | 8.45 | May 7, 2023 | 10 | 56,025 | 4,458 |
| | Apr. 27, 2023 | 8.45 | May 12, 2023 | 15 | 56,905 | 4,526 |
| | Apr. 27, 2023 | 8.45 | May 12, 2023 | 15 | 61,792 | 4,916 |
| | Apr. 27, 2023 | 8.45 | May 12, 2023 | 15 | 58,541 | 4,655 |
| | Apr. 27, 2023 | 8.50 | May 12, 2023 | 15 | 57,766 | 4,596 |
| | Apr. 27, 2023 | 8.50 | May 12, 2023 | 15 | 63,128 | 5,021 |
| | Apr. 27, 2023 | 8.50 | May 12, 2023 | 15 | 59,581 | 4,740 |
| | Apr. 27, 2023 | 8.50 | May 12, 2023 | 15 | 58,139 | 4,625 |
| | Apr. 27, 2023 | 8.50 | May 12, 2023 | 15 | 59,565 | 4,737 |
| | Apr. 27, 2023 | 8.30 | May 12, 2023 | 15 | 56,565 | 4,499 |
| | Apr. 27, 2023 | 8.30 | May 12, 2023 | 15 | 57,083 | 4,542 |
| | Apr. 27, 2023 | 8.30 | May 12, 2023 | 15 | 56,804 | 4,520 |
| | Apr. 27, 2023 | 8.35 | May 12, 2023 | 15 | 61,217 | 4,871 |
| | Apr. 27, 2023 | 8.35 | May 12, 2023 | 15 | 56,724 | 4,514 |
| | Apr. 27, 2023 | 8.40 | May 12, 2023 | 15 | 60,287 | 4,795 |
| | Apr. 27, 2023 | 8.40 | May 12, 2023 | 15 | 56,795 | 4,518 |
| | Apr. 27, 2023 | 8.40 | May 12, 2023 | 15 | 62,203 | 4,949 |
| | Apr. 27, 2023 | 8.40 | May 17, 2023 | 20 | 60,218 | 4,789 |
| | Apr. 27, 2023 | 8.40 | May 17, 2023 | 20 | 60,053 | 4,777 |
| | Apr. 27, 2023 | 8.40 | May 17, 2023 | 20 | 59,998 | 4,772 |
| | Apr. 27, 2023 | 8.45 | May 17, 2023 | 20 | 62,475 | 4,971 |
| | Apr. 27, 2023 | 8.50 | May 17, 2023 | 20 | 63,290 | 5,035 |
| | Apr. 27, 2023 | 8.50 | May 17, 2023 | 20 | 63,013 | 5,011 |
| | Apr. 27, 2023 | 8.50 | May 17, 2023 | 20 | 64,297 | 5,113 |
| | Apr. 27, 2023 | 8.50 | May 17, 2023 | 20 | 62,549 | 4,974 |
| | Apr. 27, 2023 | 8.40 | May 17, 2023 | 20 | 60,135 | 4,782 |
| | Apr. 27, 2023 | 8.40 | May 17, 2023 | 20 | 58,198 | 4,628 |
| | Apr. 27, 2023 | 8.40 | May 17, 2023 | 20 | 58,665 | 4,667 |
| | Apr. 27, 2023 | 8.40 | May 17, 2023 | 20 | 57,068 | 4,540 |
| | Apr. 27, 2023 | 8.40 | May 17, 2023 | 20 | 56,907 | 4,528 |
| | Apr. 27, 2023 | 8.40 | May 17, 2023 | 20 | 57,527 | 4,577 |
| | Apr. 27, 2023 | 8.40 | May 17, 2023 | 20 | 58,990 | 4,691 |
| | Apr. 27, 2023 | 8.40 | May 17, 2023 | 20 | 58,839 | 4,679 |
| | Apr. 27, 2023 | 8.35 | May 25, 2023 | 28 | 62,026 | 4,927 |
| | Apr. 27, 2023 | 8.40 | May 25, 2023 | 28 | 64,563 | 5,137 |
| | Apr. 27, 2023 | 8.40 | May 25, 2023 | 28 | 60,455 | 4,808 |
| | Apr. 27, 2023 | 8.45 | May 25, 2023 | 28 | 64,306 | 5,115 |
| | Apr. 27, 2023 | 8.45 | May 25, 2023 | 28 | 62,459 | 4,937 |
| | Apr. 27, 2023 | 8.50 | May 25, 2023 | 28 | 64,227 | 5,111 |
| | Apr. 27, 2023 | 8.50 | May 25, 2023 | 28 | 63,331 | 5,038 |
| | Apr. 27, 2023 | 8.35 | May 25, 2023 | 28 | 59,963 | 4,770 |
| | Apr. 27, 2023 | 8.35 | May 25, 2023 | 28 | 58,766 | 4,675 |
| | Apr. 27, 2023 | 8.40 | May 25, 2023 | 28 | 62,418 | 4,984 |
| | Apr. 27, 2023 | 8.40 | May 25, 2023 | 28 | 62,125 | 4,942 |
| | Apr. 27, 2023 | 8.40 | May 25, 2023 | 28 | 62,100 | 4,941 |
| | Apr. 27, 2023 | 8.45 | May 25, 2023 | 28 | 64,805 | 5,155 |
| | Apr. 27, 2023 | 8.45 | May 25, 2023 | 28 | 58,959 | 4,692 |

Comparative to Table 38 for improved results despite removing 20% of the binder.

In Table 42, “PB45” is Portland cement, sand, aggregate and water, and binder reducing agent, tested in duplicate, triplicate, etc., as the case may be (“PB45” is sample 1 and “T121” is sample 2 from a pour). Per 10 4″×8″ Cylinders: 9.0 lbs. of Portland IL (PLC) cement, 41 pounds of medium to large aggregate (rock), 27 lbs. of fine aggregate (sand), and 8.34 lbs. of water and 0.88 lbs. of binder reducing formulation. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens.

TABLE 42

| Formula | Pour Date | Weight | Test Date | Cure Days | LBF | PSI |
|---|---|---|---|---|---|---|
| PB45 | Mar. 20, 2023 | 8.00 | Mar. 25, 2023 | 5 | 39,416 | 3,145 |
| T121 | Mar. 20, 2023 | 8.15 | Mar. 25, 2023 | 5 | 38,740 | 3,090 |
| 100 Cylinders | Mar. 20, 2023 | 8.15 | Mar. 25, 2023 | 5 | 39,185 | 3,127 |
| −25% Portland 1L | Mar. 20, 2023 | 8.15 | Mar. 25, 2023 | 5 | 40,578 | 3,238 |
| 1:3:2 Mix | Mar. 20, 2023 | 8.15 | Mar. 25, 2023 | 5 | 37,479 | 2,991 |
| | Mar. 20, 2023 | 8.15 | Mar. 25, 2023 | 5 | 34,221 | 2,726 |
| | Mar. 20, 2023 | 8.15 | Mar. 25, 2023 | 5 | 40,660 | 3,245 |
| | Mar. 20, 2023 | 8.15 | Mar. 25, 2023 | 5 | 39,737 | 3,170 |
| | Mar. 20, 2023 | 8.15 | Mar. 25, 2023 | 5 | 34,016 | 2,715 |
| | Mar. 20, 2023 | 8.20 | Mar. 25, 2023 | 5 | 39,468 | 3,150 |
| | Mar. 20, 2023 | 8.20 | Mar. 25, 2023 | 5 | 36,698 | 2,924 |
| | Mar. 20, 2023 | 8.20 | Mar. 25, 2023 | 5 | 38,773 | 3,094 |
| | Mar. 20, 2023 | 8.20 | Mar. 25, 2023 | 5 | 41,831 | 3,338 |
| | Mar. 20, 2023 | 8.20 | Mar. 25, 2023 | 5 | 35,233 | 2,810 |
| | Mar. 20, 2023 | 8.20 | Mar. 25, 2023 | 5 | 42,321 | 3,377 |
| | Mar. 20, 2023 | 8.20 | Mar. 25, 2023 | 5 | 39,329 | 3,139 |
| | Mar. 20, 2023 | 8.20 | Mar. 25, 2023 | 5 | 37,420 | 2,986 |
| | Mar. 20, 2023 | 8.25 | Mar. 25, 2023 | 5 | 34,995 | 2,791 |
| | Mar. 20, 2023 | 8.25 | Mar. 25, 2023 | 5 | 44,559 | 3,554 |
| | Mar. 20, 2023 | 8.30 | Mar. 25, 2023 | 5 | 36,311 | 2,896 |
| | Mar. 20, 2023 | 8.20 | Mar. 30, 2023 | 10 | 41,099 | 3,279 |
| | Mar. 20, 2023 | 8.25 | Mar. 30, 2023 | 10 | 44,242 | 3,529 |
| | Mar. 20, 2023 | 8.10 | Mar. 30, 2023 | 10 | 43,596 | 3,475 |
| | Mar. 20, 2023 | 8.15 | Mar. 30, 2023 | 10 | 43,646 | 3,484 |
| | Mar. 20, 2023 | 8.15 | Mar. 30, 2023 | 10 | 42,120 | 3,352 |
| | Mar. 20, 2023 | 8.10 | Mar. 30, 2023 | 10 | 37,907 | 3,026 |
| | Mar. 20, 2023 | 8.15 | Mar. 30, 2023 | 10 | 39,739 | 3,171 |
| | Mar. 20, 2023 | 8.15 | Mar. 30, 2023 | 10 | 42,094 | 3,354 |
| | Mar. 20, 2023 | 8.25 | Mar. 30, 2023 | 10 | 40,696 | 3,247 |
| | Mar. 20, 2023 | 8.15 | Mar. 30, 2023 | 10 | 43,275 | 3,452 |
| | Mar. 20, 2023 | 8.20 | Mar. 30, 2023 | 10 | 41,302 | 3,291 |
| | Mar. 20, 2023 | 8.20 | Mar. 30, 2023 | 10 | 41,833 | 3,340 |
| | Mar. 20, 2023 | 8.15 | Mar. 30, 2023 | 10 | 42,854 | 3,414 |
| | Mar. 20, 2023 | 8.10 | Mar. 30, 2023 | 10 | 41,300 | 3,297 |
| | Mar. 20, 2023 | 8.15 | Mar. 30, 2023 | 10 | 41,312 | 3,301 |
| | Mar. 20, 2023 | 8.10 | Mar. 30, 2023 | 10 | 42,333 | 3,381 |
| | Mar. 20, 2023 | 8.15 | Mar. 30, 2023 | 10 | 41,236 | 3,292 |
| | Mar. 20, 2023 | 8.05 | Mar. 30, 2023 | 10 | 40,485 | 3,229 |
| | Mar. 20, 2023 | 8.20 | Mar. 30, 2023 | 10 | 42,830 | 3,389 |
| | Mar. 20, 2023 | 8.20 | Mar. 30, 2023 | 10 | 38,372 | 3,098 |
| | Mar. 20, 2023 | 8.10 | Apr. 4, 2023 | 15 | 43,529 | 3,473 |
| | Mar. 20, 2023 | 8.10 | Apr. 4, 2023 | 15 | 53,506 | 3,472 |
| | Mar. 20, 2023 | 8.15 | Apr. 4, 2023 | 15 | 47,378 | 3,781 |
| | Mar. 20, 2023 | 8.15 | Apr. 4, 2023 | 15 | 46,832 | 3,736 |
| | Mar. 20, 2023 | 8.15 | Apr. 4, 2023 | 15 | 43,869 | 3,501 |
| | Mar. 20, 2023 | 8.15 | Apr. 4, 2023 | 15 | 40,724 | 3,250 |
| | Mar. 20, 2023 | 8.15 | Apr. 4, 2023 | 15 | 36,852 | 2,941 |
| | Mar. 20, 2023 | 8.15 | Apr. 4, 2023 | 15 | 43,228 | 3,447 |
| | Mar. 20, 2023 | 8.15 | Apr. 4, 2023 | 15 | 41,428 | 3,307 |
| | Mar. 20, 2023 | 8.15 | Apr. 4, 2023 | 15 | 44,946 | 3,585 |
| | Mar. 20, 2023 | 8.20 | Apr. 4, 2023 | 15 | 39,048 | 3,117 |
| | Mar. 20, 2023 | 8.20 | Apr. 4, 2023 | 15 | 42,336 | 3,375 |
| | Mar. 20, 2023 | 8.20 | Apr. 4, 2023 | 15 | 41,431 | 3,306 |
| | Mar. 20, 2023 | 8.20 | Apr. 4, 2023 | 15 | 43,651 | 3,479 |
| | Mar. 20, 2023 | 8.20 | Apr. 4, 2023 | 15 | 38,744 | 3,092 |
| | Mar. 20, 2023 | 8.20 | Apr. 4, 2023 | 15 | 42,280 | 3,369 |
| | Mar. 20, 2023 | 8.20 | Apr. 4, 2023 | 15 | 46,613 | 3,715 |
| | Mar. 20, 2023 | 8.25 | Apr. 4, 2023 | 15 | 43,626 | 3,480 |
| | Mar. 20, 2023 | 8.30 | Apr. 4, 2023 | 15 | 48,938 | 3,902 |
| | Mar. 20, 2023 | 8.30 | Apr. 4, 2023 | 15 | 41,350 | 3,300 |
| | Mar. 20, 2023 | 8.10 | Apr. 9, 2023 | 20 | 45,366 | 3,611 |
| | Mar. 20, 2023 | 8.10 | Apr. 9, 2023 | 20 | 35,654 | 2,838 |
| | Mar. 20, 2023 | 8.15 | Apr. 9, 2023 | 20 | 35,769 | 2,847 |
| | Mar. 20, 2023 | 8.15 | Apr. 9, 2023 | 20 | 45,561 | 3,634 |
| | Mar. 20, 2023 | 8.15 | Apr. 9, 2023 | 20 | 37,767 | 3,006 |
| | Mar. 20, 2023 | 8.15 | Apr. 9, 2023 | 20 | 42,058 | 3,357 |
| | Mar. 20, 2023 | 8.15 | Apr. 9, 2023 | 20 | 46,507 | 3,710 |
| | Mar. 20, 2023 | 8.15 | Apr. 9, 2023 | 20 | 41,845 | 3,338 |
| | Mar. 20, 2023 | 8.20 | Apr. 9, 2023 | 20 | 48,626 | 3,877 |
| | Mar. 20, 2023 | 8.20 | Apr. 9, 2023 | 20 | 37,552 | 2,989 |
| | Mar. 20, 2023 | 8.20 | Apr. 9, 2023 | 20 | 37,214 | 2,962 |
| | Mar. 20, 2023 | 8.20 | Apr. 9, 2023 | 20 | 41,061 | 3,272 |
| | Mar. 20, 2023 | 8.20 | Apr. 9, 2023 | 20 | 37,177 | 2,959 |
| | Mar. 20, 2023 | 8.20 | Apr. 9, 2023 | 20 | 44,628 | 3,561 |
| | Mar. 20, 2023 | 8.20 | Apr. 9, 2023 | 20 | 45,195 | 3,609 |
| | Mar. 20, 2023 | 8.25 | Apr. 9, 2023 | 20 | 38,612 | 3,079 |
| | Mar. 20, 2023 | 8.35 | Apr. 9, 2023 | 20 | 45,156 | 3,603 |
| | Mar. 20, 2023 | 8.15 | Apr. 9, 2023 | 20 | 48,507 | 3,863 |
| | Mar. 20, 2023 | 8.20 | Apr. 9, 2023 | 20 | 49,949 | 3,977 |
| | Mar. 20, 2023 | 8.20 | Apr. 9, 2023 | 20 | 49,361 | 3,929 |
| | Mar. 20, 2023 | 8.00 | Apr. 17, 2023 | 28 | 43,591 | 3,471 |
| | Mar. 20, 2023 | 8.05 | Apr. 17, 2023 | 28 | 43,316 | 3,449 |
| | Mar. 20, 2023 | 8.10 | Apr. 17, 2023 | 28 | 42,977 | 3,422 |
| | Mar. 20, 2023 | 8.10 | Apr. 17, 2023 | 28 | 45,074 | 3,589 |
| | Mar. 20, 2023 | 8.10 | Apr. 17, 2023 | 28 | 48,792 | 3,896 |
| | Mar. 20, 2023 | 8.10 | Apr. 17, 2023 | 28 | 47,094 | 3,750 |
| | Mar. 20, 2023 | 8.15 | Apr. 17, 2023 | 28 | 49,602 | 3,949 |
| | Mar. 20, 2023 | 8.15 | Apr. 17, 2023 | 28 | 51,028 | 4,065 |
| | Mar. 20, 2023 | 8.15 | Apr. 17, 2023 | 28 | 47,916 | 3,826 |
| | Mar. 20, 2023 | 8.15 | Apr. 17, 2023 | 28 | 47,615 | 3,802 |
| | Mar. 20, 2023 | 8.15 | Apr. 17, 2023 | 28 | 44,574 | 3,548 |
| | Mar. 20, 2023 | 8.20 | Apr. 17, 2023 | 28 | 45,674 | 3,635 |
| | Mar. 20, 2023 | 8.20 | Apr. 17, 2023 | 28 | 51,851 | 4,126 |
| | Mar. 20, 2023 | 8.20 | Apr. 17, 2023 | 28 | 48,675 | 3,874 |
| | Mar. 20, 2023 | 8.20 | Apr. 17, 2023 | 28 | 55,532 | 4,420 |
| | Mar. 20, 2023 | 8.20 | Apr. 17, 2023 | 28 | 51,377 | 4,089 |
| | Mar. 20, 2023 | 8.20 | Apr. 17, 2023 | 28 | 49,919 | 3,986 |
| | Mar. 20, 2023 | 8.20 | Apr. 17, 2023 | 28 | 45,824 | 3,659 |
| | Mar. 20, 2023 | 8.25 | Apr. 17, 2023 | 28 | 53,405 | 4,252 |
| | Mar. 20, 2023 | 8.25 | Apr. 17, 2023 | 28 | 52,464 | 4,175 |

Comparative to Table 38 for improved results despite removing 25% of the binder.

In Table 43, “PB45” is Portland cement, sand, aggregate and water, and binder reducing agent, tested in duplicate, triplicate, etc., as the case may be (“PB45” is sample 1 and “T95” is sample 2 from a pour, etc.). Per 10 4″×8″ Cylinders: 8.4 lbs. of Portland IL (PLC) cement, 41 pounds of medium to large aggregate (rock), 27 lbs. of fine aggregate (sand), and 8.34 lbs. of water and 0.88 lbs. of binder reducing formulation. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens.

TABLE 43

| Formula | Pour Date | Weight (lb) | Test Date | Cure Days | LBF | PSI |
|---|---|---|---|---|---|---|
| PB45 | Dec. 17, 2022 | 8.35 | Dec. 22, 2022 | 5 | 38,363 | 3,059 |
| T95 | Dec. 17, 2022 | 8.35 | Dec. 22, 2022 | 5 | 38,653 | 3,084 |
| 19 Cylinders | Dec. 17, 2022 | 8.45 | Dec. 22, 2022 | 5 | 38,780 | 3,096 |
| −30% Portland 1L | Dec. 17, 2022 | 8.45 | Dec. 22, 2022 | 5 | 37,403 | 2,984 |
| 1:3:2 Mix | Dec. 17, 2022 | 8.35 | Dec. 27, 2022 | 10 | 47,106 | 3,759 |
| | Dec. 17, 2022 | 8.35 | Dec. 27, 2022 | 10 | 46,992 | 3,750 |
| | Dec. 17, 2022 | 8.45 | Dec. 27, 2022 | 10 | 50,911 | 4,060 |
| | Dec. 17, 2022 | 8.45 | Dec. 27, 2022 | 10 | 49,690 | 3,962 |
| | Dec. 17, 2022 | 8.35 | Jan. 2, 2023 | 15 | 47,695 | 3,805 |
| | Dec. 17, 2022 | 8.35 | Jan. 2, 2023 | 15 | 50,325 | 4,014 |
| | Dec. 17, 2022 | 8.45 | Jan. 2, 2023 | 15 | 47,739 | 3,810 |
| | Dec. 17, 2022 | 8.45 | Jan. 2, 2023 | 15 | 46,726 | 3,728 |
| | Dec. 17, 2022 | 8.35 | Jan. 6, 2023 | 20 | 51,292 | 4,092 |
| | Dec. 17, 2022 | 8.35 | Jan. 6, 2023 | 20 | 51,161 | 4,080 |
| | Dec. 17, 2022 | 8.40 | Jan. 6, 2023 | 20 | 48,910 | 3,898 |
| | Dec. 17, 2022 | 8.45 | Jan. 6, 2023 | 20 | 48,443 | 3,863 |
| | Dec. 17, 2022 | 8.30 | Jan. 13, 2023 | 28 | 52,401 | 4,180 |
| | Dec. 17, 2022 | 8.30 | Jan. 13, 2023 | 28 | 54,206 | 4,324 |
| | Dec. 17, 2022 | 8.50 | Jan. 13, 2023 | 28 | 53,479 | 4,266 |
| PB45 | Jan. 13, 2023 | 8.25 | Jan. 18, 2023 | 5 | 31,240 | 2,493 |
| T100 | Jan. 13, 2023 | 8.35 | Jan. 18, 2023 | 5 | 32,343 | 2,580 |
| 20 Cylinders | Jan. 13, 2023 | 8.35 | Jan. 18, 2023 | 5 | 33,065 | 2,637 |
| −30% Portland 1L | Jan. 13, 2023 | 8.50 | Jan. 18, 2023 | 5 | 35,131 | 2,804 |
| 1:3:2 Mix | Jan. 13, 2023 | 8.30 | Jan. 23, 2023 | 10 | 43,044 | 3,435 |
| | Jan. 13, 2023 | 8.40 | Jan. 23, 2023 | 10 | 42,612 | 3,402 |
| | Jan. 13, 2023 | 8.40 | Jan. 23, 2023 | 10 | 41,737 | 3,333 |
| | Jan. 13, 2023 | 8.45 | Jan. 23, 2023 | 10 | 40,527 | 3,234 |
| | Jan. 13, 2023 | 8.30 | Jan. 28, 2023 | 15 | 45,370 | 3,620 |
| | Jan. 13, 2023 | 8.35 | Jan. 28, 2023 | 15 | 46,181 | 3,684 |
| | Jan. 13, 2023 | 8.50 | Jan. 28, 2023 | 15 | 34,994 | 2,791 |
| | Jan. 13, 2023 | 8.50 | Jan. 28, 2023 | 15 | 41,198 | 3,288 |
| | Jan. 13, 2023 | 8.30 | Feb. 2, 2023 | 20 | 46,534 | 3,714 |
| | Jan. 13, 2023 | 8.35 | Feb. 2, 2023 | 20 | 46,918 | 3,742 |
| | Jan. 13, 2023 | 8.45 | Feb. 2, 2023 | 20 | 46,927 | 3,746 |
| | Jan. 13, 2023 | 8.45 | Feb. 2, 2023 | 20 | 45,573 | 3,634 |
| | Jan. 13, 2023 | 8.25 | Feb. 10, 2023 | 28 | 48,323 | 3,856 |
| | Jan. 13, 2023 | 8.35 | Feb. 10, 2023 | 28 | 47,791 | 3,813 |
| | Jan. 13, 2023 | 8.40 | Feb. 10, 2023 | 28 | 50,251 | 4,012 |
| PB45 | Jan. 26, 2023 | 6.05 | Jan. 31, 2023 | 5 | 42,491 | 3,395 |
| T106 | Jan. 26, 2023 | 6.10 | Jan. 31, 2023 | 5 | 44,169 | 3,518 |
| 20 Cylinders | Jan. 26, 2023 | 6.10 | Jan. 31, 2023 | 5 | 42,675 | 3,410 |
| −30% Portland 1L | Jan. 26, 2023 | 6.10 | Jan. 31, 2023 | 5 | 43,554 | 3,471 |
| 1:3:2 Mix | Jan. 26, 2023 | 5.85 | Feb. 6, 2023 | 10 | 52,796 | 4,213 |
| | Jan. 26, 2023 | 5.85 | Feb. 6, 2023 | 10 | 55,511 | 4,434 |
| | Jan. 26, 2023 | 5.85 | Feb. 6, 2023 | 10 | 54,153 | 4,323 |
| | Jan. 26, 2023 | 5.85 | Feb. 6, 2023 | 10 | 54,308 | 4,337 |
| | Jan. 26, 2023 | 5.95 | Feb. 10, 2023 | 15 | 51,317 | 4,095 |
| | Jan. 26, 2023 | 5.95 | Feb. 10, 2023 | 15 | 53,836 | 4,293 |
| | Jan. 26, 2023 | 5.95 | Feb. 10, 2023 | 15 | 52,120 | 4,158 |
| | Jan. 26, 2023 | 5.95 | Feb. 10, 2023 | 15 | 53,105 | 4,237 |
| | Jan. 26, 2023 | 5.75 | Feb. 15, 2023 | 20 | 55,732 | 4,449 |
| | Jan. 26, 2023 | 5.75 | Feb. 15, 2023 | 20 | 57,619 | 4,598 |
| | Jan. 26, 2023 | 5.75 | Feb. 15, 2023 | 20 | 57,668 | 4,605 |
| | Jan. 26, 2023 | 5.75 | Feb. 15, 2023 | 20 | 56,747 | 4,520 |
| | Jan. 26, 2023 | 5.75 | Feb. 23, 2023 | 28 | 64,462 | 5,147 |
| | Jan. 26, 2023 | 5.75 | Feb. 23, 2023 | 28 | 64,148 | 5,122 |
| | Jan. 26, 2023 | 5.75 | Feb. 23, 2023 | 28 | 62,117 | 4,960 |
| | Jan. 26, 2023 | 5.75 | Feb. 23, 2023 | 28 | 65,805 | 5,249 |
| PB45 | Feb. 7, 2023 | 8.25 | Feb. 12, 2023 | 5 | 29,257 | 2,333 |
| T109 | Feb. 7, 2023 | 8.30 | Feb. 12, 2023 | 5 | 29,025 | 2,313 |
| 20 Cylinders | Feb. 7, 2023 | 8.35 | Feb. 12, 2023 | 5 | 33,217 | 2,650 |
| −30% Portland 1L | Feb. 7, 2023 | 8.40 | Feb. 12, 2023 | 5 | 33,045 | 2,636 |
| 1:3:2 Mix | Feb. 7, 2023 | 8.25 | Feb. 17, 2023 | 10 | 35,339 | 2,816 |
| | Feb. 7, 2023 | 8.30 | Feb. 17, 2023 | 10 | 31,812 | 2,537 |
| | Feb. 7, 2023 | 8.35 | Feb. 17, 2023 | 10 | 29,286 | 2,337 |
| | Feb. 7, 2023 | 8.35 | Feb. 17, 2023 | 10 | 34,361 | 2,740 |
| | Feb. 7, 2023 | 8.30 | Feb. 23, 2023 | 15 | 36,182 | 2,887 |
| | Feb. 7, 2023 | 8.30 | Feb. 23, 2023 | 15 | 33,861 | 2,702 |
| | Feb. 7, 2023 | 8.25 | Feb. 23, 2023 | 15 | 35,992 | 2,871 |
| | Feb. 7, 2023 | 8.45 | Feb. 23, 2023 | 15 | 40,746 | 3,250 |
| | Feb. 7, 2023 | 8.30 | Feb. 28, 2023 | 20 | 36,839 | 2,939 |
| | Feb. 7, 2023 | 8.30 | Feb. 28, 2023 | 20 | 37,782 | 3,015 |
| | Feb. 7, 2023 | 8.25 | Feb. 28, 2023 | 20 | 42,040 | 3,355 |
| | Feb. 7, 2023 | 8.45 | Feb. 28, 2023 | 20 | 41,278 | 3,295 |
| | Feb. 7, 2023 | 8.10 | Mar. 8, 2023 | 28 | 42,593 | 3,401 |
| | Feb. 7, 2023 | 8.00 | Mar. 8, 2023 | 28 | 42,455 | 3,390 |
| | Feb. 7, 2023 | 8.35 | Mar. 8, 2023 | 28 | 44,908 | 3,581 |

Comparative to Table 38 for improved results despite removing 30% of the binder.

In Table 44, “PB45” is Portland cement, sand, aggregate and water, and binder reducing agent, tested in duplicate, triplicate, etc., as the case may be (“PB45” is sample 1 and “T96” is sample 2 from a pour, etc.). Per 10 4″×8″ Cylinders: 7.2 lbs. of Portland IL (PLC) cement, 41 pounds of medium to large aggregate (rock), 27 lbs. of fine aggregate (sand), and 8.34 lbs. of water and 0.88 lbs. of binder reducing formulation. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens. Comparative to Table 38 results were less than comparable to baseline with removal of 40% of the binder.

TABLE 44

| Formula | Pour Date | Weight (lb) | Test Date | Cure Days | LBF | PSI |
|---|---|---|---|---|---|---|
| PB45 | Dec. 17, 2022 | 8.30 | Dec. 22, 2022 | 5 | 31,921 | 2,542 |
| T96 | Dec. 17, 2022 | 8.30 | Dec. 22, 2022 | 5 | 32,335 | 2,575 |
| 19 Cylinders | Dec. 17, 2022 | 8.30 | Dec. 22, 2022 | 5 | 31,205 | 2,485 |
| −40% Portland 1L | Dec. 17, 2022 | 8.30 | Dec. 22, 2022 | 5 | 30,929 | 2,460 |
| 1:3:2 Mix | Dec. 17, 2022 | 8.30 | Dec. 27, 2022 | 10 | 39,013 | 3,113 |
| | Dec. 17, 2022 | 8.30 | Dec. 27, 2022 | 10 | 39,823 | 3,178 |
| | Dec. 17, 2022 | 8.30 | Dec. 27, 2022 | 10 | 35,491 | 2,832 |
| | Dec. 17, 2022 | 8.30 | Dec. 27, 2022 | 10 | 35,341 | 2,820 |
| | Dec. 17, 2022 | 8.30 | Jan. 2, 2023 | 15 | 36,603 | 2,917 |
| | Dec. 17, 2022 | 8.30 | Jan. 2, 2023 | 15 | 39,912 | 3,179 |
| | Dec. 17, 2022 | 8.30 | Jan. 2, 2023 | 15 | 38,714 | 3,088 |
| | Dec. 17, 2022 | 8.30 | Jan. 2, 2023 | 15 | 43,033 | 3,435 |
| | Dec. 17, 2022 | 8.25 | Jan. 6, 2023 | 20 | 40,588 | 3,238 |
| | Dec. 17, 2022 | 8.25 | Jan. 6, 2023 | 20 | 41,793 | 3,335 |
| | Dec. 17, 2022 | 8.25 | Jan. 6, 2023 | 20 | 41,764 | 3,332 |
| | Dec. 17, 2022 | 8.35 | Jan. 6, 2023 | 20 | 41,727 | 3,330 |
| | Dec. 17, 2022 | 8.35 | Jan. 13, 2023 | 28 | 43,902 | 3,502 |
| | Dec. 17, 2022 | 8.35 | Jan. 13, 2023 | 28 | 42,297 | 3,374 |
| | Dec. 17, 2022 | 8.35 | Jan. 13, 2023 | 28 | 43,337 | 3,457 |
| PB45 | Feb. 7, 2023 | 8.30 | Feb. 12, 2023 | 5 | 22,838 | 1,818 |
| T110 | Feb. 7, 2023 | 8.35 | Feb. 12, 2023 | 5 | 17,504 | 1,393 |
| 20 Cylinders | Feb. 7, 2023 | 8.35 | Feb. 12, 2023 | 5 | 24,575 | 1,956 |
| −40% Portland 1L | Feb. 7, 2023 | 8.40 | Feb. 12, 2023 | 5 | 26,279 | 2,091 |
| 1:3:2 Mix | Feb. 7, 2023 | 8.30 | Feb. 17, 2023 | 10 | 26,942 | 2,145 |
| | Feb. 7, 2023 | 8.35 | Feb. 17, 2023 | 10 | 26,491 | 2,108 |
| | Feb. 7, 2023 | 8.30 | Feb. 17, 2023 | 10 | 28,504 | 2,270 |
| | Feb. 7, 2023 | 8.35 | Feb. 17, 2023 | 10 | 24,370 | 1,940 |
| | Feb. 7, 2023 | 8.30 | Feb. 23, 2023 | 15 | 30,034 | 2,391 |
| | Feb. 7, 2023 | 8.25 | Feb. 23, 2023 | 15 | 29,521 | 2,351 |
| | Feb. 7, 2023 | 8.35 | Feb. 23, 2023 | 15 | 29,685 | 2,365 |
| | Feb. 7, 2023 | 8.40 | Feb. 23, 2023 | 15 | 29,520 | 2,350 |
| | Feb. 7, 2023 | 8.25 | Feb. 28, 2023 | 20 | 28,489 | 2,272 |
| | Feb. 7, 2023 | 8.30 | Feb. 28, 2023 | 20 | 28,803 | 2,297 |
| | Feb. 7, 2023 | 8.20 | Feb. 28, 2023 | 20 | 30,972 | 2,466 |
| | Feb. 7, 2023 | 8.35 | Feb. 28, 2023 | 20 | 30,468 | 2,425 |
| | Feb. 7, 2023 | 8.00 | Mar. 8, 2023 | 28 | 33,363 | 2,664 |
| | Feb. 7, 2023 | 8.00 | Mar. 8, 2023 | 28 | 34,002 | 2,715 |
| | Feb. 7, 2023 | 8.35 | Mar. 8, 2023 | 28 | 38,658 | 3,083 |

Comparative to Table 38 results were less than comparable to baseline with removal of 40% of the binder.

In Table 45, “PB45” is Portland cement, sand, aggregate and water, and binder reducing agent, tested in duplicate, triplicate, etc., as the case may be (“PB45” is sample 1 and “T101” is sample 2 from a pour). Per 10 4″×8″ Cylinders: 10.8 lbs. of Portland IL (PLC) cement, 41 pounds of medium to large aggregate (rock), 27 lbs. of fine aggregate (sand), and 8.34 lbs. of water and 1.76 lbs. of binder reducing formulation. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens.

TABLE 45

| Formula | Pour Date | Weight (lb) | Test Date | Cure Days | LBF | PSI |
|---|---|---|---|---|---|---|
| T101 | Jan. 19, 2023 | 5.65 | Jan. 24, 2023 | 5 | 42,169 | 3,367 |
| 20 Cylinders | Jan. 19, 2023 | 5.70 | Jan. 24, 2023 | 5 | 41,915 | 3,344 |
| −10% Portland 1L | Jan. 19, 2023 | 5.70 | Jan. 24, 2023 | 5 | 43,415 | 3,462 |
| 1:3:2 Mix | Jan. 19, 2023 | 5.75 | Jan. 29, 2023 | 10 | 52,051 | 4,157 |
| | Jan. 19, 2023 | 5.90 | Jan. 29, 2023 | 10 | 55,463 | 4,430 |
| | Jan. 19, 2023 | 5.95 | Jan. 29, 2023 | 10 | 55,031 | 4,388 |
| | Jan. 19, 2023 | 5.95 | Jan. 29, 2023 | 10 | 53,254 | 4,245 |
| | Jan. 19, 2023 | 5.70 | Feb. 3, 2023 | 15 | 58,039 | 4,630 |
| | Jan. 19, 2023 | 5.70 | Feb. 3, 2023 | 15 | 57,422 | 4,581 |
| | Jan. 19, 2023 | 5.75 | Feb. 3, 2023 | 15 | 59,141 | 4,714 |
| | Jan. 19, 2023 | 5.75 | Feb. 3, 2023 | 15 | 52,803 | 4,212 |
| | Jan. 19, 2023 | 5.75 | Feb. 8, 2023 | 20 | 59,650 | 4,764 |
| | Jan. 19, 2023 | 5.75 | Feb. 8, 2023 | 20 | 61,989 | 4,943 |
| | Jan. 19, 2023 | 5.80 | Feb. 8, 2023 | 20 | 62,473 | 4,983 |
| | Jan. 19, 2023 | 5.85 | Feb. 8, 2023 | 20 | 56,690 | 4,523 |
| | Jan. 19, 2023 | 5.60 | Feb. 16, 2023 | 28 | 71,878 | 5,733 |
| | Jan. 19, 2023 | 5.60 | Feb. 16, 2023 | 28 | 65,503 | 5,225 |
| | Jan. 19, 2023 | 5.60 | Feb. 16, 2023 | 28 | 60,576 | 4,832 |
| | Jan. 19, 2023 | 5.65 | Feb. 16, 2023 | 28 | 63,945 | 5,095 |

Comparative to Table 38 for improved results despite removing 10% of the binder.

In Table 46, “PB45” is Portland cement, sand, aggregate and water, and binder reducing agent, tested in duplicate, triplicate, etc., as the case may be (“PB45” is sample 1 and “T102” is sample 2 from a pour). Per 10 4″×8″ Cylinders: 9.6 lbs. of Portland IL (PLC) cement, 41 pounds of medium to large aggregate (rock), 27 lbs. of fine aggregate (sand), and 8.34 lbs. of water and 1.76 lbs. of binder reducing formulation. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens.

TABLE 46

| Formula | Pour Date | Weight (lb) | Test Date | Cure Days | LBF | PSI |
|---|---|---|---|---|---|---|
| PB45 (2X Strength) | Jan. 19, 2023 | 5.75 | Jan. 24, 2023 | 5 | 44,175 | 3,525 |
| T102 | Jan. 19, 2023 | 5.75 | Jan. 24, 2023 | 5 | 46,701 | 3,728 |
| 20 Cylinders | Jan. 19, 2023 | 5.80 | Jan. 24, 2023 | 5 | 44,006 | 3,512 |
| −20% Portland 1L | Jan. 19, 2023 | 5.80 | Jan. 24, 2023 | 5 | 43,624 | 3,484 |
| 1:3:2 Mix | Jan. 19, 2023 | 5.45 | Jan. 29, 2023 | 10 | 52,025 | 4,150 |
| | Jan. 19, 2023 | 5.50 | Jan. 29, 2023 | 10 | 52,033 | 4,151 |
| | Jan. 19, 2023 | 5.50 | Jan. 29, 2023 | 10 | 53,713 | 4,287 |
| | Jan. 19, 2023 | 5.50 | Jan. 29, 2023 | 10 | 53,139 | 4,242 |
| | Jan. 19, 2023 | 5.80 | Feb. 3, 2023 | 15 | 59,149 | 4,715 |
| | Jan. 19, 2023 | 5.85 | Feb. 3, 2023 | 15 | 59,579 | 4,750 |
| | Jan. 19, 2023 | 5.85 | Feb. 3, 2023 | 15 | 53,466 | 4,268 |
| | Jan. 19, 2023 | 5.85 | Feb. 3, 2023 | 15 | 60,175 | 4,807 |
| | Jan. 19, 2023 | 5.85 | Feb. 8, 2023 | 20 | 66,025 | 5,271 |
| | Jan. 19, 2023 | 5.90 | Feb. 8, 2023 | 20 | 63,832 | 5,090 |
| | Jan. 19, 2023 | 5.90 | Feb. 8, 2023 | 20 | 66,252 | 5,284 |
| | Jan. 19, 2023 | 5.95 | Feb. 8, 2023 | 20 | 62,674 | 5,000 |
| | Jan. 19, 2023 | 5.60 | Feb. 16, 2023 | 28 | 66,552 | 5,304 |
| | Jan. 19, 2023 | 5.70 | Feb. 16, 2023 | 28 | 67,990 | 5,424 |
| | Jan. 19, 2023 | 5.70 | Feb. 16, 2023 | 28 | 66,135 | 5,280 |
| | Jan. 19, 2023 | 5.70 | Feb. 16, 2023 | 28 | 66,833 | 5,331 |

Comparative to Table 38 for improved results despite removing 20% of the binder.

In Table 47, “PB45” is Portland cement, sand, aggregate and water, and binder reducing agent, tested in duplicate (“PB45” is sample 1 and “T103” is sample 2 from a pour). Per 10 4″×8″ Cylinders: 8.4 lbs. of Portland IL (PLC) cement, 41 pounds of medium to large aggregate (rock), 27 lbs. of fine aggregate (sand), and 8.34 lbs. of water and 1.76 lbs. of binder reducing formulation. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens.

TABLE 47

| Formula | Pour Date | Weight (lb) | Test Date | Cure Days | LBF | PSI |
|---|---|---|---|---|---|---|
| PB45 (2X Strength) | Jan. 19, 2023 | 5.80 | Jan. 24, 2023 | 5 | 25,014 | 1,994 |
| T103 | Jan. 19, 2023 | 5.85 | Jan. 24, 2023 | 5 | 25,492 | 2,032 |
| 20 Cylinders | Jan. 19, 2023 | 5.90 | Jan. 24, 2023 | 5 | 25,678 | 2,048 |
| −30% Portland 1L | Jan. 19, 2023 | 5.90 | Jan. 24, 2023 | 5 | 25,080 | 2,000 |
| 1:3:2 Mix | Jan. 19, 2023 | 5.50 | Jan. 29, 2023 | 10 | 33,972 | 2,713 |
| | Jan. 19, 2023 | 5.50 | Jan. 29, 2023 | 10 | 34,008 | 2,715 |
| | Jan. 19, 2023 | 5.50 | Jan. 29, 2023 | 10 | 34,944 | 2,789 |
| | Jan. 19, 2023 | 5.50 | Jan. 29, 2023 | 10 | 37,187 | 2,968 |
| | Jan. 19, 2023 | 5.80 | Feb. 3, 2023 | 15 | 41,583 | 3,316 |
| | Jan. 19, 2023 | 5.85 | Feb. 3, 2023 | 15 | 42,400 | 3,384 |
| | Jan. 19, 2023 | 5.90 | Feb. 3, 2023 | 15 | 42,845 | 3,421 |
| | Jan. 19, 2023 | 5.90 | Feb. 3, 2023 | 15 | 42,688 | 3,406 |
| | Jan. 19, 2023 | 5.90 | Feb. 8, 2023 | 20 | 43,429 | 3,466 |
| | Jan. 19, 2023 | 5.90 | Feb. 8, 2023 | 20 | 41,374 | 3,301 |
| | Jan. 19, 2023 | 5.95 | Feb. 8, 2023 | 20 | 43,587 | 3,477 |
| | Jan. 19, 2023 | 5.95 | Feb. 8, 2023 | 20 | 52,230 | 3,366 |
| | Jan. 19, 2023 | 5.70 | Feb. 16, 2023 | 28 | 45,070 | 3,590 |
| | Jan. 19, 2023 | 5.75 | Feb. 16, 2023 | 28 | 45,185 | 3,608 |
| | Jan. 19, 2023 | 5.75 | Feb. 16, 2023 | 28 | 44,034 | 3,515 |
| | Jan. 19, 2023 | 5.75 | Feb. 16, 2023 | 28 | 46,548 | 3,715 |

Comparative to Table 38 for comparable results despite removing 300 of the binder.

In Table 48, “PB45” is Portland cement, sand, aggregate and water, and binder reducing agent, tested in duplicate, triplicate, etc., as the case may be (“PB45” is sample 1 and “T62” is sample 2 from a pour). Per 10 4″×8″ Cylinders: 16 lbs. of Portland I/II cement, 32 pounds of medium to large aggregate (rock), 32 lbs. of fine aggregate (sand), 8.34 lbs. of water and 1.76 lbs. of binder reducing formulation. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens.

TABLE 48

| Formula | Pour Date | Weight (lb) | Test Date | Cure Days | LBF | PSI |
|---|---|---|---|---|---|---|
| PB45 (2X Strength) | Oct. 12, 2022 | 8.30 | Oct. 17, 2022 | 5 | 61,718 | 4,923 |
| T62 | Oct. 12, 2022 | 8.35 | Oct. 17, 2022 | 5 | 48,247 | 3,850 |
| 10 Cylinders | Oct. 12, 2022 | 8.35 | Oct. 17, 2022 | 5 | 62,740 | 5,003 |
| Portland I/II | Oct. 12, 2022 | 8.35 | Oct. 17, 2022 | 5 | 61,478 | 4,903 |
| 1:2:2 Mix | Oct. 12, 2022 | 8.35 | Oct. 17, 2022 | 5 | 60,443 | 4,821 |
| | Oct. 12, 2022 | 8.30 | Oct. 22, 2022 | 10 | 69,813 | 5,572 |
| | Oct. 12, 2022 | 8.30 | Oct. 22, 2022 | 10 | 65,929 | 5,257 |
| | Oct. 12, 2022 | 8.35 | Oct. 22, 2022 | 10 | 69,283 | 5,526 |
| | Oct. 12, 2022 | 8.35 | Oct. 22, 2022 | 10 | 66,303 | 5,293 |
| | Oct. 12, 2022 | 8.35 | Oct. 22, 2022 | 10 | 67,951 | 5,418 |

Comparative to Table 9 for improved results.

In Table 49, “PB45” is Portland cement, sand, aggregate and water, and binder reducing agent, tested in duplicate, triplicate, etc., as the case may be (“PB45” is sample 1 and “T111” is sample 2 from a pour, etc.). Per 10 4″×8″ Cylinders: 9.6 lbs. of Portland IL (PLC) cement, 41 pounds of medium to large aggregate (rock), 27 lbs. of fine aggregate (sand), and 8.34 lbs. of water and 0.44 lbs. of binder reducing formulation. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens.

TABLE 49

| Formula | Pour Date | Weight (lb) | Test Date | Cure Days | LBF | PSI |
|---|---|---|---|---|---|---|
| PB45 (½ Strength) | Feb. 7, 2023 | 8.15 | Feb. 12, 2023 | 5 | 37,353 | 2,976 |
| T111 | Feb. 7, 2023 | 8.15 | Feb. 12, 2023 | 5 | 38,726 | 3,091 |
| 20 Cylinders | Feb. 7, 2023 | 8.25 | Feb. 12, 2023 | 5 | 37,991 | 3,032 |
| −20% Portland 1L | Feb. 7, 2023 | 8.30 | Feb. 12, 2023 | 5 | 39,651 | 3,165 |
| 1:3:2 Mix | Feb. 7, 2023 | 8.25 | Feb. 17, 2023 | 10 | 42,078 | 3,358 |
| | Feb. 7, 2023 | 8.25 | Feb. 17, 2023 | 10 | 42,730 | 3,408 |
| | Feb. 7, 2023 | 8.25 | Feb. 17, 2023 | 10 | 43,193 | 3,449 |
| | Feb. 7, 2023 | 8.25 | Feb. 17, 2023 | 10 | 43,404 | 3,458 |
| | Feb. 7, 2023 | 8.05 | Feb. 23, 2023 | 15 | 42,494 | 3,392 |
| | Feb. 7, 2023 | 8.15 | Feb. 23, 2023 | 15 | 45,222 | 3,607 |
| | Feb. 7, 2023 | 8.20 | Feb. 23, 2023 | 15 | 44,894 | 3,583 |
| | Feb. 7, 2023 | 8.20 | Feb. 23, 2023 | 15 | 45,004 | 3,589 |
| | Feb. 7, 2023 | 8.20 | Feb. 28, 2023 | 20 | 45,202 | 3,604 |
| | Feb. 7, 2023 | 8.20 | Feb. 28, 2023 | 20 | 45,692 | 3,644 |
| | Feb. 7, 2023 | 8.20 | Feb. 28, 2023 | 20 | 44,376 | 3,542 |
| | Feb. 7, 2023 | 8.20 | Feb. 28, 2023 | 20 | 46,283 | 3,694 |
| | Feb. 7, 2023 | 8.00 | Mar. 8, 2023 | 28 | 45,790 | 3,649 |
| | Feb. 7, 2023 | 8.00 | Mar. 8, 2023 | 28 | 44,839 | 3,578 |
| | Feb. 7, 2023 | 8.00 | Mar. 8, 2023 | 28 | 45,175 | 3,600 |
| | Feb. 7, 2023 | 7.85 | Mar. 8, 2023 | 28 | 45,461 | 3,630 |
| PB45 (½ Strength) | Feb. 22, 2023 | 8.25 | Feb. 27, 2023 | 5 | 33,315 | 2,659 |
| T113 | Feb. 22, 2023 | 8.30 | Feb. 27, 2023 | 5 | 33,778 | 2,695 |
| 20 Cylinders | Feb. 22, 2023 | 8.30 | Feb. 27, 2023 | 5 | 38,468 | 3,070 |
| −20% Portland 1L | Feb. 22, 2023 | 8.40 | Feb. 27, 2023 | 5 | 40,557 | 3,236 |
| 1:3:2 Mix | Feb. 22, 2023 | 8.20 | Mar. 4, 2023 | 10 | 34,181 | 2,729 |
| | Feb. 22, 2023 | 8.30 | Mar. 4, 2023 | 10 | 40,967 | 3,271 |
| | Feb. 22, 2023 | 8.35 | Mar. 4, 2023 | 10 | 40,347 | 3,220 |
| | Feb. 22, 2023 | 8.35 | Mar. 4, 2023 | 10 | 41,064 | 3,277 |
| | Feb. 22, 2023 | 8.25 | Mar. 9, 2023 | 15 | 43,859 | 3,499 |
| | Feb. 22, 2023 | 8.25 | Mar. 9, 2023 | 15 | 42,047 | 3,353 |
| | Feb. 22, 2023 | 8.35 | Mar. 9, 2023 | 15 | 49,691 | 3,963 |
| | Feb. 22, 2023 | 8.40 | Mar. 9, 2023 | 15 | 45,899 | 3,662 |
| | Feb. 22, 2023 | 8.20 | Mar. 14, 2023 | 20 | 40,655 | 3,243 |
| | Feb. 22, 2023 | 8.25 | Mar. 14, 2023 | 20 | 43,277 | 3,455 |
| | Feb. 22, 2023 | 8.25 | Mar. 14, 2023 | 20 | 50,867 | 4,057 |
| | Feb. 22, 2023 | 8.40 | Mar. 14, 2023 | 20 | 43,012 | 3,431 |
| | Feb. 22, 2023 | 8.25 | Mar. 22, 2023 | 28 | 52,587 | 4,199 |
| | Feb. 22, 2023 | 8.25 | Mar. 22, 2023 | 28 | 53,914 | 4,305 |
| | Feb. 22, 2023 | 8.40 | Mar. 22, 2023 | 28 | 56,876 | 4,536 |
| | Feb. 22, 2023 | 8.40 | Mar. 22, 2023 | 28 | 51,875 | 4,141 |
| PB45 (½ Strength) | Feb. 22, 2023 | 8.15 | Feb. 27, 2023 | 5 | 34,451 | 2,748 |
| T114 | Feb. 22, 2023 | 8.30 | Feb. 27, 2023 | 5 | 35,009 | 2,793 |
| 20 Cylinders | Feb. 22, 2023 | 8.30 | Feb. 27, 2023 | 5 | 38,196 | 3,049 |
| −20% Portland 1L | Feb. 22, 2023 | 8.30 | Feb. 27, 2023 | 5 | 36,267 | 2,889 |
| 1:3:2 Mix | Feb. 22, 2023 | 8.05 | Mar. 4, 2023 | 10 | 38,898 | 3,104 |
| | Feb. 22, 2023 | 8.10 | Mar. 4, 2023 | 10 | 41,204 | 3,288 |
| | Feb. 22, 2023 | 8.30 | Mar. 4, 2023 | 10 | 43,541 | 3,471 |
| | Feb. 22, 2023 | 8.35 | Mar. 4, 2023 | 10 | 44,181 | 3,524 |
| | Feb. 22, 2023 | 8.20 | Mar. 9, 2023 | 15 | 44,411 | 3,544 |
| | Feb. 22, 2023 | 8.25 | Mar. 9, 2023 | 15 | 44,614 | 3,559 |
| | Feb. 22, 2023 | 8.25 | Mar. 9, 2023 | 15 | 48,492 | 3,869 |
| | Feb. 22, 2023 | 8.35 | Mar. 9, 2023 | 15 | 47,739 | 3,811 |
| | Feb. 22, 2023 | 8.25 | Mar. 14, 2023 | 20 | 44,729 | 3,565 |
| | Feb. 22, 2023 | 8.30 | Mar. 14, 2023 | 20 | 45,045 | 3,594 |
| | Feb. 22, 2023 | 8.30 | Mar. 14, 2023 | 20 | 49,519 | 3,951 |
| | Feb. 22, 2023 | 8.30 | Mar. 14, 2023 | 20 | 48,485 | 3,869 |
| | Feb. 22, 2023 | 8.25 | Mar. 22, 2023 | 28 | 50,395 | 4,024 |
| | Feb. 22, 2023 | 8.25 | Mar. 22, 2023 | 28 | 50,070 | 3,998 |
| | Feb. 22, 2023 | 8.30 | Mar. 22, 2023 | 28 | 52,518 | 4,187 |
| | Feb. 22, 2023 | 8.30 | Mar. 22, 2023 | 28 | 51,205 | 4,049 |

Comparative to Table 38 for comparable results despite removing 200 of the binder.

In Table 50, “PB45” is Portland cement, sand, aggregate and water, and binder reducing agent, tested in duplicate, triplicate, etc., as the case may be (“PB45” is sample 1 and “T126” is sample 2 from a pour). Per 3′×6′×6″ slab and 15 8″×4″ Cylinders: 153.6 lbs. of Portland I/II cement, 656 lbs. of medium to large aggregate (rock), 432 lbs. of fine aggregate (sand), and 88 lbs. of water and 10.8 lbs. of binder reducing formulation. All cylinders were mixed and cured pursuant to the guidelines of ASTM C31: Standard Practice for Making and Curing Concrete Test Specimens in the Field. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical

TABLE 50

| Formula | Pour Date | Weight (lb) | Test Date | Cure Days | LBF | PSI |
|---|---|---|---|---|---|---|
| PB45 | Mar. 24, 2023 | 5.35 | Mar. 29, 2023 | 5 | 45,927 | 3,663 |
| T126 | Mar. 24, 2023 | 5.35 | Mar. 29, 2023 | 5 | 45,381 | 3,621 |
| 3′ × 6′ × 6″ Slab (Cores) | Mar. 24, 2023 | 5.35 | Mar. 29, 2023 | 5 | 53,269 | 4,249 |
| & 15 Cylinders | Mar. 24, 2023 | 5.40 | Mar. 29, 2023 | 5 | 51,250 | 4,087 |
| −20% Portland I/II | Mar. 24, 2023 | 5.40 | Mar. 29, 2023 | 5 | 47,810 | 3,814 |
| 1:3:2 Mix | Mar. 24, 2023 | 5.40 | Mar. 29, 2023 | 5 | 56,646 | 4,520 |
| | Mar. 24, 2023 | 5.50 | Mar. 29, 2023 | 5 | 49,548 | 3,953 |
| | Mar. 24, 2023 | 5.50 | Mar. 29, 2023 | 5 | 45,450 | 3,625 |
| | Mar. 24, 2023 | 5.50 | Mar. 29, 2023 | 5 | 47,306 | 3,773 |
| | Mar. 24, 2023 | 5.50 | Mar. 29, 2023 | 5 | 50,714 | 4,041 |
| | Mar. 24, 2023 | 5.50 | Mar. 29, 2023 | 5 | 50,034 | 3,992 |
| | Mar. 24, 2023 | 5.50 | Mar. 29, 2023 | 5 | 53,731 | 4,286 |
| Cylinders: | Mar. 24, 2023 | 8.05 | Mar. 29, 2023 | 5 | 38,554 | 3,075 |
| | Mar. 24, 2023 | 8.35 | Mar. 29, 2023 | 5 | 40,974 | 3,268 |
| | Mar. 24, 2023 | 8.50 | Mar. 29, 2023 | 5 | 36,990 | 2,952 |
| | Mar. 24, 2023 | 5.55 | Apr. 3, 2023 | 10 | 50,899 | 4,061 |
| | Mar. 24, 2023 | 5.60 | Apr. 3, 2023 | 10 | 50,451 | 4,020 |
| | Mar. 24, 2023 | 5.65 | Apr. 3, 2023 | 10 | 56,490 | 4,506 |
| | Mar. 24, 2023 | 5.65 | Apr. 3, 2023 | 10 | 57,042 | 4,550 |
| | Mar. 24, 2023 | 5.65 | Apr. 3, 2023 | 10 | 55,196 | 4,401 |
| | Mar. 24, 2023 | 5.65 | Apr. 3, 2023 | 10 | 52,584 | 4,193 |
| | Mar. 24, 2023 | 5.65 | Apr. 3, 2023 | 10 | 52,659 | 4,201 |
| | Mar. 24, 2023 | 5.70 | Apr. 3, 2023 | 10 | 50,326 | 4,012 |
| | Mar. 24, 2023 | 5.70 | Apr. 3, 2023 | 10 | 50,451 | 4,026 |
| | Mar. 24, 2023 | 5.75 | Apr. 3, 2023 | 10 | 51,260 | 4,090 |
| | Mar. 24, 2023 | 5.75 | Apr. 3, 2023 | 10 | 50,183 | 4,002 |
| | Mar. 24, 2023 | 5.75 | Apr. 3, 2023 | 10 | 53,664 | 4,280 |
| Cylinders: | Mar. 24, 2023 | 8.15 | Apr. 3, 2023 | 10 | 41,461 | 3,308 |
| | Mar. 24, 2023 | 8.40 | Apr. 3, 2023 | 10 | 42,734 | 3,410 |
| | Mar. 24, 2023 | 8.45 | Apr. 3, 2023 | 10 | 46,459 | 3,705 |
| | Mar. 24, 2023 | 5.65 | Apr. 8, 2023 | 15 | 56,221 | 4,483 |
| | Mar. 24, 2023 | 5.65 | Apr. 8, 2023 | 15 | 59,789 | 4,770 |
| | Mar. 24, 2023 | 5.65 | Apr. 8, 2023 | 15 | 55,111 | 4,390 |
| | Mar. 24, 2023 | 5.65 | Apr. 8, 2023 | 15 | 56,624 | 4,517 |
| | Mar. 24, 2023 | 5.70 | Apr. 8, 2023 | 15 | 57,468 | 4,581 |
| | Mar. 24, 2023 | 5.70 | Apr. 8, 2023 | 15 | 59,017 | 4,708 |
| | Mar. 24, 2023 | 5.70 | Apr. 8, 2023 | 15 | 64,278 | 5,126 |
| | Mar. 24, 2023 | 5.70 | Apr. 8, 2023 | 15 | 56,834 | 4,532 |
| | Mar. 24, 2023 | 5.70 | Apr. 8, 2023 | 15 | 58,041 | 4,631 |
| | Mar. 24, 2023 | 5.70 | Apr. 8, 2023 | 15 | 58,397 | 4,656 |
| | Mar. 24, 2023 | 5.70 | Apr. 8, 2023 | 15 | 62,456 | 4,982 |
| | Mar. 24, 2023 | 5.75 | Apr. 8, 2023 | 15 | 66,135 | 5,273 |
| Cylinders: | Mar. 24, 2023 | 8.15 | Apr. 8, 2023 | 15 | 51,542 | 4,115 |
| | Mar. 24, 2023 | 8.20 | Apr. 8, 2023 | 15 | 52,835 | 4,216 |
| | Mar. 24, 2023 | 8.30 | Apr. 8, 2023 | 15 | 53,068 | 4,234 |
| | Mar. 24, 2023 | 5.65 | Apr. 13, 2023 | 20 | 54,896 | 4,379 |
| | Mar. 24, 2023 | 5.65 | Apr. 13, 2023 | 20 | 57,382 | 4,577 |
| | Mar. 24, 2023 | 5.65 | Apr. 13, 2023 | 20 | 56,682 | 4,521 |
| | Mar. 24, 2023 | 5.65 | Apr. 13, 2023 | 20 | 56,371 | 4,496 |
| | Mar. 24, 2023 | 5.70 | Apr. 13, 2023 | 20 | 58,654 | 4,679 |
| | Mar. 24, 2023 | 5.70 | Apr. 13, 2023 | 20 | 55,878 | 4,457 |
| | Mar. 24, 2023 | 5.60 | Apr. 13, 2023 | 20 | 65,001 | 5,175 |
| | Mar. 24, 2023 | 5.65 | Apr. 13, 2023 | 20 | 68,612 | 5,464 |
| | Mar. 24, 2023 | 5.65 | Apr. 13, 2023 | 20 | 68,986 | 5,493 |
| | Mar. 24, 2023 | 5.65 | Apr. 13, 2023 | 20 | 63,419 | 5,049 |
| | Mar. 24, 2023 | 5.70 | Apr. 13, 2023 | 20 | 71,387 | 5,680 |
| | Mar. 24, 2023 | 5.70 | Apr. 13, 2023 | 20 | 62,357 | 4,963 |
| Cylinders: | Mar. 24, 2023 | 8.05 | Apr. 13, 2023 | 20 | 55,984 | 4,466 |
| | Mar. 24, 2023 | 8.15 | Apr. 13, 2023 | 20 | 47,533 | 3,784 |
| | Mar. 24, 2023 | 8.30 | Apr. 13, 2023 | 20 | 47,759 | 3,801 |
| | Mar. 24, 2023 | 5.65 | Apr. 21, 2023 | 28 | 72,299 | 5,773 |
| | Mar. 24, 2023 | 5.65 | Apr. 21, 2023 | 28 | 67,853 | 5,405 |
| | Mar. 24, 2023 | 5.65 | Apr. 21, 2023 | 28 | 70,258 | 5,610 |
| | Mar. 24, 2023 | 5.65 | Apr. 21, 2023 | 28 | 72,612 | 5,798 |
| | Mar. 24, 2023 | 5.65 | Apr. 21, 2023 | 28 | 69,941 | 5,570 |
| | Mar. 24, 2023 | 5.65 | Apr. 21, 2023 | 28 | 72,848 | 5,802 |
| | Mar. 24, 2023 | 5.65 | Apr. 21, 2023 | 28 | 71,272 | 5,691 |
| | Mar. 24, 2023 | 5.65 | Apr. 21, 2023 | 28 | 73,941 | 5,889 |
| | Mar. 24, 2023 | 5.70 | Apr. 21, 2023 | 28 | 73,275 | 5,836 |
| | Mar. 24, 2023 | 5.70 | Apr. 21, 2023 | 28 | 72,612 | 5,798 |
| | Mar. 24, 2023 | 5.70 | Apr. 21, 2023 | 28 | 67,915 | 5,408 |
| | Mar. 24, 2023 | 5.70 | Apr. 21, 2023 | 28 | 70,355 | 5,601 |
| Cylinders: | Mar. 24, 2023 | 8.10 | Apr. 21, 2023 | 28 | 54,465 | 4,336 |
| | Mar. 24, 2023 | 8.15 | Apr. 21, 2023 | 28 | 50,251 | 4,002 |
| | Mar. 24, 2023 | 8.20 | Apr. 21, 2023 | 28 | 49,756 | 3,962 |

Comparative to Table 38 for improved results despite removing 200 of the binder.

In Table 51, “PB45” is Portland cement, sand, aggregate and water, and binder reducing agent, tested in duplicate, triplicate, etc., as the case may be (“PB45” is sample 1 and “T125” is sample 2 from a pour). Per 3′×6′×6″ slab and 15 8″×4″ Cylinders: 153.6 lbs. of Portland IL (PLC) cement, 656 lbs. of medium to large aggregate (rock), 432 lbs. of fine aggregate (sand), and 88 lbs. of water and 10.8 lbs. of binder reducing formulation. All cylinders were mixed and cured pursuant to the guidelines of ASTM C31: Standard Practice for Making and Curing Concrete Test Specimens in the Field. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical

TABLE 51

| Formula | Pour Date | Weight (lb) | Test Date | Cure Days | LBF | PSI |
|---|---|---|---|---|---|---|
| PB45 | Mar. 24, 2023 | 5.60 | Mar. 29, 2023 | 5 | 44,435 | 3,544 |
| T125 | Mar. 24, 2023 | 5.65 | Mar. 29, 2023 | 5 | 49,262 | 3,929 |
| 3′ × 6′ × 6″ Slab (Cores) | Mar. 24, 2023 | 5.65 | Mar. 29, 2023 | 5 | 49,320 | 3,939 |
| & 15 Cylinders | Mar. 24, 2023 | 5.65 | Mar. 29, 2023 | 5 | 47,975 | 3,829 |
| −20% Portland 1L | Mar. 24, 2023 | 5.65 | Mar. 29, 2023 | 5 | 44,584 | 3,557 |
| 1:3:2 Mix | Mar. 24, 2023 | 5.65 | Mar. 29, 2023 | 5 | 45,745 | 3,650 |
| | Mar. 24, 2023 | 5.65 | Mar. 29, 2023 | 5 | 45,640 | 3,641 |
| | Mar. 24, 2023 | 5.65 | Mar. 29, 2023 | 5 | 48,712 | 3,885 |
| | Mar. 24, 2023 | 5.65 | Mar. 29, 2023 | 5 | 43,924 | 3,504 |
| | Mar. 24, 2023 | 5.70 | Mar. 29, 2023 | 5 | 45,925 | 3,665 |
| | Mar. 24, 2023 | 5.70 | Mar. 29, 2023 | 5 | 46,492 | 3,708 |
| | Mar. 24, 2023 | 5.70 | Mar. 29, 2023 | 5 | 46,914 | 3,737 |
| Cylinders: | Mar. 24, 2023 | 8.00 | Mar. 29, 2023 | 5 | 28,050 | 2,233 |
| | Mar. 24, 2023 | 8.10 | Mar. 29, 2023 | 5 | 32,518 | 2,593 |
| | Mar. 24, 2023 | 8.10 | Mar. 29, 2023 | 5 | 31,329 | 2,497 |
| | Mar. 24, 2023 | 5.55 | Apr. 3, 2023 | 10 | 51,776 | 4,131 |
| | Mar. 24, 2023 | 5.60 | Apr. 3, 2023 | 10 | 50,811 | 4,054 |
| | Mar. 24, 2023 | 5.60 | Apr. 3, 2023 | 10 | 49,411 | 3,944 |
| | Mar. 24, 2023 | 5.60 | Apr. 3, 2023 | 10 | 50,659 | 4,037 |
| | Mar. 24, 2023 | 5.65 | Apr. 3, 2023 | 10 | 50,059 | 3,994 |
| | Mar. 24, 2023 | 5.65 | Apr. 3, 2023 | 10 | 49,657 | 3,962 |
| | Mar. 24, 2023 | 5.65 | Apr. 3, 2023 | 10 | 52,854 | 4,216 |
| | Mar. 24, 2023 | 5.65 | Apr. 3, 2023 | 10 | 48,768 | 3,891 |
| | Mar. 24, 2023 | 5.65 | Apr. 3, 2023 | 10 | 48,282 | 3,853 |
| | Mar. 24, 2023 | 5.65 | Apr. 3, 2023 | 10 | 49,019 | 3,910 |
| | Mar. 24, 2023 | 5.65 | Apr. 3, 2023 | 10 | 49,510 | 3,951 |
| | Mar. 24, 2023 | 5.65 | Apr. 3, 2023 | 10 | 50,463 | 4,027 |
| Cylinders: | Mar. 24, 2023 | 8.00 | Apr. 3, 2023 | 10 | 39,067 | 3,116 |
| | Mar. 24, 2023 | 8.00 | Apr. 3, 2023 | 10 | 38,202 | 3,048 |
| | Mar. 24, 2023 | 8.35 | Apr. 3, 2023 | 10 | 36,874 | 2,942 |
| | Mar. 24, 2023 | 5.55 | Apr. 8, 2023 | 15 | 52,097 | 4,156 |
| | Mar. 24, 2023 | 5.55 | Apr. 8, 2023 | 15 | 51,079 | 4,070 |
| | Mar. 24, 2023 | 5.55 | Apr. 8, 2023 | 15 | 50,293 | 4,013 |
| | Mar. 24, 2023 | 5.55 | Apr. 8, 2023 | 15 | 56,271 | 4,487 |
| | Mar. 24, 2023 | 5.60 | Apr. 8, 2023 | 15 | 57,046 | 4,550 |
| | Mar. 24, 2023 | 5.60 | Apr. 8, 2023 | 15 | 55,266 | 4,404 |
| | Mar. 24, 2023 | 5.60 | Apr. 8, 2023 | 15 | 59,657 | 4,756 |
| | Mar. 24, 2023 | 5.60 | Apr. 8, 2023 | 15 | 53,627 | 4,277 |
| | Mar. 24, 2023 | 5.60 | Apr. 8, 2023 | 15 | 50,568 | 4,035 |
| | Mar. 24, 2023 | 5.60 | Apr. 8, 2023 | 15 | 57,413 | 4,579 |
| | Mar. 24, 2023 | 5.60 | Apr. 8, 2023 | 15 | 57,782 | 4,609 |
| | Mar. 24, 2023 | 5.65 | Apr. 8, 2023 | 15 | 61,888 | 4,931 |
| Cylinders: | Mar. 24, 2023 | 8.00 | Apr. 8, 2023 | 15 | 44,480 | 3,549 |
| | Mar. 24, 2023 | 8.05 | Apr. 8, 2023 | 15 | 49,161 | 3,922 |
| | Mar. 24, 2023 | 8.20 | Apr. 8, 2023 | 15 | 42,992 | 3,430 |
| | Mar. 24, 2023 | 5.55 | Apr. 13, 2023 | 20 | 50,523 | 4,031 |
| | Mar. 24, 2023 | 5.55 | Apr. 13, 2023 | 20 | 62,352 | 4,974 |
| | Mar. 24, 2023 | 5.60 | Apr. 13, 2023 | 20 | 55,081 | 4,394 |
| | Mar. 24, 2023 | 5.60 | Apr. 13, 2023 | 20 | 60,534 | 4,829 |
| | Mar. 24, 2023 | 5.60 | Apr. 13, 2023 | 20 | 53,879 | 4,298 |
| | Mar. 24, 2023 | 5.65 | Apr. 13, 2023 | 20 | 54,773 | 4,371 |
| | Mar. 24, 2023 | 5.65 | Apr. 13, 2023 | 20 | 60,559 | 4,831 |
| | Mar. 24, 2023 | 5.65 | Apr. 13, 2023 | 20 | 56,109 | 4,476 |
| | Mar. 24, 2023 | 5.65 | Apr. 13, 2023 | 20 | 53,853 | 4,296 |
| | Mar. 24, 2023 | 5.65 | Apr. 13, 2023 | 20 | 59,782 | 4,769 |
| | Mar. 24, 2023 | 5.65 | Apr. 13, 2023 | 20 | 60,932 | 4,851 |
| | Mar. 24, 2023 | 5.65 | Apr. 13, 2023 | 20 | 59,697 | 4,752 |
| Cylinders: | Mar. 24, 2023 | 8.15 | Apr. 13, 2023 | 20 | 42,738 | 3,405 |
| | Mar. 24, 2023 | 8.25 | Apr. 13, 2023 | 20 | 52,602 | 4,189 |
| | Mar. 24, 2023 | 8.30 | Apr. 13, 2023 | 20 | 53,818 | 3,489 |
| | Mar. 24, 2023 | 5.55 | Apr. 21, 2023 | 28 | 59,888 | 4,782 |
| | Mar. 24, 2023 | 5.55 | Apr. 21, 2023 | 28 | 58,198 | 4,634 |
| | Mar. 24, 2023 | 5.55 | Apr. 21, 2023 | 28 | 61,216 | 4,888 |
| | Mar. 24, 2023 | 5.55 | Apr. 21, 2023 | 28 | 61,523 | 4,900 |
| | Mar. 24, 2023 | 5.60 | Apr. 21, 2023 | 28 | 59,938 | 4,786 |
| | Mar. 24, 2023 | 5.60 | Apr. 21, 2023 | 28 | 62,318 | 4,976 |
| | Mar. 24, 2023 | 5.60 | Apr. 21, 2023 | 28 | 61,360 | 4,887 |
| | Mar. 24, 2023 | 5.60 | Apr. 21, 2023 | 28 | 58,972 | 4,695 |
| | Mar. 24, 2023 | 5.65 | Apr. 21, 2023 | 28 | 61,021 | 4,860 |
| | Mar. 24, 2023 | 5.65 | Apr. 21, 2023 | 28 | 61,172 | 4,872 |
| | Mar. 24, 2023 | 5.65 | Apr. 21, 2023 | 28 | 59,100 | 4,707 |
| | Mar. 24, 2023 | 5.65 | Apr. 21, 2023 | 28 | 58,723 | 4,677 |
| Cylinders: | Mar. 24, 2023 | 8.05 | Apr. 21, 2023 | 28 | 48,867 | 3,892 |
| | Mar. 24, 2023 | 8.25 | Apr. 21, 2023 | 28 | 50,901 | 4,054 |
| | Mar. 24, 2023 | 8.30 | Apr. 21, 2023 | 28 | 48,089 | 3,830 |

Comparative to Table 38 for improved results despite removing 20% of the binder.

In Table 52, “PB45” is Portland cement, sand, aggregate and water, and binder reducing agent, tested in duplicate, triplicate, etc., as the case may be (“PB45” is sample 1 and “T133” is sample 2 from a pour). Per 3′×6′×6″ slab and 15 8″×4″ Cylinders: 144 lbs. of Portland IL (PLC) cement, 656 lbs. of medium to large aggregate (rock), 432 lbs. of fine aggregate (sand), and 88 lbs. of water and 10.8 lbs. of binder reducing formulation. All cylinders were mixed and cured pursuant to the guidelines of ASTM C31: Standard Practice for Making and Curing Concrete Test Specimens in the Field. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical

| Formula | Pour Date | Weight (lb) | Table 52 Test Date | Cure Days | LBF | PSI |
|---|---|---|---|---|---|---|
| PB45 | May 2, 2023 | 5.40 | May 7, 2023 | 5 | 48,649 | 3,870 |
| T133 | May 2, 2023 | 5.45 | May 7, 2023 | 5 | 44,633 | 3,551 |
| 3′ × 6′ × 6″ Slab (Cores) | May 2, 2023 | 5.45 | May 7, 2023 | 5 | 46,550 | 3,701 |
| & 10 Cylinders | May 2, 2023 | 5.45 | May 7, 2023 | 5 | 47,599 | 3,787 |
| −25% Portland 1L | May 2, 2023 | 5.45 | May 7, 2023 | 5 | 52,427 | 4,169 |
| 1:3:2 Mix | May 2, 2023 | 5.45 | May 7, 2023 | 5 | 48,724 | 3,877 |
| | May 2, 2023 | 5.45 | May 7, 2023 | 5 | 52,539 | 4,180 |
| | May 2, 2023 | 5.45 | May 7, 2023 | 5 | 47,322 | 3,765 |
| | May 2, 2023 | 5.45 | May 7, 2023 | 5 | 48,251 | 3,839 |
| | May 2, 2023 | 5.45 | May 7, 2023 | 5 | 60,924 | 4,847 |
| | May 2, 2023 | 5.45 | May 7, 2023 | 5 | 53,719 | 4,275 |
| | May 2, 2023 | 5.45 | May 7, 2023 | 5 | 56,542 | 4,498 |
| Cylinders: | May 2, 2023 | 8.45 | May 7, 2023 | 5 | 39,581 | 3,150 |
| | May 2, 2023 | 8.45 | May 7, 2023 | 5 | 39,667 | 3,156 |
| | May 2, 2023 | 5.40 | May 12, 2023 | 10 | 50,470 | 4,016 |
| | May 2, 2023 | 5.40 | May 12, 2023 | 10 | 49,902 | 3,969 |
| | May 2, 2023 | 5.40 | May 12, 2023 | 10 | 54,705 | 4,351 |
| | May 2, 2023 | 5.40 | May 12, 2023 | 10 | 59,376 | 4,725 |
| | May 2, 2023 | 5.40 | May 12, 2023 | 10 | 53,487 | 4,256 |
| | May 2, 2023 | 5.40 | May 12, 2023 | 10 | 49,717 | 3,956 |
| | May 2, 2023 | 5.40 | May 12, 2023 | 10 | 60,124 | 4,782 |
| | May 2, 2023 | 5.40 | May 12, 2023 | 10 | 54,841 | 4,364 |
| | May 2, 2023 | 5.45 | May 12, 2023 | 10 | 58,132 | 4,625 |
| | May 2, 2023 | 5.45 | May 12, 2023 | 10 | 64,929 | 5,166 |
| | May 2, 2023 | 5.45 | May 12, 2023 | 10 | 53,245 | 4,235 |
| | May 2, 2023 | 5.45 | May 12, 2023 | 10 | 52,495 | 4,176 |
| Cylinders: | May 2, 2023 | 8.50 | May 12, 2023 | 10 | 44,859 | 3,560 |
| | May 2, 2023 | 8.50 | May 12, 2023 | 10 | 44,194 | 3,516 |
| | May 2, 2023 | 5.40 | May 17, 2023 | 15 | 59,051 | 4,698 |
| | May 2, 2023 | 5.40 | May 17, 2023 | 15 | 57,808 | 4,597 |
| | May 2, 2023 | 5.40 | May 17, 2023 | 15 | 55,557 | 4,418 |
| | May 2, 2023 | 5.45 | May 17, 2023 | 15 | 63,737 | 5,069 |
| | May 2, 2023 | 5.45 | May 17, 2023 | 15 | 64,048 | 5,097 |
| | May 2, 2023 | 5.45 | May 17, 2023 | 15 | 62,650 | 4,982 |
| | May 2, 2023 | 5.45 | May 17, 2023 | 15 | 58,522 | 4,657 |
| | May 2, 2023 | 5.45 | May 17, 2023 | 15 | 54,470 | 4,331 |
| | May 2, 2023 | 5.45 | May 17, 2023 | 15 | 54,860 | 4,361 |
| | May 2, 2023 | 5.45 | May 17, 2023 | 15 | 57,509 | 4,576 |
| | May 2, 2023 | 5.45 | May 17, 2023 | 15 | 60,679 | 4,829 |
| | May 2, 2023 | 5.45 | May 17, 2023 | 15 | 55,771 | 4,435 |
| Cylinders: | May 2, 2023 | 8.50 | May 17, 2023 | 15 | 47,571 | 3,786 |
| | May 2, 2023 | 8.55 | May 17, 2023 | 15 | 48,930 | 3,894 |
| | May 2, 2023 | 5.60 | May 22, 2023 | 20 | 63,831 | 5,079 |
| | May 2, 2023 | 5.60 | May 22, 2023 | 20 | 56,777 | 4,517 |
| | May 2, 2023 | 5.60 | May 22, 2023 | 20 | 59,740 | 4,754 |
| | May 2, 2023 | 5.65 | May 22, 2023 | 20 | 57,967 | 4,610 |
| | May 2, 2023 | 5.65 | May 22, 2023 | 20 | 64,533 | 5,135 |
| | May 2, 2023 | 5.65 | May 22, 2023 | 20 | 56,843 | 4,523 |
| | May 2, 2023 | 5.65 | May 22, 2023 | 20 | 63,065 | 5,018 |
| | May 2, 2023 | 5.70 | May 22, 2023 | 20 | 57,057 | 4,540 |
| | May 2, 2023 | 5.70 | May 22, 2023 | 20 | 55,863 | 4,445 |
| | May 2, 2023 | 5.70 | May 22, 2023 | 20 | 66,795 | 5,315 |
| | May 2, 2023 | 5.70 | May 22, 2023 | 20 | 66,133 | 5,260 |
| | May 2, 2023 | 5.75 | May 22, 2023 | 20 | 57,619 | 4,584 |
| Cylinders: | May 2, 2023 | 8.45 | May 22, 2023 | 20 | 51,996 | 4,138 |
| | May 2, 2023 | 8.50 | May 22, 2023 | 20 | 53,637 | 4,268 |
| | May 2, 2023 | 5.10 | May 30, 2023 | 28 | 69,087 | 5,498 |
| | May 2, 2023 | 5.10 | May 30, 2023 | 28 | 67,214 | 5,367 |
| | May 2, 2023 | 5.10 | May 30, 2023 | 28 | 67,997 | 5,410 |
| | May 2, 2023 | 5.10 | May 30, 2023 | 28 | 69,010 | 5,490 |
| | May 2, 2023 | 5.10 | May 30, 2023 | 28 | 66,897 | 5,304 |
| | May 2, 2023 | 5.20 | May 30, 2023 | 28 | 65,451 | 5,208 |
| | May 2, 2023 | 5.20 | May 30, 2023 | 28 | 72,719 | 5,785 |
| | May 2, 2023 | 5.20 | May 30, 2023 | 28 | 67,930 | 5,405 |
| | May 2, 2023 | 5.20 | May 30, 2023 | 28 | 70,660 | 5,622 |
| | May 2, 2023 | 5.25 | May 30, 2023 | 28 | 66,248 | 5,271 |
| | May 2, 2023 | 5.30 | May 30, 2023 | 28 | 77,321 | 6,153 |
| | May 2, 2023 | 5.30 | May 30, 2023 | 28 | 70,157 | 5,582 |
| Cylinders: | May 2, 2023 | 8.50 | May 30, 2023 | 28 | 55,115 | 4,386 |
| | May 2, 2023 | 8.55 | May 30, 2023 | 28 | 54,698 | 4,352 |

Comparative to Table 38 for improved results despite removing 25% of the binder.

In Table 53, “PB45” is Portland cement, sand, aggregate and water, and binder reducing agent, tested in duplicate, triplicate, etc., as the case may be (“PB45” is sample 1 and “T134” is sample 2 from a pour). Per 3′×6′×6″ slab and 15 8″×4″ Cylinders: 144 lbs. of Portland I/II cement, 656 lbs. of medium to large aggregate (rock), 432 lbs. of fine aggregate (sand), and 88 lbs. of water and 10.8 lbs. of binder reducing formulation. All cylinders were mixed and cured pursuant to the guidelines of ASTM C31: Standard Practice for Making and Curing Concrete Test Specimens in the Field. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical

TABLE 53

| Formula | Pour Date | Weight (lb) | Test Date | Cure Days | LBF | PSI |
|---|---|---|---|---|---|---|
| PB45 | May 2, 2023 | 5.50 | May 7, 2023 | 5 | 60,571 | 4,819 |
| T134 | May 2, 2023 | 5.50 | May 7, 2023 | 5 | 59,319 | 4,720 |
| 3′ × 6′ × 6″ Slab (Cores) | May 2, 2023 | 5.50 | May 7, 2023 | 5 | 63,373 | 5,043 |
| & 10 Cylinders | May 2, 2023 | 5.50 | May 7, 2023 | 5 | 57,873 | 4,604 |
| −25% Portland I/II | May 2, 2023 | 5.50 | May 7, 2023 | 5 | 60,990 | 4,853 |
| 1:3:2 Mix | May 2, 2023 | 5.50 | May 7, 2023 | 5 | 58,326 | 4,641 |
| | May 2, 2023 | 5.50 | May 7, 2023 | 5 | 58,933 | 4,690 |
| | May 2, 2023 | 5.50 | May 7, 2023 | 5 | 58,609 | 4,663 |
| | May 2, 2023 | 5.50 | May 7, 2023 | 5 | 54,449 | 4,331 |
| | May 2, 2023 | 5.50 | May 7, 2023 | 5 | 59,364 | 4,723 |
| | May 2, 2023 | 5.50 | May 7, 2023 | 5 | 57,076 | 4,542 |
| | May 2, 2023 | 5.55 | May 7, 2023 | 5 | 58,652 | 4,667 |
| Cylinders: | May 2, 2023 | 8.55 | May 7, 2023 | 5 | 52,089 | 4,145 |
| | May 2, 2023 | 8.55 | May 7, 2023 | 5 | 51,194 | 4,074 |
| | May 2, 2023 | 5.45 | May 12, 2023 | 10 | 59,184 | 4,710 |
| | May 2, 2023 | 5.50 | May 12, 2023 | 10 | 53,871 | 4,287 |
| | May 2, 2023 | 5.50 | May 12, 2023 | 10 | 58,099 | 4,621 |
| | May 2, 2023 | 5.50 | May 12, 2023 | 10 | 56,792 | 4,518 |
| | May 2, 2023 | 5.50 | May 12, 2023 | 10 | 59,711 | 4,749 |
| | May 2, 2023 | 5.50 | May 12, 2023 | 10 | 60,007 | 4,774 |
| | May 2, 2023 | 5.50 | May 12, 2023 | 10 | 55,617 | 4,425 |
| | May 2, 2023 | 5.50 | May 12, 2023 | 10 | 59,852 | 4,762 |
| | May 2, 2023 | 5.50 | May 12, 2023 | 10 | 54,378 | 4,327 |
| | May 2, 2023 | 5.55 | May 12, 2023 | 10 | 60,923 | 4,846 |
| | May 2, 2023 | 5.55 | May 12, 2023 | 10 | 54,319 | 4,320 |
| | May 2, 2023 | 5.55 | May 12, 2023 | 10 | 59,606 | 4,743 |
| Cylinders: | May 2, 2023 | 8.55 | May 12, 2023 | 10 | 59,977 | 4,769 |
| | May 2, 2023 | 8.55 | May 12, 2023 | 10 | 56,110 | 4,461 |
| | May 2, 2023 | 5.45 | May 17, 2023 | 15 | 64,652 | 5,145 |
| | May 2, 2023 | 5.50 | May 17, 2023 | 15 | 70,199 | 5,586 |
| | May 2, 2023 | 5.50 | May 17, 2023 | 15 | 64,309 | 5,118 |
| | May 2, 2023 | 5.50 | May 17, 2023 | 15 | 65,018 | 5,172 |
| | May 2, 2023 | 5.50 | May 17, 2023 | 15 | 64,947 | 5,167 |
| | May 2, 2023 | 5.50 | May 17, 2023 | 15 | 65,756 | 5,229 |
| | May 2, 2023 | 5.50 | May 17, 2023 | 15 | 63,894 | 5,081 |
| | May 2, 2023 | 5.50 | May 17, 2023 | 15 | 62,448 | 4,966 |
| | May 2, 2023 | 5.50 | May 17, 2023 | 15 | 3,931 | 5,087 |
| | May 2, 2023 | 5.50 | May 17, 2023 | 15 | 62,336 | 4,961 |
| | May 2, 2023 | 5.50 | May 17, 2023 | 15 | 65,190 | 5,184 |
| | May 2, 2023 | 5.50 | May 17, 2023 | 15 | 62,410 | 4,966 |
| Cylinders: | May 2, 2023 | 8.55 | May 17, 2023 | 15 | 59,974 | 4,769 |
| | May 2, 2023 | 8.60 | May 17, 2023 | 15 | 61,606 | 4,899 |
| | May 2, 2023 | 5.70 | May 22, 2023 | 20 | 65,684 | 5,226 |
| | May 2, 2023 | 5.70 | May 22, 2023 | 20 | 60,108 | 4,783 |
| | May 2, 2023 | 5.75 | May 22, 2023 | 20 | 64,941 | 5,152 |
| | May 2, 2023 | 5.75 | May 22, 2023 | 20 | 69,097 | 5,494 |
| | May 2, 2023 | 5.75 | May 22, 2023 | 20 | 63,109 | 5,017 |
| | May 2, 2023 | 5.75 | May 22, 2023 | 20 | 60,516 | 4,814 |
| | May 2, 2023 | 5.75 | May 22, 2023 | 20 | 76,497 | 6,084 |
| | May 2, 2023 | 5.75 | May 22, 2023 | 20 | 64,932 | 5,167 |
| | May 2, 2023 | 5.75 | May 22, 2023 | 20 | 70,924 | 5,643 |
| | May 2, 2023 | 5.75 | May 22, 2023 | 20 | 68,228 | 5,429 |
| | May 2, 2023 | 5.80 | May 22, 2023 | 20 | 68,150 | 5,423 |
| | May 2, 2023 | 5.85 | May 22, 2023 | 20 | 70,450 | 5,606 |
| Cylinders: | May 2, 2023 | 8.55 | May 22, 2023 | 20 | 65,580 | 5,216 |
| | May 2, 2023 | 8.55 | May 22, 2023 | 20 | 64,506 | 5,131 |
| | May 2, 2023 | 5.30 | May 30, 2023 | 28 | 81,855 | 6,514 |
| | May 2, 2023 | 5.30 | May 30, 2023 | 28 | 79,407 | 6,317 |
| | May 2, 2023 | 5.30 | May 30, 2023 | 28 | 74,480 | 5,927 |
| | May 2, 2023 | 5.30 | May 30, 2023 | 28 | 74,847 | 5,956 |
| | May 2, 2023 | 5.35 | May 30, 2023 | 28 | 77,029 | 6,130 |
| | May 2, 2023 | 5.35 | May 30, 2023 | 28 | 81,145 | 6,457 |
| | May 2, 2023 | 5.35 | May 30, 2023 | 28 | 76,372 | 6,077 |
| | May 2, 2023 | 5.35 | May 30, 2023 | 28 | 79,735 | 6,345 |
| | May 2, 2023 | 5.35 | May 30, 2023 | 28 | 79,131 | 6,297 |
| | May 2, 2023 | 5.35 | May 30, 2023 | 28 | 74,696 | 5,944 |
| | May 2, 2023 | 5.35 | May 30, 2023 | 28 | 80,972 | 6,440 |
| | May 2, 2023 | 5.35 | May 30, 2023 | 28 | 80,452 | 6,402 |
| Cylinders: | May 2, 2023 | 8.55 | May 30, 2023 | 28 | 64,828 | 5,158 |
| | May 2, 2023 | 8.55 | May 30, 2023 | 28 | 64,652 | 5,144 |

Comparative to Table 9 for improved results despite removing 25% of the binder.

In Table 54, “PB45” is Portland cement, sand, aggregate and water, and binder reducing agent, tested in duplicate, triplicate, etc., as the case may be (“PB45” is sample 1 and “T135” is sample 2 from a pour). Per 8-yard slab and 48 8″×4″ Cylinders: 451 lbs. of Portland IL (PLC) cement, 1750 lbs. of medium to large aggregate (rock), 1350 lbs. of fine aggregate (sand), and 221 lbs. of water and 32 lbs. of binder reducing formulation. All cylinders were mixed and cured pursuant to the guidelines of ASTM C31: Standard Practice for Making and Curing Concrete Test Specimens in the Field. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical

TABLE 54

| Formula | Pour Date | Weight (lb) | Test Date | Cure Days | LBF | PSI |
|---|---|---|---|---|---|---|
| PB45 | May 22, 2023 | 5.65 | May 27, 2023 | 5 | 37,871 | 3,012 |
| T135 | May 22, 2023 | 5.65 | May 27, 2023 | 5 | 36,817 | 2,929 |
| 8 yard Slab | May 22, 2023 | 5.65 | May 27, 2023 | 5 | 37,497 | 2,983 |
| (Cores) | | | | | | |
| & 48 Cylinders | May 22, 2023 | 5.65 | May 27, 2023 | 5 | 37,049 | 2,948 |
| −20% Portland | May 22, 2023 | 5.65 | May 27, 2023 | 5 | 32,806 | 2,610 |
| 1 L | | | | | | |
| 1:3:2 Mix | May 22, 2023 | 5.70 | May 27, 2023 | 5 | 32,477 | 2,584 |
| | May 22, 2023 | 5.70 | May 27, 2023 | 5 | 35,511 | 2,825 |
| | May 22, 2023 | 5.70 | May 27, 2023 | 5 | 35,572 | 2,830 |
| | May 22, 2023 | 5.70 | May 27, 2023 | 5 | 39,332 | 3,130 |
| | May 22, 2023 | 5.70 | May 27, 2023 | 5 | 35,922 | 2,856 |
| | May 22, 2023 | 5.70 | May 27, 2023 | 5 | 33,817 | 2,691 |
| | May 22, 2023 | 5.70 | May 27, 2023 | 5 | 32,541 | 2,590 |
| | May 22, 2023 | 5.70 | May 27, 2023 | 5 | 36,034 | 2,868 |
| | May 22, 2023 | 5.70 | May 27, 2023 | 5 | 38,525 | 3,065 |
| | May 22, 2023 | 5.70 | May 27, 2023 | 5 | 37,337 | 2,971 |
| | May 22, 2023 | 5.70 | May 27, 2023 | 5 | 35,806 | 2,833 |
| | May 22, 2023 | 5.70 | May 27, 2023 | 5 | 41,741 | 3,321 |
| | May 22, 2023 | 5.70 | May 27, 2023 | 5 | 41,610 | 3,308 |
| | May 22, 2023 | 5.70 | May 27, 2023 | 5 | 39,107 | 3,109 |
| | May 22, 2023 | 5.75 | May 27, 2023 | 5 | 41,445 | 3,297 |
| | May 22, 2023 | 5.75 | May 27, 2023 | 5 | 38,197 | 3,039 |
| | May 22, 2023 | 5.75 | May 27, 2023 | 5 | 36,536 | 2,905 |
| | May 22, 2023 | 5.75 | May 27, 2023 | 5 | 36,541 | 2,903 |
| | May 22, 2023 | 5.75 | May 27, 2023 | 5 | 39,911 | 3,175 |
| | May 22, 2023 | 5.75 | May 27, 2023 | 5 | 44,631 | 3,551 |
| | May 22, 2023 | 5.75 | May 27, 2023 | 5 | 40,408 | 3,215 |
| Cylinders: | May 22, 2023 | 8.40 | May 27, 2023 | 5 | 42,351 | 3,368 |
| | May 22, 2023 | 8.50 | May 27, 2023 | 5 | 41,087 | 3,269 |
| | May 22, 2023 | 8.50 | May 27, 2023 | 5 | 40,753 | 3,243 |
| | May 22, 2023 | 8.50 | May 27, 2023 | 5 | 41,247 | 3,281 |
| | May 22, 2023 | 8.50 | May 27, 2023 | 5 | 41,985 | 3,340 |
| | May 22, 2023 | 8.50 | May 27, 2023 | 5 | 40,857 | 3,250 |
| | May 22, 2023 | 8.55 | May 27, 2023 | 5 | 41,015 | 3,264 |
| | May 22, 2023 | 8.55 | May 27, 2023 | 5 | 40,071 | 3,186 |
| | May 22, 2023 | 5.60 | Jun. 1, 2023 | 10 | 37,740 | 2,995 |
| | May 22, 2023 | 5.60 | Jun. 1, 2023 | 10 | 31,802 | 2,530 |
| | May 22, 2023 | 5.75 | Jun. 1, 2023 | 10 | 43,637 | 3,472 |
| | May 22, 2023 | 5.75 | Jun. 1, 2023 | 10 | 38,638 | 3,074 |
| | May 22, 2023 | 5.75 | Jun. 1, 2023 | 10 | 38,769 | 3,084 |
| | May 22, 2023 | 5.75 | Jun. 1, 2023 | 10 | 39,215 | 3,120 |
| | May 22, 2023 | 5.75 | Jun. 1, 2023 | 10 | 46,866 | 3,728 |
| | May 22, 2023 | 5.75 | Jun. 1, 2023 | 10 | 44,394 | 3,532 |
| | May 22, 2023 | 5.75 | Jun. 1, 2023 | 10 | 40,745 | 3,242 |
| | May 22, 2023 | 5.75 | Jun. 1, 2023 | 10 | 37,486 | 2,983 |
| | May 22, 2023 | 5.75 | Jun. 1, 2023 | 10 | 40,799 | 3,246 |
| | May 22, 2023 | 5.75 | Jun. 1, 2023 | 10 | 39,554 | 3,147 |
| | May 22, 2023 | 5.75 | Jun. 1, 2023 | 10 | 39,301 | 3,127 |
| | May 22, 2023 | 5.75 | Jun. 1, 2023 | 10 | 36,507 | 2,903 |
| | May 22, 2023 | 5.75 | Jun. 1, 2023 | 10 | 38,702 | 3,078 |
| | May 22, 2023 | 5.75 | Jun. 1, 2023 | 10 | 40,026 | 3,184 |
| | May 22, 2023 | 5.75 | Jun. 1, 2023 | 10 | 37,368 | 2,972 |
| | May 22, 2023 | 5.75 | Jun. 1, 2023 | 10 | 43,186 | 3,436 |
| | May 22, 2023 | 5.75 | Jun. 1, 2023 | 10 | 39,457 | 3,137 |
| | May 22, 2023 | 5.75 | Jun. 1, 2023 | 10 | 43,317 | 3,446 |
| | May 22, 2023 | 5.75 | Jun. 1, 2023 | 10 | 40,917 | 3,255 |
| | May 22, 2023 | 5.75 | Jun. 1, 2023 | 10 | 39,228 | 3,121 |
| | May 22, 2023 | 5.75 | Jun. 1, 2023 | 10 | 37,491 | 2,987 |
| | May 22, 2023 | 5.75 | Jun. 1, 2023 | 10 | 37,726 | 2,994 |
| | May 22, 2023 | 5.75 | Jun. 1, 2023 | 10 | 42,509 | 3,382 |
| | May 22, 2023 | 5.75 | Jun. 1, 2023 | 10 | 42,043 | 3,345 |
| Cylinders: | May 22, 2023 | 8.45 | Jun. 1, 2023 | 10 | 44,691 | 3,555 |
| | May 22, 2023 | 8.45 | Jun. 1, 2023 | 10 | 47,011 | 3,741 |
| | May 22, 2023 | 8.45 | Jun. 1, 2023 | 10 | 47,127 | 3,749 |
| | May 22, 2023 | 8.50 | Jun. 1, 2023 | 10 | 42,039 | 3,343 |
| | May 22, 2023 | 8.50 | Jun. 1, 2023 | 10 | 42,703 | 3,398 |
| | May 22, 2023 | 8.50 | Jun. 1, 2023 | 10 | 44,132 | 3,510 |
| | May 22, 2023 | 8.50 | Jun. 1, 2023 | 10 | 44,902 | 3,572 |
| | May 22, 2023 | 8.55 | Jun. 1, 2023 | 10 | 44,244 | 3,520 |
| | May 22, 2023 | 5.65 | Jun. 6, 2023 | 15 | 39,228 | 3,121 |
| | May 22, 2023 | 5.70 | Jun. 6, 2023 | 15 | 43,036 | 3,425 |
| | May 22, 2023 | 5.70 | Jun. 6, 2023 | 15 | 43,427 | 3,452 |
| | May 22, 2023 | 5.70 | Jun. 6, 2023 | 15 | 43,078 | 3,428 |
| | May 22, 2023 | 5.70 | Jun. 6, 2023 | 15 | 43,233 | 3,439 |
| | May 22, 2023 | 5.70 | Jun. 6, 2023 | 15 | 41,699 | 3,318 |
| | May 22, 2023 | 5.70 | Jun. 6, 2023 | 15 | 45,009 | 3,579 |
| | May 22, 2023 | 5.70 | Jun. 6, 2023 | 15 | 47,515 | 3,779 |
| | May 22, 2023 | 5.70 | Jun. 6, 2023 | 15 | 40,850 | 3,250 |
| | May 22, 2023 | 5.70 | Jun. 6, 2023 | 15 | 46,126 | 3,666 |
| | May 22, 2023 | 5.70 | Jun. 6, 2023 | 15 | 42,219 | 3,358 |
| | May 22, 2023 | 5.70 | Jun. 6, 2023 | 15 | 41,682 | 3,316 |
| | May 22, 2023 | 5.70 | Jun. 6, 2023 | 15 | 37,298 | 2,966 |
| | May 22, 2023 | 5.70 | Jun. 6, 2023 | 15 | 44,238 | 3,520 |
| | May 22, 2023 | 5.75 | Jun. 6, 2023 | 15 | 43,627 | 3,469 |
| | May 22, 2023 | 5.75 | Jun. 6, 2023 | 15 | 43,144 | 3,433 |
| | May 22, 2023 | 5.75 | Jun. 6, 2023 | 15 | 43,203 | 3,438 |
| | May 22, 2023 | 5.75 | Jun. 6, 2023 | 15 | 40,490 | 3,222 |
| | May 22, 2023 | 5.75 | Jun. 6, 2023 | 15 | 39,836 | 3,164 |
| | May 22, 2023 | 5.75 | Jun. 6, 2023 | 15 | 41,378 | 3,292 |
| | May 22, 2023 | 5.75 | Jun. 6, 2023 | 15 | 42,777 | 3,401 |
| | May 22, 2023 | 5.75 | Jun. 6, 2023 | 15 | 44,943 | 3,571 |
| | May 22, 2023 | 5.80 | Jun. 6, 2023 | 15 | 51,692 | 4,112 |
| | May 22, 2023 | 5.85 | Jun. 6, 2023 | 15 | 43,178 | 3,435 |
| | May 22, 2023 | 5.85 | Jun. 6, 2023 | 15 | 48,894 | 3,890 |
| | May 22, 2023 | 5.85 | Jun. 6, 2023 | 15 | 47,373 | 3,769 |
| Cylinders: | May 22, 2023 | 8.45 | Jun. 6, 2023 | 15 | 46,407 | 3,692 |
| | May 22, 2023 | 8.50 | Jun. 6, 2023 | 15 | 48,900 | 3,891 |
| | May 22, 2023 | 8.50 | Jun. 6, 2023 | 15 | 47,779 | 3,800 |
| | May 22, 2023 | 8.50 | Jun. 6, 2023 | 15 | 52,047 | 4,141 |
| | May 22, 2023 | 8.50 | Jun. 6, 2023 | 15 | 49,807 | 3,962 |
| | May 22, 2023 | 8.50 | Jun. 6, 2023 | 15 | 50,743 | 4,036 |
| | May 22, 2023 | 8.55 | Jun. 6, 2023 | 15 | 47,006 | 3,740 |
| | May 22, 2023 | 8.55 | Jun. 6, 2023 | 15 | 47,715 | 3,792 |
| | May 22, 2023 | 5.50 | Jun. 11, 2023 | 20 | 43,205 | 3,438 |
| | May 22, 2023 | 5.55 | Jun. 11, 2023 | 20 | 47,541 | 3,783 |
| | May 22, 2023 | 5.55 | Jun. 11, 2023 | 20 | 48,856 | 3,886 |
| | May 22, 2023 | 5.55 | Jun. 11, 2023 | 20 | 45,511 | 3,622 |
| | May 22, 2023 | 5.55 | Jun. 11, 2023 | 20 | 48,623 | 3,869 |
| | May 22, 2023 | 5.55 | Jun. 11, 2023 | 20 | 47,970 | 3,817 |
| | May 22, 2023 | 5.55 | Jun. 11, 2023 | 20 | 46,928 | 3,734 |
| | May 22, 2023 | 5.65 | Jun. 11, 2023 | 20 | 51,621 | 4,105 |
| | May 22, 2023 | 5.70 | Jun. 11, 2023 | 20 | 46,934 | 3,733 |
| | May 22, 2023 | 5.70 | Jun. 11, 2023 | 20 | 43,977 | 3,500 |
| | May 22, 2023 | 5.70 | Jun. 11, 2023 | 20 | 43,104 | 3,429 |
| | May 22, 2023 | 5.75 | Jun. 11, 2023 | 20 | 48,410 | 3,851 |
| | May 22, 2023 | 5.75 | Jun. 11, 2023 | 20 | 48,586 | 3,865 |
| | May 22, 2023 | 5.75 | Jun. 11, 2023 | 20 | 46,801 | 3,724 |
| | May 22, 2023 | 5.75 | Jun. 11, 2023 | 20 | 45,820 | 3,645 |
| | May 22, 2023 | 5.75 | Jun. 11, 2023 | 20 | 48,925 | 3,892 |
| | May 22, 2023 | 5.80 | Jun. 11, 2023 | 20 | 47,140 | 3,750 |
| | May 22, 2023 | 5.80 | Jun. 11, 2023 | 20 | 46,208 | 3,677 |
| | May 22, 2023 | 5.80 | Jun. 11, 2023 | 20 | 47,494 | 3,778 |
| | May 22, 2023 | 5.80 | Jun. 11, 2023 | 20 | 47,086 | 3,744 |
| | May 22, 2023 | 6.25 | Jun. 11, 2023 | 20 | 43,451 | 3,457 |
| | May 22, 2023 | 6.25 | Jun. 11, 2023 | 20 | 43,422 | 3,454 |
| | May 22, 2023 | 6.25 | Jun. 11, 2023 | 20 | 48,347 | 3,846 |
| | May 22, 2023 | 6.30 | Jun. 11, 2023 | 20 | 48,246 | 3,838 |
| | May 22, 2023 | 6.30 | Jun. 11, 2023 | 20 | 45,396 | 3,611 |
| | May 22, 2023 | 6.30 | Jun. 11, 2023 | 20 | 47,404 | 3,771 |
| Cylinders: | May 22, 2023 | 8.45 | Jun. 11, 2023 | 20 | 51,814 | 4,123 |
| | May 22, 2023 | 8.45 | Jun. 11, 2023 | 20 | 49,950 | 3,974 |
| | May 22, 2023 | 8.45 | Jun. 11, 2023 | 20 | 53,151 | 4,229 |
| | May 22, 2023 | 8.50 | Jun. 11, 2023 | 20 | 52,201 | 4,152 |
| | May 22, 2023 | 8.50 | Jun. 11, 2023 | 20 | 49,932 | 3,973 |
| | May 22, 2023 | 8.50 | Jun. 11, 2023 | 20 | 50,673 | 4,032 |
| | May 22, 2023 | 8.55 | Jun. 11, 2023 | 20 | 50,906 | 4,050 |
| | May 22, 2023 | 8.55 | Jun. 11, 2023 | 20 | 48,074 | 3,821 |
| | May 22, 2023 | 5.45 | Jun. 19, 2023 | 28 | 47,083 | 3,745 |
| | May 22, 2023 | 5.45 | Jun. 19, 2023 | 28 | 48,860 | 3,887 |
| | May 22, 2023 | 5.45 | Jun. 19, 2023 | 28 | 45,423 | 3,614 |
| | May 22, 2023 | 5.50 | Jun. 19, 2023 | 28 | 48,991 | 3,898 |
| | May 22, 2023 | 5.50 | Jun. 19, 2023 | 28 | 47,168 | 3,752 |
| | May 22, 2023 | 5.50 | Jun. 19, 2023 | 28 | 46,263 | 3,681 |
| | May 22, 2023 | 5.50 | Jun. 19, 2023 | 28 | 50,012 | 3,979 |
| | May 22, 2023 | 5.50 | Jun. 19, 2023 | 28 | 50,485 | 4,017 |
| | May 22, 2023 | 5.50 | Jun. 19, 2023 | 28 | 48,282 | 3,840 |
| | May 22, 2023 | 5.50 | Jun. 19, 2023 | 28 | 45,280 | 3,597 |
| | May 22, 2023 | 5.50 | Jun. 19, 2023 | 28 | 43,826 | 3,487 |
| | May 22, 2023 | 5.90 | Jun. 19, 2023 | 28 | 43,110 | 3,429 |
| | May 22, 2023 | 5.90 | Jun. 19, 2023 | 28 | 41,775 | 3,322 |
| | May 22, 2023 | 5.90 | Jun. 19, 2023 | 28 | 47,808 | 3,802 |
| | May 22, 2023 | 5.90 | Jun. 19, 2023 | 28 | 41,248 | 3,282 |
| | May 22, 2023 | 5.95 | Jun. 19, 2023 | 28 | 46,407 | 3,693 |
| | May 22, 2023 | 5.95 | Jun. 19, 2023 | 28 | 42,433 | 3,376 |
| | May 22, 2023 | 6.00 | Jun. 19, 2023 | 28 | 42,733 | 3,398 |
| | May 22, 2023 | 6.00 | Jun. 19, 2023 | 28 | 45,563 | 3,623 |
| | May 22, 2023 | 6.10 | Jun. 19, 2023 | 28 | 45,823 | 3,643 |
| | May 22, 2023 | 6.15 | Jun. 19, 2023 | 28 | 40,325 | 3,208 |
| | May 22, 2023 | 6.15 | Jun. 19, 2023 | 28 | 40,228 | 3,200 |
| | May 22, 2023 | 6.20 | Jun. 19, 2023 | 28 | 41,061 | 3,265 |
| | May 22, 2023 | 6.20 | Jun. 19, 2023 | 28 | 39,870 | 3,172 |
| | May 22, 2023 | 6.20 | Jun. 19, 2023 | 28 | 41,400 | 3,293 |
| | May 22, 2023 | 6.25 | Jun. 19, 2023 | 28 | 41,831 | 3,329 |
| Cylinders: | May 22, 2023 | 8.45 | Jun. 19, 2023 | 28 | 53,026 | 4,216 |
| | May 22, 2023 | 8.45 | Jun. 19, 2023 | 28 | 53,710 | 4,233 |
| | May 22, 2023 | 8.45 | Jun. 19, 2023 | 28 | 53,886 | 4,285 |
| | May 22, 2023 | 8.50 | Jun. 19, 2023 | 28 | 52,481 | 4,176 |
| | May 22, 2023 | 8.50 | Jun. 19, 2023 | 28 | 53,327 | 4,244 |
| | May 22, 2023 | 8.50 | Jun. 19, 2023 | 28 | 53,469 | 4,254 |
| | May 22, 2023 | 8.50 | Jun. 19, 2023 | 28 | 52,977 | 4,215 |
| | May 22, 2023 | 8.50 | Jun. 19, 2023 | 28 | 56,722 | 4,514 |
| | May 22, 2023 | 5.35 | Jul. 17, 2023 | 56 | 44,836 | 3,568 |
| | May 22, 2023 | 5.40 | Jul. 17, 2023 | 56 | 44,974 | 3,579 |
| | May 22, 2023 | 5.40 | Jul. 17, 2023 | 56 | 46,580 | 3,706 |
| | May 22, 2023 | 5.40 | Jul. 17, 2023 | 56 | 49,260 | 3,919 |
| | May 22, 2023 | 5.40 | Jul. 17, 2023 | 56 | 45,074 | 3,582 |
| | May 22, 2023 | 5.40 | Jul. 17, 2023 | 56 | 48,277 | 3,842 |
| | May 22, 2023 | 5.40 | Jul. 17, 2023 | 56 | 47,482 | 3,777 |
| | May 22, 2023 | 5.40 | Jul. 17, 2023 | 56 | 49,002 | 3,898 |
| | May 22, 2023 | 5.40 | Jul. 17, 2023 | 56 | 49,046 | 3,903 |
| | May 22, 2023 | 5.40 | Jul. 17, 2023 | 56 | 49,908 | 3,966 |
| | May 22, 2023 | 5.45 | Jul. 17, 2023 | 56 | 53,053 | 4,221 |
| | May 22, 2023 | 5.45 | Jul. 17, 2023 | 56 | 52,343 | 4,164 |
| | May 22, 2023 | 5.45 | Jul. 17, 2023 | 56 | 50,864 | 4,047 |
| | May 22, 2023 | 5.50 | Jul. 17, 2023 | 56 | 46,194 | 3,674 |
| | May 22, 2023 | 5.50 | Jul. 17, 2023 | 56 | 51,630 | 4,108 |
| | May 22, 2023 | 5.65 | Jul. 17, 2023 | 56 | 53,754 | 4,277 |
| | May 22, 2023 | 5.65 | Jul. 17, 2023 | 56 | 50,097 | 3,986 |
| | May 22, 2023 | 5.65 | Jul. 17, 2023 | 56 | 47,721 | 3,796 |
| | May 22, 2023 | 5.65 | Jul. 17, 2023 | 56 | 48,161 | 3,832 |
| | May 22, 2023 | 5.65 | Jul. 17, 2023 | 56 | 48,114 | 3,828 |
| | May 22, 2023 | 5.65 | Jul. 17, 2023 | 56 | 46,175 | 3,674 |
| | May 22, 2023 | 5.65 | Jul. 17, 2023 | 56 | 46,382 | 3,691 |
| | May 22, 2023 | 5.65 | Jul. 17, 2023 | 56 | 47,606 | 3,788 |
| | May 22, 2023 | 5.65 | Jul. 17, 2023 | 56 | 46,428 | 3,695 |
| | May 22, 2023 | 5.65 | Jul. 17, 2023 | 56 | 45,364 | 3,609 |
| | May 22, 2023 | 5.70 | Jul. 17, 2023 | 56 | 47,815 | 3,805 |
| Cylinders: | May 22, 2023 | 8.40 | Jul. 17, 2023 | 56 | 55,087 | 4,382 |
| | May 22, 2023 | 8.45 | Jul. 17, 2023 | 56 | 54,067 | 4,301 |
| | May 22, 2023 | 8.45 | Jul. 17, 2023 | 56 | 55,240 | 4,396 |
| | May 22, 2023 | 8.45 | Jul. 17, 2023 | 56 | 56,618 | 4,505 |
| | May 22, 2023 | 8.45 | Jul. 17, 2023 | 56 | 56,391 | 4,487 |
| | May 22, 2023 | 8.45 | Jul. 17, 2023 | 56 | 56,687 | 4,511 |
| | May 22, 2023 | 8.50 | Jul. 17, 2023 | 56 | 53,750 | 4,275 |
| | May 22, 2023 | 8.55 | Jul. 17, 2023 | 56 | 55,452 | 4,409 |

Comparative to Table 38 for comparable results despite removing 200 of the binder.

In Table 55, “PB45” is Portland cement, sand, aggregate and water, and binder reducing agent, tested in duplicate, triplicate, etc., as the case may be (“PB45” is sample 1 and “T136A” is sample 2 from a pour, etc.). Per 6″×6″×21″ column and 2 8″×4″ Cylinders: 9.6 lbs. of Portland IL (PLC) cement, 41 lbs. of medium to large aggregate (rock), 27 lbs. of fine aggregate (sand), and 8.34 lbs. of water and 0.88 lbs. of binder reducing formulation. All cylinders were mixed and cured pursuant to the guidelines of ASTM C39: Standard Practice for Making and Curing Concrete Test Specimens in the Lab. Each of the test specimens were tested pursuant to ASTM C78: Standard Test Method for Flexural Strength of Concrete (Using Simple Beam with Third Point Loading).

TABLE 55

| Formula | Pour Date | Weight (lb) | Test Date | Cure Days | LBF | PSI |
|---|---|---|---|---|---|---|
| PB45 | May 25, 2023 | 64.35 | May 30, 2023 | 5 | 8,927 | 868 |
| T136A | May 25, 2023 | 64.60 | May 30, 2023 | 5 | 9,174 | 892 |
| −20% | May 25, 2023 | 63.65 | Jun. 4, 2023 | 10 | 9,380 | 912 |
| Portland 1 L | | | | | | |
| 1:3:2 Mix | May 25, 2023 | 63.80 | Jun. 4, 2023 | 10 | 9,226 | 897 |
| | May 25, 2023 | 63.45 | Jun. 9, 2023 | 15 | 9,442 | 918 |
| | May 25, 2023 | 64.15 | Jun. 9, 2023 | 15 | 9,524 | 926 |
| | May 25, 2023 | 63.40 | Jun. 14, 2023 | 20 | 9,586 | 932 |
| | May 25, 2023 | 64.35 | Jun. 14, 2023 | 20 | 9,699 | 943 |
| | May 25, 2023 | 63.65 | Jun. 22, 2023 | 28 | 9,925 | 965 |
| | May 25, 2023 | 64.95 | Jun. 22, 2023 | 28 | 9,637 | 937 |
| PB45 | May 31, 2023 | 63.70 | Jun. 5, 2023 | 5 | 9,123 | 887 |
| T136B | May 31, 2023 | 64.60 | Jun. 5, 2023 | 5 | 8,824 | 858 |
| −20% | May 31, 2023 | 64.85 | Jun. 10, 2023 | 10 | 9,164 | 891 |
| Portland 1 L | | | | | | |
| 1:3:2 Mix | May 31, 2023 | 63.50 | Jun. 10, 2023 | 10 | 9,349 | 909 |
| | May 31, 2023 | 63.95 | Jun. 15, 2023 | 15 | 9,565 | 930 |
| | May 31, 2023 | 64.80 | Jun. 15, 2023 | 15 | 9,390 | 913 |
| | May 31, 2023 | 63.60 | Jun. 20, 2023 | 20 | 9,658 | 939 |
| | May 31, 2023 | 64.85 | Jun. 20, 2023 | 20 | 9,647 | 938 |
| | May 31, 2023 | 63.85 | Jun. 28, 2023 | 28 | 9,668 | 940 |
| | May 31, 2023 | 64.55 | Jun. 28, 2023 | 28 | 9,781 | 951 |
| PB45 | Jun. 1, 2023 | 63.40 | Jun. 6, 2023 | 5 | 8,927 | 868 |
| T136C | Jun. 1, 2023 | 64.40 | Jun. 6, 2023 | 5 | 8,732 | 849 |
| −20% | Jun. 1, 2023 | 63.35 | Jun. 11, 2023 | 10 | 9,226 | 897 |
| Portland 1 L | | | | | | |
| 1:3:2 Mix | Jun. 1, 2023 | 64.00 | Jun. 11, 2023 | 10 | 9,380 | 912 |
| | Jun. 1, 2023 | 63.25 | Jun. 16, 2023 | 15 | 9,544 | 928 |
| | Jun. 1, 2023 | 64.25 | Jun. 16, 2023 | 15 | 9,493 | 923 |
| | Jun. 1, 2023 | 64.15 | Jun. 21, 2023 | 20 | 9,740 | 947 |
| | Jun. 1, 2023 | 64.20 | Jun. 21, 2023 | 20 | 9,514 | 925 |
| | Jun. 1, 2023 | 63.35 | Jun. 29, 2023 | 28 | 9,863 | 959 |
| | Jun. 1, 2023 | 63.40 | Jun. 29, 2023 | 28 | 9,894 | 962 |
| PB45 | Jun. 2, 2023 | 64.80 | Jun. 7, 2023 | 5 | 8,948 | 870 |
| T136D | Jun. 2, 2023 | 64.00 | Jun. 7, 2023 | 5 | 9,184 | 893 |
| −20% | Jun. 2, 2023 | 63.75 | Jun. 12, 2023 | 10 | 9,431 | 917 |
| Portland 1 L | | | | | | |
| 1:3:2 Mix | Jun. 2, 2023 | 63.95 | Jun. 12, 2023 | 10 | 9,277 | 902 |
| | Jun. 2, 2023 | 64.70 | Jun. 17, 2023 | 15 | 9,411 | 915 |
| | Jun. 2, 2023 | 63.60 | Jun. 17, 2023 | 15 | 9,586 | 932 |
| | Jun. 2, 2023 | 63.90 | Jun. 22, 2023 | 20 | 9,637 | 937 |
| | Jun. 2, 2023 | 63.75 | Jun. 22, 2023 | 20 | 9,524 | 926 |
| | Jun. 2, 2023 | 64.70 | Jun. 30, 2023 | 28 | 9,925 | 965 |
| | Jun. 2, 2023 | 63.90 | Jun. 30, 2023 | 28 | 9,730 | 946 |
| PB45 | Jun. 7, 2023 | 64.45 | Jun. 12, 2023 | 5 | 9,143 | 889 |
| T136E | Jun. 7, 2023 | 63.85 | Jun. 12, 2023 | 5 | 9,174 | 892 |
| −20% | Jun. 1, 1978 | 64.30 | Jun. 17, 2023 | 10 | 9,308 | 905 |
| Portland 1 L | | | | | | |
| 1:3:2 Mix | Jun. 7, 2023 | 64.20 | Jun. 17, 2023 | 10 | 9,215 | 896 |
| | Jun. 7, 2023 | 63.75 | Jun. 22, 2023 | 15 | 9,555 | 929 |
| | Jun. 7, 2023 | 63.85 | Jun. 22, 2023 | 15 | 9,452 | 919 |
| | Jun. 7, 2023 | 63.95 | Jun. 27, 2023 | 20 | 9,688 | 942 |
| | Jun. 7, 2023 | 64.65 | Jun. 27, 2023 | 20 | 9,596 | 933 |
| | Jun. 7, 2023 | 64.60 | Jul. 5, 2023 | 28 | 9,740 | 947 |
| | Jun. 7, 2023 | 64.00 | Jul. 5, 2023 | 28 | 9,586 | 932 |
| PB45 | Jun. 8, 2023 | 64.50 | Jun. 13, 2023 | 5 | 9,195 | 894 |
| T136F | Jun. 8, 2023 | 63.60 | Jun. 13, 2023 | 5 | 8,917 | 867 |
| −20% | Jun. 8, 2023 | 63.70 | Jun. 18, 2023 | 10 | 9,215 | 896 |
| Portland 1 L | | | | | | |
| 1:3:2 Mix | Jun. 8, 2023 | 64.85 | Jun. 18, 2023 | 10 | 9,380 | 912 |
| | Jun. 8, 2023 | 64.75 | Jun. 23, 2023 | 15 | 9,565 | 930 |
| | Jun. 8, 2023 | 63.90 | Jun. 23, 2023 | 15 | 9,503 | 924 |
| | Jun. 8, 2023 | 64.05 | Jun. 28, 2023 | 20 | 9,730 | 946 |
| | Jun. 8, 2023 | 64.50 | Jun. 28, 2023 | 20 | 9,637 | 937 |
| | Jun. 8, 2023 | 64.65 | Jul. 6, 2023 | 28 | 9,771 | 950 |
| | Jun. 8, 2023 | 63.80 | Jul. 6, 2023 | 28 | 9,658 | 939 |
| PB45 | Jun. 9, 2023 | 63.80 | Jun. 14, 2023 | 5 | 9,112 | 886 |
| T136G | Jun. 9, 2023 | 64.50 | Jun. 14, 2023 | 5 | 8,794 | 855 |
| −20% | Jun. 9, 2023 | 63.65 | Jun. 19, 2023 | 10 | 9,267 | 901 |
| Portland 1 L | | | | | | |
| 1:3:2 Mix | Jun. 9, 2023 | 64.05 | Jun. 19, 2023 | 10 | 9,390 | 913 |
| | Jun. 9, 2023 | 64.05 | Jun. 24, 2023 | 15 | 9,431 | 917 |
| | Jun. 9, 2023 | 64.65 | Jun. 24, 2023 | 15 | 9,565 | 930 |
| | Jun. 9, 2023 | 64.65 | Jun. 29, 2023 | 20 | 9,668 | 940 |
| | Jun. 9, 2023 | 63.90 | Jun. 29, 2023 | 20 | 9,524 | 926 |
| | Jun. 9, 2023 | 64.10 | Jul. 7, 2023 | 28 | 9,637 | 937 |
| | Jun. 9, 2023 | 64.00 | Jul. 7, 2023 | 28 | 9,894 | 962 |

Comparative to industry accepted standard (See “Concrete in Practice, What, Why & How?, National Ready Mixed Concrete Association, 2000).

In Table 56, “PB45” is Portland cement, sand, aggregate and water, and binder reducing agent, tested in duplicate, triplicate, etc., as the case may be (“PB45” is sample 1 and “T137A” is sample 2 from a pour, etc.). Per 6″×6″×2″ column and 2 8″×4″ Cylinders: 9.6 lbs. of Portland I/I cement, 41 lbs. of medium to large aggregate (rock), 27 lbs. of fine aggregate (sand), and 8.34 lbs. of water and 0.88 lbs. of binder reducing formulation. All cylinders were mixed and cured pursuant to the guidelines of ASTM C39: Standard Practice for Making and Curing Concrete Test Specimens in the Lab. Each of the test specimens were tested pursuant to ASTM C78: Standard Test Method for Flexural Strength of Concrete (Using Simple Beam with Third Point Loading).

TABLE 56

| Formula | Pour Date | Weight (lb) | Test Date | Cure Days | LBF | PSI |
|---|---|---|---|---|---|---|
| PB45 | May 25, 2023 | 63.35 | May 30, 2023 | 5 | 8,824 | 858 |
| T137A | May 25, 2023 | 63.60 | May 30, 2023 | 5 | 8,732 | 849 |
| −20% | May 25, 2023 | 64.55 | Jun. 4, 2023 | 10 | 8,907 | 866 |
| Portland | | | | | | |
| I/II | | | | | | |
| 1:3:2 | May 25, 2023 | 63.70 | Jun. 4, 2023 | 10 | 9,040 | 879 |
| Mix | | | | | | |
| | May 25, 2023 | 63.85 | Jun. 9, 2023 | 15 | 9,236 | 898 |
| | May 25, 2023 | 64.70 | Jun. 9, 2023 | 15 | 9,071 | 882 |
| | May 25, 2023 | 64.65 | Jun. 14, 2023 | 20 | 9,298 | 904 |
| | May 25, 2023 | 63.75 | Jun. 14, 2023 | 20 | 9,236 | 898 |
| | May 25, 2023 | 64.85 | Jun. 22, 2023 | 28 | 9,442 | 918 |
| | May 25, 2023 | 63.95 | Jun. 22, 2023 | 28 | 9,575 | 931 |
| PB45 | May 31, 2023 | 63.75 | Jun. 5, 2023 | 5 | 8,711 | 847 |
| T137B | May 31, 2023 | 64.60 | Jun. 5, 2023 | 5 | 8,866 | 862 |
| −20% | May 31, 2023 | 63.75 | Jun. 10, 2023 | 10 | 8,979 | 873 |
| Portland | | | | | | |
| I/II | | | | | | |
| 1:3:2 | May 31, 2023 | 63.95 | Jun. 10, 2023 | 10 | 8,896 | 865 |
| Mix | | | | | | |
| | May 31, 2023 | 64.35 | Jun. 15, 2023 | 15 | 9,164 | 891 |
| | May 31, 2023 | 64.75 | Jun. 15, 2023 | 15 | 9,277 | 902 |
| | May 31, 2023 | 63.65 | Jun. 20, 2023 | 20 | 9,380 | 912 |
| | May 31, 2023 | 64.40 | Jun. 20, 2023 | 20 | 9,349 | 909 |
| | May 31, 2023 | 64.90 | Jun. 28, 2023 | 28 | 9,616 | 935 |
| | May 31, 2023 | 63.75 | Jun. 28, 2023 | 28 | 9,462 | 920 |
| PB45 | Jun. 1, 2023 | 64.05 | Jun. 6, 2023 | 5 | 8,783 | 854 |
| T137C | Jun. 1, 2023 | 64.40 | Jun. 6, 2023 | 5 | 8,711 | 847 |
| −20% | Jun. 1, 2023 | 63.75 | Jun. 11, 2023 | 10 | 9,030 | 878 |
| Portland | | | | | | |
| I/II | | | | | | |
| 1:3:2 | Jun. 1, 2023 | 64.50 | Jun. 11, 2023 | 10 | 8,835 | 859 |
| Mix | | | | | | |
| | Jun. 1, 2023 | 64.45 | Jun. 16, 2023 | 15 | 9,246 | 899 |
| | Jun. 1, 2023 | 63.75 | Jun. 16, 2023 | 15 | 9,184 | 893 |
| | Jun. 1, 2023 | 64.15 | Jun. 21, 2023 | 20 | 9,400 | 914 |
| | Jun. 1, 2023 | 63.80 | Jun. 21, 2023 | 20 | 9,411 | 915 |
| | Jun. 1, 2023 | 63.95 | Jun. 29, 2023 | 28 | 9,544 | 928 |
| | Jun. 1, 2023 | 64.50 | Jun. 29, 2023 | 28 | 9,658 | 939 |
| PB45 | Jun. 2, 2023 | 64.85 | Jun. 7, 2023 | 5 | 8,866 | 862 |
| T137D | Jun. 2, 2023 | 63.60 | Jun. 7, 2023 | 5 | 8,794 | 855 |
| −20% | Jun. 2, 2023 | 64.20 | Jun. 12, 2023 | 10 | 9,071 | 882 |
| Portland | | | | | | |
| I/II | | | | | | |
| 1:3:2 | Jun. 2, 2023 | 63.85 | Jun. 12, 2023 | 10 | 8,948 | 870 |
| Mix | | | | | | |
| | Jun. 2, 2023 | 63.70 | Jun. 17, 2023 | 15 | 9,277 | 902 |
| | Jun. 2, 2023 | 64.05 | Jun. 17, 2023 | 15 | 9,184 | 893 |
| | Jun. 2, 2023 | 64.45 | Jun. 22, 2023 | 20 | 9,472 | 921 |
| | Jun. 2, 2023 | 63.70 | Jun. 22, 2023 | 20 | 9,370 | 911 |
| | Jun. 2, 2023 | 64.00 | Jun. 30, 2023 | 28 | 9,359 | 910 |
| | Jun. 2, 2023 | 63.70 | Jun. 30, 2023 | 28 | 9,637 | 937 |
| PB45 | Jun. 7, 2023 | 64.85 | Jun. 12, 2023 | 5 | 8,835 | 859 |
| T137E | Jun. 7, 2023 | 63.95 | Jun. 12, 2023 | 5 | 8,855 | 861 |
| −20% | Jun. 1, 1978 | 64.85 | Jun. 17, 2023 | 10 | 8,999 | 875 |
| Portland | | | | | | |
| I/II | | | | | | |
| 1:3:2 | Jun. 7, 2023 | 63.95 | Jun. 17, 2023 | 10 | 8,927 | 868 |
| Mix | | | | | | |
| | Jun. 7, 2023 | 64.00 | Jun. 22, 2023 | 15 | 9,154 | 890 |
| | Jun. 7, 2023 | 64.85 | Jun. 22, 2023 | 15 | 9,298 | 904 |
| | Jun. 7, 2023 | 63.60 | Jun. 27, 2023 | 20 | 9,411 | 915 |
| | Jun. 7, 2023 | 64.10 | Jun. 27, 2023 | 20 | 9,236 | 898 |
| | Jun. 7, 2023 | 64.25 | Jul. 5, 2023 | 28 | 9,596 | 933 |
| | Jun. 7, 2023 | 64.20 | Jul. 5, 2023 | 28 | 9,555 | 929 |
| PB45 | Jun. 8, 2023 | 63.80 | Jun. 13, 2023 | 5 | 8,701 | 846 |
| T137F | Jun. 8, 2023 | 63.70 | Jun. 13, 2023 | 5 | 8,742 | 850 |
| −20% | Jun. 8, 2023 | 63.65 | Jun. 18, 2023 | 10 | 8,989 | 874 |
| Portland | | | | | | |
| I/II | | | | | | |
| 1:3:2 | Jun. 8, 2023 | 64.45 | Jun. 18, 2023 | 10 | 8,917 | 867 |
| Mix | | | | | | |
| | Jun. 8, 2023 | 63.70 | Jun. 23, 2023 | 15 | 9,051 | 880 |
| | Jun. 8, 2023 | 63.60 | Jun. 23, 2023 | 15 | 9,143 | 889 |
| | Jun. 8, 2023 | 63.75 | Jun. 28, 2023 | 20 | 9,267 | 901 |
| | Jun. 8, 2023 | 63.70 | Jun. 28, 2023 | 20 | 9,380 | 912 |
| | Jun. 8, 2023 | 64.20 | Jul. 6, 2023 | 28 | 9,668 | 940 |
| | Jun. 8, 2023 | 63.65 | Jul. 6, 2023 | 28 | 9,575 | 931 |
| PB45 | Jun. 9, 2023 | 63.90 | Jun. 14, 2023 | 5 | 8,711 | 847 |
| T137G | Jun. 9, 2023 | 64.00 | Jun. 14, 2023 | 5 | 8,701 | 846 |
| −20% | Jun. 9, 2023 | 64.20 | Jun. 19, 2023 | 10 | 8,886 | 864 |
| Portland | | | | | | |
| I/II | | | | | | |
| 1:3:2 | Jun. 9, 2023 | 63.55 | Jun. 19, 2023 | 10 | 9,020 | 877 |
| Mix | | | | | | |
| | Jun. 9, 2023 | 63.80 | Jun. 24, 2023 | 15 | 9,308 | 905 |
| | Jun. 9, 2023 | 63.70 | Jun. 24, 2023 | 15 | 9,246 | 899 |
| | Jun. 9, 2023 | 64.15 | Jun. 29, 2023 | 20 | 9,400 | 914 |
| | Jun. 9, 2023 | 64.30 | Jun. 29, 2023 | 20 | 9,215 | 896 |
| | Jun. 9, 2023 | 64.55 | Jul. 7, 2023 | 28 | 9,658 | 939 |
| | Jun. 9, 2023 | 64.65 | Jul. 7, 2023 | 28 | 9,544 | 928 |

Comparative to industry accepted standard (See “Concrete in Practice, What, why & how?, National Ready Mixed Concrete Association, 2000).

In Table 57, “PB45” is Portland cement, sand, aggregate and water, and binder reducing agent, tested in duplicate, triplicate, etc., as the case may be (“PB45” is sample 1 and “T136A” is sample 2 from a pour). Per 6″×6″×21″ column and 2 8″×4″ Cylinders: 9.6 lbs. of Portland IL (PLC) cement, 41 lbs. of medium to large aggregate (rock), 27 lbs. of fine aggregate (sand), and 8.34 lbs. of water and 0.88 lbs. of binder reducing formulation. All cylinders were mixed and cured pursuant to the guidelines of ASTM C192: Standard Practice for Making and Curing Concrete Test Specimens in the Lab. Each of the test specimens were capped in a manner conforming to ASTMC617: Standard Practice for Capping Cylindrical Concrete Specimens and ASTM C1231: Use of Unbonded Caps in Determination of Compressive Strength of Hardened Cylindrical Concrete Specimens. The impedance of each sample was tested under ASTM C1202: Standard Test Method for Electrical Indication of Concrete's Ability to Resist Chloride Ion Penetration. Each of the cylinders were tested for compressive strength at the day indicated. Each cylinder was tested for compressive strength following the requirements of ASTM C39: Standard Test Method for Compressive Strength of Cylindrical Concrete Specimens.

TABLE 57

| Formula | Wet Test | Impedance | Degree | Weight (lb) | Dry Test | Cure | LBF | PSI |
|---|---|---|---|---|---|---|---|---|
| PB45 | May 25, 2023 | 51.1 Ω | 2° | 8.35 | May 30, 2023 | 5 | 40,175 | 3,208 |
| T136A | May 25, 2023 | 51.5 Ω | 1° | 8.40 | May 30, 2023 | 5 | 39,937 | 3,189 |
| −20% | May 25, 2023 | 51.2 Ω | 1° | 8.40 | Jun. 4, 2023 | 10 | 44,796 | 3,577 |
| Portland | | | | | | | | |
| 1 L | | | | | | | | |
| 1:3:2 Mix | May 25, 2023 | 50.9 Ω | 3° | 8.40 | Jun. 4, 2023 | 10 | 43,770 | 3,495 |
| | May 25, 2023 | 51.0 Ω | 2° | 8.45 | Jun. 9, 2023 | 15 | 47,740 | 3,812 |
| Super Air | May 25, 2023 | 51.4 Ω | 2° | 8.45 | Jun. 9, 2023 | 15 | 47,539 | 3,796 |
| Meter: | | | | | | | | |
| 2.2% | | | | | | | | |
| | May 25, 2023 | 51.4 Ω | 3° | 8.45 | Jun. 14, 2023 | 20 | 53,287 | 4,255 |
| | May 25, 2023 | 51.2 Ω | 1° | 8.45 | Jun. 14, 2023 | 20 | 51,421 | 4,106 |
| | May 25, 2023 | 50.9 Ω | 1° | 8.45 | Jun. 21, 2023 | 28 | 56,919 | 4,545 |
| | May 25, 2023 | 50.0 Ω | 2° | 8.50 | Jun. 21, 2023 | 28 | 54,703 | 4,368 |
| | May 25, 2023 | 50.1 Ω | 2° | 8.50 | Jun. 19, 2023 | 56 | 56,719 | 4,529 |
| | May 25, 2023 | 51.2 Ω | 1° | 8.55 | Jun. 19, 2023 | 56 | 57,608 | 4,600 |

Comparative to Table 59 for demonstration of improved results.

In Table 58, “PB45” is Portland cement, sand, aggregate and water, and binder reducing agent, tested in duplicate, triplicate, etc., as the case may be (“PB45” is sample 1 and “T137A” is sample 2 from a pour, etc.). Per 6″×6″×2l″ column and 2 8″×4″ Cylinders: 9.6 lbs. of Portland I/II cement, 41 lbs. of medium to large aggregate (rock), 27 lbs. of fine aggregate (sand), and 8.34 lbs. of water and 0.88 lbs. of binder reducing formulation. All cylinders were mixed and cured pursuant to the guidelines of ASTM C192: Standard Practice for Making and Curing Concrete Test Specimens in the Lab. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. The impedance of each sample was tested under ASTM C1202: Standard Test Method for Electrical Indication of Concrete's Ability to Resist Chloride Ion Penetration. Each of the cylinders were tested for compressive strength at the day indicated. Each cylinder was tested for compressive strength following the requirements of ASTM C39: Standard Test Method for Compressive Strength of Cylindrical

TABLE 58

| Formula | Wet Test | Impedance | Degree | Weight | Dry Test | Cure | LBF | PSI |
|---|---|---|---|---|---|---|---|---|
| PB45 | Wet Test | 37.8 Ω | 2° | 8.40 | May 30, 2023 | 5 | 51,910 | 4,145 |
| T137A | Wet Test | 45.2 Ω | 2° | 8.40 | May 30, 2023 | 5 | 51,622 | 4,122 |
| −20% Portland | Wet Test | 44.1 Ω | 2° | 8.40 | Jun. 4, 2023 | 10 | 56,619 | 4,521 |
| I/II | | | | | | | | |
| 1:3:2 Mix | Wet Test | 42.6 Ω | 2° | 8.40 | Jun. 4, 2023 | 10 | 57,633 | 4,602 |
| | Wet Test | 39.1 Ω | 1° | 8.45 | Jun. 9, 2023 | 15 | 59,086 | 4,718 |
| Super Air | Wet Test | 38.8 Ω | 1° | 8.45 | Jun. 9, 2023 | 15 | 61,215 | 4,888 |
| Meter: 1.9% | | | | | | | | |
| | Wet Test | 39.9 Ω | 1° | 8.50 | Jun. 14, 2023 | 20 | 62,718 | 5,008 |
| | Wet Test | 33.8 Ω | 2° | 8.50 | Jun. 14, 2023 | 20 | 63,995 | 5,110 |
| | Wet Test | 38.8 Ω | 3° | 8.55 | Jun. 21, 2023 | 28 | 66,600 | 5,318 |
| | Wet Test | 39.9 Ω | 2° | 8.55 | Jun. 21, 2023 | 28 | 65,247 | 5,210 |
| | Wet Test | 39.2 Ω | 2° | 8.55 | Jun. 19, 2023 | 56 | 67,902 | 5,422 |
| | Wet Test | 43.3 Ω | 1° | 8.55 | Jun. 19, 2023 | 56 | 67,376 | 5,380 |

Comparative to Table 59 for demonstration of improved results.

In Table 59, “PB45” is Portland cement, sand, aggregate and water, and binder reducing agent, tested in duplicate, triplicate, etc., as the case may be (“PB45” is sample 1 and “T143” is sample 2 from a pour). Per 10 4″×8″ Cylinders: 12 lbs. of Portland IL (PLC) cement, 41 pounds of medium to large aggregate (rock), 27 lbs. of fine aggregate (sand), and 8.34 lbs. of water. All cylinders were mixed and cured pursuant to the guidelines of ASTM C192: Standard Practice for Making and Curing Concrete Test Specimens in the Laboratory. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. Each of the cylinders were tested for compressive strength at the day indicated. Each cylinder was tested for compressive strength following the requirements of ASTM C39: Standard Test Method for Compressive Strength of Cylindrical Concrete Specimens. The impedance and Resistivity of each sample was tested under ASTM C1202: Standard Test Method for Electrical Indication of Concrete's Ability to Resist Chloride Ion Penetration. This Table will serve as the baseline measure for all 1:3:2 mixtures utilizing Portland IL (PLC) cement as the binder.

TABLE 59

| Formula | Pour Date | Weight (lb) | Test Date | Cure | LBF | PSI | Break | Resistivity | Impedance | |
|---|---|---|---|---|---|---|---|---|---|---|
| Baseline | Oct. 6, 2023 | 8.30 | Oct. 11, 2023 | 5 | 43,043 | 3,437 | 5 | 38.2 Ω · m | 638 | Ω |
| T143 | Oct. 6, 2023 | 8.35 | Oct. 11, 2023 | 5 | 42,430 | 3,388 | 5 | 41.0 Ω · m | 687 | Ω |
| 20 | Oct. 6, 2023 | 8.35 | Oct. 11, 2023 | 5 | 43,669 | 3,487 | 5 | 40.1 Ω · m | 670 | Ω |
| Cylinders | | | | | | | | | | |
| 1:3:2 Mix | Oct. 6, 2023 | 8.45 | Oct. 11, 2023 | 5 | 42,542 | 3,397 | 5 | 43.3 Ω · m | 723 | Ω |
| | Oct. 6, 2023 | 8.30 | Oct. 16, 2023 | 10 | 53,024 | 4,234 | 5 | 47.3 Ω · m | 791 | Ω |
| | Oct. 6, 2023 | 8.35 | Oct. 16, 2023 | 10 | 54,615 | 4,361 | 5 | 47.4 Ω · m | 793 | Ω |
| | Oct. 6, 2023 | 8.35 | Oct. 16, 2023 | 10 | 49,994 | 3,992 | 5 | 45.3 Ω · m | 758 | Ω |
| | Oct. 6, 2023 | 8.35 | Oct. 16, 2023 | 10 | 50,282 | 4,015 | 5 | 46.5 Ω · m | 778 | Ω |
| | Oct. 6, 2023 | 8.35 | Oct. 21, 2023 | 15 | 55,329 | 4,418 | 5 | 58.4 Ω · m | 976 | Ω |
| | Oct. 6, 2023 | 8.40 | Oct. 21, 2023 | 15 | 55,041 | 4,395 | 5 | 61.0 Ω · m | 1021 | Ω |
| | Oct. 6, 2023 | 8.40 | Oct. 21, 2023 | 15 | 55,855 | 4,460 | 3 | 58.9 Ω · m | 984 | Ω |
| | Oct. 6, 2023 | 8.40 | Oct. 21, 2023 | 15 | 53,876 | 4,302 | 3 | 60.8 Ω · m | 1003 | Ω |
| | Oct. 6, 2023 | | Oct. 26, 2023 | 20 | 0 | | | | | |
| | Oct. 6, 2023 | | Oct. 26, 2023 | 20 | 0 | | | | | |
| | Oct. 6, 2023 | | Oct. 26, 2023 | 20 | 0 | | | | | |
| | Oct. 6, 2023 | | Oct. 26, 2023 | 20 | 0 | | | | | |
| | Oct. 6, 2023 | | Nov. 3, 2023 | 28 | 0 | | | | | |
| | Oct. 6, 2023 | | Nov. 3, 2023 | 28 | 0 | | | | | |
| | Oct. 6, 2023 | | Nov. 3, 2023 | 28 | 0 | | | | | |
| | Oct. 6, 2023 | | Nov. 3, 2023 | 28 | 0 | | | | | |

In Table 60, “PB45” is Portland cement, sand, aggregate and water, and binder reducing agent, tested in duplicate, triplicate, etc., as the case may be (“PB45” is sample 1 and “T141” is sample 2 from a pour, etc.). Per 10 8″×4″ Cylinders: 9.6 lbs. of Portland IL (PLC) cement, 41 lbs. of medium to large aggregate (rock), 27 lbs. of fine aggregate (sand), and 8.34 lbs. of water and 0.88 lbs. of binder reducing formulation. All cylinders were mixed and cured pursuant to the guidelines of ASTM C192: Standard Practice for Making and Curing Concrete Test Specimens in the Lab. Each of the test specimens were capped in a manner conforming to ASTM C617: Standard Practice for Capping Cylindrical Concrete Specimens and ASTM C1231: Use of Unbonded Caps in Determination of Compressive Strength of Hardened Cylindrical Concrete Specimens. The impedance of each sample was tested under ASTM C1202: Standard Test Method for Electrical Indication of Concrete's Ability to Resist Chloride Ion Penetration. Each of the cylinders were tested for compressive strength at the day indicated. Each cylinder was tested for compressive strength following the requirements of ASTM C39: Standard Test Method for Compressive Strength of Cylindrical

TABLE 60

| Formula | Pour Date | Weight (lb) | Test Date | Cure | LBF | PSI | Break | Resistivity | Impedance | |
|---|---|---|---|---|---|---|---|---|---|---|
| PB45 | Sep. 7, 2023 | 8.40 | Sep. 12, 2023 | 5 | 51,046 | 4,076 | 3 | 43.3 Ω · m | 723 | Ω |
| T141 | Sep. 7, 2023 | 8.40 | Sep. 12, 2023 | 5 | 44,809 | 3,578 | 6 | 45.3 Ω · m | 755 | Ω |
| 38 | Sep. 7, 2023 | 8.40 | Sep. 12, 2023 | 5 | 46,074 | 3,679 | 6 | 42.8 Ω · m | 715 | Ω |
| Cylinders | | | | | | | | | | |
| −20% | Sep. 7, 2023 | 8.40 | Sep. 12, 2023 | 5 | 46,462 | 3,710 | 5 | 44.9 Ω · m | 748 | Ω |
| Portland | | | | | | | | | | |
| 1 L | | | | | | | | | | |
| 1:3:2 Mix | Sep. 7, 2023 | 8.40 | Sep. 12, 2023 | 5 | 44,245 | 3,533 | 5 | 44.7 Ω · m | 746 | Ω |
| | Sep. 7, 2023 | 8.40 | Sep. 12, 2023 | 5 | 50,069 | 3,998 | 5 | 43.2 Ω · m | 721 | Ω |
| | Sep. 7, 2023 | 8.40 | Sep. 12, 2023 | 5 | 48,003 | 3,833 | 5 | 45.0 Ω · m | 750 | Ω |
| | Sep. 7, 2023 | 8.40 | Sep. 12, 2023 | 5 | 47,188 | 3,768 | 5 | 43.9 Ω · m | 733 | Ω |
| | Sep. 7, 2023 | 8.40 | Sep. 17, 2023 | 10 | 55,416 | 4,425 | 3 | 45.7 Ω · m | 761 | Ω |
| | Sep. 7, 2023 | 8.40 | Sep. 17, 2023 | 10 | 62,179 | 4,965 | 3 | 49.3 Ω · m | 824 | Ω |
| | Sep. 7, 2023 | 8.40 | Sep. 17, 2023 | 10 | 55,153 | 4,404 | 6 | 44.1 Ω · m | 735 | Ω |
| | Sep. 7, 2023 | 8.40 | Sep. 17, 2023 | 10 | 57,433 | 4,586 | 3 | 48.9 Ω · m | 820 | Ω |
| | Sep. 7, 2023 | 8.40 | Sep. 17, 2023 | 10 | 60,213 | 4,808 | 6 | 51.1 Ω · m | 857 | Ω |
| | Sep. 7, 2023 | 8.40 | Sep. 17, 2023 | 10 | 56,844 | 4,539 | 6 | 45.2 Ω · m | 755 | Ω |
| | Sep. 7, 2023 | 8.40 | Sep. 17, 2023 | 10 | 61,453 | 4,907 | 6 | 48.4 Ω · m | 810 | Ω |
| | Sep. 7, 2023 | 8.40 | Sep. 17, 2023 | 10 | 59,812 | 4,776 | 3 | 46.1 Ω · m | 769 | Ω |
| | Sep. 7, 2023 | 8.35 | Sep. 22, 2023 | 15 | 61,603 | 4,919 | 6 | 51.1 Ω · m | 854 | Ω |
| | Sep. 7, 2023 | 8.35 | Sep. 22, 2023 | 15 | 59,987 | 4,790 | 6 | 51.1 Ω · m | 856 | Ω |
| | Sep. 7, 2023 | 8.35 | Sep. 22, 2023 | 15 | 60,739 | 4,850 | 6 | 51.0 Ω · m | 842 | Ω |
| | Sep. 7, 2023 | 8.35 | Sep. 22, 2023 | 15 | 62,805 | 5,015 | 3 | 50.8 Ω · m | 849 | Ω |
| | Sep. 7, 2023 | 8.35 | Sep. 22, 2023 | 15 | 58,121 | 4,641 | 4 | 52.3 Ω · m | 875 | Ω |
| | Sep. 7, 2023 | 8.35 | Sep. 22, 2023 | 15 | 60,213 | 4,808 | 5 | 52.4 Ω · m | 877 | Ω |
| | Sep. 7, 2023 | 8.35 | Sep. 22, 2023 | 15 | 57,245 | 4,571 | 5 | 52.5 Ω · m | 877 | Ω |
| | Sep. 7, 2023 | 8.35 | Sep. 22, 2023 | 15 | 62,242 | 4,970 | 3 | 45.1 Ω · m | 752 | Ω |
| | Sep. 7, 2023 | 8.40 | Sep. 27, 2023 | 20 | 57,470 | 4,589 | 5 | 51.1 Ω · m | 856 | Ω |
| | Sep. 7, 2023 | 8.35 | Sep. 27, 2023 | 20 | 63,168 | 5,044 | 3 | 49.4 Ω · m | 826 | Ω |
| | Sep. 7, 2023 | 8.35 | Sep. 27, 2023 | 20 | 58,635 | 4,682 | 5 | 51.0 Ω · m | 843 | Ω |
| | Sep. 7, 2023 | 8.35 | Sep. 27, 2023 | 20 | 64,145 | 5,122 | 5 | 46.7 Ω · m | 781 | Ω |
| | Sep. 7, 2023 | 8.35 | Sep. 27, 2023 | 20 | 61,741 | 4,930 | 5 | 54.9 Ω · m | 919 | Ω |
| | Sep. 7, 2023 | 8.35 | Sep. 27, 2023 | 20 | 66,387 | 5,301 | 2 | 59.6 Ω · m | 998 | Ω |
| | Sep. 7, 2023 | 8.35 | Sep. 27, 2023 | 20 | 65,423 | 5,224 | 5 | 55.8 Ω · m | 933 | Ω |
| | Sep. 7, 2023 | 8.40 | Oct. 5, 2023 | 28 | 66,049 | 5,274 | 5 | 57.5 Ω · m | 962 | Ω |
| | Sep. 7, 2023 | 8.40 | Oct. 5, 2023 | 28 | 63,519 | 5,072 | 5 | 55.5 Ω · m | 928 | Ω |
| | Sep. 7, 2023 | 8.45 | Oct. 5, 2023 | 28 | 65,711 | 5,247 | 5 | 53.1 Ω · m | 886 | Ω |
| | Sep. 7, 2023 | 8.45 | Oct. 5, 2023 | 28 | 66,312 | 5,295 | 3 | 56.9 Ω · m | 951 | Ω |
| | Sep. 7, 2023 | 8.45 | Oct. 5, 2023 | 28 | 67,765 | 5,411 | 3 | 57.4 Ω · m | 959 | Ω |
| | Sep. 7, 2023 | 8.45 | Oct. 5, 2023 | 28 | 66,174 | 5,284 | 5 | 57.6 Ω · m | 960 | Ω |
| | Sep. 7, 2023 | 8.45 | Oct. 5, 2023 | 28 | 68,391 | 5,461 | 5 | 57.6 Ω · m | 963 | Ω |
| PB45 | Sep. 22, 2023 | 8.45 | Sep. 27, 2023 | 5 | 39,887 | 3,185 | 5 | 50.3 Ω · m | 843 | Ω |
| T142 | Sep. 22, 2023 | 8.40 | Sep. 27, 2023 | 5 | 42,066 | 3,359 | 5 | 50.2 Ω · m | 836 | Ω |
| 25 | Sep. 22, 2023 | 8.40 | Sep. 27, 2023 | 5 | 41,152 | 3,286 | 5 | 53.5 Ω · m | 894 | Ω |
| Cylinders | | | | | | | | | | |
| −20% | Sep. 22, 2023 | 8.45 | Oct. 2, 2023 | 10 | 45,836 | 3,660 | 5 | 57.6 Ω · m | 964 | Ω |
| Portland | | | | | | | | | | |
| 1 L | | | | | | | | | | |
| 1:3:2 Mix | Sep. 22, 2023 | 8.45 | Oct. 2, 2023 | 10 | 49,418 | 3,946 | 5 | 56.9 Ω · m | 951 | Ω |
| | Sep. 22, 2023 | 8.45 | Oct. 2, 2023 | 10 | 49,405 | 3,945 | 5 | 54.9 Ω · m | 918 | Ω |
| | Sep. 22, 2023 | 8.40 | Oct. 7, 2023 | 15 | 51,033 | 4,075 | 5 | 63.3 Ω · m | 1060 | Ω |
| | Sep. 22, 2023 | 8.40 | Oct. 7, 2023 | 15 | 49,230 | 3,931 | 5 | 61.1 Ω · m | 1020 | Ω |
| | Sep. 22, 2023 | 8.40 | Oct. 7, 2023 | 15 | 46,612 | 3,722 | 5 | 55.7 Ω · m | 931 | Ω |
| | Sep. 22, 2023 | 8.35 | Oct. 12, 2023 | 20 | 51,797 | 4,136 | 3 | 59.2 Ω · m | 987 | Ω |
| | Sep. 22, 2023 | 8.40 | Oct. 12, 2023 | 20 | 54,352 | 4,340 | 5 | 60.8 Ω · m | 1018 | Ω |
| | Sep. 22, 2023 | 8.40 | Oct. 12, 2023 | 20 | 57,746 | 4,611 | 5 | 57.1 Ω · m | 952 | Ω |
| | Sep. 22, 2023 | 8.40 | Oct. 20, 2023 | 28 | 60,263 | 4,812 | 5 | 62.5 Ω · m | 1078 | Ω |
| | Sep. 22, 2023 | 8.40 | Oct. 20, 2023 | 28 | 58,835 | 4,698 | 3 | 63.1 Ω · m | 1102 | Ω |
| | Sep. 22, 2023 | 8.45 | Oct. 20, 2023 | 28 | 59,161 | 4,724 | 5 | 61.9 Ω · m | 1065 | Ω |

Comparative to Table 59 for demonstration of improved results.

In Table 61, “PB45” is Portland cement, sand, aggregate and water, and binder reducing agent, tested in duplicate, triplicate, etc., as the case may be (“PB45” is sample 1 and “T138” is sample 2 from a pour, etc.). Per 18 3″×4″×16″ column: 38.4 lbs. of Portland IL (PLC) cement, 164 lbs. of medium to large aggregate (rock), 108 lbs. of fine aggregate (sand), and 22 lbs. of water and 2.7 lbs. of binder reducing formulation. All samples were mixed and cured pursuant to the guidelines of ASTM C192: Standard Practice for Making and Curing Concrete Test Specimens in the Lab. All sample specimens were tested pursuant to ASTM C78: Standard Test Method for Flexural Strength of Concrete (Using Simple Beam with Third Point Loading). Each sample was put through 300 cycles in a freeze/thaw machine model type Humboldt 3816S and tested according to ASTM C666: Standard Test Method for Resistance of Concrete to Rapid Freezing and Thawing.

TABLE 61

| Formula | ID # | Date | Cycles | Weight (lb) | Length | Width | Depth | LBF | PSI |
|---|---|---|---|---|---|---|---|---|---|
| PB45 | 138A | Jul. 14, 2023 | 0 | 15.75 | 16.00 | 2.97 | 4.00 | — | — |
| T138 | 138A | Jul. 31, 2023 | 100 | 15.75 | 16.06 | 2.96 | 4.00 | — | — |
| −20% | 138A | Aug. 17, 2023 | 200 | 15.75 | 16.06 | 2.95 | 3.97 | 9,793 | 782 |
| Portland | | | | | | | | | |
| 1 L | | | | | | | | | |
| 1:3:2 Mix | 138B | Jul. 14, 2023 | 0 | 15.85 | 16.00 | 2.96 | 3.99 | — | — |
| Pour: | 138B | Jul. 31, 2023 | 100 | 15.90 | 16.00 | 2.97 | 3.99 | — | — |
| Jun. 30, 2023 | | | | | | | | | |
| | 138B | Aug. 17, 2023 | 200 | 15.95 | 16.00 | 2.96 | 4.00 | 8,967 | 716 |
| | 138C | Jul. 14, 2023 | 0 | 15.85 | 16.00 | 2.94 | 4.00 | — | — |
| | 138C | Jul. 31, 2023 | 100 | 15.85 | 16.06 | 2.92 | 4.01 | — | — |
| | 138C | Aug. 17, 2023 | 200 | 15.85 | 16.06 | 2.93 | 4.02 | 8,503 | 679 |
| | 138D | Jul. 14, 2023 | 0 | 15.70 | 16.00 | 2.97 | 3.98 | — | — |
| | 138D | Jul. 31, 2023 | 100 | 15.75 | 16.06 | 2.92 | 4.03 | — | — |
| | 138D | Aug. 17, 2023 | 200 | 15.75 | 16.06 | 2.94 | 4.02 | 9,743 | 778 |
| | 138E | Jul. 14, 2023 | 0 | 15.85 | 16.00 | 2.95 | 4.03 | — | — |
| | 138E | Jul. 31, 2023 | 100 | 15.90 | 16.06 | 2.95 | 3.98 | — | — |
| | 138E | Aug. 17, 2023 | 200 | 15.90 | 16.06 | 2.96 | 4.03 | 11,196 | 894 |
| | 138F | Jul. 14, 2023 | 0 | 16.10 | 15.88 | 3.00 | 4.02 | — | — |
| | 138F | Jul. 31, 2023 | 100 | 16.10 | 15.94 | 2.96 | 4.01 | — | — |
| | 138F | Aug. 17, 2023 | 200 | 16.10 | 16.00 | 2.96 | 4.03 | 11,096 | 886 |
| | 138G | Jul. 14, 2023 | 0 | 17.25 | 16.13 | 3.17 | 4.05 | — | — |
| | 138G | Jul. 31, 2023 | 100 | 17.30 | 16.13 | 3.10 | 4.02 | — | — |
| | 138G | Aug. 17, 2023 | 200 | 17.30 | 16.13 | 3.15 | 4.13 | 12,473 | 996 |
| | 138H | Jul. 14, 2023 | 0 | 15.85 | 16.00 | 2.98 | 3.97 | — | — |
| | 138H | Jul. 31, 2023 | 100 | 15.85 | 16.00 | 2.97 | 3.98 | — | — |
| | 138H | Aug. 17, 2023 | 200 | 15.80 | 16.00 | 2.96 | 3.95 | 12,574 | 1,004 |
| | 138J | Jul. 14, 2023 | 0 | 15.80 | 16.00 | 2.93 | 3.97 | — | — |
| | 138J | Jul. 31, 2023 | 100 | 15.80 | 16.06 | 2.96 | 4.00 | — | — |
| | 138J | Aug. 17, 2023 | 200 | 15.85 | 16.06 | 2.95 | 4.08 | 10,770 | 860 |
| PB45 | 140A | Aug. 17, 2023 | 0 | 16.45 | 16.00 | 3.00 | 4.09 | — | — |
| T140 | 140A | Sep. 6, 2023 | 100 | 16.30 | 16.00 | 2.98 | 4.09 | — | — |
| −20% | 140A | Sep. 22, 2023 | 200 | 16.25 | 15.88 | 2.98 | 4.08 | — | — |
| Portland | | | | | | | | | |
| 1 L | | | | | | | | | |
| 1:3:2 Mix | 140A | Oct. 9, 2023 | 300 | 16.20 | 15.88 | 2.95 | 4.08 | 15,041 | 1,201 |
| Pour: | 140B | Aug. 21, 2023 | 0 | 16.05 | 16.00 | 2.99 | 4.04 | — | — |
| Aug. 2, 2023 | | | | | | | | | |
| | 140B | Sep. 6, 2023 | 100 | 15.90 | 15.88 | 2.94 | 4.03 | — | — |
| | 140B | Sep. 22, 2023 | 200 | 15.85 | 15.88 | 2.92 | 4.03 | — | — |
| | 140B | Oct. 9, 2023 | 300 | 15.75 | 15.75 | 2.90 | 4.10 | 15,003 | 1,198 |
| | 140C | Aug. 21, 2023 | 0 | 16.50 | 16.00 | 2.94 | 4.13 | — | — |
| | 140C | Sep. 6, 2023 | 100 | 16.50 | 15.88 | 2.93 | 4.10 | — | — |
| | 140C | Sep. 22, 2023 | 200 | 16.25 | 15.81 | 2.93 | 4.09 | — | — |
| | 140C | Oct. 9, 2023 | 300 | 15.90 | 15.81 | 2.90 | 4.09 | 14,302 | 1,142 |
| | 140D | Aug. 21, 2023 | 0 | 15.90 | 16.00 | 2.93 | 4.05 | — | — |
| | 140D | Sep. 6, 2023 | 100 | 15.85 | 16.00 | 2.93 | 4.04 | — | — |
| | 140D | Sep. 22, 2023 | 200 | 15.85 | 16.00 | 2.90 | 4.04 | — | — |
| | 140D | Oct. 9, 2023 | 300 | 15.75 | 15.88 | 2.88 | 4.03 | 14,602 | 1,166 |
| | 140E | Aug. 21, 2023 | 0 | 15.80 | 16.00 | 2.93 | 3.96 | — | — |
| | 140E | Sep. 6, 2023 | 100 | 15.65 | 16.00 | 2.91 | 3.95 | — | — |
| | 140E | Sep. 22, 2023 | 200 | 15.60 | 15.88 | 2.90 | 3.95 | — | — |
| | 140E | Oct. 9, 2023 | 300 | 15.55 | 15.88 | 2.89 | 3.95 | 15,216 | 1,215 |
| | 140F | Aug. 21, 2023 | 0 | 15.90 | 16.13 | 2.97 | 4.03 | — | — |
| | 140F | Sep. 6, 2023 | 100 | 15.75 | 16.00 | 2.97 | 4.01 | — | — |
| | 140F | Sep. 22, 2023 | 200 | 15.70 | 16.00 | 2.95 | 4.01 | — | — |
| | 140F | Oct. 9, 2023 | 300 | 15.60 | 15.88 | 2.93 | 4.00 | 15,842 | 1,265 |
| | 140G | Aug. 21, 2023 | 0 | 16.20 | 16.13 | 2.99 | 4.07 | — | — |
| | 140G | Sep. 6, 2023 | 100 | 16.05 | 16.13 | 2.97 | 4.04 | — | — |
| | 140G | Sep. 22, 2023 | 200 | 16.00 | 16.00 | 2.95 | 4.02 | — | — |
| | 140G | Oct. 9, 2023 | 300 | 15.90 | 16.00 | 2.95 | 4.02 | 13,876 | 1,108 |
| | 140H | Aug. 21, 2023 | 0 | 16.60 | 16.13 | 3.00 | 4.08 | — | — |
| | 140H | Sep. 6, 2023 | 100 | 16.45 | 16.00 | 2.98 | 4.05 | — | — |
| | 140H | Sep. 22, 2023 | 200 | 16.45 | 15.88 | 2.98 | 4.05 | — | — |
| | 140H | Oct. 9, 2023 | 300 | 16.30 | 15.88 | 2.92 | 4.03 | 14,352 | 1,146 |
| | 140J | Aug. 21, 2023 | 0 | 16.05 | 16.00 | 3.00 | 4.04 | — | — |
| | 140J | Sep. 6, 2023 | 100 | 16.05 | 15.88 | 2.98 | 4.00 | — | — |
| | 140J | Sep. 22, 2023 | 200 | 16.00 | 15.88 | 2.95 | 3.99 | — | — |
| | 140J | Oct. 9, 2023 | 300 | 15.85 | 15.75 | 2.91 | 3.98 | 14,264 | 1,139 |
| | 140K | Aug. 21, 2023 | 0 | 16.25 | 16.00 | 2.96 | 4.07 | — | — |
| | 140K | Sep. 6, 2023 | 100 | 16.20 | 15.88 | 2.95 | 4.05 | — | — |
| | 140K | Sep. 22, 2023 | 200 | 16.15 | 15.88 | 2.95 | 4.05 | — | — |
| | 140K | Oct. 9, 2023 | 300 | 16.00 | 15.75 | 2.92 | 4.03 | 16,043 | 1,281 |
| | 140L | Aug. 21, 2023 | 0 | 16.20 | 16.13 | 2.96 | 4.08 | — | — |
| | 140L | Sep. 6, 2023 | 100 | 16.10 | 16.13 | 2.96 | 4.05 | — | — |
| | 140L | Sep. 22, 2023 | 200 | 16.00 | 16.00 | 2.92 | 4.04 | — | — |
| | 140L | Oct. 9, 2023 | 300 | 15.95 | 16.00 | 2.91 | 4.02 | 14,890 | 1,189 |
| | 140M | Aug. 21, 2023 | 0 | 15.90 | 16.00 | 2.98 | 4.03 | — | — |
| | 140M | Sep. 6, 2023 | 100 | 15.85 | 16.00 | 2.97 | 4.00 | — | — |
| | 140M | Sep. 22, 2023 | 200 | 15.80 | 15.88 | 2.95 | 4.00 | — | — |
| | 140M | Oct. 9, 2023 | 300 | 15.80 | 15.88 | 2.94 | 3.98 | 15,178 | 1,212 |
| | 140N | Aug. 21, 2023 | 0 | 16.95 | 16.00 | 3.00 | 4.09 | — | — |
| | 140N | Sep. 6, 2023 | 100 | 16.80 | 15.88 | 2.99 | 4.07 | — | — |
| | 140N | Sep. 22, 2023 | 200 | 16.75 | 15.88 | 2.96 | 4.06 | — | — |
| | 140N | Oct. 9, 2023 | 300 | 16.70 | 15.75 | 2.96 | 4.05 | 14,590 | 1,165 |
| | 140P | Aug. 21, 2023 | 0 | 15.55 | 16.00 | 2.90 | 4.09 | — | — |
| | 140P | Sep. 6, 2023 | 100 | 15.45 | 16.00 | 2.90 | 4.08 | — | — |
| | 140P | Sep. 22, 2023 | 200 | 15.40 | 15.88 | 2.88 | 4.08 | — | — |
| | 140P | Oct. 9, 2023 | 300 | 15.30 | 15.88 | 2.85 | 4.05 | 13,751 | 1,098 |
| | 140Q | Aug. 21, 2023 | 0 | 16.30 | 15.88 | 3.00 | 4.09 | — | — |
| | 140Q | Sep. 6, 2023 | 100 | 16.20 | 15.88 | 2.98 | 4.06 | — | — |
| | 140Q | Sep. 22, 2023 | 200 | 16.15 | 15.88 | 2.97 | 4.05 | — | — |
| | 140Q | Oct. 9, 2023 | 300 | 16.00 | 15.75 | 2.94 | 4.02 | 14,389 | 1,149 |
| | 140R | Aug. 21, 2023 | 0 | 16.20 | 15.13 | 2.96 | 4.08 | — | — |
| | 140R | Sep. 6, 2023 | 100 | 16.10 | 15.00 | 2.96 | 4.07 | — | — |
| | 140R | Sep. 22, 2023 | 200 | 16.05 | 15.00 | 2.94 | 4.07 | — | — |
| | 140R | Oct. 9, 2023 | 300 | 15.90 | 15.00 | 2.91 | 4.05 | 14,327 | 1,144 |
| | 140T | Aug. 21, 2023 | 0 | 16.00 | 16.00 | 2.95 | 4.08 | — | — |
| | 140T | Sep. 6, 2023 | 100 | 15.95 | 15.88 | 2.94 | 4.05 | — | — |
| | 140T | Sep. 22, 2023 | 200 | 15.90 | 15.75 | 2.93 | 4.05 | — | — |
| | 140T | Oct. 9, 2023 | 300 | 15.80 | 15.75 | 2.91 | 4.03 | 14,878 | 1,188 |
| | 140U | Aug. 21, 2023 | 0 | 16.40 | 16.13 | 2.98 | 4.09 | — | — |
| | 140U | Sep. 6, 2023 | 100 | 16.35 | 16.00 | 2.97 | 4.06 | — | — |
| | 140U | Sep. 22, 2023 | 200 | 16.25 | 16.00 | 2.97 | 4.05 | — | — |
| | 140U | Oct. 9, 2023 | 300 | 16.20 | 15.88 | 2.95 | 4.03 | 13,601 | 1,086 |

In Table 62, “PB45” is Portland cement, sand, aggregate and water, and binder reducing agent, tested in duplicate, triplicate, etc., as the case may be (“PB45” is sample 1 and “T139” is sample 2 from a pour, etc.). Per 18 3″×4″×16″ column: 38.4 lbs. of Portland I/II cement, 164 lbs. of medium to large aggregate (rock), 108 lbs. of fine aggregate (sand), and 22 lbs. of water and 2.7 lbs. of binder reducing formulation. All samples were mixed and cured pursuant to the guidelines of ASTM C192: Standard Practice for Making and Curing Concrete Test Specimens in the Lab. All sample specimens were tested pursuant to ASTM C78: Standard Test Method for Flexural Strength of Concrete (Using Simple Beam with Third Point Loading). Each sample was put through 300 cycles in a freeze/thaw machine model type Humboldt 3816S and tested according to ASTM C666: Standard Test Method for Resistance of Concrete to Rapid Freezing and Thawing.

TABLE 62

| Formula | ID # | Date | Cycles | Weight (lb) | Length | Width | Depth | LBF | PSI |
|---|---|---|---|---|---|---|---|---|---|
| PB45 | 139A | Jul. 14, 2023 | 0 | 17.45 | 16.06 | 3.20 | 4.13 | — | — |
| T139 | 139A | Jul. 31, 2023 | 100 | 17.45 | 16.06 | 3.17 | 4.20 | — | — |
| −20% | 139A | Aug. 17, 2023 | 200 | 17.45 | 16.06 | 3.19 | 4.09 | 13,413 | 1,071 |
| Portland | | | | | | | | | |
| I/II | | | | | | | | | |
| 1:3:2 Mix | 139B | Jul. 14, 2023 | 0 | 16.75 | 16.00 | 3.05 | 4.05 | — | — |
| Pour: | 139B | Jul. 31, 2023 | 100 | 16.75 | 16.06 | 3.05 | 4.07 | — | — |
| Jun. 30, 2023 | | | | | | | | | |
| | 139B | Aug. 17, 2023 | 200 | 16.70 | 16.06 | 3.06 | 4.08 | 10,369 | 828 |
| | 139C | Jul. 14, 2023 | 0 | 16.00 | 16.00 | 2.98 | 3.97 | — | — |
| | 139C | Jul. 31, 2023 | 100 | 16.00 | 16.13 | 2.98 | 4.08 | — | — |
| | 139C | Aug. 17, 2023 | 200 | 16.00 | 16.06 | 3.00 | 4.07 | 13,187 | 1,053 |
| | 139D | Jul. 14, 2023 | 0 | 15.80 | 16.00 | 2.93 | 4.06 | — | — |
| | 139D | Jul. 31, 2023 | 100 | 15.85 | 16.00 | 2.95 | 4.07 | — | — |
| | 139D | Aug. 17, 2023 | 200 | 15.80 | 16.06 | 2.96 | 4.05 | 11,922 | 952 |
| | 139E | Jul. 14, 2023 | 0 | 17.55 | 16.13 | 3.20 | 4.08 | — | — |
| | 139E | Jul. 31, 2023 | 100 | 17.60 | 16.13 | 3.20 | 4.09 | — | — |
| | 139E | Aug. 17, 2023 | 200 | 17.60 | 16.06 | 3.18 | 4.09 | 14,652 | 1,170 |
| | 139F | Jul. 14, 2023 | 0 | 15.65 | 16.00 | 3.03 | 3.99 | — | — |
| | 139F | Jul. 31, 2023 | 100 | 15.65 | 16.13 | 2.93 | 4.00 | — | — |
| | 139F | Aug. 17, 2023 | 200 | 15.60 | 16.06 | 2.94 | 4.02 | 12,599 | 1,006 |
| | 139G | Jul. 14, 2023 | 0 | 17.10 | 16.06 | 3.21 | 4.04 | — | — |
| | 139G | Jul. 31, 2023 | 100 | 17.30 | 16.13 | 3.18 | 4.03 | — | — |
| | 139G | Aug. 17, 2023 | 200 | 17.20 | 16.06 | 3.18 | 4.05 | 14,164 | 1,131 |
| | 139H | Jul. 14, 2023 | 0 | 15.95 | 16.00 | 3.01 | 3.96 | — | — |
| | 139H | Jul. 31, 2023 | 100 | 16.05 | 16.13 | 2.95 | 4.05 | — | — |
| | 139H | Aug. 17, 2023 | 200 | 16.00 | 16.06 | 3.00 | 4.00 | 10,758 | 859 |
| | 139J | Jul. 14, 2023 | 0 | 17.15 | 16.00 | 3.21 | 4.08 | — | — |
| | 139J | Jul. 31, 2023 | 100 | 17.15 | 16.13 | 3.14 | 4.11 | — | — |
| | 139J | Aug. 17, 2023 | 200 | 17.30 | 16.06 | 3.16 | 4.10 | 12,198 | 974 |

What is claimed is:

1. A binder reducing formulation for addition to a cementitious composition comprising a hydraulic binder, said binder reducing formulation comprising carbon nanotubes, glycerol, silane, nanosilica and a surfactant.

2. The binder reducing formulation of claim 1, wherein said carbon nanotubes are carboxylic acid functionalized.

3. The binder reducing formulation of claim 2, wherein said carbon nanotubes are multi-wall carbon nanotubes.

4. The binder reducing formulation of claim 1, wherein said surfactant comprises an organosilane.

5. The binder reducing formulation of claim 1, wherein said surfactant comprises (3-glycidoxypropyl)-trimethoxysilane.

6. A cementitious composition comprising a hydraulic binder and a binder reducing formulation comprising carbon nanotubes, glycerol, silane, nanosilica and a surfactant.

7. The cementitious composition of claim 6, wherein said hydraulic binder comprises Portland cement.

8. The cementitious composition of claim 7, further comprising aggregate.

9. The cementitious composition of claim 6, wherein the amount of said binder reducing agent is effective to achieve a mechanical strength of the cementitious composition 28 days after curing that is at least 5% greater than the mechanical strength 28 days after curing of an identical cementitious composition devoid of said binder reducing composition.

10. The cementitious composition of claim 6, wherein the amount of said binder reducing formulation is effective to achieve a mechanical strength of the cementitious composition 28 days after curing that is at least 10% greater than the mechanical strength 28 days after curing of an identical cementitious composition devoid of said binder reducing composition.

11. The cementitious composition of claim 6, further comprising one or more chemical admixtures selected from the group consisting of water-reducing agent, viscosity modifying agent, corrosion-inhibitor, shrinkage reducing admixture, set accelerator, set retarder, air entrainer, air detrainer, strength enhancer, pigment, colorant, thickener, and fiber for plastic shrinkage control or structural reinforcement.

12. The cementitious composition of claim 6, wherein said carbon nanotubes are acid-functionalized multi-wall carbon nanotubes.

13. A method of preparing a binder reducing formulation for incorporation into a cementitious composition to reduce the amount of a hydraulic binder in said cementitious composition without a concomitant loss in strength, comprising
a. preparing a first aqueous mixture of silane and glycerol;
b. combining carbon nanotubes and a surfactant, and subjecting the resulting combination to sonication, followed by incorporating a first portion of said first aqueous mixture to form a second mixture;
c. combining a second portion of said first aqueous solution with nanosilica and a surfactant to form a third mixture and applying sonication to said third mixture; and
d. combining said second and third mixtures to form said binder reducing composition.

14. The method of claim 13, wherein said first aqueous mixture is stored for at least about 2 hours prior to combining it with said second and third mixtures.

15. The method of claim 13, wherein said carbon nanotubes comprise carboxylic acid functionalized multi-wall carbon nanotubes.

16. The method of claim 13, wherein said surfactant comprises sulfonated melamine formaldehyde.

17. The method of claim 13, further comprising combining said binder reducing formulation with cementitious composition comprising a hydraulic binder to form a modified cementitious composition.

18. The method of claim 13, wherein said hydraulic binder comprises Portland cement.

19. The method of claim 17, wherein the amount of said hydraulic binder in said modified cementitious composition is 5% less than present in an identical composition devoid of said binder reducing agent without a loss in mechanical strength 28 days after curing.

20. The method of claim 17, wherein the amount of said hydraulic binder in said modified cementitious composition is at least 10% less than present in an identical composition devoid of said binder reducing agent without a loss in mechanical strength 28 days after curing.

21. The method of claim 17, wherein the amount of said hydraulic binder in said modified cementitious composition is at least 15% less than present in an identical composition devoid of said binder reducing agent without a loss in mechanical strength 28 days after curing.

22. The method of claim 17, wherein the amount of said hydraulic binder in said modified cementitious composition is at least 20% less than present in an identical composition devoid of said binder reducing agent without a loss in mechanical strength 28 days after curing.

23. The method of claim 17, wherein the amount of said hydraulic binder in said modified cementitious composition is at least 25% less than present in an identical composition devoid of said binder reducing agent without a loss in mechanical strength 28 days after curing.

24. The method of claim 17, wherein the amount of said hydraulic binder in said modified cementitious composition is at least 30% less than present in an identical composition devoid of said binder reducing agent without a loss in mechanical strength 28 days after curing.
